(19) United States
(12) Patent Application Publication
(10) Pub. No.: US 2025/0384733 A1
(43) Pub. Date: Dec. 18, 2025

(54) TECHNIQUES FOR PROVIDING INDIVIDUALIZED FINANCIAL SERVICES AND CONCURRENT MULTI-PLAYER AND MULTI-GAME WAGERING ON A SHARED WAGER-BASED ELECTRONIC GAMING MACHINE

(71) Applicant: Tech (Macau) Limited, Macau (MO)

(72) Inventors: Jay Chun, Hong Kong (HK); Hon Man Au, Coloane (MO); David Y. So, Macau (MO)

(73) Assignee: Tech (Macau) Limited, Macau (MO)

(21) Appl. No.: 19/237,187

(22) Filed: Jun. 13, 2025

Related U.S. Application Data
(60) Provisional application No. 63/660,458, filed on Jun. 14, 2024.

(51) Int. Cl. G07F 17/32; G07F 17/34

(52) U.S. Cl. CPC G07F 17/3225; G07F 17/34

(57) ABSTRACT

An improved electronic wager-based gaming machine (EGM) is disclosed. The EGM supports multiple concurrent players and maintains a plurality of distinct virtual meters, each exclusively associated with a distinct, concurrent game session on a single EGM. The server processes financial transactions, such as deposits and withdrawals using the EGM's cash handling peripherals, against a specific virtual meter and a corresponding player's casino account, which is maintained separate from the EGM's operational funds. This enables the EGM to act as a financial terminal for the player's account. Concurrently, data derived from the virtual meters is transformed and aggregated into a single, unified regulatory meter for compliance reporting, which is distinct from the virtual meters. The EGM provides a shared multiplayer interactive control interface to solve the technical problem of supporting multiple, independent player sessions concurrently on a single EGM.

### RELATED APPLICATION DATA

The present application claims benefit, pursuant to the provisions of 35 U.S.C. § 119, of U.S. Provisional Application Ser. No. 63/660,458 (Attorney Docket No. LTG1P006P), titled “MULTI-FUNCTIONAL WAGER-BASED GAMING MACHINE ENABLING SYNCHRONOUS AND ASYNCHRONOUS MULTIPLAYER INTERACTIONS AND GAME MECHANICS”, naming Chun et al. as inventors, and filed 14 Jun. 2024, the entirety of which is incorporated herein by reference for all purposes.

### BACKGROUND

Electronic Gaming Machines (EGMs) are a central component of the modern casino and wagering industry, providing a wide array of games to patrons. These devices have evolved from simple mechanical devices to sophisticated computer-based systems offering multiple game types on a single interface, including arrangements that support simultaneous play by multiple users. The financial accounting for these EGMs is a matter of strict regulatory oversight, and conventional systems are designed to meet these requirements by consolidating all financial activities on a given machine into a single set of meters for reporting.

This conventional approach to consolidated accounting, however, presents certain technical and operational challenges. For instance, in multi-game or multi-player environments, managing player funds may be cumbersome. Some known systems handle a player's departure from a multi-player session by processing a complete cash-out of all combined credits on the machine, which is then followed by a new buy-in for the remaining players. This process is operationally inefficient and disrupts the gameplay experience. Furthermore, this consolidated accounting model generally lacks the functionality for a player to conduct direct, individual financial transactions with their personal casino account through the EGM's interface.

Player tracking systems and associated casino accounts are also well-known in the industry, allowing casinos to manage player loyalty and for players to maintain a balance of funds. While players may transfer funds to an EGM to establish a credit meter for immediate gameplay, the EGM itself does not typically serve as a direct interface for managing the broader balance of the player's casino account. Consequently, players wishing to deposit cash into their account or make a cash withdrawal from their account balance are required to visit a separate casino cage, ATM, or kiosk. This separation of functions is an operational inefficiency and an inconvenience for the player.

Additionally, casinos employ Anti-Money Laundering (AML) systems to monitor for and report suspicious financial activities. Existing AML systems typically operate on a centralized, backend basis, analyzing aggregated data from numerous sources across the casino. A technical limitation of this approach is the potential time delay inherent in waiting for data to be collected, aggregated, and processed by a central system. This latency may result in suspicious patterns at a specific EGM being detected after the activity has already occurred, which poses a challenge for timely intervention and risk management.

### BRIEF DESCRIPTION OF THE DRAWINGS

FIG. 1 is a schematic block diagram illustrating an example of a network configuration for a plurality of gaming devices according to some embodiments;

FIGS. 2A-E are diagrams illustrating examples of gaming devices, systems, and networks according to various embodiments.

FIG. 3A is a block diagram depicting various functional elements of an EGM in an example embodiment.

FIG. 3B depicts a casino gaming environment in an example embodiment.

FIG. 4 is a diagram of components of a system for providing online gaming in an example embodiment.

FIG. 5 illustrates, in block diagram form, an implementation of a game processing architecture algorithm that implements a game processing pipeline for the play of a game in accordance with various implementations described herein.

FIG. 6 illustrates an example embodiment of a Gaming Network 600 which may be configured or designed to implement various automated money laundering detection and reporting techniques described and/or referenced herein.

FIG. 7 shows an example block diagram of an electronic gaming system 700 in accordance with a specific embodiment.

FIG. 8 shows electronic gaming table 760 with various features, in accordance with a specific embodiment.

FIG. 9 shows a block diagram of electronic gaming device 900, in accordance with a specific embodiment.

FIG. 10 is a simplified block diagram of an exemplary intelligent electronic gaming system 1000 in accordance with a specific embodiment.

FIG. 11 is a simplified block diagram of an exemplary mobile gaming device 1100 in accordance with a specific embodiment.

FIG. 12 illustrates an example of a functional block diagram of a Casino Gaming Server System in accordance with a specific embodiment.

FIG. 13 illustrates an alternate example embodiment of a Gaming Network 1300 which may be configured or designed to implement various automated money laundering detection and reporting techniques described and/or referenced herein.

FIG. 14 shows a block diagram illustrating components of a gaming system which may be used for implementing various aspects of example embodiments.

FIG. 15 shows an example embodiment of a VCLAPS! Multiplayer EGM with shared multiplayer interface and shared unitary game display.

FIG. 16 shows an alternate example embodiment of a VCLAPS! Multiplayer EGM with shared multiplayer shared unitary game display and integrated multiplayer touchscreen interface.

FIG. 17 shows an alternate example embodiment of a VCLAPS! Multiplayer EGM comprising shared unitary game display and individualized player game console interfaces.

Additional Figures depict various system diagrams, flow diagrams, and screenshots of graphical user interfaces which have been configured or designed to facilitate, enable, initiate, and/or perform one or more operation(s), action(s), and/or feature(s) of the VCLAPS! techniques described herein.

### DETAILED DESCRIPTION OF EXAMPLE EMBODIMENTS

### Overview

The following summary describes various features and concepts of a multi-functional, wager-based gaming system, hereinafter referred to as the VCLAPS! technology. The inventive concepts detailed herein are directed to different methods, systems, and computer program products that, individually and in combination, serve to improve conventional Electronic Gaming Machine (EGM) technology by enhancing its functionality, security, and user experience. These innovations introduce novel solutions to technical problems in casino operations, including the management of concurrent multiplayer gameplay, the integration of granular and regulatory financial metering, and the provision of advanced player services directly at the gaming terminal. Each of the subsequent summaries describes a specific innovative feature or concept that contributes to the overall novelty and utility of the VCLAPS! system, which is designed to support a more dynamic, interactive, and efficient gaming environment.

### Dual-Architecture Metering System for Individual Player Account Transactions at a Physical EGM

Existing Electronic Gaming Machine (EGM) systems face a significant technical problem in managing granular, individualized financial accounting for multiple concurrent players or games while also adhering to simplified regulatory reporting standards, which often rely on a single, consolidated credit meter. This limitation makes direct transactions with a player's personal casino account from the EGM cumbersome and operationally complex. The VCLAPS! system introduces a novel dual-architecture metering framework as its most significant innovative aspect, creating a specific technical solution to this problem. This system features a first server system, akin to a player tracking server, that establishes and maintains a plurality of distinct virtual meters, with each meter exclusively associated with a distinct game session or player, enabling direct fund transfers like deposits and withdrawals with a player's casino account which is maintained separately from the EGM's operational funds. For implementation, the physical EGM communicates over a secure casino network with this first server system to manage all player-specific virtual meter transactions, while data from these meters is concurrently aggregated into a separate, unified regulatory meter, which may be managed by the EGM or a second server system for compliance purposes. This architecture contributes to the overall novelty by providing a unique and improved EGM functionality that supports complex, individual financial interactions seamlessly alongside standard gameplay, a capability not clearly offered by conventional consolidated accounting methods.

Unified Multi-Game and Multi-Player Management on a Single Physical EGM with Segmented Unitary Touchscreen and Shared Hardware, Integrated with Dual-Architecture Metering

A primary technical problem in casino operations is the inefficient utilization of floor space and the limited gameplay variety available on a single EGM, as offering diverse game types or accommodating multiple players typically may require numerous distinct physical machines. The VCLAPS! system addresses this by introducing its most significant innovative aspect: the comprehensive integration of multi-game and multi-player management on a single EGM, featuring a dynamically segmented unitary touchscreen, shared hardware peripherals, and the foundational support of the dual-architecture metering system. This system allows multiple, different games, each with unique paytables and volatilities, to run concurrently and be controlled independently by either a single player or multiple players on the same machine. A Game Management System within the EGM orchestrates these concurrent sessions, dynamically segments the touchscreen with isolated input zones for each game, and arbitrates access to shared peripherals like a single bill acceptor and player tracking reader. For implementation, this GMS communicates with a first server system that manages the individual virtual meter for each concurrent session, while all financial data is also aggregated into the unified regulatory meter for compliance. This specific, holistic integration contributes to the technology's novelty by providing a unique technical solution that maximizes machine utility, enhances player choice, and solves the complex problem of managing granular, independent financial accounting for concurrent sessions on shared hardware, representing a significant advancement over prior art.

### Integrated EGM-Level Anti-Money Laundering (AML) Monitoring

An important problem for casino operators is the latency inherent in traditional Anti-Money Laundering (AML) systems, which typically operate on a centralized, backend basis and analyze aggregated data, leading to delays in detecting suspicious financial activities. The VCLAPS! system addresses this with its core innovative aspect: the integration of AML monitoring mechanisms directly within the physical EGM or in close conjunction with the server managing its virtual meters, enabling real-time analysis at the transaction's point of origin. The primary feature of this concept is its ability to leverage granular, high-resolution data from individual virtual meters, EGM transaction peripherals, and player gameplay behavior to identify suspicious patterns like structuring or minimal play as they unfold. For implementation, a dedicated software module running on the EGM or the first server system applies a rule engine and pattern recognition algorithms to the real-time data streams. If a suspicious pattern is detected, the system generates an immediate alert that is transmitted over the secure casino network to a central compliance system or relevant personnel. This EGM-level monitoring contributes to the overall novelty by representing a specific technological improvement in how gaming technology addresses financial crime, moving from reactive, delayed analysis to proactive, localized detection that enhances the security and compliance of the entire gaming environment.

### Physical EGM as a Personal ATM for Player Tracking Accounts

In a typical casino environment, players face a fragmented and inefficient process for managing their funds, often requiring them to leave the gaming floor and visit a separate ATM kiosk or the main casino cage to conduct transactions with their player accounts. The VCLAPS! system solves this problem through its notable innovative aspect: transforming the physical EGM into a versatile financial terminal that functions as a personal ATM for a player's specific casino tracking account. This feature allows a player to use the EGM's existing cash handling peripherals to perform direct financial transactions, such as depositing cash into their account or making cash withdrawals from it, potentially independent of any immediate wagering activity. This functionality is implemented through the EGM's user interface, which provides options for account management upon secure authentication via a player card and PIN or biometrics. The EGM communicates these transaction requests securely to a first server system that manages the player account database, which in turn authorizes the transaction and commands the EGM's hardware to dispense or accept cash. One aspect of novelty of this concept lies in its unique integration of direct player account management into the EGM itself, a capability not offered by conventional systems, thereby improving EGM utility and providing a new level of player convenience.

### Server Interaction Architecture and Data Exchange

A significant technical challenge in advanced gaming systems is designing a server architecture capable of managing diverse, concurrent financial activities on a shared device, ensuring both granular player-specific transaction integrity and simplified, consolidated regulatory compliance. The VCLAPS! system addresses this with its innovative tiered server interaction architecture that supports the dual-architecture metering system. The core of this concept is the defined functional separation between a First Server System (analogous to a Player Tracking server) and a Second Server System (a Casino Management System). The First Server System's primary role is to manage the plurality of distinct virtual meters, handle real-time player account transactions, and process granular gameplay data for each concurrent session on an EGM. In contrast, the Second Server System is responsible for maintaining the single, unified regulatory meter by receiving and processing aggregated financial data derived from the virtual meters. For implementation, these systems communicate over a secure TCP/IP network using encrypted protocols like TLS/SSL, with robust data reconciliation mechanisms to ensure consistency between the two metering layers. This specific architecture contributes to the invention's novelty by providing a defined, secure, and auditable framework that is a technological improvement over monolithic EGM accounting systems, enabling complex individualized financial control while maintaining streamlined compliance.

### AML Detection Algorithms and Logic

Detecting sophisticated money laundering schemes like structuring or minimal play in real-time at the EGM level presents a significant technical problem that simple transaction monitoring cannot solve. The innovative aspect of this concept is the implementation of specific, localized Anti-Money Laundering (AML) detection algorithms and logic within the VCLAPS! system, which leverage the granular data from individual virtual meters to perform this analysis. The scope of this concept includes the deployment of a rule engine and pattern recognition to analyze a combination of financial transaction data, gameplay behavior, and virtual meter fund flows. Notable features are the specific algorithms designed to detect suspicious activities, such as calculating the wager-to-deposit ratio to flag minimal play, monitoring transaction sequences for structuring, and analyzing betting patterns for anomalies. This logic is implemented as a software module on the EGM or its associated first server system, where it continuously processes real-time data streams and triggers alerts if predefined thresholds are breached. This contributes to the overall novelty by embedding intelligent, specific analytical capabilities into the EGM system's core functionality, representing a technological improvement that moves beyond mere data collection to active, automated threat detection at the point of origin.

### Intelligent Shared Multiplayer Touchscreen Control Interface

The VCLAPS! EGM introduces an adaptable shared multiplayer touchscreen control interface to solve the technical problem of supporting multiple, independent player sessions concurrently on a single physical screen. This innovation addresses the rigidity of traditional EGM hardware by creating a multi-zone touchscreen interface where different regions of the same display are independently and concurrently mapped to different players engaged in their own wager-based gameplay. The system dynamically assigns inputs from multiple sets of physical or virtual buttons to these distinct player sessions, ensuring complete control isolation. For instance, a software controller intelligently recognizes the active multiplayer mode and maps each button set to a specific player's session, processing inputs based on screen coordinates or source to guarantee that one player's actions exclusively affect their own game. This is implemented via a sophisticated UI management system that virtualizes input segmentation and routes commands only to the appropriate player's game logic engine, providing independent, real-time visual feedback within each player's dedicated screen zone. This concept's contribution to novelty lies in its unique and flexible human-computer interaction model, which transforms the EGM from a solitary device into a true parallel gaming console for multiple users, significantly enhancing machine utility and creating an entirely new social and interactive gaming environment on a single machine.

### Dynamic Touchscreen Segmentation and Input Logic

Providing multiple, simultaneous, and independent gaming experiences on a single physical screen poses the complex technical problem of processing user inputs for one interactive application without interfering with other concurrently running applications on the same display. The innovative aspect of this concept is a sophisticated software architecture that enables the dynamic segmentation of a unitary touchscreen display, coupled with logic for independent input processing and isolated UI rendering for each segment. The primary feature is the system's ability to divide the touchscreen into distinct active zones, each mapped to a separate game instance and displaying its own set of virtual controls. A Game Management System within the EGM captures the raw coordinates of any touch event, determines which segment was touched, and routes the corresponding command exclusively to that segment's game logic engine, ensuring complete input isolation. Implemented via specialized UI management and rendering software on the EGM's processor and GPU, this system manages viewports and resource allocation to prevent any visual or functional interference between the concurrent game UIs. This contributes to one aspect of novelty of the overall technology stack by providing a specific technological improvement to the EGM's human-computer interaction capabilities, enabling a true, seamless multi-game or multi-player experience on a single device.

### Proportional Award Calculation Methods

In cooperative multiplayer gaming, a significant problem is the fair distribution of collective awards, as a simplistic equal split fails to recognize or incentivize individual player contributions, skill, or investment. The innovative aspect of this concept is a server-based system that utilizes specific, configurable algorithms to proportionally calculate and distribute prizes among participating players based on their tracked in-game actions and contributions. The system's scope includes the ability to track diverse contribution parameters such as wagers placed, specific tasks completed, points scored, or role-based duties performed. Notable features are the different calculation methods, which may be points-based, weighted according to the importance of actions, or directly proportional to financial stake, allowing for flexible and fair reward structures tailored to each cooperative game's design. This system is implemented on the first server system, which receives detailed player action data from the EGM, applies the relevant distribution algorithm, and sends secure commands back to the EGM to update each player's virtual meter with their calculated share. This contributes to the invention's novelty by providing a technological improvement in the management of complex social gaming mechanics, automating a fair and nuanced reward adjudication process that enhances player engagement.

### EGM-as-ATM Authentication and Security

An important technical problem in enabling an Electronic Gaming Machine (EGM) to function as an ATM for player accounts is the need for a security framework far more robust than that required for standard gameplay, in order to prevent unauthorized access and fraudulent financial transactions. The innovative aspect of this concept is a multi-faceted security architecture designed specifically for the EGM-as-ATM functionality, integrating multi-factor authentication, secure server-side transaction authorization, and comprehensive, immutable audit trails. The scope of this feature includes enforcing strong player authentication at the EGM, typically using a player tracking card combined with a PIN or biometric data, before any account access is granted. Furthermore, all communications between the EGM and the authorizing first server system are encrypted, and the EGM's cash-handling hardware is controlled by specific, secure commands from the server, which only issues them after validating the transaction and player's account status. This is implemented via a defined protocol where the EGM captures authentication credentials, the server validates them against a secure database, and only then transmits a signed, encrypted command packet to activate the EGM's physical cash dispenser. This contributes to the technology's novelty by providing a technological improvement that elevates the EGM's computer functionality to that of a secure financial terminal, solving the problem of safeguarding direct access to a player's main casino funds via a public gaming device.

### Technological Improvements and Practical Applications

Conventional Electronic Gaming Machines (EGMs) present several technical problems, including inefficient use of casino floor space, limited player choice on a single device, cumbersome fund management processes, and security vulnerabilities related to modern transactional demands. The VCLAPS! system's core innovation is its holistic integration of multiple novel features to create a technologically superior and more versatile gaming platform that solves these issues. The system's scope encompasses a dual-architecture metering framework for granular yet compliant accounting, EGM-as-ATM functionality for streamlined fund management, unified multi-game and multi-player operation on a dynamically segmented touchscreen to maximize machine utility, and integrated real-time AML monitoring for enhanced security. These features are implemented through a distributed network of computers—the EGM with its advanced UI and game management logic, and specialized server systems for player account management and regulatory aggregation—all interconnected via secure communication protocols. The primary contribution to novelty is this specific, synergistic combination of functionalities. The VCLAPS! system represents a tangible technological improvement to the EGM's underlying computer functioning, enabling it to manage concurrent applications, perform secure financial intermediation, and conduct localized data analysis, thereby providing practical solutions to concrete problems in casino operations.

### Alternative Server Architectures

A significant technical problem in deploying advanced gaming networks is the lack of architectural flexibility, as a rigid, one-size-fits-all server configuration may be inefficient across different casino environments with varied network capabilities and data center strategies. The innovative aspect of the VCLAPS! system is its inherent design for architectural adaptability, allowing its core functionalities to be deployed in multiple configurations, such as a distributed model or a logically-separated single-server model, without compromising the fundamental dual-architecture metering logic. Notable features include a distributed model where a powerful EGM processor handles real-time virtual meter updates locally to reduce network latency, and a consolidated model where the First and Second Server Systems operate as separate, firewalled virtual machines on the same physical hardware to reduce the data center footprint. This is implemented by leveraging either the EGM's own processing power for local logic execution or using virtualization technology within the casino's data center to host multiple server roles on one machine, with secure virtual networking ensuring logical separation. This architectural flexibility is a technological improvement that contributes to the invention's novelty by providing adaptable solutions that optimize resource usage—be it network bandwidth, EGM processing power, or server hardware—to fit a casino's specific operational context.

### Expanded Cooperative Game Modes

Traditional multiplayer electronic games in casinos often suffer from a limited scope of cooperation, typically confined to shared jackpots or simplistic team scores, which fails to meet the demand from modern players for more strategic and socially interactive experiences. The VCLAPS! system addresses this by introducing an architecture that supports advanced and diverse cooperative game modes, with its most innovative aspect being the ability to facilitate deep, interdependent team-based play. The system's features include a “Team Bank” mode, where players pool funds into a special-purpose shared virtual meter for a collective mission, and a “Player-Triggered Feature Unlock” mode, where one player's achievement directly activates a bonus or advantage for their teammates. These modes are implemented through the First Server System, which manages the complex accounting of shared virtual meters, and the EGM's Game Management System, which acts as a real-time message bus to handle event-driven communications between concurrent game sessions. This concept's contribution to novelty lies in its technological improvement to EGM computer functioning, elevating it from running isolated parallel games to managing complex, logical interactions between them, thereby enabling a more dynamic and strategically rich cooperative entertainment experience.

### Data Transformation Specifies

To be patent-eligible, an invention must represent a technological improvement rather than merely organizing or processing data; a notable technical problem is clearly articulating how data is fundamentally changed to achieve a specific technical purpose. The innovative aspect of the VCLAPS! system is that its core functionality is dependent on several specific and non-trivial data transformations that are integral to its operation. The system's scope includes at least three such transformations: first, it transforms raw player transaction requests from the EGM into secure, authenticated database commands that precisely modify financial records in the player account database. Second, it transforms a continuous stream of granular virtual meter events into a consolidated, single-context summary data packet formatted for the unified regulatory meter. Third, it transforms a high-level server authorization decision into an encrypted, low-level hardware command packet that is uniquely interpreted by an EGM microcontroller to execute a physical action, like dispensing cash. These are implemented by processors across the distributed system. This concept's contribution to novelty is that it explicitly defines how the system improves computer functioning by changing data's structure and utility to solve concrete technical problems, such as enabling secure remote control over physical hardware and managing distinct, concurrent views of financial data.

### Hardware Control Specifies

A significant technical problem in distributed gaming systems is how to securely and reliably bridge a logical, server-side financial decision with a precise physical action at a remote EGM, as a generic approval signal lacks the required security and auditability for financial transactions. This inventive concept addresses the problem with its most innovative aspect: a specific and secure protocol enabling a server system to exert direct, low-level control over the EGM's physical hardware components. The scope of this feature involves the server generating a structured, encrypted, and digitally signed hardware command packet upon authorizing a physical event like a cash withdrawal. This packet contains specific command identifiers, parameters, a unique transaction ID, and security tokens. For implementation, the EGM's dedicated hardware microcontroller is programmed with firmware that securely interprets this specific command packet, directly activating motors and optical sensors to perform the precise physical action, such as counting and dispensing an exact number of bills. This mechanism contributes to the invention's novelty by providing a technological improvement to the computer functioning of both the server and the EGM, creating a secure, tightly coupled system where every physical hardware action is verifiably tied to an authorized and auditable server-side transaction.

### User Interface Customization

A common problem with multi-game EGM interfaces is their rigid and static design, which does not accommodate individual player preferences for the layout, size, or prominence of different game displays, leading to a less engaging user experience. The innovative aspect of this concept is the introduction of a user-driven UI customization capability within the VCLAPS! system, allowing players to dynamically resize game segments and save their preferred layouts to a personal profile. The scope of this feature includes a layout editing mode with draggable borders for resizing concurrent game windows on the unitary touchscreen, along with the ability to save a named layout configuration—including segment sizes, positions, and assigned games—to a player's account. This is implemented through the EGM's Game Management System, which handles real-time UI rendering in response to user gestures, and through secure communication with the First Server System, which stores and retrieves the personalized layout data from the player's account database. This concept contributes to one aspect of novelty by providing a technological improvement to EGM computer functionality, enabling advanced, user-driven graphical rendering and creating a persistent, personalized user environment that follows the player across different physical machines on the casino network.

### Biometric Authentication Details

The use of traditional PIN-based authentication at an EGM presents a significant security problem, as PINs may be forgotten, stolen, or observed, creating vulnerabilities for systems that allow direct financial transactions with a player's casino account. The VCLAPS! system addresses this through its innovative integration of biometric authentication as a robust and secure method for authorizing high-security transactions like the EGM-as-ATM functionality. The scope of this concept includes utilizing EGM-equipped hardware, such as a fingerprint scanner or a high-resolution camera for facial recognition, to capture a player's unique biological data. The process involves a secure, one-time enrollment where a player's biometric sample is converted into an encrypted mathematical template and stored with their account on the First Server System. For transaction verification, a live template is generated at the EGM and sent to the server for a high-speed, one-to-one comparison against the enrolled template. This is implemented via a defined workflow where the EGM captures the data and the server performs the matching. This feature contributes a significant technological improvement to the gaming system's security, enhancing computer function by enabling the EGM as a secure biometric capture terminal and the server as a specialized matching engine, thereby providing a more reliable and fraud-resistant method of user verification.

### Multiple Games Sharing Unified Meters and a Single Cashbox

Casino operators face the technical problem of operational and regulatory complexity when managing a diverse gaming floor, as each traditional EGM may require individual financial tracking. The innovative aspect of the VCLAPS! system is its ability to run multiple, distinct games concurrently on a single physical EGM while channelling all financial activity through a unified metering infrastructure and a single, common cashbox. This concept's primary feature is that, despite hosting varied game states and player sessions, the entire multi-game apparatus is treated as a singular EGM from an operational and regulatory perspective. The system uses a centralized transaction processor and a unified credit meter to consolidate all coin-in, coin-out, and credit balance transactions in real-time, simplifying floor management and reporting. This is implemented via a multi-threaded software architecture on the EGM's central controller, which isolates game logic but routes all financial transaction requests through a single, shared module that updates the master meters. One aspect of novelty of this foundational architecture lies in its ability to improve machine utility and floor space efficiency while simultaneously streamlining backend auditing and regulatory compliance by treating a complex multi-game device as a simple, single financial entity.

### Linked Jackpot, Competitive, and Cooperative Game Modes

A significant limitation of traditional EGMs is their solitary and repetitive nature, which often fails to provide the dynamic social and competitive interactions that modern gamers seek. Integrating diverse multiplayer mechanics into a regulated, wager-based EGM presents technical challenges related to data synchronization, session management, and fair outcome determination. The VCLAPS! system's innovative aspect is its flexible architecture, uniquely designed to support a variety of distinct multiplayer modes-including shared progressive jackpots, player-versus-player competitions, and collaborative team missions-on one unified platform. The scope of this concept covers the management of jackpot contributions from linked games, real-time score tracking for competitive play, and the aggregation of team contributions for cooperative objectives. Implementation relies on a central multiplayer session controller, operating on the EGM and backend server, which synchronizes player actions and shared game data (like jackpot pools or team scores) across all active sessions. This feature's contribution to the overall novelty is its ability to seamlessly integrate and manage these fundamentally different social gaming mechanics, transforming the EGM from a static wagering device into a dynamic and versatile social entertainment hub.

### Multiple Player Buttons and Multi-Game Control

Physical EGM interfaces are traditionally rigid, designed for a single player and a single game, which is a technical problem that limits machine utility and prevents more flexible use cases. The innovative aspect of this concept is the implementation of an adaptable player control interface that may dynamically map inputs from multiple physical or virtual button sets to different game sessions, enabling both concurrent multiplayer and solo multi-game scenarios. The scope of this feature allows an EGM to be configured with multiple sets of player buttons or to present distinct virtual button sets on its touchscreen. A software controller then intelligently recognizes the active play mode and maps inputs accordingly; in multiplayer mode, each button set controls a separate player's session, while in solo multi-game mode, one player may use the different button sets to manage several games at once. This is implemented via a controller interface logic that dynamically assigns input devices to active game engines, ensuring complete input isolation. This concept contributes to the overall novelty by solving the problem of rigid hardware design, creating a physically adaptable EGM that significantly enhances machine utility and allows one device to serve multiple distinct gameplay scenarios.

### Independent Mapping of the Same Touchscreen to Different Games

A technical problem with conventional multi-game EGMs is that they force players to switch between full-screen interfaces, making it impossible to interact with or monitor several games simultaneously and creating a disjointed user experience. The most significant innovative aspect of this concept is the implementation of a multi-zone touchscreen interface where different regions of the same physical screen are independently and concurrently mapped to distinct, fully active games. The scope of this feature includes the parallel processing of user inputs, ensuring that a touch or gesture within one screen region exclusively affects the corresponding game session, thereby providing complete control isolation. Each segmented zone delivers independent visual feedback and real-time updates for its respective game. This is implemented through a sophisticated software architecture within the EGM that virtualizes input segmentation; a UI management system maps input coordinates to a specific game zone and routes the command only to that zone's associated game engine. This concept's contribution to one aspect of novelty is its unique human-computer interaction model, which transforms the EGM from a sequential game-switcher into a parallel game management console, thereby improving usability and creating new strategic possibilities for players.

### Same Touchscreen, 3 Sets of Virtual Buttons, Each Mapped to a Different Game, That Are Independently Controllable

A significant technical problem in designing intuitive multi-game EGM interfaces is providing clear and non-interfering controls for each concurrently running game on a single screen, as physical buttons are inflexible. The innovative aspect of this concept is the specific implementation of multiple, distinct sets of virtual buttons on a shared touchscreen, where each set is independently controllable and explicitly mapped to a different game instance. The scope of this feature includes presenting a segmented touchscreen where each game's zone contains a unique and complete set of virtual controls, such as spin, bet adjustment, and paytable access, relevant to its specific gameplay. A notable feature is that the system is designed to process inputs from one set of virtual buttons so that they only influence their respective game, enabling parallel operation without cross-game interference. Implemented through the EGM's software, which dynamically generates and assigns these button sets to specific screen zones, the system's input detection is coordinate-based, ensuring that an action on a virtual button is exclusively routed to the correct game's logic engine. This concept contributes to the overall novelty by solving the problem of control ambiguity on a shared screen, thereby providing a specific and improved technical means for user interaction that is important to enabling the complex, simultaneous gameplay scenarios of the VCLAPS! system.

Virtual Meters Sets with Aggregation for Regulatory Reporting and Routing to Player Accounts

In a multi-game or multi-player EGM environment, a technical problem arises from the conflicting needs to track player-specific financial activity for personalization and loyalty, while also satisfying gaming regulations that often may require a single, consolidated accounting record for the entire machine. The innovative aspect of this concept is a hierarchical metering system that uses individual “virtual meter sets” for each game or player session, which are then aggregated into a single unified credit meter set for regulatory reporting. Each game on the EGM is associated with its own virtual meter set to independently track all financial transactions, and these virtual meters may be linked to separate player tracking accounts for personalized rewards and analytics. A notable feature is the system's ability to route different virtual meter sets to different player accounts, facilitating complex multi-player financial tracking. This is implemented via a first server system that manages the individual virtual meters for each session, while an aggregation module on the EGM or a second server system combines the data from these virtual meters into a single, compliant report. This dual-layer structure is a novel technological solution that enables advanced, granular financial management for multiple concurrent sessions while ensuring streamlined regulatory compliance.

### AML (Anti-Money Laundering) Mechanisms Built In

A persistent problem for casino operators is the security risk and regulatory burden associated with money laundering, where traditional AML systems that rely on centralized, backend analysis often suffer from detection delays. The VCLAPS! system addresses this through its innovative integration of Anti-Money Laundering (AML) monitoring mechanisms and logic directly into the EGM's operational framework, enabling real-time analysis at the point of transaction. The scope of this concept includes the continuous monitoring of gameplay and financial transactions for patterns indicative of illicit activity, such as structuring deposits or minimal play before a cash-out. These activities are analyzed against predefined criteria, and any suspicious patterns are automatically flagged, logged in detail, and compiled into reports for regulatory review. The AML monitoring is implemented as a software module within the EGM or its closely coupled first server system, applying advanced algorithms to real-time data from transaction peripherals and virtual meters and generating immediate alerts to security personnel when necessary. One aspect of novelty of this concept lies in embedding this intelligence directly into the EGM, providing a localized, real-time monitoring capability that is a specific technological improvement over delayed, centralized analysis, thus offering a more proactive and robust solution to mitigating financial crime risks.

### Single Meter Set

Offering multiple concurrent games on a single Electronic Gaming Machine (EGM) presents a significant technical problem related to accounting complexity and auditing efficiency, as separate physical metering for each game would increase hardware costs and operational overhead. This inventive concept solves this problem by consolidating all financial transactions from every concurrent game into a single, unified meter set for the entire EGM. The innovative aspect is this complete aggregation, where all bets, wins, and credit transfers across all active games are channeled into one authoritative financial record in real-time, from an operational and regulatory perspective. Notable features include displaying a player's total financial status across all their engaged games and using this single meter set as the sole source for generating financial reports for auditing and regulatory compliance, which streamlines the process immensely. This is implemented within the EGM's financial processing unit, which is architected to automatically aggregate transaction data from each independent game instance as it occurs, constantly updating the single master meter set stored in the EGM's memory. This concept's contribution to novelty lies in its elegant simplification of complex multi-game financial management, ensuring the advanced, multi-functional EGM remains as straightforward to audit and manage as a traditional single-game machine.

### Single Bill Acceptor

A significant design problem for a multi-game or multi-player EGM is the potential need for redundant hardware, as providing separate currency inputs for each concurrent session would increase the machine's cost, physical size, complexity, and points of failure. The innovative aspect of this concept is the integration of a single, shared bill acceptor that serves as the unified currency input mechanism for all games and player sessions hosted on the EGM. The scope of this feature is to have one physical device receive and validate all cash or ticket inputs, with the EGM's software then intelligently allocating the credits to the appropriate game session or player account. After currency is inserted, the player may be prompted via the user interface to assign the funds to a specific active virtual meter. This system leverages advanced validation technologies to ensure high security while minimizing hardware. It is implemented by treating the bill acceptor as a shared hardware resource managed by the EGM's central controller, which uses software logic to route the credited amount correctly based on player input. This concept's novelty lies in its provision of a more efficient and streamlined physical design, solving the problem of hardware duplication to reduce manufacturing costs, simplify the user experience, and improve the EGM's overall reliability.

### Single Coin Box

In a multi-game EGM that handles physical coins, a notable technical problem is the mechanical complexity and operational inefficiency that would result from using separate coin boxes for each concurrent game, which would complicate cash handling and auditing. The innovative aspect of this concept is the centralization of all physical coin collection from multiple games and player sessions into a single, secure, and shared coin box integrated within the EGM. The scope of this feature is to have one physical repository for all validated coins inserted into the machine, regardless of the game being played, thereby simplifying the internal hardware design and maintenance routines. This is implemented by having the EGM's central controller manage the physical routing of all accepted coins into the single collection box, while the EGM's accounting software logs the transaction and updates the correct virtual credit meter. This ensures that although the physical storage is consolidated, the financial attribution of the transaction remains accurate for each session. This concept's contribution to the invention's novelty lies in its simplification of the EGM's internal architecture and cash management procedures, solving the problem of hardware redundancy to reduce operational costs, enhance machine reliability, and streamline the physical auditing process.

### Single Player Tracking Reader

A notable problem in designing a multi-game or multi-player EGM is how to handle player identification efficiently without cluttering the machine with redundant hardware or creating a confusing user experience. The innovative aspect of this concept is the integration of a single, shared player tracking reader that serves as the unified point of authentication and identification for all concurrent games and player sessions on the EGM. The primary feature of this system is its ability to associate data from a single physical reader (using RFID or magnetic stripe technology) with multiple different active sessions. The EGM's software manages this association, for instance by handling sequential card swipes to link different players to different game segments on the screen. All subsequent gameplay and transaction data is then correctly associated with the appropriate player profile in real-time. This is implemented via the EGM's central controller, which, upon a card swipe, communicates with the user interface and the first server system to link the identified player to a specific game session and its virtual meter. One aspect of novelty of this concept is its streamlined solution for user identification in a complex multi-session environment, solving the problem of hardware redundancy to enable seamless, personalized player tracking on a single, shared device.

### Single GM Running Multiple Game Sessions by Different Players

A fundamental technical problem in creating a true multi-player EGM is managing multiple independent game sessions for different players concurrently on a single set of hardware, ensuring each session operates with the integrity and isolation of a dedicated machine. The innovative aspect of this concept is the implementation of a single, centralized Game Manager (GM) module within the EGM's software architecture, designed specifically to orchestrate these distinct, simultaneous game sessions. The scope of this GM is to act as a central controller that manages the entire lifecycle of each player's session, from initiation and resource allocation to the independent processing of inputs and the correct attribution of financial transactions to each player's respective credit meter. This is implemented as a core software component on the EGM's processor that uses advanced partitioning algorithms and session management protocols to sandbox each game instance, preventing any crossover or interference between them. This concept contributes to the overall novelty by providing a specific technological solution for robust concurrent session management on shared hardware, which is a cornerstone of the VCLAPS! multi-player capability and enables significant gains in machine utilization and operational efficiency.

Multiple Different Concurrent Games with Different Paytables and Volatilities

A problem with many multi-game EGMs is that they offer games with similar mathematical structures or may require players to switch between them sequentially. The innovative aspect of the VCLAPS! system is its architectural capability to not only run multiple games concurrently but to support games with fundamentally different paytables and volatility models operating side-by-side in real-time. The scope of this feature is to provide players with a diverse portfolio of risk and reward experiences on a single machine at the same time. For example, a player may engage with a high-volatility, large-jackpot game in one screen segment while simultaneously playing a low-volatility, frequent-hit game in another. This is implemented by having each game run as a separate software instance, each with its own embedded mathematical logic. The EGM's game management system launches these distinct instances and ensures that the financial and gameplay data for each is processed independently according to its unique rules before being routed to the correct virtual meter. One aspect of novelty of this concept lies in the system's ability to manage and present this mathematical diversity concurrently within a single, compliant framework, representing a technological improvement that offers players unparalleled choice and allows operators to maximize the appeal of a single gaming machine.

### Head-to-Head (Competitive) Game Play & Betting Modes

Traditional EGM gameplay is a fundamentally solitary experience, pitting a player against the house, which is a limitation that fails to attract players seeking more social and competitive forms of entertainment. The innovative aspect of this concept is the integration of a head-to-head competitive gameplay and betting mode directly into the EGM's software, allowing players to compete against each other in real-time on the same machine. The scope of this feature includes pairing players for competition, tracking individual performance metrics like scores or speed, and displaying these results for both players to see. A notable feature is the ability for players to place wagers on the outcome of the competition, with the system acting as an adjudicator to determine the winner and process the peer-to-peer payout. This mode is implemented through the EGM's Game Management System, which synchronizes the start of the game for the paired players and communicates with a competition module to track scores and outcomes. The system's financial layer is configured to handle the betting between players' virtual meters. One aspect of novelty of this concept is its transformation of the EGM into a platform for direct, social competition, solving the problem of its solitary nature and introducing skill-based elements that enhance player engagement.

### Team Play (Cooperative) Game Play & Betting Modes

The technical problem of the traditionally solitary nature of Electronic Gaming Machine (EGM) play limits social interaction and fails to cater to groups seeking a shared, collaborative entertainment experience, which is a significant missed opportunity for player engagement. The innovative aspect of this concept is the full integration of a team play cooperative gameplay and betting mode, enabling multiple players to work together towards a common objective on a single EGM. The scope of this feature allows players to form teams and engage in games where their combined actions influence the outcome, with the system tracking the team's collective progress in real-time. A notable feature is the ability for team members to place bets on the cooperative session, with rewards being distributed among the team based on their joint performance. This mode is implemented through the EGM's Game Management System, which groups players into teams and initiates a cooperative session managed by a server-side controller that synchronizes inputs, aggregates progress metrics, and handles reward distribution to players' virtual meters. One aspect of novelty of this concept lies in its ability to transform the EGM into a hub for collaborative social entertainment, solving the technical challenges of synchronizing team actions and managing collective rewards in a regulated wagering environment.

Virtual Machines and Virtual Meter Sets That Combine into One ‘Physical’ Meter Set to Report to Game Server

A significant technical problem in managing multiple distinct game instances on a single EGM is maintaining software isolation for stability while ensuring financial data may be reported in a simple, consolidated format for regulatory compliance. The innovative aspect of this concept is an architecture where individual games are operated as distinct “virtual machine” instances, each with its own sandboxed virtual meter set, with the data from all virtual meters being programmatically aggregated into a single “physical” meter set for reporting. The scope includes each virtual game instance tracking its financial transactions independently, while a backend aggregator service merges all virtual meter outputs into one consolidated dataset representing the EGM's total activity for server reporting. This is implemented using a hypervisor or containerization layer on the EGM to manage the concurrent execution of isolated game instances, each of which communicates financial data to a virtual meter system. A separate software module then aggregates this data for reporting to the central game server. This concept contributes to one aspect of novelty by applying a virtualization and abstraction model to EGM management, providing a technologically superior solution that ensures software stability while solving the problem of complex reporting by creating a clear, two-level system of detailed virtual meters and a simplified, aggregated physical meter.

### Dividing Awards, Payouts, Prizes Between Players (Proportionality)

In cooperative multiplayer games, the technical problem of equitably distributing a collective reward often leads to dissatisfaction, as a simple equal split fails to recognize players' varying levels of skill, effort, or financial contribution. The innovative aspect of this concept is a dynamic and automated system for dividing awards, payouts, and prizes proportionally based on players' tracked in-game contributions. The system's scope includes logging each player's specific contributions, such as bets placed, notable actions taken, or performance scores. Upon achieving a win, a server-side algorithm calculates each player's proportional share of the total reward based on this recorded data. For implementation, the EGM reports detailed player action data to the first server system, which stores predefined contribution rules, executes the calculation, and sends secure commands back to the EGM to credit the precise, calculated amounts to each player's respective virtual meter. One aspect of novelty of this concept lies in its automated and fair adjudication of collective rewards. It solves the problem of simplistic prize distribution by providing a technologically advanced and equitable solution that enhances player trust and engagement by ensuring individual effort is directly and proportionally rewarded.

### Players Bet Against Each Other: Double Down During Competition

A problem in existing player-versus-player competitive modes on EGMs is the lack of dynamic, high-stakes decision-making, as static wager amounts limit the strategic depth and excitement found in other competitive formats. This concept introduces the innovative feature of a “double down” betting mechanic within a head-to-head competitive gameplay mode, allowing players to strategically increase their wager against an opponent mid-game. The scope of this feature enables players at designated moments to double their initial bet, with the system recalculating potential payouts and updating game odds to reflect the new stakes. It is implemented within the EGM's game logic, which presents the “double down” option to a player and, if selected, communicates the increased bet to a betting system module that verifies fund availability from the player's virtual meter and adjusts the match's financial parameters. One aspect of novelty of this concept lies in its introduction of dynamic, strategic betting to a competitive EGM environment. It solves the problem of static peer-to-peer wagers by adding a layer of risk management and psychological strategy, significantly enhancing player engagement by allowing them to leverage their confidence or skill to increase potential winnings.

### Multiple Player Tracking Cards Linked to the EGM for Tax and Regulatory Purposes

When multiple players use a single EGM for concurrent but separate gaming sessions, a significant technical problem arises in accurately tracking and associating all financial activity with the correct individual for tax and regulatory compliance. The innovative aspect of this concept is a system that allows multiple, distinct player tracking cards to be concurrently linked to a single EGM, with the underlying software ensuring that all gameplay and financial data is correctly segregated and associated with the respective player's account. The scope of this feature is to have the EGM's single card reader recognize each unique player card and link it to a specific game session and virtual meter, often displayed in a separate segment of the screen. As players engage in their games, all wins and losses are meticulously logged under their individual accounts, enabling the generation of separate, accurate reports for tax and compliance purposes for each person who used the machine. This is implemented via the EGM's central controller, which manages the single reader and communicates with the first server system to associate each authenticated player with a specific session and virtual meter. One aspect of novelty lies in its seamless solution to the complex data association problem in a multi-user, single-device environment, enabling new forms of social gaming while maintaining discrete and compliant financial data paths for each user.

### For Tax Purposes, Individual Game Winnings Reported Under Players' Tax IDs

A significant technical problem and regulatory burden for both casino operators and players is the accurate tracking and reporting of gambling winnings for tax purposes, a process that is often manual and prone to error on shared or complex gaming machines. The innovative aspect of this concept is a fully integrated system that automatically associates all winnings from a specific game session with the corresponding player's tax ID and generates the necessary compliance reports. The scope of this feature ensures that when a player initiates a session with their player tracking card, their associated tax ID is securely linked to all financial transactions within that session. The system tracks all bets and wins in real-time, and upon a reportable win, it may automatically generate the required documentation (such as a W-2G in the U.S.) by attributing the specific winnings to the correct player's tax ID. This is implemented by leveraging the secure link between the player tracking card, the player profile on the first server system (which contains the tax ID), and the virtual meter for the game session. One aspect of novelty is the automation of this important compliance task at the individual session level, solving the problem of manual tracking by creating a direct, secure link between game outcomes and a player's tax identity.

### Rewards Based on Player Longevity and Loyalty

A problem with many traditional casino loyalty programs is their reliance on simple point-per-dollar metrics, which often fails to adequately reward diverse styles of play, such as long sessions with smaller bets or frequent, shorter visits, thus missing notable opportunities for player retention. The innovative aspect of this concept is a dynamic rewards engine that tracks and provides incentives based on a broader set of player longevity and loyalty metrics beyond mere wagering volume. The scope of this feature includes a system that tracks not only wager amounts but also the total duration of play, frequency of visits, and patterns of consistent engagement over time. Based on these metrics, a loyalty algorithm awards points or unlocks tiered benefits, and the player's progress toward the next reward tier may be displayed in real-time on the EGM interface. This is implemented via the Player Tracking System on the first server, which receives and processes detailed gameplay data from the EGM, calculates loyalty points based on configurable rules, and communicates updates back to the EGM for display. This concept's novelty lies in its more holistic and nuanced approach to player rewards, solving the problem of one-dimensional loyalty schemes by creating a more engaging retention tool that recognizes a wider range of valuable player behaviors.

### Real-Time Multi-Player Soft Meter Tracking and Player Tracking Account Logging

In a multi-player EGM environment, the technical problem of accurately tracking individual in-game activities and financial transactions for each concurrent player in real-time is a significant data management challenge that, if unsolved, compromises fairness, personalization, and compliance. The innovative aspect of this concept is a system that maintains multiple, separate “soft meters” to individually and concurrently track the activities of each player, and then logs this data to each player's respective tracking account in real-time. The scope of this feature is to allocate a dedicated soft meter to each player on the EGM, which tracks their specific bets, wins, losses, and other in-game activities without interference from other sessions. A notable feature is the real-time logging of this granular data to each individual's central player tracking account. This is implemented through the EGM's central controller, which manages the multiple software-based soft meters, and its network components, which transmit these real-time updates to the first server system for logging in the appropriate player account database. This concept's novelty lies in its robust, real-time, and individualized tracking architecture for a multi-player device, solving the problem of data ambiguity and delayed reporting in shared gaming environments and providing a foundational data structure for fair and personalized multiplayer experiences.

Various aspects described or referenced herein are directed to different methods, systems, and computer program products directed to electronic gaming devices and VCLAPS! techniques implemented in a wager-based gaming networks.

In at least one embodiment, various method(s), system(s) and/or computer program product(s) may be operable to cause at least one processor to execute a plurality of instructions stored in non-transient memory for: Presenting a plurality of game options on a single touchscreen interface of an Electronic Gaming Machine (EGM); Receiving cash or ticket inputs through a bill validator, and validating said inputs; Updating a unified credit meter in response to the validated cash or ticket inputs; Allowing players to select and engage with multiple game options independently on the same EGM; Aggregating all financial transactions, including coins in, coins out, and bets placed across multiple games, into a unified metering system; Coordinating the operation of multiple games via a central game management system, ensuring shared use of the metering system and cash box without interference between games; Processing each transaction in real-time to update the unified credit meter accordingly; Logging all game state updates, bet amounts, win amounts, and credit adjustments in a centralized database for auditing and compliance purposes; Displaying updated credit balances to the players in real-time across all engaged games; Consolidating credits from all active games into a single transaction upon a player's cash-out request; Resetting the EGM interfaces and metering system after each cash-out to maintain readiness for subsequent players; Implementing robust error-checking mechanisms to detect and resolve transaction discrepancies, and employing security protocols to prevent fraud and tampering.

In at least one embodiment, various method(s), system(s) and/or computer program product(s) may be operable to cause at least one processor to execute a plurality of instructions stored in non-transient memory for: Presenting a plurality of diverse game options on a single touchscreen interface of an Electronic Gaming Machine (EGM); Enabling players to select from a variety of game types, including individual play games, games linked to a progressive jackpot, competitive games, and cooperative mission games; Managing game mechanics and interactions via advanced software architecture that integrates each game type into the shared financial and operational infrastructure of the EGM; Handling game state updates, bet amounts, win amounts, and credit adjustments dynamically based on the selected game type; Allowing seamless switching between different game types without requiring players to cash out or reset the machine; Aggregating progressive jackpot contributions from relevant games into a pooled jackpot fund; Tracking competitive game scores in real-time and facilitating score comparisons among players; Coordinating cooperative mission progress among multiple players to collectively achieve game objectives; Updating the unified credit meter to reflect transactions from all engaged game types; Logging all game and financial transactions in a centralized database for auditing and regulatory compliance; Displaying real-time game outcomes and financial transactions to players; Ensuring error detection and resolution mechanisms to maintain the integrity of game interactions and financial transactions; Protecting against fraud and tampering through robust security protocols.

In at least one embodiment, various method(s), system(s) and/or computer program product(s) may be operable to cause at least one processor to execute a plurality of instructions stored in non-transient memory for: Presenting a user interface on an Electronic Gaming Machine (EGM) with multiple player buttons to accommodate concurrent multiplayer gameplay or solo gameplay with multiple games; Receiving inputs from players via the player buttons and recognizing the selected play mode as either multiplayer or solo; Displaying a selection of games on the EGM's touchscreen interface, allowing players to choose their preferred games; Configuring the EGM interface dynamically based on the chosen play mode, providing dedicated controls and displays for each player in multiplayer mode, or unified controls for a single player managing multiple games in solo mode; Processing game selections and initializing the chosen games independently for each player or game session; Managing and synchronizing player inputs for multiplayer mode, ensuring independent game control and preventing input interference between players; Handling multiple game instances for a single player in solo mode, ensuring synchronization and distinct game state maintenance for each game; Updating game states, bet amounts, win amounts, and credit adjustments in real-time based on player inputs and game outcomes; Displaying real-time updates on game status and credit balances to each player or for each game instance; Logging all gameplay and financial transactions in a centralized database, ensuring compliance with regulatory standards and facilitating auditing; Implementing robust error detection and handling mechanisms to ensure accurate input processing and secure financial transactions; Securing data integrity and preventing tampering through advanced security protocols; Resetting the EGM interfaces and preparing for subsequent players upon the conclusion of each gaming session.

In at least one embodiment, various method(s), system(s) and/or computer program product(s) may be operable to cause at least one processor to execute a plurality of instructions stored in non-transient memory for: Presenting a segmented touchscreen interface on an Electronic Gaming Machine (EGM), each segment independently mapped to different games; Allowing players to select and engage with multiple games simultaneously by interacting with distinct sections of the touchscreen; Detecting and processing touch inputs within each segmented zone independently, ensuring that inputs for one game do not interfere with another; Managing game logic and responses for each game based on the respective touchscreen interactions; Updating game states, bet amounts, win amounts, and credit adjustments in real-time according to player interactions within each segment; Providing visual feedback and game updates within each touchscreen segment, reflecting real-time game status and outcomes; Logging interaction data and financial transactions from each segmented zone separately, facilitating detailed tracking and analysis; Implementing error-checking algorithms to ensure accurate touch detection and input processing; Protecting against input spoofing and ensuring data integrity through advanced security measures; Resetting the segmented touchscreen interface upon the conclusion of player sessions, preparing for new interactions without residual data from previous sessions.

In at least one embodiment, various method(s), system(s) and/or computer program product(s) may be operable to cause at least one processor to execute a plurality of instructions stored in non-transient memory for: Presenting a segmented touchscreen interface on an Electronic Gaming Machine (EGM), each segment featuring a unique set of virtual buttons mapped to different games; Enabling players to select the multi-game mode and presenting segmented zones on the touchscreen interface with virtual buttons corresponding to each game; Allowing players to choose from multiple games displayed in different segments of the touchscreen interface; Receiving player inputs via virtual buttons within each designated game zone; Processing player inputs in real-time, ensuring that each set of virtual buttons influences only its respective game; Managing game logic and responses for each game independently based on the inputs received from the corresponding virtual buttons; Updating game states, bet amounts, win amounts, and credit adjustments in real-time according to player interactions within each game zone; Providing real-time feedback and game state updates to players based on their interactions with the virtual buttons; Logging gameplay and financial transaction data separately for each game zone, facilitating detailed tracking and analysis; Implementing error detection and input processing mechanisms to prevent cross-game interference and ensure data integrity; Securing data handling and protecting against input spoofing through robust security measures; Resetting the segmented touchscreen interface upon the conclusion of player sessions, preparing for new interactions without residual data from previous sessions.

In at least one embodiment, various method(s), system(s) and/or computer program product(s) may be operable to cause at least one processor to execute a plurality of instructions stored in non-transient memory for: Presenting game options on an Electronic Gaming Machine (EGM) interface; Enabling players to link gameplay to their tracking accounts or play anonymously; Associating each selected game with its own set of virtual meters for tracking financial transactions; Updating virtual meters in real-time as players engage with games, tracking bets, wins, and balances for each game; Displaying real-time updates to players on their financial status, reflecting changes in virtual meters; Linking virtual meters to individual player accounts for personalized tracking and displaying updated financial statuses; Aggregating data from virtual meters for compliance reporting, ensuring accurate tracking and analysis of financial transactions; Logging detailed gameplay and transaction data at both the game and account levels, facilitating regulatory compliance and auditing; Implementing error detection and data validation mechanisms to ensure accurate financial tracking and protect against data manipulation or loss; Providing secure access to individual game data through player accounts, enabling players to review their gameplay history and financial status; Aggregating virtual meters into a unified report at the end of gameplay for regulatory compliance and operational review.

In at least one embodiment, various method(s), system(s) and/or computer program product(s) may be operable to cause at least one processor to execute a plurality of instructions stored in non-transient memory for: Presenting game options on an Electronic Gaming Machine (EGM) interface and enabling players to engage with their selected games; Continuously monitoring gameplay and financial transactions in real-time using AML mechanisms integrated within the EGM; Analyzing player behavior and transaction patterns against predefined criteria to detect potential money laundering activities; Flagging suspicious activities and generating real-time alerts for further review; Logging detailed gameplay and transaction data, highlighting flagged activities for easy retrieval and analysis; Compiling reports of flagged activities for regulatory review and further investigation; Implementing robust error detection and data validation protocols to ensure accurate monitoring and alerting; Securing data integrity and player privacy through advanced security measures; Maintaining continuous monitoring until the player completely disengages from the gaming session, ensuring all transactions within the session are vetted for compliance.

In at least one embodiment, various method(s), system(s) and/or computer program product(s) may be operable to cause at least one processor to execute a plurality of instructions stored in non-transient memory for: Presenting multiple game options on an Electronic Gaming Machine (EGM) interface; Allowing players to engage with various games and tracking all financial transactions (bets, wins, and credits) for each game; Aggregating financial data from all active games into a single meter set in real-time; Displaying real-time updates to players, reflecting their financial status across all engaged games; Logging all game-related financial transactions in a centralized database to facilitate auditing and compliance with gaming regulations; Generating financial reports from the aggregated data within the single meter set for regulatory purposes; Implementing error detection and handling mechanisms to ensure accurate aggregation and reporting of financial data; Securing financial data and preventing data corruption or loss through robust security measures; Providing a consolidated financial report upon the conclusion of gameplay, ready for regulatory compliance and operational review; Resetting the financial tracking system to clear temporary records and prepare for subsequent players.

In at least one embodiment, various method(s), system(s) and/or computer program product(s) may be operable to cause at least one processor to execute a plurality of instructions stored in non-transient memory for: Presenting multiple game options on an Electronic Gaming Machine (EGM) interface; Receiving currency inputs from players through a single bill acceptor integrated into the EGM; Validating the inserted currency using advanced validation technologies; Updating the player's account with credits corresponding to the validated currency; Allowing players to use the credited amounts to engage with various games available on the EGM; Consolidating all financial transactions from multiple games through the single bill acceptor; Displaying real-time credit updates to players, reflecting their available balance; Logging all currency transactions in a centralized database for auditing and regulatory compliance; Implementing error detection and handling protocols to manage misreads or hardware malfunctions; Securing financial data and ensuring high security and acceptance rates through robust security measures; Resetting the system to accept new transactions continuously and prepare for subsequent players.

In at least one embodiment, various method(s), system(s) and/or computer program product(s) may be operable to cause at least one processor to execute a plurality of instructions stored in non-transient memory for: Presenting multiple game options on an Electronic Gaming Machine (EGM) interface; Allowing players to insert coins into a coin slot integrated into the EGM; Validating the inserted coins using advanced validation technologies; Updating the player's account with credits corresponding to the validated coins; Enabling players to use the credited amounts to engage with various games available on the EGM; Collecting all validated coins into a single coin box integrated within the EGM; Managing all coin-related transactions through the single coin box to simplify hardware design and maintenance; Displaying real-time credit updates to players, reflecting their available balance; Logging all coin transactions in a centralized database for auditing and regulatory compliance; Implementing error detection and handling mechanisms to prevent jams and ensure accurate dispensing of coins; Securing financial data and preventing fraud through robust security measures; Resetting the system to prepare for new coin transactions continuously.

In at least one embodiment, various method(s), system(s) and/or computer program product(s) may be operable to cause at least one processor to execute a plurality of instructions stored in non-transient memory for: Presenting a user interface on an Electronic Gaming Machine (EGM) equipped with a single player tracking reader; Receiving player identification data via the player tracking reader, which may utilize RFID or magnetic stripe technology; Verifying the received player identification data and retrieving the corresponding player profile from a central database; Linking the player profile to the current gaming session, enabling personalized game suggestions and loyalty rewards based on the player's history; Displaying personalized game options and special offers on the EGM interface tailored to the player's preferences and historical data; Tracking player actions and gameplay data in real-time, associating this data with the player's profile; Updating the player's profile with new gameplay data, including points earned, bets placed, and game selections; Logging detailed player interactions and financial transactions in a centralized database to facilitate auditing and regulatory compliance; Implementing error detection and handling mechanisms to ensure accurate player tracking and data integrity; Securing player data against unauthorized access through robust security protocols; Resetting the player tracking system at the end of the gaming session, ensuring readiness for subsequent players and maintaining continuous data integrity.

In at least one embodiment, various method(s), system(s) and/or computer program product(s) may be operable to cause at least one processor to execute a plurality of instructions stored in non-transient memory for: Presenting a user interface on an Electronic Gaming Machine (EGM) capable of running multiple game sessions concurrently for different players; Allowing players to insert cash or tickets into the EGM and validating these inputs through a bill validator; Updating individual player credit meters corresponding to the validated inputs; Enabling each player to select a game from the available options on the EGM interface; Initiating independent game sessions for each player based on their selected games; Processing each game session independently, including updating game states, bet amounts, win amounts, and credit adjustments in real-time; Displaying real-time updates on game outcomes and credit balances to each player; Logging all gameplay and financial transactions for each game session in a centralized database for auditing and regulatory compliance; Implementing robust error-checking mechanisms to prevent transaction errors and ensure data integrity across concurrent game sessions; Protecting against fraud and tampering through advanced security protocols; Resetting each game session interface upon the conclusion of the player's gaming session, ensuring readiness for new players.

In at least one embodiment, various method(s), system(s) and/or computer program product(s) may be operable to cause at least one processor to execute a plurality of instructions stored in non-transient memory for: Presenting a user interface on an Electronic Gaming Machine (EGM) that offers multiple different games concurrently, each with its own paytable and volatility; Allowing players to insert cash or tickets into the EGM and validating these inputs through a bill validator; Updating individual player credit meters corresponding to the validated inputs; Enabling players to select from a variety of games displayed on the EGM interface, each game having distinct paytables and volatility levels; Initiating and managing each selected game independently, applying the specific paytable and volatility rules associated with each game in real-time; Processing game states, bet amounts, win amounts, and credit adjustments independently for each game based on the respective paytables and volatilities; Displaying real-time updates on game outcomes and credit balances to players based on their individual game sessions; Logging all gameplay and financial transactions for each game session in a centralized database to facilitate auditing and regulatory compliance; Implementing error-checking mechanisms to ensure accurate application of paytables and game rules; Securing financial transactions and protecting against fraud through robust security protocols; Resetting each game session interface upon the conclusion of the player's gaming session, ensuring readiness for new players.

In at least one embodiment, various method(s), system(s) and/or computer program product(s) may be operable to cause at least one processor to execute a plurality of instructions stored in non-transient memory for: Presenting a user interface on an Electronic Gaming Machine (EGM) that offers a head-to-head competitive game mode; Allowing players to insert cash or tickets into the EGM and validating these inputs through a bill validator; Updating player credit meters corresponding to the validated inputs; Enabling players to select the head-to-head competitive mode from the available game options; Pairing players for competition and displaying the game rules for head-to-head competition; Allowing players to place bets and initiating the competitive gameplay session; Tracking each player's performance and updating scores in real-time based on their gameplay actions; Processing game states, bet amounts, win amounts, and score adjustments independently for each player; Displaying real-time score updates and game outcomes to players; Logging all gameplay and financial transactions in a centralized database for auditing and regulatory compliance; Implementing error detection and handling mechanisms to ensure accurate score tracking and fair play; Protecting against fraud and tampering through robust security protocols; Resetting the competitive game interface upon the conclusion of the game session, ensuring readiness for subsequent players.

In at least one embodiment, various method(s), system(s) and/or computer program product(s) may be operable to cause at least one processor to execute a plurality of instructions stored in non-transient memory for: Presenting a user interface on an Electronic Gaming Machine (EGM) that offers a team play cooperative game mode; Allowing players to insert cash or tickets into the EGM and validating these inputs through a bill validator; Updating player credit meters corresponding to the validated inputs; Enabling players to select the team play cooperative mode from the available game options; Grouping players into teams and displaying the game rules for team play; Allowing players to place bets and initiating the cooperative gameplay session; Tracking each team's performance and updating scores in real-time based on their combined gameplay actions; Processing game states, bet amounts, win amounts, and score adjustments for each team; Displaying real-time score updates and game outcomes to all team members; Logging all gameplay and financial transactions in a centralized database for auditing and regulatory compliance; Implementing error detection and handling mechanisms to ensure accurate score tracking and fair play; Protecting against fraud and tampering through robust security protocols; Distributing rewards among team members based on their cooperative performance; Resetting the cooperative game interface upon the conclusion of the game session, ensuring readiness for subsequent players.

In at least one embodiment, various method(s), system(s) and/or computer program product(s) may be operable to cause at least one processor to execute a plurality of instructions stored in non-transient memory for: Presenting multiple game options on an Electronic Gaming Machine (EGM) interface; Enabling players to select and engage with various games offered on the EGM; Creating virtual game instances for each selected game and associating each with a virtual meter set to track financial transactions; Aggregating data from all virtual meter sets in real-time to form a single physical meter set for reporting purposes; Displaying real-time updates to players, reflecting their financial status across all engaged games; Logging all game-related financial transactions in a centralized database to facilitate auditing and regulatory compliance; Generating comprehensive financial reports from the aggregated data within the physical meter set for regulatory compliance; Implementing error detection and handling mechanisms to ensure accurate financial tracking and reporting; Securing financial data and preventing data corruption or loss through robust security measures; Providing consolidated financial reports upon the conclusion of gameplay, ready for regulatory compliance and operational review; Resetting the virtual and physical meter sets to clear temporary records and prepare for subsequent players.

In at least one embodiment, various method(s), system(s) and/or computer program product(s) may be operable to cause at least one processor to execute a plurality of instructions stored in non-transient memory for: Presenting a user interface on an Electronic Gaming Machine (EGM) that tracks player contributions during gameplay; Allowing players to insert cash or tickets into the EGM and validating these inputs through a bill validator; Updating player credit meters corresponding to the validated inputs; Enabling players to select their games and engage with them; Tracking each player's contributions to game outcomes in real-time, including bets placed, actions taken, and performance metrics; Calculating each player's proportional share of the total awards, payouts, or prizes based on their contributions; Displaying real-time updates to players, showing their contributions and potential proportional rewards; Distributing awards, payouts, or prizes proportionally to players based on the calculated contributions; Logging all gameplay, contribution data, and financial transactions in a centralized database for auditing and regulatory compliance; Implementing error detection and handling mechanisms to ensure accurate tracking and proportional distribution of rewards; Protecting against fraud and tampering through robust security protocols; Resetting the game interface upon the conclusion of the gaming session, ensuring readiness for subsequent players.

In at least one embodiment, various method(s), system(s) and/or computer program product(s) may be operable to cause at least one processor to execute a plurality of instructions stored in non-transient memory for: Presenting a user interface on an Electronic Gaming Machine (EGM) that supports competitive gameplay where players bet against each other; Allowing players to insert cash or tickets into the EGM and validating these inputs through a bill validator; Updating player credit meters corresponding to the validated inputs; Enabling players to select the competitive mode and choose to bet against each other; Pairing players for head-to-head competition and displaying the game rules and betting options; Allowing players to place initial bets and engage in gameplay where they can double down at any point; Tracking each player's bets, including initial and double-down bets, in real-time; Updating player balances based on the outcomes of the competitive gameplay and bets placed; Displaying real-time updates to players, showing their current bets, balances, and game status; Logging all gameplay and betting transactions in a centralized database for auditing and regulatory compliance; Implementing error detection and handling mechanisms to ensure accurate bet tracking and fair play; Protecting against fraud and tampering through robust security protocols; Resetting the competitive game interface upon the conclusion of the gaming session, ensuring readiness for subsequent players.

In at least one embodiment, various method(s), system(s) and/or computer program product(s) may be operable to cause at least one processor to execute a plurality of instructions stored in non-transient memory for: Presenting a user interface on an Electronic Gaming Machine (EGM) that supports betting with odds offered by the casino; Allowing players to insert cash or tickets into the EGM and validating these inputs through a bill validator; Updating player credit meters corresponding to the validated inputs; Enabling players to select the betting mode where they bet against the casino with offered odds; Displaying the available games and the corresponding odds offered by the casino for each game; Allowing players to place bets based on the displayed odds and engage in gameplay; Calculating potential payouts based on the odds and the amount bet by the player; Tracking player bets and updating their balances in real-time based on game outcomes and the casino's odds; Displaying real-time updates to players, showing their current bets, potential payouts, and game status; Logging all gameplay and betting transactions in a centralized database for auditing and regulatory compliance; Implementing error detection and handling mechanisms to ensure accurate bet tracking and fair play; Protecting against fraud and tampering through robust security protocols; Resetting the betting interface upon the conclusion of the gaming session, ensuring readiness for subsequent players.

In at least one embodiment, various method(s), system(s) and/or computer program product(s) may be operable to cause at least one processor to execute a plurality of instructions stored in non-transient memory for: Presenting a user interface on an Electronic Gaming Machine (EGM) that facilitates individual game winnings reporting under players' tax IDs; Allowing players to insert their player tracking cards into the EGM and validating these inputs; Verifying the player identification data and retrieving the corresponding player profiles from a central database; Linking each game session to the respective player profile, ensuring that all gameplay data and winnings are associated with the correct player; Tracking all financial transactions, including bets placed, winnings earned, and credits adjusted, in real-time during gameplay; Associating each financial transaction with the player's tax ID and updating the player's profile accordingly; Displaying real-time updates to players, reflecting their current game status, winnings, and associated tax implications; Logging all gameplay and financial transactions in a centralized database for auditing, tax reporting, and regulatory compliance; Generating detailed tax reports based on the tracked data, ensuring that individual winnings are reported under the respective players' tax IDs; Implementing error detection and handling mechanisms to ensure accurate tracking and reporting of financial transactions; Securing player data and protecting against unauthorized access through advanced security protocols; Resetting the EGM interface upon the conclusion of the gaming session, ensuring readiness for subsequent players.

In at least one embodiment, various method(s), system(s) and/or computer program product(s) may be operable to cause at least one processor to execute a plurality of instructions stored in non-transient memory for: Presenting a user interface on an Electronic Gaming Machine (EGM) that supports rewards based on player longevity and loyalty; Allowing players to insert their player tracking cards into the EGM and validating these inputs; Verifying player identities and retrieving their profiles from a central database; Displaying current rewards status, including accumulated points and progress towards the next reward tier, based on the player's history of playtime and frequency of visits; Tracking player actions and gameplay data in real-time, including playtime duration, wager amounts, and frequency of visits; Awarding loyalty points to players based on predefined criteria such as duration of play, amounts wagered, and frequency of visits; Updating player profiles with new loyalty points and rewards status in real-time; Displaying real-time updates to players, showing their progress and points earned; Notifying players when they reach new reward tiers or earn bonuses; Allowing players to redeem accumulated loyalty points for rewards such as free spins, bonus credits, or physical gifts; Logging detailed gameplay, loyalty points, and rewards data in a centralized database for auditing and regulatory compliance; Implementing error detection and handling mechanisms to ensure accurate tracking of player activity and points accumulation; Securing player data against unauthorized access through advanced security protocols; Resetting the player tracking system at the end of the gaming session, ensuring readiness for subsequent players.

In at least one embodiment, various method(s), system(s) and/or computer program product(s) may be operable to cause at least one processor to execute a plurality of instructions stored in non-transient memory for: Presenting a user interface on an Electronic Gaming Machine (EGM) that supports real-time multi-player soft meter tracking and player tracking account logging; Allowing players to insert their player tracking cards into the EGM and validating these inputs through the player tracking readers; Verifying player identities and retrieving their profiles from a central database; Allocating soft meters to each player for tracking individual in-game activities and financial transactions in real-time; Enabling players to select and engage with various games offered on the EGM; Continuously updating each player's soft meter to track bets, wins, losses, and other in-game activities; Displaying real-time updates to players, reflecting their current game status, bets, wins, and losses; Logging all player activities and financial transactions to their individual player tracking accounts in real-time; Storing detailed logs of player activities and soft meter data in a centralized database for auditing and regulatory compliance; Implementing error detection and handling mechanisms to ensure accurate tracking and logging of player activities and financial transactions; Securing player data and preventing unauthorized access through advanced security protocols; Resetting the EGM interface and soft meter tracking system upon the conclusion of the gaming session, ensuring readiness for subsequent players.

In at least one embodiment, various method(s), system(s) and/or computer program product(s) may be operable to cause at least one processor to execute a plurality of instructions stored in non-transient memory for: Presenting a user interface on an Electronic Gaming Machine (EGM) that connects to a single game state server; Allowing players to insert cash or tickets into the EGM and validating these inputs; Updating player credit meters corresponding to the validated inputs; Enabling players to select and engage with various games offered on the EGM; Establishing a connection between the EGM and the single game state server; Transmitting game state data between the EGM and the game state server in real-time, ensuring synchronization of game progress and outcomes; Processing game states, bet amounts, win amounts, and credit adjustments in real-time based on player interactions; Displaying real-time updates to players, reflecting their current game status and credit balances; Logging all gameplay and financial transactions in a centralized database for auditing and regulatory compliance; Implementing error detection and handling mechanisms to ensure accurate synchronization of game states and financial transactions; Securing data transmission and protecting against unauthorized access through advanced security protocols; Resetting the EGM interface and game state server connection upon the conclusion of the gaming session, ensuring readiness for subsequent players.

Various objects, features and advantages of the various aspects described or referenced herein will become apparent from the following descriptions of its example embodiments, which descriptions should be taken in conjunction with the accompanying drawings.

### SPECIFIC EXAMPLE EMBODIMENTS

Various techniques will now be described in detail with reference to a few example embodiments thereof as illustrated in the accompanying drawings. In the following description, numerous specific details are set forth in order to provide a thorough understanding of one or more aspects and/or features described or reference herein. It will be apparent, however, to one skilled in the art, that one or more aspects and/or features described or reference herein may be practiced without some or all of these specific details. In other instances, well known process steps and/or structures have not been described in detail in order to not obscure some of the aspects and/or features described or reference herein.

One or more different inventions may be described in the present application. Further, for one or more of the invention(s) described herein, numerous embodiments may be described in this patent application, and are presented for illustrative purposes only. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. To the contrary, a variety of optional components are described to illustrate the wide variety of possible embodiments of one or more of the invention(s).

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

When a single device or article is described, it will be readily apparent that more than one device/article (whether or not they cooperate) may be used in place of a single device/article. Similarly, where more than one device or article is described (whether or not they cooperate), it will be readily apparent that a single device/article may be used in place of the more than one device or article.

The functionality and/or the features of a device may be alternatively embodied by one or more other devices that are not explicitly described as having such functionality/features. Thus, other embodiments of one or more of the invention(s) need not include the device itself.

Techniques and mechanisms described or reference herein will sometimes be described in singular form for clarity. However, it should be noted that particular embodiments include multiple iterations of a technique or multiple instantiations of a mechanism unless noted otherwise.

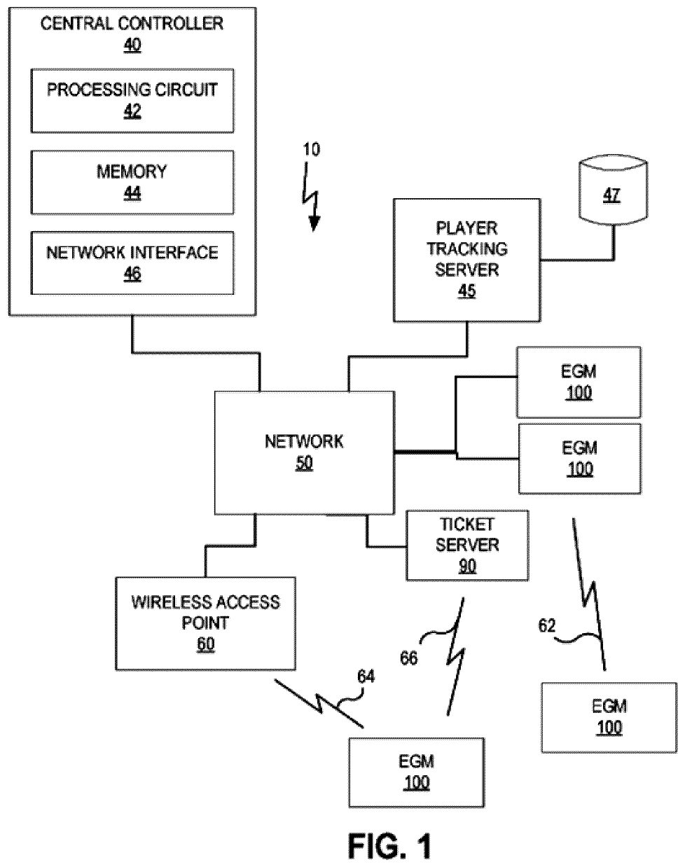

FIG. 1 illustrates a gaming system 10 including a plurality of gaming devices 100. As discussed above, the gaming devices 100 may be one type of a variety of different types of gaming devices, such as electronic gaming machines (EGMs), mobile devices, or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security.

The central controller 40 may be any suitable server or computing device which includes at least one processor circuit and at least one memory or storage device. Each gaming device 100 may include a processor circuit that transmits and receives events, messages, commands or any other suitable data or signal between the gaming device 100 and the central controller 40. The gaming device processor circuit is operable to execute such communicated events, messages or commands in conjunction with the operation of the gaming device 100. Moreover, the processor circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processor circuits. Moreover, in some embodiments, one or more of the functions of one or more gaming device processor circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processor circuit that transmits and receives events, messages, commands or any other suitable data or signal between the ticket server 90 and the central controller 40. The ticket server 90 processor circuit may be operable to execute such communicated events, messages or commands in conjunction with the operation of the ticket server 90. Moreover, in some embodiments, one or more of the functions of one or more ticket server 90 processor circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, an NFC link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

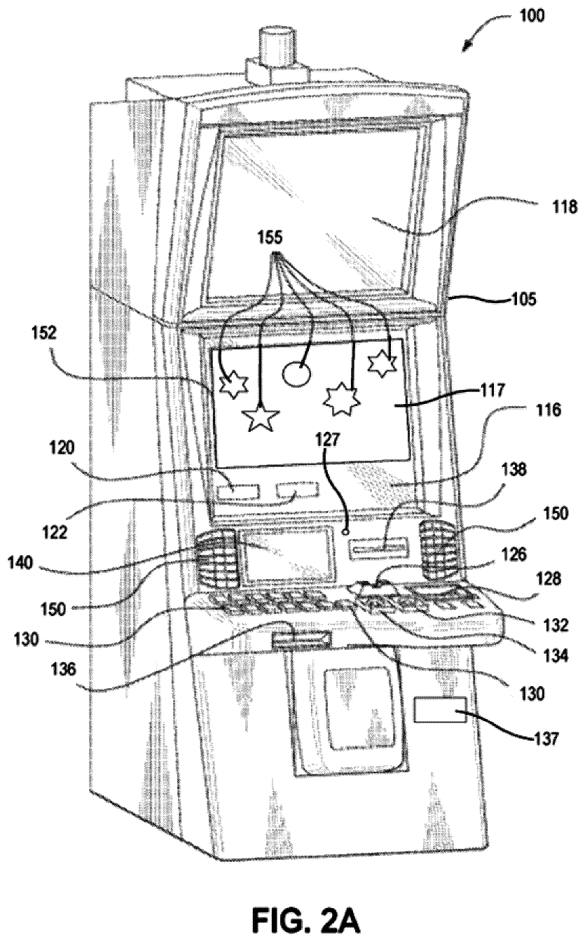

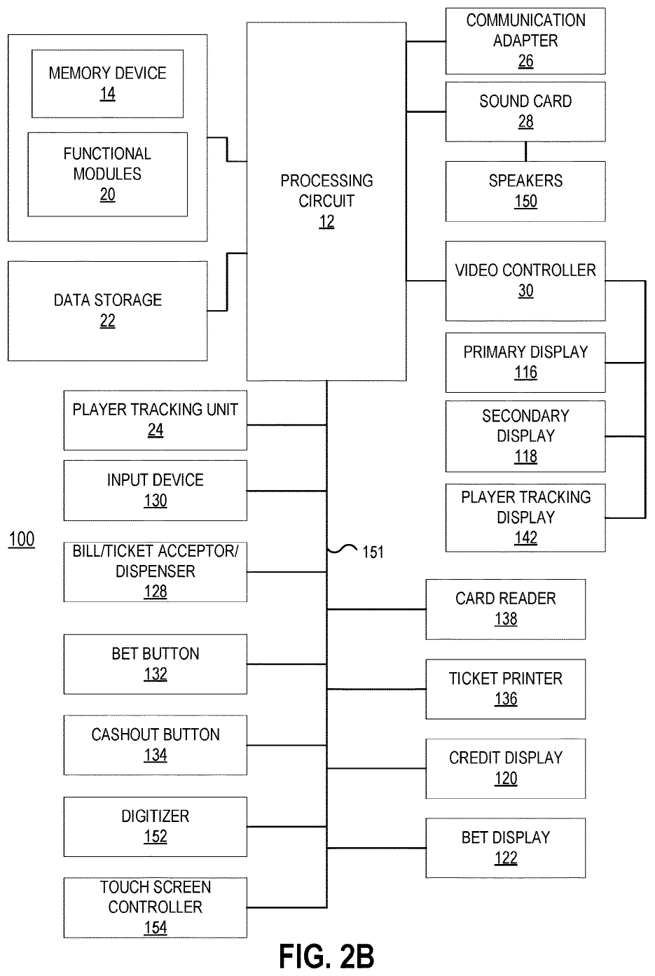

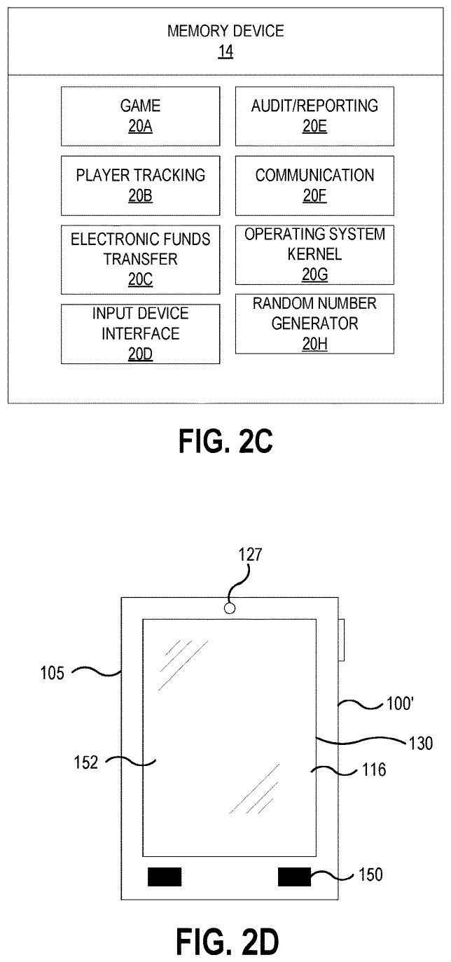

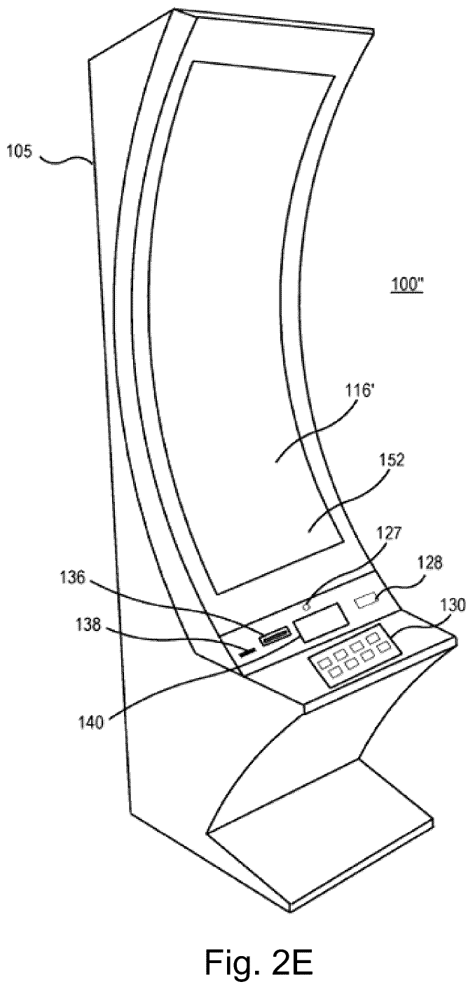

Embodiments herein may include different types of gaming devices. Various embodiments are illustrated in FIGS. 2A, 2B, and 2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A-C are provided as examples for illustrative purposes only. It will be appreciated that gaming devices may come in many different shapes, sizes, layouts, form factors, and configurations, and with varying numbers and types of input and output devices, and that embodiments of the inventive concepts are not limited to the particular gaming device structures described herein.

Gaming devices 100 typically include a number of standard features, many of which are illustrated in FIGS. 2A-B. For example, referring to FIG. 2A, a gaming device 100 may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIGS. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processor circuit 12 or directly from a memory device 14 and displays the video data on the display screen. The credit display 120 and the bet display 122 are typically implemented as simple LCD or LED displays that display a number of credits available for wagering and a number of credits being wagered on a particular game. Accordingly, the credit display 120 and the bet display 122 may be driven directly by the processor circuit 12. In some embodiments however, the credit display 120 and/or the bet display 122 may be driven by the video controller 30. The gaming device 100 may also include a player tracking unit 24 for managing communications and functionality between the processor circuit 12 and certain peripherals and components. Player tracking units 24 may be standardized across machine types to operate interchangeably across a manufacturer's lineup.

Referring again to FIG. 2A, the display devices 116, 118, 140 may include, without limitation: a cathode ray tube, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touchscreen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket printer 136, a bill/ticket acceptor/dispenser 128, that allows the player to deposit and/or receive tickets and/or currency into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processor circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processor circuit 12 that controls operations of the gaming device 100. Although illustrated as a single processor circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processor circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processor circuit 12. It will be appreciated that the components may be connected to the processor circuit 12 through a system bus 151, a communication bus and controller, such as a USB controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processor circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EE PROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, DVD or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or near field communications (NFC) that enable the gaming device 100 to communicate, for example, with a mobile communication device operated by a player.

The gaming device 100 may include one or more internal or external communication ports that enable the processor circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumb drives, ticket readers, touch screens, trackballs, touchpads, wheels, and wireless communication devices. In some embodiments, internal or external peripheral devices may communicate with the processor circuit through a universal serial bus (USB) hub (not shown) connected to the processor circuit 12.

In some embodiments, the gaming device 100 may include a sensor, such as a camera 127, in communication with the processor circuit 12 (and possibly controlled by the processor circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processor circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

Many embodiments described herein employ gaming devices 100 that are land-based EGMs, such as banks of slot machines in a casino environment, but in some embodiments, a gaming device 100 may additionally or alternatively include a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

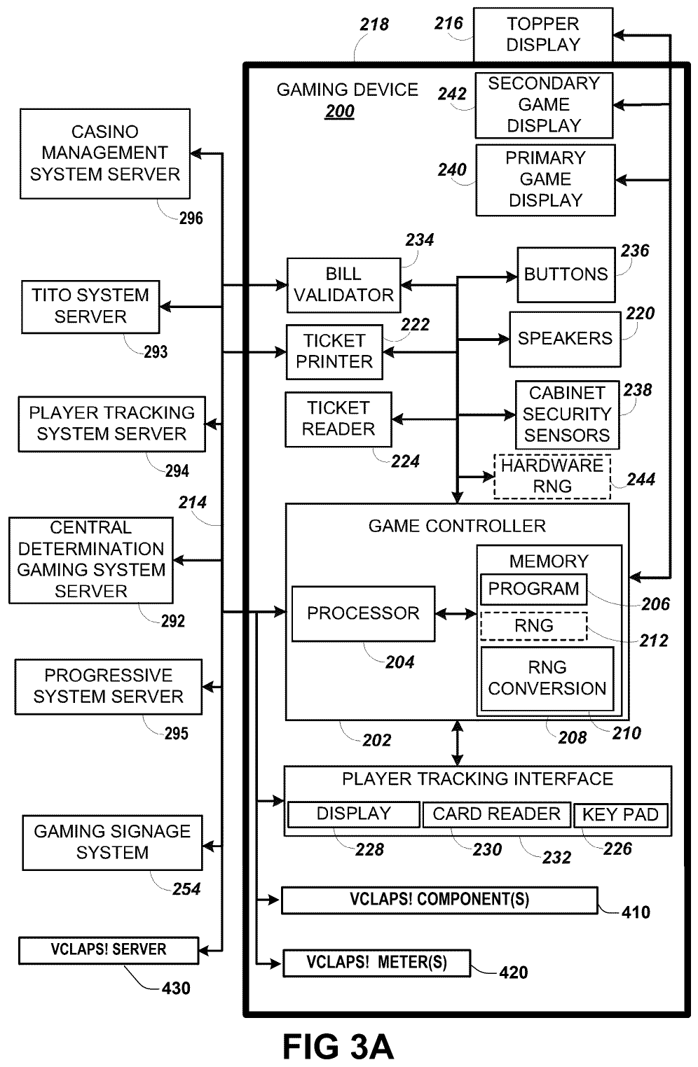

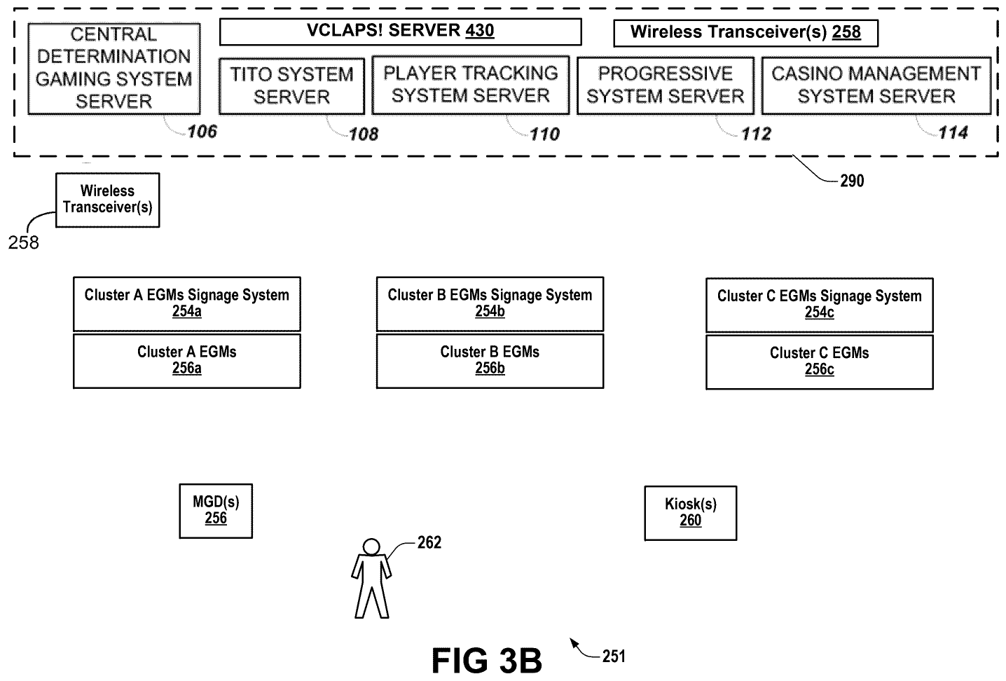

For example, referring to FIG. 2D, a gaming device 100′ may be implemented as a handheld device including a compact housing 105 on which is mounted a touchscreen display device 116 including a digitizer 152. As described in greater detail with respect to FIG. 3 below, one or more input devices 130 may be included for providing functionality of for embodiments described herein. A camera 127 may be provided in a front face of the housing 105. The housing 105 may include one or more speakers 150. In the gaming device 100′, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100′ may omit certain features, such as a bill acceptor, a ticket generator, a coin acceptor or dispenser, a card reader, secondary displays, a bet display, a credit display, etc. Credits can be deposited in or transferred from the gaming device 100′ electronically.

FIG. 2E illustrates a standalone gaming device 100″, i.e., an EGM in this example, having a different form factor from the gaming device 100 illustrated in FIG. 2A. In particular, the gaming device 100″ is characterized by having a large, high aspect ratio, curved primary display device 116′ provided in the housing 105, with no secondary display device. The primary display device 116′ may include a digitizer 152 to allow touchscreen interaction with the primary display device 116′. The gaming device 100″ may further include a player tracking display 142, an input device 130, a bill/ticket acceptor 128, a card reader 138, and a bill/ticket dispenser 136. The gaming device 100″ may further include one or more cameras 127 to enable facial recognition and/or motion tracking.

Although illustrated as certain gaming devices, such as electronic gaming machines (EGMs) and mobile devices, similar functions and/or operations as described herein may include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

In some embodiments, in response to receiving a wager from a user of a gaming device, a gaming system displays, on a display device of the gaming device, a graphical interface for a wagering game. The graphical interface includes a plurality of game symbols arranged in an array (also referred to herein as a grid) of a plurality of lines (also referred to herein as rows) of game symbols. Based on the array, a game result for the wagering game is determined. A game award is provided to the user in response to the game result indicating a winning game result. In some examples, a winning game result occurs when the grid of game symbols includes a winning shape formed by a combination of game symbols.

In additional or alternative embodiments, subsequent play (or subsequent stages) of the wagering game includes generating a new array based on the array. For example, the winning combination of game symbols can be removed and replaced (e.g., the previously displayed symbols can cascade down to fill the removed slots in the array). These and other aspects will be described in greater detail below.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 3A is a block diagram depicting various functional elements of a gaming device 200 (e.g., an EGM) in an example embodiment. All or parts of gaming device 200 shown could be used to implement any one of the example gaming devices depicted in FIGS. 1 and 2A-E.

Communication between or among the gaming devices and/or the server computers 290, may be direct or indirect using one or more communication protocols. As an example, gaming devices 100 and the server computers 290 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices to communicate with one another and/or the server computers 290 using a variety of communication-based technologies, such as radio frequency (RF) (e.g., wireless fidelity (WiFi®) and Bluetooth®), cable TV, satellite links and the like.

In some implementation, server computers 290 may not be necessary and/or preferred. For example, in one or more implementations, a stand-alone gaming device can implement one or more aspects of the present disclosure. However, it is typical to find multiple EGMs connected to networks implemented with one or more of the different server computers 290 described herein.

The server computers 290 may include a central determination gaming system server 292, a ticket-in-ticket-out (TITO) system server 293, a player tracking system server 294, a progressive system server 295, and/or a casino management system server 296. Gaming devices may include features to enable operation of any or all servers for use by the player and/or operator (e.g., the casino, resort, gaming establishment, tavern, pub, etc.). For example, game outcomes may be generated on a central determination gaming system server 292 and then transmitted over the network to any of a group of remote terminals or remote gaming devices that utilize the game outcomes and display the results to the players.

As shown in FIG. 3A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 3A also depicts utilizing a ticket printer 222 to print tickets for a TITO system server 293. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 3A illustrates that game controller 202 includes a single processor 204, game controller 202 is not limited to this representation and instead can include multiple processors 204 (e.g., two or more processors).

FIG. 3A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 3A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 292. For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 292 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 3A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 3A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 3A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 3A also depicts that gaming device 200 is connected over network 214 to player tracking system server 294. Player tracking system server 294 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel.

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, at least some gaming devices may include or be coupled to one or more wireless transmitters, receivers, and/or transceivers that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between one or more gaming devices and a mobile device. After establishing a secure wireless connection between the gaming device and the mobile device, the wireless transmitter or transceiver does not send and/or receive application data to and/or from the mobile device. Rather, the mobile device communicates with gaming devices using another wireless connection (e.g., WiFi® or cellular network). In another implementation, a wireless transceiver establishes a secure connection to directly communicate with the mobile device. The mobile device and/or gaming device(s) send and receive data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

The VCLAPS! Component(s) 410 represent component(s) within the EGM which are configured or designed to provide support for at least some f the VCLAPS!-related features described herein. In at least one embodiment, the VCLAPS! Component(s) may be configured or designed to facilitate, enable, initiate, and/or perform one or more of the following operation(s), action(s), and/or feature(s) (or combinations thereof):
Multi-Game Management System—Manages the operation of multiple games simultaneously on a single EGM, allowing players to switch between games without the need to cash out or transfer credits.
Player Interaction Interface—Facilitates multiplayer gaming experiences by providing tools and interfaces that support real-time interaction, competition, and collaboration among players.
Unified Progression Tracker—Tracks the progress of all active games and players in a unified manner, ensuring that individual contributions towards shared goals or jackpots are accurately recorded.
Dynamic Game Allocator—Dynamically allocates resources and screen space for multiple games based on current player selections and preferences to optimize the gaming experience.
Enhanced Graphics Engine—Delivers high-quality, immersive graphics that enhance the narrative and engagement of each mini-game within the EGM.
Adaptive Sound System—Provides an immersive audio experience that adjusts based on game events, player interactions, and specific scenes within the games.
Social Gaming Enhancer—Integrates social media functionalities to allow players to connect, share results, and invite others to join the game remotely or in real-time.
Regulatory Compliance Monitor—Ensures that all game operations within the EGM adhere to gaming regulations, including responsible gaming features and anti-money laundering mechanisms.
Personalization Framework—Allows players to customize their gaming experiences, including themes, difficulty levels, and preferred types of gameplay, whether competitive or cooperative.
Real-time Analytics and Feedback System—Collects and analyzes gameplay data to provide real-time feedback and suggestions to players, enhancing strategies and overall game enjoyment.
VCLAPS! Meter(s)
Etc.

VCLAPS! Meter(s) 420 may be implemented as additional gaming meters (e.g., virtual meters or soft meters) which may be configured or designed to track and display various game metrics relating to one or more of the VCLAPS! features disclosed herein. In at least one embodiment, these meters are a visual representation of each player's current VCLAPS! credit balance. The meter(s) may update in real-time, reflecting credits earned through gameplay events or promotional activities, as well as deductions when credits are utilized. The design and operation of these meters are geared towards enhancing player engagement by providing clear, immediate feedback. This encourages strategic gameplay, as players may make informed decisions on when to use their credits to maximize potential game outcomes. Furthermore, the VCLAPS! Meter(s) serve as a constant reminder of the added value and excitement that the VCLAPS! feature brings to their gaming experience.

The VCLAPS! Server Component(s) 430 represent component(s) within the Casino Server System and/or Casino Gaming Network which are configured or designed to provide support for at least some of the VCLAPS!-related features described herein. In at least one embodiment, the VCLAPS! Server Component(s) may be configured or designed to facilitate, enable, initiate, and/or perform one or more of the following operation(s), action(s), and/or feature(s) (or combinations thereof):
Centralized Game Management System—Oversees the management and distribution of games, updates, and configurations across multiple EGMs within the casino network.
Multiplayer Session Manager—Facilitates the setup, management, and monitoring of multiplayer gaming sessions, ensuring seamless interaction and synchronization between players.
Progressive Jackpot Controller—Manages and updates the progressive jackpots across different machines and games, ensuring accurate and timely reflection of jackpot values.
Player Account Management System—Manages player accounts, including tracking of player activity, game history, and account balances within the VCLAPS! games.
Real-Time Analytics Engine—Provides real-time analytics on gaming trends, player behavior, and machine performance to optimize game offerings and casino operations.
Security and Compliance Module—Ensures that all gaming activities comply with regulatory requirements, including data protection, transaction security, and anti-fraud measures.
Player Loyalty and Rewards System—Administers the casino's loyalty programs, tracking player points and facilitating the redemption of rewards within the VCLAPS! gaming environment.
Remote Gaming Gateway—Enables remote access to VCLAPS! games, allowing players to participate from outside the casino premises while maintaining security and compliance.
Financial Transaction Processor—Manages all financial transactions related to VCLAPS! games, including deposits, withdrawals, and in-game purchases.
Customer Support Portal—Provides a support system for VCLAPS! players, offering assistance with technical issues, gameplay questions, and account management.
Etc.

It will be appreciated that the present disclosure is not limited only to those implementations shown in the Figures. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices may also include other processors that are not separately shown. Using FIG. 3A as an example, gaming device 200 could include display controllers (not shown in FIG. 3A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 3B depicts a casino gaming environment in an example embodiment. In this example, the casino 251 includes banks (e.g., 252a, 252b, 252c) of EGMs. In this example, each bank 252 of EGMs includes a corresponding gaming signage system (e.g., 254a, 254b, 254c). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 290, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 292, one of the EGMs, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 293. For example, the TITO system server 293 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 294. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

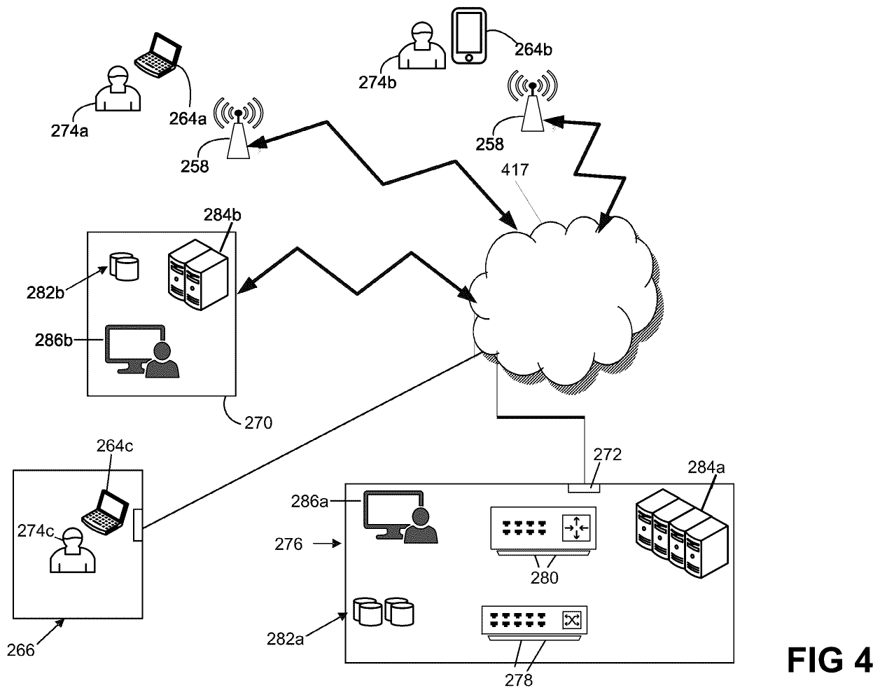

FIG. 4 is a diagram of components of a system for providing online gaming in an example embodiment. As with other Figures presented in this disclosure, the numbers, types and arrangements of gaming devices shown in FIG. 4 are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 4. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 4, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

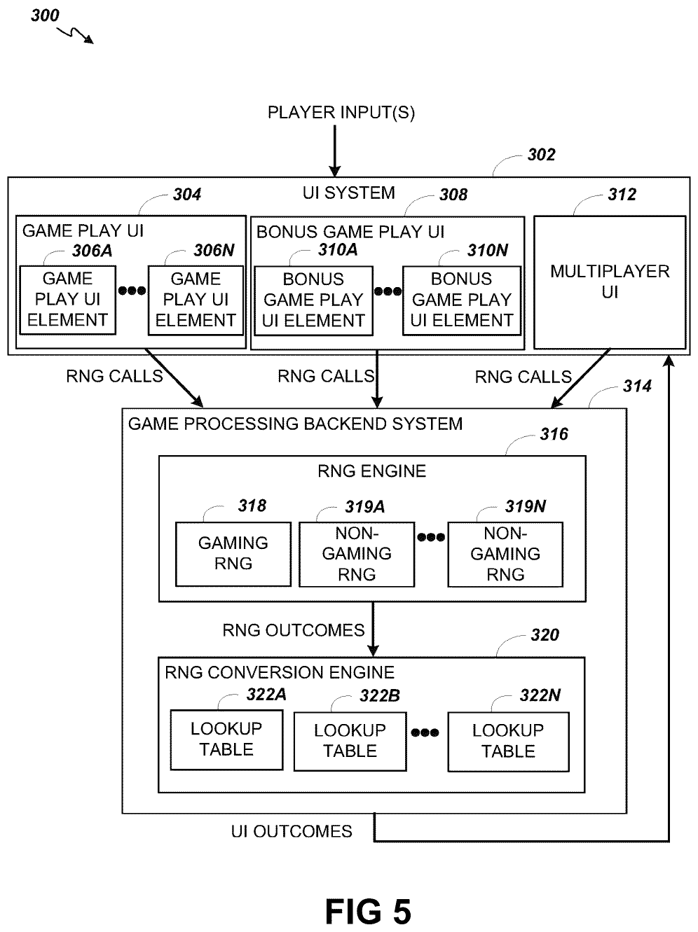

FIG. 5 illustrates, in block diagram form, an implementation of a game processing architecture 300 that implements a game processing pipeline for the play of a game in accordance with various implementations described herein. As shown in FIG. 5, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming device 200 of FIG. 3A. Alternatively, portions of the gaming processing architecture 300 can implement the game processing pipeline using a gaming device and one or more remote gaming devices, such as central determination gaming system server 292 shown in FIG. 3B.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 5 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 5 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 5 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 3A. As previously discussed with reference to FIG. 3A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 3A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 3A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

Further described herein are network-based systems and methods for seamlessly operating multi-vendor gaming devices and management systems within a casino.

Electronic gaming machines (EGMs), electronic gaming tables (EGTs), or other types of gaming devices provide a variety of wagering games such as slot games, video poker games, video blackjack games, roulette games, video bingo games, keno games and other types of games that are frequently offered at casinos and other locations. EGMs and EGTs are made by a variety of different manufactures, including but not limited to Aristocrat (ATI), Light and Wonder (LNW), International Game Technology (IGT), Konami Gaming, etc. Many EGMs/EGTs communicate with slot machine interface boards (SMIBs) via the slot accounting system (SAS) or the game to system (G2S) protocol. Further, there are a number of different casino monitoring/management systems (CMS) that are provided by the different EGM/EGT manufactures. The result of the incompatible frontend and backend is that when a casino buys EGMs/EGTs from vendor A, and installs the CMS system from vendor A to manage and control the casino's various EGMs/EGTs, then the casino may be locked into vendor A's solution, as interoperability between the gaming machines, their SMIBs, and management solutions from different vendors is generally non-existent. This limits the options that casinos have regarding management system solutions that deviate from the already installed base of vendor A's management solution.

Gaming devices (e.g., EGMs, EGTs, bar tops, gaming servers, mobile devices, mobile game devices, etc.), may be a device located in a physical casino and/or at remote locations for online gaming. Gaming devices are made by a variety of different vendors, with the different vendors typically providing a closed management system for monitoring and controlling that vendor's gaming device. A SMIB is used within an EGM/Ts to allow the EGM/Ts to connect to a system server. However, SMIBs made by different vendors are proprietary, and may use different controllers, power supplies, connectors, hardware, board sizes, and proprietary communication protocols. Each vendor's SMIB is designed to connect its proprietary management system to its EGM/Ts and to all other manufacturers' EGM/Ts. For instance, there is a SMIB from supplier A designed to connect to supplier A's machines, and to supplier B's, C's, and D's machines, a SMIB from supplier B designed to connect to supplier B's machines as well as to supplier A's, C's, and D's machines, etc. Once a casino decides to network its casino floor, it is locked into one vendor's hardware and software solutions.

For example, a casino may initially select an implementation from supplier A, with supplier A's SMIBs installed in the EGM/Ts that communicate with supplier A's CMS. As used herein, a CMS refers to any backend system or software service designed to operate with a casino's gaming device network such as a casino accounting system, a ticket voucher system, a player account system, a social network system, a responsible gaming system, a marketing system, a bonus system, a progressive system, a concierge system, and/or a Remote Gaming System (RGS). Generally, RGS is a solution for vendors and operators that enables implementation and distribution of online, mobile, and server-based gaming content.

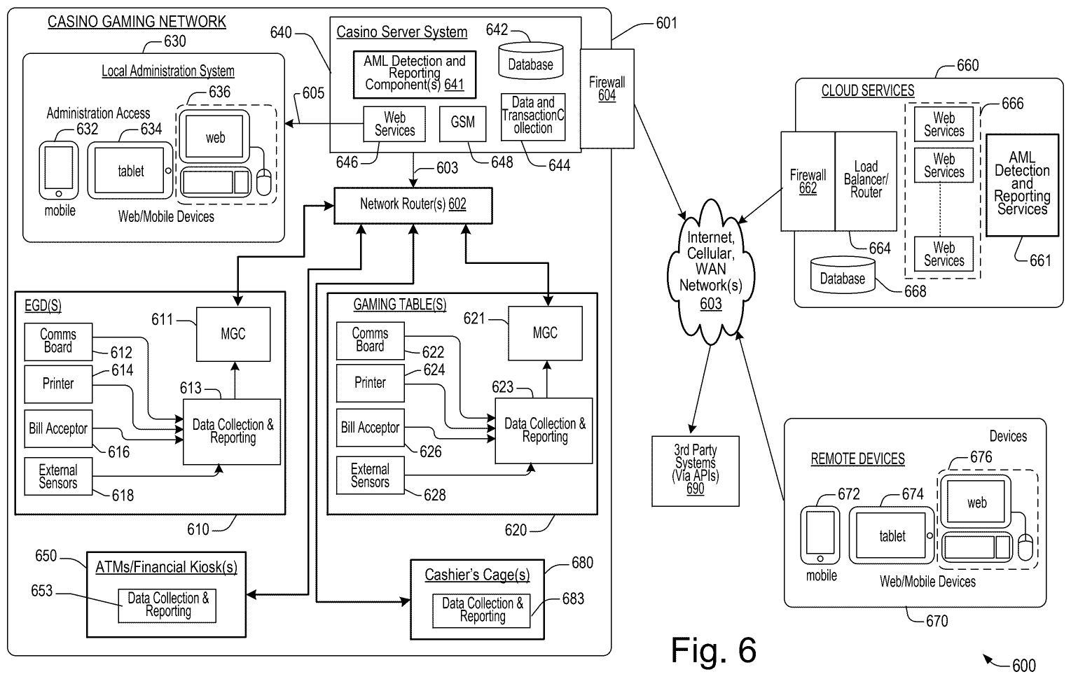

FIG. 6 illustrates a simplified block diagram of a specific example embodiment of a Gaming Network 600 which may be configured or designed to implement various automated money laundering detection and reporting techniques described and/or referenced herein. As described in greater detail herein, different embodiments of gaming networks may be configured, designed, and/or operable to provide various different types of operations, functionalities, and/or features generally relating to automated money laundering detection and reporting techniques. Further, as described in greater detail herein, many of the various operations, functionalities, and/or features of the Gaming Network(s) and/or Gaming System(s) disclosed herein may provide may enable or provide different types of advantages and/or benefits to different entities interacting with the Gaming Network(s).

According to different embodiments, the Gaming Network 600 may include a plurality of different types of components, devices, modules, processes, systems, etc., which, for example, may be implemented and/or instantiated via the use of hardware and/or combinations of hardware and software. For example, as illustrated in the example embodiment of FIG. 6, the Gaming Network may include one or more of the following types of systems, components, devices, processes, etc. (or combinations thereof):
Casino Gaming Network(s) 601. In at least one embodiment, the Casino Gaming Network 601 may include or may correspond to one or more gaming network(s), systems, components, devices, etc., which are associated with one or more casino gaming establishments such as, for example, Harrah's Casino (Las Vegas), Caesars Palace (Las Vegas), The Palazzo (Las Vegas), etc. In at least one embodiment, a Casino Gaming Network may be associated with a real-world, physical casino which is located at a particular geographic location. In some embodiments, the Casino Gaming Network may include multiple gaming networks associated with multiple casino gaming establishments at different physical locations (such as, for example, Harrah's Casino Las Vegas, Harrah's Casino New Orleans, Harrah's Casino Atlantic City, etc.).
Internet, Cellular, and WAN Network(s) 603.
3rd Party Systems 690. In at least one embodiment, one or more 3rd Party Systems may include remote server system(s)/service(s), which, for example, may be configured or designed to provide various types of services described and/or referenced herein. In at least one embodiment, one or more 3rd Party Systems may communicate with other components, devices, systems of the Gaming Network via APIs and/or other types of standardized (and/or proprietary) communication protocols. Examples of various types of 3^{rd} Party Systems may include, but are not limited to, one or more of the following (or combinations thereof):
   Content provider servers/services
   Media Streaming servers/services
   Database storage/access/query servers/services
   Financial transaction servers/services
   Payment gateway servers/services
   Electronic commerce servers/services
   Event management/scheduling servers/services
   Automated money laundering detection and reporting services;
   Remote Database System(s) which, for example, may be operable to store and provide access to various types of information and data described herein.
Remote Device(s) 670—In at least one embodiment, the Remote Device(s) may be operable to provide administration and customer remote access to other components, devices, systems of the Gaming Network. According to different embodiments, one or more Remote Device may be configured or designed to perform and/or implement various types of functions, operations, actions, and/or other features such as those described or referenced herein (e.g., such as those illustrated and/or described with respect to FIG. 6).
Cloud Services 660—In at least one embodiment, Cloud Services may include a plurality of different public and/or provide computing clouds which, for example, may reside at different physical and/or geographic locations, and which may each be configured or designed to provide different types of services. For example, as illustrated in the example embodiment of FIG. 6, Cloud Services 660 may include functionality for performing and/or implementing ML Analysis, Detection and Reporting Services such as one or more of those described herein.

According to specific embodiments, the at least some of the computing clouds may include several different types of local area networks such as, for example, a backbone LAN which may be utilized for providing localized communication between various local network elements within a given computing cloud, and an internet LAN which, for example, may be utilized for providing WAN or Internet access to various local network elements within the computing cloud. In at least one embodiment, one or more of the computing clouds may be operable to host a variety of different types of applications and/or other software for performing various types of services such as, for example, one or more of those described herein. Additionally, in at least one embodiment, one or more of the computing clouds may be operable to provide various types of database services such as, for example, data storage, database queries, data access, etc. As illustrated in the example embodiment of FIG. 6, cloud services network 660 may include one or more of the following components, devices, and/or systems (or combinations thereof): firewall components 662, load balancer and router components 664, Web services components 666, database components 668, AML detection and reporting components 661.

As illustrated in the example embodiment of FIG. 6, the Casino Gaming Network 601 may include one or more of the following types of systems, components, devices, processes, etc. (or combinations thereof):
Casino Server System(s) 640
Local Administration System(s) 630
Electronic Gaming Machine(s) (EGMs) 610
Gaming Table(s) 620
ATMs/Financial Kiosk(s) 650
Cashiers Cage(s) 680
Network Router(s) 602

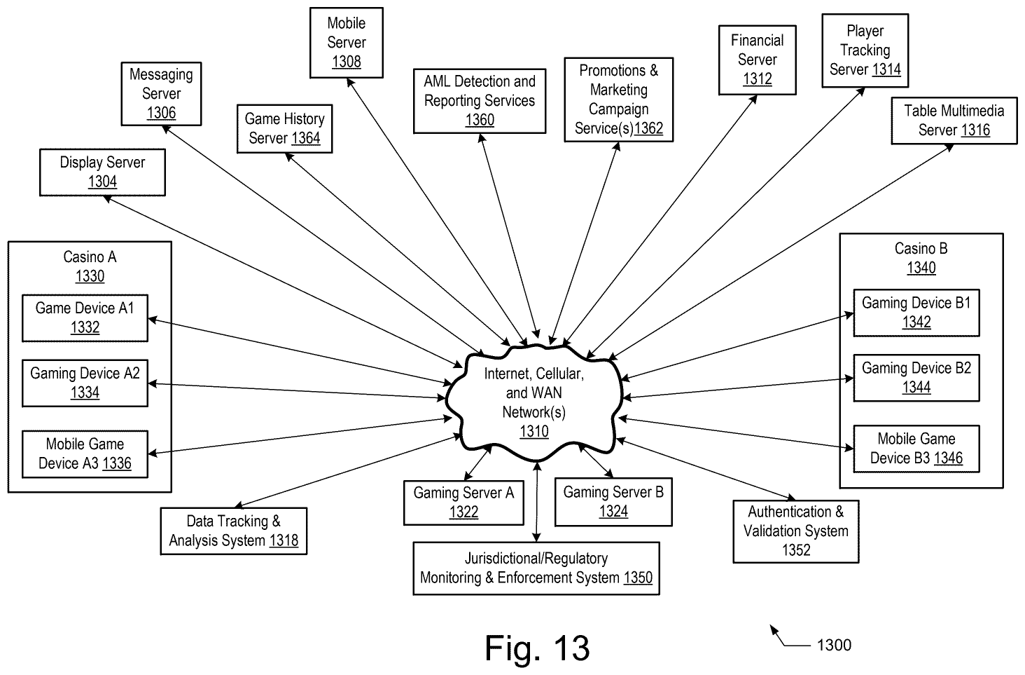

According to different embodiments, the Casino Server System(s) may include various systems, components, and/or devices for facilitating, initiating, and/or performing various operation(s), action(s), feature(s), and/or other functionality, such as, for example, one or more of the following (or combinations thereof):
Display Server System(s) (e.g., 1304, FIG. 13). In at least one embodiment, the Display Server System(s) may be configured or designed to implement and/or facilitate management of content (e.g., graphics, images, text, video fees, etc.) to be displayed and/or presented at one or more EGDs (or at one or more groups of EGDs), dealer displays, administrator displays, etc.
Table Multimedia Server System(s) (e.g., 1316). In at least one embodiment, the Table Multimedia Server System(s) may be configured or designed to generate, implement and/or facilitate management of content (e.g., graphics, images, text, video fees, audio feeds, etc.), which, for example, is to be streamed or provided to one or more EGDs (or to one or more groups of EGDs).
Messaging Server System(s) (e.g., 1306). In at least one embodiment, the Messaging Server System(s) may be configured or designed to implement and/or facilitate management of messaging and/or other communications among and between the various systems, components, devices, EGDs, players, dealers, administrators, and/or other personnel of the gaming network.
Mobile Server System(s) (e.g., 1308). In at least one embodiment, the Mobile Server System(s) may be configured or designed to implement and/or facilitate management of communications and/or data exchanged with various types of mobile devices, including for example: player-managed mobile devices (e.g., smart phones, PDAs, tablets, mobile computers), casino-managed mobile devices (e.g., mobile gaming devices), etc.
AML Detection and Reporting Service(s) (e.g., 1360). In at least one embodiment, the AML Detection and Reporting Service(s) may be configured or designed to include functionality for facilitating, enabling, initiating, and/or performing various types of AML Detection and Reporting operation(s), action(s), and/or feature(s) such as one or more of those described herein.
Financial Server System(s) (e.g., 1312). In at least one embodiment, the Financial Server System(s) may be configured or designed to implement and/or facilitate tracking, management, reporting, and storage of financial data and financial transactions relating to one or more wager-based gaming sessions. For example, at least some Financial Server System(s) may be configured or designed to track of the game accounting (money in, money out) for a virtual table game being played, and may also be configured or designed to handle various financial transactions relating to player wagers and payouts. For example, in at least one embodiment, Financial Servers may be configured or designed to monitor each remote player's account information, and may also manage or handle funds transfers between each player's account and the active game server (e.g., associated with the player's game session).
Player Tracking Server System(s) (e.g., 1314). In at least one embodiment, the Player Tracking Server System(s) may be configured or designed to implement and/or facilitate management and exchange of player tracking information associated with one or more EGDs, gaming sessions, etc. In at least one embodiment, a Player Tracking Server System may include at least one database that tracks each player's hands, wins/losses, bet amounts, player preferences, etc., in the network. In at least one embodiment, the presenting and/or awarding of promotions, bonuses, rewards, achievements, etc., may be based on a player's play patterns, time, games selected, bet amount for each game type, etc. A Player Tracking Server System may also help establish a player's preferences, which assists the casino in their promotional efforts to: award player comps (loyalty points); award free game play credits, free/additional reel spin opportunities; decide which promotion(s) are appropriate; generate bonuses; etc.
Data Tracking & Analysis System(s) (e.g., 1318). In at least one embodiment, the Data Tracking & Analysis System(s) may be configured or designed to implement and/or facilitate management and analysis of game data. For example, in one embodiment the Data Tracking & Analysis System(s) may be configured or designed to aggregate multisite virtual game table trends, local wins, jackpots, etc.
Gaming Server System(s) (922, (e.g., 1324). In at least one embodiment, different game servers may be configured or designed to be dedicated to one or more specifically designated type(s) of game(s) (e.g., Baccarat, Black Jack, Poker, Mahjong, Pai-gow, Chess, etc.). Each game server has game logic to host one of more virtual table game sessions. At least some game server(s) may also capable of keeping track of the game accounting (money in, money out, games won, game lost, etc.) for a virtual table game being played, and/or for updating the Financial Servers at the end of each game. The game servers may also operable to generate the virtual table graphics primitives (e.g., game pieces and game states), and may further be operable to update the remote EGDs when a game state change (e.g., new card dealt, player upped the ante, player folds/busts, etc.) has been detected.
Jurisdictional/Regulatory Monitoring & Enforcement System(s) (e.g., 1350). In at least one embodiment, the Jurisdictional/Regulatory Monitoring & Enforcement System(s) may be configured or designed to handle tracking, monitoring, reporting, and enforcement of specific regulatory requirements relating to wager-based gameplay activities in one or more jurisdictions.
Authentication & Validation System(s) (e.g., 1352). According to different embodiments, the Authentication & Validation System(s) may be configured or designed to determine and/or authenticate the identity of the current player at a given EGD. For example, in one embodiment, the current player may be required to perform a log in process at the EGD in order to access one or more features. Alternatively, the EGD may be adapted to automatically determine the identity of the current player based upon one or more external signals such as, for example, scanning of a barcode of a player tracking card, an RFID tag or badge worn by the current player which provides a wireless signal to the EGD for determining the identity of the current player. In at least one implementation, various security features may be incorporated into the EGD to prevent unauthorized players from engaging in certain types of activities at the EGD. In some embodiments, the Authentication & Validation System(s) may be configured or designed to authenticate and/or validate various types of hardware and/or software components, such as, for example, hardware/software components residing at a remote EGDs, game play information, wager information, player information and/or identity, etc. Examples of various authentication and/or validation components are described in U.S. Pat. No. 6,620,047, titled, “ELECTRONIC GAMING APPARATUS HAVING AUTHENTICATION DATA SETS,” incorporated herein by reference in its entirety for all purposes.
Game History Server(s) (e.g., 1364). In at least one embodiment, the Game History Server(s) may be configured or designed to track all (or selected) game types and game play history for all (or selected) virtual game tables. In at least one embodiment, a Game History Server may be configured or designed to assists the remote players in selecting a table by, for example, displaying the win/loss statistics of the tables selected by the player as potential candidates to participate. In some embodiments, a Game History Server may also assist the casino manager in case of disputes between players and the casino by, for example, providing the ability to “replay” (e.g., by virtually recreating the game events) the game in dispute, step by step, based on previously stored game states.
Database components 642, which, for example, may be configured or designed to include functionality for storing and/or providing access to various types of information, events, and/or conditions such as, for example, one or more of the following (or combinations thereof): historical game-related information, ML information, ML rules, player ID information, gaming device ID information, location maps of gaming devices, casino-related information, historical financial transaction information, and/or other types of information described and/or referenced herein.
Web Services components 646, which, for example, may be configured or designed to include functionality for facilitating, aggregating gaming data, enabling, initiating, and/or performing various types of web-based services and communications.
Cellular (GSM/CDMA) Communication components 648, which, for example, may be configured or designed to include functionality for facilitating, enabling, initiating, and/or performing various types of cellular-based and/or wireless communications such as transporting gaming data to/from the Cloud Services 660.
Data And Transaction Collection components 644, which, for example, may be configured or designed to include functionality for facilitating, enabling, initiating, and/or performing collection of data and transactions (e.g., financial transaction events) occurring at various components and/or devices of the casino gaming network such as, for example, one or more of the following (or combinations thereof): EGM(s), gaming table(s), ATMs, financial kiosks, casino token storage tray(s), cashier cage component(s), wireless gaming devices, end user mobile device(s), remote devices (e.g., 670), etc.
Firewall component(s) 604.
Etc.

According to different embodiments, Electronic Game Device(s) (EGDs) may include one or more of the following (or combinations thereof): mechanical slot machines, electronic slot machines, electronic gaming machines, mobile gaming devices, video gaming machines, server-based gaming machines, and/or other types of devices or components which provide capabilities for enabling casino patrons to participate in gaming and/or wagering activities. In some embodiments, at least some mobile gaming devices may be implemented using personal mobile computing devices such as tablets, smartphones, laptops, PC's, and the like. As illustrated in the example embodiment of FIG. 6, one or more EGDs may be configured or designed to include one or more of the following components (or combinations thereof): at least one master gaming controller (MGC) 611, communication components 612, printer components 614, Bill/coin acceptor components 616, sensor components 618, data collection and reporting components 613.

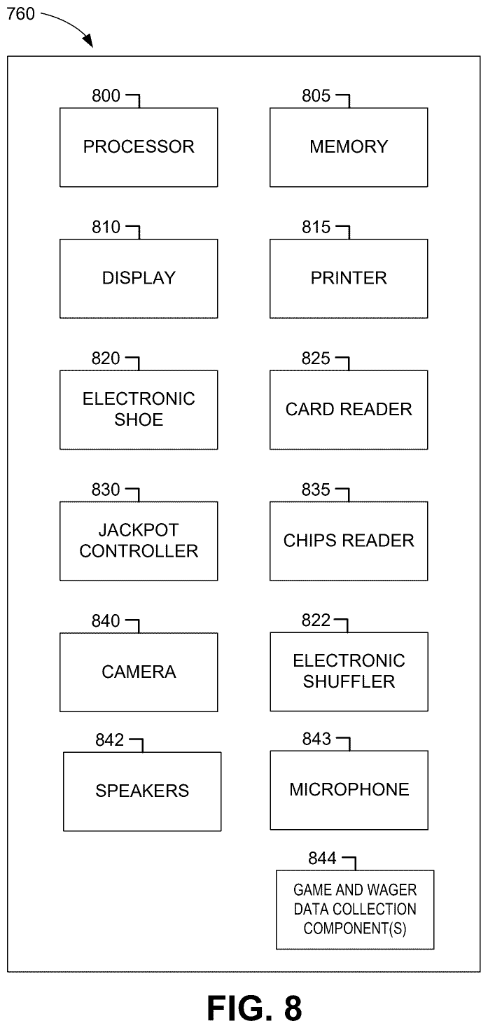

According to different embodiments, Gaming Tables(s) may include one or more of the following (or combinations thereof): traditional casino gaming tables (e.g., craps, baccarat at, blackjack, roulette, etc.), electronic gaming tables, server-based gaming tables, and/or other types of devices or components which provide capabilities for enabling two or more casino patrons to concurrently participate in gaming and/or wagering activities. As illustrated in the example embodiment of FIG. 6, one or more gaming tables may be configured or designed to include one or more of the following components (or combinations thereof): at least one master gaming controller (MGC) 621, communication components 622, printer components 624, Bill/voucher/coin acceptor components 626, sensor components 628, data collection and reporting components 623. In at least one embodiment data collection and reporting components 623 may include functionality for facilitating, enabling, initiating, and/or performing collection and reporting of game-related information and/or wager-related information (e.g., including financial transaction events) occurring at that gaming table. Additional gaming table features and functionalities are illustrated and described with respect to FIG. 8.

In at least one embodiment data collection and reporting components (e.g., 613, 623, 653, 683) may include functionality for facilitating, aggregating, enabling, initiating, and/or performing collection and reporting of various types of information relating to conditions and/or events occurring at an associated gaming device and/or gaming table game, such as, for example: game-related information, player tracking information, wager-related information (e.g., including financial transaction events), and the like.

In at least one embodiment, Local Administration System 630 may include various types of devices or components (such as, for example, mobile devices 632, tablets 634, computer systems 636, etc.) which provide capabilities for enabling casino administrators to implement or perform administration of one or more aspects, components, systems, operations, and/or activities relating to a casino gaming network (e.g., 601). Additionally, local administrative access can be provided for the casino manager for configuring, registering, monitoring, analyzing, sending alerts, generating reports, etc., relating to ML and suspicious activities.

According to different embodiments, Remote Devices 670 may include various types of devices or components (such as, for example, smart phones 672, tablets 674, computer systems 676, etc.) which provide capabilities for enabling a remote user to remotely participate in gaming and/or wagering activities at a casino gaming network (e.g., 601). In at least one embodiment, one or more remote device components may also be used by remote casino administrators to implement or perform remote administration of one or more aspects, components, systems, operations, and/or activities relating to a casino gaming network (e.g., 601).

In at least one embodiment, the Gaming Network may be operable to utilize and/or generate various different types of data and/or other types of information when performing specific tasks and/or operations. This may include, for example, input data/information and/or output data/information. For example, in at least one embodiment, the Gaming Network may be operable to access, process, and/or otherwise utilize information from one or more different types of sources, such as, for example, one or more local and/or remote memories, devices and/or systems.

Additionally, in at least one embodiment, the Gaming Network may be operable to generate one or more different types of output data/information, which, for example, may be stored in memory of one or more local and/or remote devices and/or systems. Examples of different types of input data/information and/or output data/information which may be accessed and/or utilized by the Gaming Network may include, but are not limited to, one or more of those described and/or referenced herein. According to specific embodiments, multiple instances or threads of the Gaming Network processes and/or procedures may be concurrently implemented and/or initiated via the use of one or more processors and/or other combinations of hardware and/or hardware and software.

According to different embodiments, various different types of encryption/decryption techniques may be used to facilitate secure communications between devices, systems, and/or components of the Gaming Network(s). Examples of the various types of security techniques which may be used may include, but are not limited to, one or more of the following (or combinations thereof): random number generators, SHA-1 (Secured Hashing Algorithm), MD2, MD5, DES (Digital Encryption Standard), 3DES (Triple DES), RC4 (Rivest Cipher), ARC4 (related to RC4), TKIP (Temporal Key Integrity Protocol, uses RC4), AES (Advanced Encryption Standard), RSA, DSA, DH, NTRU, and ECC (elliptic curve cryptography), PKA (Private Key Authentication), Device-Unique Secret Key and other cryptographic key data, SSL, etc. Other security features contemplated may include use of well-known hardware-based and/or software-based security components, and/or any other known or yet to be devised security and/or hardware and encryption/decryption processes implemented in hardware and/or software.

It will be appreciated that the Gaming Network of FIG. 6 is but one example from a wide range of Gaming Network embodiments which may be implemented. Other embodiments of the Gaming Network (not shown) may include additional, fewer and/or different components/features that those illustrated in the example Gaming Network embodiment of FIG. 6.

Generally, the automated money laundering detection and reporting techniques described herein may be implemented in hardware and/or hardware+software. Hardware and/or software+hardware hybrid embodiments of the automated money laundering detection and reporting techniques described herein may be implemented on a general-purpose programmable machine selectively activated or reconfigured by a computer program stored in memory. Such programmable machine may include, for example, mobile or handheld computing systems, PDA, smart phones, notebook computers, tablets, netbooks, desktop computing systems, server systems, cloud computing systems, network devices, etc.

FIG. 13 illustrates an alternate example embodiment of a Gaming Network 1300 which may be configured or designed to implement various automated money laundering detection and reporting techniques described and/or referenced herein. As described in greater detail herein, different embodiments of Gaming Networks may be configured, designed, and/or operable to provide various different types of operations, functionalities, and/or features generally relating to Gaming Network technology. Further, as described in greater detail herein, many of the various operations, functionalities, and/or features of the Gaming Network(s) and/or Gaming System(s) disclosed herein may provide may enable or provide different types of advantages and/or benefits to different entities interacting with the Gaming Network(s).

According to different embodiments, the Gaming Network 1300 may include a plurality of different types of components, devices, modules, processes, systems, etc., which, for example, may be implemented and/or instantiated via the use of hardware and/or combinations of hardware and software. For example, as illustrated in the example embodiment of FIG. 13, the Gaming Network may include one or more of the following types of systems, components, devices, processes, etc. (or combinations thereof):
Display Server System(s) 1304. Table Multimedia Server System(s) 1316.
Messaging Server System(s) 1306.
Mobile Server System(s) 1308.
AML Detection and Reporting Services 1360.
Promotions & Marketing Campaign Service(s) 1362.
Financial Server System(s) 1312.
Player Tracking Server System(s) 1314.
Data Tracking & Analysis System(s) 1318.
Gaming Server System(s) (922, 1324).
Jurisdictional/Regulatory Monitoring & Enforcement System(s) 1350.
Authentication & Validation System(s) 1352.
Casino Venues (930, 1340).
Electronic Game Devices (EGDs) 1332, 1334, 1336, 1342, 1344, 1346.
Internet, Cellular, and WAN Network(s) 1310.
Game History Server(s) 1364.
Remote Database System(s).
Remote Server System(s)/Service(s).
Mobile Device(s).
Etc.

### Promotions & Marketing Campaign Service(s) 1362

Promotions & Marketing Campaign Service(s) 1362 are integral to the casino's strategy for attracting and retaining patrons by offering a dynamic range of incentives and personalized marketing communications. These services leverage data analytics to understand patron behavior and preferences, enabling the creation of targeted promotions that resonate with specific customer segments. By offering tailored rewards, bonuses, and special events, these services enhance player satisfaction and loyalty, encouraging repeat visits and increased play. The services also encompass digital and traditional marketing campaigns, utilizing various channels to engage potential and existing customers effectively. The ability to dynamically adjust promotions in response to customer feedback and changing market conditions ensures that the casino remains competitive and responsive to player needs. Furthermore, these services provide desirable tools for measuring the effectiveness of marketing strategies, offering insights that drive continuous improvement and strategic decision-making in promotional activities.

The functionality of the various systems and components of FIG. 13 may be similar to those described previously with respect to the description of FIG. 6, and therefore need not be repeated.

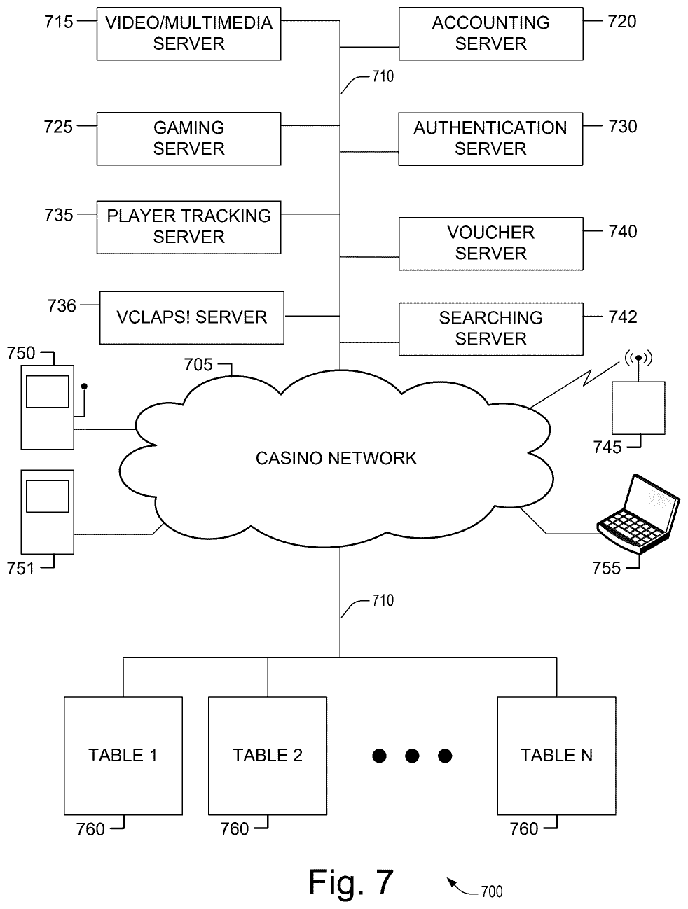

FIG. 7 shows an example block diagram of an electronic gaming system 700 in accordance with a specific embodiment. Electronic gaming system 700 may include electronic gaming tables 760, which may be coupled to network 705 via a network link 710. Electronic gaming tables 760 may be normal gaming tables with enhanced electronic capabilities. Network 705 may be the internet or a private network. One or more video streams may be received at video/multimedia server 715 from gaming tables 760. Video/Multimedia server 715 may transmit one or more of these video streams to a mobile device 745, a gaming device 750, an EGD 751, a laptop 755, and/or any other remote electronic device. Video/Multimedia server 715 may transmit these video streams via network link 710 and network 705.

Electronic gaming system 700 may include an accounting/transaction server 720, a gaming server 725, an authentication server 730, a player tracking server 735, a voucher server 740, and a searching server 742.

Accounting/transaction server 720 may compile, track, store, and/or monitor cash flows, voucher transactions, winning vouchers, losing vouchers, and/or other transaction data for the casino operator and for the players. Transaction data may include the number of wagers, the size of these wagers, the date and time for these wagers, the identity of the players making these wagers, and the frequency of the wagers. Accounting/transaction server 720 may generate tax information relating to these wagers. Accounting/transaction server 720 may generate profit/loss reports for predetermined gaming options, contingent gaming options, predetermined betting structures, and/or outcome categories.

Gaming server 725 may generate gaming options based on predetermined betting structures and/or outcome categories. These gaming options may be predetermined gaming options, contingent gaming options, and/or any other gaming option disclosed in this disclosure.

Authentication server 730 may determine the validity of vouchers, players' identity, and/or an outcome for a gaming event.

Player tracking server 735 may track a player's betting activity, a player's preferences (e.g., language, drinks, font, sound level, etc.). Based on data obtained by player tracking server 735, a player may be eligible for gaming rewards (e.g. free play), promotions, and/or other awards (e.g., complimentary food, drinks, lodging, concerts, etc.).

Voucher server 740 may generate a voucher, which may include data relating to gaming options. For example, data relating to the structure (e.g., 6 out of the next 10 rolls at craps table 4 will be a 7 or 11) may be generated. If there is a time deadline, that information may be generated by voucher server 740. Vouchers may be physical (e.g., paper) or digital.

The VCLAPS! Server Component(s) 736 represent component(s) within the Casino Server System and/or Casino Gaming Network which are configured or designed to provide support for at least some of the VCLAPS!-related features described herein.

Searching server 742 may implement a search on one or more gaming devices to obtain gaming data. Searching server 742 may implement a messaging function, which may transmit a message to a third party (e.g., a player) relating to a search, a search status update, a game status update, a wager status update, a confirmation of a wager, a confirmation of a money transfer, and/or any other data relating to the player's account. The message can take the form of a text display on the gaming device, a pop up window, a text message, an email, a voice message, a video message and the like. Searching server 742 may implement a wagering function, which may be an automatic wagering mechanism. These functions of searching server 742 may be integrated into one or more servers.

Searching server 742 may include one or more searching structures, one or more searching algorithms, and/or any other searching mechanisms. In general, the search structures may cover which table games paid out the most money during a time period, which table games kept the most money from players during a time period, which table games are most popular (top games), which table games are least popular, which table games have the most amount of money wager during a period, which table games have the highest wager volume, which table games are more volatile (volatility, or deviation from the statistical norms, of wager volume, wager amount, pay out, etc.) during a time period, and the like. Search may also be associated with location queries, time queries, and/or people queries (e.g., where are the table games that most of my friends wager on, where are my favorite dealers, what do players wager on the most today, when are most wagers placed, etc.).

The searching structures may be predetermined searching structures. For example, the method may start searching a first device, then a second device, then a third device, up to an N^{th} device based on one or more searching parameters (e.g., triggering event). In one example, the search may end once one or more triggering events are determined. In another example, the search may end once data has been received from a predetermined number (e.g., one, two, ten, one hundred, all) of the devices. In another example, the search may be based on a predetermined number of devices to be searched in combination with a predetermined number of search results to be obtained. In this example, the search structure may be a minimum of ten devices to be searched, along with a minimum of five gaming options to be determined.

In another example, the searching structures may be based on one or more specific games (e.g., baccarat tables, roulette tables, blackjack tables, poker tables, craps tables, Sic Bo tables, etc.). Searching structure may search one or more of these games.

In another example, the searching structure may be based on a player's preferences, past transactional history, player input, a particular table, a particular game, a particular dealer, a particular casino, a particular location within a casino, game outcomes over a time period, payout over a time period, and/or any other criteria.

Searching algorithms may be dynamic searching programs, which may be modified based on one or more past results. For example, a search algorithm may be based on searching blackjack tables. The search algorithm may initially search blackjack tables 1-10 to determine whether any triggering events have occurred. Based on one or more previous searches, the search algorithm may determine: (1) that blackjack tables 1-4 are only opened from 7 pm to 3 am; (2) that blackjack tables 5-7 are opened twenty-four hours a day; and (3) that blackjack tables 8-10 are only opened from 7 am to 5 pm. The search algorithm may then modify the search parameters utilized based on this data. For example, if the search algorithm is initiated at 6 pm to determine blackjack triggering events, then the search algorithm may only search blackjack tables 5-7 because these blackjack tables are the only blackjack tables operating at that specific time.

In another example, the search algorithm may determine that a specific triggering event occurs with a ninety percent success rate on a first table, a ten percent success rate on a second table, a fifty percent success rate on a third table, and a seventy percent success rate on a fourth table. The search algorithm may generate a search priority based on the probability of success, which may lead to the first table being searched first, the fourth table being searched second, the third table being searched third, and the second table being searched fourth. Search algorithm may utilize any dynamic feedback procedure to enhance current and/or future searching results FIG. 8 shows electronic gaming table 760 with various features, in accordance with a specific embodiment.

Various different embodiments of the electronic gaming table 760 may be used as a live game table for conducting gameplay relating to one or more gaming sessions.

Electronic gaming table 760 may include a processor 800, a memory 805, a display 810, a printer 815, an electronic shoe 820, an electronic shuffler 822, a smart card reader 825, a jackpot controller 830, a chips reader 835, and a camera 840.

Processor 800 may be communicatively coupled to any other device in electronic gaming table 760. Processor 800 via an interface may communicate wired or wireless, with any of the elements of electronic gaming device 900 and/or electronic gaming table system 700.

Memory 805 may include data relating to gaming events, video streams transmitted from electronic gaming table 760, winning and losing percentages for gaming options relating to electronic gaming table 760, and game management data (e.g., dealer schedule, chip refills, etc.).

Display 810 may show previous game results, a betting structure, outstanding wagers, transaction volume, present value of betting options, a table minimum wager, a table maximum wager, wager and/or game play instructions input by one or more remote players (e.g., via their respective EGDs), instructions to the live dealer/attendant relating to game play activities to be performed by the dealer/attendant, video data, and/or any other type of data or content.

Printer 815 may generate vouchers, promotional items, food tickets, event tickets, and/or lodging tickets. Vouchers may be physical (e.g., paper) or digital.

Electronic shuffler 822 may be configured or designed to automatically shuffle multiple decks of cards, and to track the relative order of each of the cards of the shuffled decks of cards. The electronic shuffler can include an off the shelf unit. A dealer can use the electronic shuffler to shuffle the decks of cards before dealing the required hands, and place the shuffled decks of cards into the electronic shoe 820. In this way, the electronic gaming table may determine the relative order of all cards in the card shoe at the start of one or more game session(s), and/or at all other times of game play.

Electronic shoe 820 may obtain data and/or images of gaming objects utilized with gaming table 760. This data and/or images may be transmitted to electronic gaming device and displayed as images from table games. For example, on a blackjack table a ten of spades may be dealt to a player. This information is obtained via electronic shoe 820 and utilized to generate an image and/or illustration of a ten of spades card on an electronic gaming device. In another example, electronic shoe 820 may receive data relating to the numbers on dice, transmit this data to electronic gaming device, which may be utilized to generate an image/illustration of the dice on electronic gaming device.

In at least one embodiment, the electronic shoe can include an electronic reading system, such as an optical reader for recognizing the face value of each card. The electronic shoe can be designed to communicate directly with the card dealing/shuffling system to read or otherwise obtain the value of each card being dealt by the dealer as the card leaves the card dealing/shuffling system. For example, an optical reader or similar device can be attached to the card dealing/shuffling system, and the electronic shoe can obtain the scanned value of cards in the card dealing/shuffling system. In some implementations, the electronic shoe can interface with the table to read the value of each card being dealt by the dealer. For example, the table can include one or more scanning interfaces to scan each card before or after the card is dealt by the dealer. The electronic shoe can communicate with the one or more scanning interfaces to obtain the value of each card before or after the card is dealt by the dealer.

Card reader 825 may provide identification, authentication, and application processing functions. Card reader 825 may interface with smart cards, magnetic striped card, bar code reader, RFID card, and the like.

Jackpot controller 830 may track and compile data associated with a jackpot. Jackpot controller 830 may award the jackpot on a specific occurrence (e.g., blackjack event, dealing a royal flush, etc.) and/or randomly award a jackpot.

Chips reader 835 may compile and track data associated with the amount of chips one or more players possesses, the amount of chips won/lost at gaming table 760, the amount of chips in the dealer's rack at gaming table 760, an amount of chips wager by one or more players, amount of chips in the betting pool, and/or any combination thereof.

Camera 840 may obtain data from gaming table 760. Camera 840 may be one or more cameras located to view the gaming objects (e.g., cards, dice, dominos, ball, wheel, etc.), the dealer, the shoe, the players' hands, the players, and/or any combination thereof. Camera 840 may transmit this data to gaming table, which may be utilized to generate an image/illustration of the gaming objects.

Speakers 842 may be used to provide audio information to the game table dealer/attendant. Examples of different types of audio information may include, for example, audio instructions and/or other audio/verbal communications from one or more remote players, computer-generated audio instructions/content, sound effects, and/or other types of audio content.

Microphone 843 may be used to capture, record, and/or stream audio information from the electronic gaming table region, which, for example, may include verbal communications from the table game dealer/attendant.

Game And Wager Data Collection Component(s) 844 may include functionality for facilitating, enabling, initiating, and/or performing collection and reporting of various types of information relating to conditions and/or events occurring at an associated gaming device and/or gaming table game, such as, for example: game-related information, player tracking information, wager-related information (e.g., including financial transaction events), and/or other types of data/information described and/or referenced herein.

According to specific embodiments, a variety of different game states may be used to characterize the state of current and/or past events which are occurring (or have occurred) at a given live gaming table. For example, in one embodiment, at any given time in a game, a valid current game state may be used to characterize the state of game play (and/or other related events, such as, for example, mode of operation of the gaming table, etc.) at that particular time. In at least one embodiment, multiple different states may be used to characterize different states or events which occur at the gaming table at any given time. In one embodiment, when faced with ambiguity of game state, a single state embodiment forces a decision such that one valid current game state is chosen. In a multiple state embodiment, multiple possible game states may exist simultaneously at any given time in a game, and at the end of the game or at any point in the middle of the game, the gaming table may analyze the different game states and select one of them based on certain criteria. Thus, for example, when faced with ambiguity of game state, the multiple state embodiment(s) allow all potential game states to exist and move forward, thus deferring the decision of choosing one game state to a later point in the game. The multiple game state embodiment(s) may also be more effective in handling ambiguous data or game state scenarios.

According to specific embodiments, a variety of different entities may be used (e.g., either singly or in combination) to track the progress of game states which occur at a given gaming table. Examples of such entities may include, but are not limited to, one or more of the following (or combination thereof): master controller system, display system, gaming system, local game tracking component(s), remote game tracking component(s), etc. Examples of various game tracking components may include, but are not limited to: automated sensors, manually operated sensors, video cameras, intelligent playing card shoes, RFID readers/writers, RFID tagged chips, objects displaying machine readable code/patterns, etc.

According to a specific embodiment, local game tracking components at the gaming table may be operable to automatically monitor game play activities at the gaming table, and/or to automatically identify key events which may trigger a transition of game state from one state to another as a game progresses. For example, in the case of Blackjack, a key event may include one or more events which indicate a change in the state of a game such as, for example: a new card being added to a card hand, the split of a card hand, a card hand being moved, a new card provided from a shoe, removal or disappearance of a card by occlusion, etc.

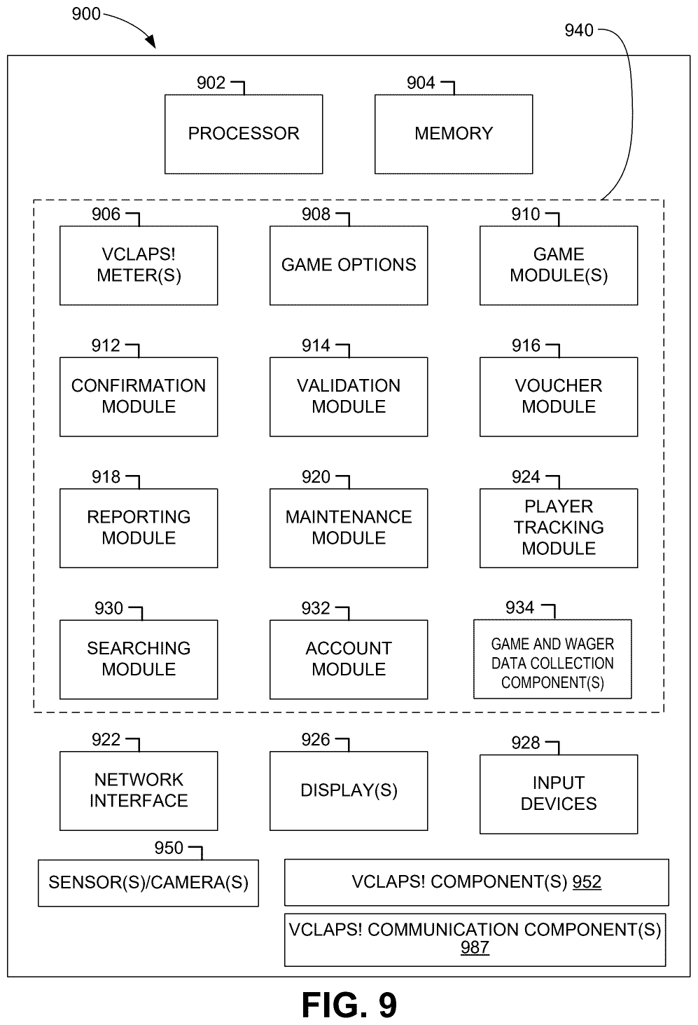

FIG. 9 shows a block diagram 900 of electronic gaming device 900, in accordance with a specific embodiment. Electronic gaming device 900 may include a processor 902, a memory 904, a network interface 922, input devices 928, and a display 926.

Processor 902 may generate gaming options based on predetermined betting structures and/or outcome categories. As previously discussed in the craps example above, predetermined betting structures may include outcome categories. In that example, there were three outcome categories (e.g., outcome equaling a seven, outcome not equaling a hard number, and outcome not equaling a craps). Predetermined betting structures may utilize one outcome category (e.g., win, lose, hard number, craps, etc.) to generate via processor 902 gaming options. Predetermined betting structures may utilize more than one outcome category to generate via processor 902 gaming options. Predetermined betting structures may combine any outcome category with any other outcome category to gaming options.

Processor 902 may generate gaming options 908, which, for example, may include contingent gaming options and/or predetermined gaming options. Contingent gaming options may be structures such that when a triggering event occurs over one or more than one gaming event, racing event, and/or sporting event, the wager is activated. Processor 902 may offer a gaming option which is structured so that the gaming option relates to more than one gaming table. The gaming option structure may be that for the next five baccarat games the dealer will win three of these five games and three of the next five roulette games red will be the winning spot.

In at least some embodiments, a predetermined game options module may store data relating to predetermined gaming options, which may be offered to a player, and a contingent game options module may store data relating to continent gaming options, which may be offered to a player.

Network interface 922 may be configured or designed to enable the electronic gaming device 900 to communicate with video/multimedia server(s), accounting/transaction server(s), gaming server(s), authentication server(s), player tracking server(s), voucher server(s), and gaming table(s).

Input devices 928 may be mechanical buttons, electronic buttons, a touchscreen, a microphone, cameras, an optical scanner, or any combination thereof. Input devices 928 may be utilized to make a wager, to make an offer to buy or sell a voucher, to determine a voucher's worth, to cash in a voucher, to modify (e.g., change sound level, configuration, font, language, etc.) electronic gaming device 900, to select a movie or music, to select live video streams (e.g., table 1, table 2, table 3), to request services (e.g., drinks, manager, etc.), or any combination thereof.

Display 926 may show video streams from one or more gaming tables 260, gaming objects from one or more gaming tables 260, computer generated graphics, predetermined gaming options 106, and/or contingent gaming options 108.

Memory 904 may include various memory modules 940. Memory 904 via various memory modules 940 may include a future betting module 906, a predetermined game options module 908, a contingent game options module 910, a confirmation module 912, a validation module 914, a voucher module 916, a reporting module 918, a maintenance module 920, a player tracking preferences module 924, a searching module 930, and an account module 932.

Confirmation module 912 may utilize data received from a voucher, the transaction history of the voucher (e.g., the voucher changed hands in a secondary market), and/or the identity of the player to confirm the value of the voucher. In another example, confirmation module 912 may utilize game event data, along with voucher data to confirm the value of the voucher.

Validation module 914 may utilize data received from a voucher to confirm the validity of the voucher.

Voucher module 916 may store data relating to generated vouchers, redeemed vouchers, bought vouchers, and/or sold vouchers.

Game And Wager Data Collection Component(s) 934 may include functionality for facilitating, enabling, initiating, and/or performing collection and reporting of various types of information relating to conditions and/or events occurring at an associated gaming device and/or gaming table game, such as, for example: game-related information, player tracking information, wager-related information (e.g., including financial transaction events), and/or other types of data/information described and/or referenced herein.

Sensor(s)/Camera(s) 950 may be configured or designed to detect and capture external data, events, and/or conditions including, for example, biometric information (e.g., facial images, facial features, fingerprints, voice recordings, etc.) relating to the player(s) or user(s) interacting with the gaming device. In some embodiments, the camera and/or other sensor(s) of the electronic gaming device may be remotely controlled and actuated. For example, in one embodiment, if it is determined that suspicious ML activities may be occurring at a given electronic gaming device, the camera of the electronic gaming device may be caused to be remotely actuated in order to capture a facial image of the person(s) who is/are interacting with the electronic gaming device.

Reporting module 918 may generate reports related to a performance of electronic gaming device 900, electronic gaming system, table game, video streams, gaming objects, credit device, and/or identification device.

In one implementation, reporting module 918 may reside on a central server and can aggregate and generate real time statistics on betting activities at one or more table games at one or more participating casino's. The aggregate betting statistics may include trends (e.g., aggregate daily wager volume and wager amount by game types, by casinos, and the like), top games with the most payouts, top tables with the most payouts, top search structures used by players, most popular dealers by wager volume, most searched for game, tables with least payouts, weekly trends, monthly trends, and other statistics related to game plays, wagers, people, location, and searches.

The information and statistics generated by the server-based reporting module 918 can be displayed publicly or privately. For example, popular trending and statistical information on wager volume and wager amount for the top ten table games can be publicly displayed in a casino display system so that players can study and decide what game to play, where, when, etc. Such a public display of general statistics can also be posted on the Internet, sent out as a text, an email, or multimedia message to the player's smart phones, tablets, desktop computer, etc. In another example, the trending and statistical information can also be distributed privately to privileged players such as casino club members.

Maintenance module 920 may track any maintenance that is implemented on electronic gaming device 900 and/or electronic gaming system 200. Maintenance module 920 may schedule preventative maintenance and/or request a service call based on a device error.

The Player Tracking Module 924 is a sophisticated component within the gaming system that monitors and records player activity during gaming sessions. This module is desirable for gathering data on player behavior, preferences, and gaming patterns. By tracking such activities, casinos may tailor their offerings and promotions to better suit individual player preferences, thereby enhancing the overall gaming experience. This module often works in conjunction with player loyalty programs, awarding points or credits based on gaming frequency, duration, and wager amounts. The insights gained from the Player Tracking Module 924 enable casinos to deliver personalized gaming experiences, incentivize repeat visits, and foster a deeper engagement with players. Moreover, this data is invaluable for optimizing game floor management, marketing strategies, and customer service initiatives, ultimately contributing to improved customer satisfaction and loyalty.

Player tracking module 924 may be configured or designed to communicate with the Casino's network-based player tracking system to retrieve player tracking data associated with the identified player and/or compile and track player tracking-related data including, for example, one or more of the following (or combinations thereof):
data associated with a players preferences;
game play activity
wagering activity;
earned rewards;
comps;
free game play opportunities;
free spin (and respin) opportunities;
VCLAPS!-related opportunities;
promotional offers;
non-game play activities conducted by that player/patron at the casino property such as, for example:
   shopping activities;
   dining activities;
   purchasing/spending activities;
   entertainment activities;
etc.

VCLAPS! Meter(s) 906 may be implemented as additional gaming meters (e.g., virtual meters or soft meters) which may be configured or designed to track and display various game metrics relating to one or more of the VCLAPS! features disclosed herein.

Game Options 908 encompasses the variety of selectable settings and choices presented to players within a gaming machine. This component allows players to customize their gaming experience according to personal preferences, including adjusting bet amounts, selecting pay lines, and activating various game features relating to one or more of the VCLAPS! features disclosed herein. The availability of these options plays a notable role in enhancing player engagement by offering a sense of control over the game mechanics and outcomes. By enabling players to tailor the gameplay to their liking, Game Options 908 fosters a more immersive and enjoyable gaming environment. This customization feature is designed with the player in mind, ensuring that the gaming experience may be as dynamic and interactive as possible, thus encouraging prolonged play and increased satisfaction with the gaming experience.

Game Modules 910 refer to the core components of the gaming system that execute the various games available on an Electronic Gaming Machine (EGM). These modules encompass the software and hardware elements necessary for the operation of games, including game logic, graphics, sound, and interactive features such as touch screen controls. Each module is responsible for delivering a distinct gaming experience, complete with unique themes, pay tables, bonus rounds, and, where applicable, VCLAPS! features. The modularity of these systems allows for a diverse gaming portfolio within a single EGM, offering players a wide range of entertainment options. Game Modules 910 are notable in maintaining player interest and engagement by providing fresh and varied gaming content. Additionally, they facilitate easy updates and integration of new games or features, ensuring that the gaming experience remains current and appealing to players.

The VCLAPS! Component(s) 952 represent component(s) within the EGM which are configured or designed to provide support for at least some of the VCLAPS!-related features disclosed herein.

VCLAPS! Communication Component(s) 987 facilitate the communications between the EGM and components and/or systems of the Casino Gaming Network. VCLAPS! Communication Component(s) 987 facilitate efficient data exchange, and helps ensure that all transactions amd communications are processed accurately and swiftly, enhancing the player's experience by minimizing wait times and preventing transaction errors. Furthermore, the communication components play a notable role in maintaining the gaming environment's security, safeguarding against fraud and unauthorized voucher use, thereby preserving the system's integrity and the players' confidence in the gaming establishment.

Searching module 930 may include one or more searching structures, one or more searching algorithms, and/or any other searching mechanisms. The searching structures may be predetermined searching structures. For example, the method may start searching a first device, then a second device, then a third device, up to an N^{th} device based on one or more searching parameters (e.g., triggering event). In one example, the search may end once one or more triggering events are determined. In another example, the search may end once data has been received from a predetermined number (e.g., one, two, ten, one hundred, all) of the devices. In another example, the search may be based on a predetermined number of devices to be searched in combination with a predetermined number of search results to be obtained. In this example, the search structure may be a minimum of ten devices to be searched, along with a minimum of five gaming options to be determined.

In another example, the searching structures may be based on one or more specific games (e.g., baccarat tables, roulette tables, blackjack tables, poker tables, craps tables, Sic Bo tables, etc.). Searching structure may search one or more of these games.

In another example, the searching structure may be based on a player's preferences, past transactional history, player input, a particular table, a particular game, a particular dealer, a particular casino, a particular location within a casino, game outcomes over a time period, payout over a time period, and/or any other criteria. Searching algorithms may be dynamic searching programs, which may be modified based on one or more past results, as described previously.

In another example, the search algorithm may generate a search priority based on the probability of success various events and/or conditions, as described previously. In some embodiments, the search algorithm may utilize any dynamic feedback procedure to enhance current and/or future searching results.

Account module 932 may include data relating to an account balance, a wager limit, a number of wagers placed, credit limits, any other player information, and/or any other account information.

Data from account module 932 may be utilized to determine whether a wager may be accepted. For example, when a search has determined a triggering event, the device and/or system may determine whether to allow this wager based on one or more of a wager amount, a number of wagers, a wager limit, an account balance, and/or any other criteria.

For example, the system and/or device determines via searching function that a triggering event has occurred. Based on this triggering event, the player would like to make a $400 wager, however, the player's account balance is only $50. In this case, the system and/or device may not accept the wager, modify the wager to the account balance (e.g., $50), send a notice to the player, modify the wager to some percentage (e.g., 10%, 25%, 50%, 75%, etc.) of the account balance (e.g., $5, $12.50, $25, $37.5, etc.), send a notice to the gaming entity, make a flat wager (e.g., $10), and/or any combination thereof.

In another example, the system and/or device determines via searching function that a triggering event has occurred. Based on this triggering event, the player would like to make a $400 wager and the player's account balance is $150. However, the system and/or device may not accept the wager because one betting parameter may be that no one wager may be more than a certain percentage (e.g., fifty percent) of a player's account balance. In this case, the system and/or device may not accept the wager, modify the wager to the predetermined limit (e.g., $75), send a notice to the player, modify the wager to some other percentage (e.g., 5%, 10%, 25%, 90%, etc.) of the account balance, send a notice to the gaming entity, make a flat wager (e.g., $10), and/or any combination thereof.

In another example, the gaming jurisdiction, the casino, the system and/or device may not allow an individual to place a wager over a specific value (e.g., $25, $400, $1,000, $10,000, $400,000, $1,000,000, etc.).

In another example, the system and/or device may not allow an individual to lose more than a specific amount of money in a predetermined timeframe. An individual may only be allowed to lose $200 (or any other number) over a two hour period (or any other time period).

In another example, based on this triggering event, the player would like to make a $400 wager and the player has a $200 balance. However, the player has made a predetermined number of wagers within a predetermined time frame. For example, the system and/or device may not allow an individual to make more than 5 wagers a day, 25 wagers a week, 1,000 wagers a year, etc.

Any of these betting parameters may be combined by the system and/or device.

In at least one embodiment, at least a portion of the modules discussed in block diagram 900 may reside locally in gaming terminal 900. However, In at least some embodiments, the functions performed by these modules may be implemented in one or more remote servers. For instance, modules 906-420 and 924 may each be on a remote server, communicating with gaming terminal 900 via a network interface such as Ethernet in a local or a wide area network topology. In some implementations, these servers may be physical servers in a data center. In some other implementations, these servers may be virtualized. In yet some other implementations, the functions performed by these modules may be implemented as web services. For example, the predetermined game options module 908 may be implemented in software as a web service provider. Gaming terminal 900 would make service requests over the web for the available predetermined wager options to be displayed. Regardless of how the modules and their respective functions are implemented, the interoperability with the gaming terminal 900 is seamless.

In one implementation, reporting module 918 may reside on a central server and can aggregate and generate real time statistics on betting activities at one or more table games at one or more participating casino's. The aggregate betting statistics may include trends (e.g., aggregate daily wager volume and wager amount by game types, by casinos, and the like), top games with the most payouts, top tables with the most payouts, top search structures used by players, most popular dealers by wager volume, most searched for game, tables with least payouts, weekly trends, monthly trends, and other statistics related to game plays, wagers, people, location, and searches.

The information and statistics generated by the server-based reporting module 918 can be displayed publicly or privately. For example, popular trending and statistical information on wager volume and wager amount for the top ten table games can be publicly displayed in a casino display system so that players can study and decide what game to play, where, when, etc. Such a public display of general statistics can also be posted on the Internet, sent out as a text, an email, or multimedia message to the player's smart phones, tablets, desktop computer, etc. In another example, the trending and statistical information can also be distributed privately to privileged players such as casino club members.

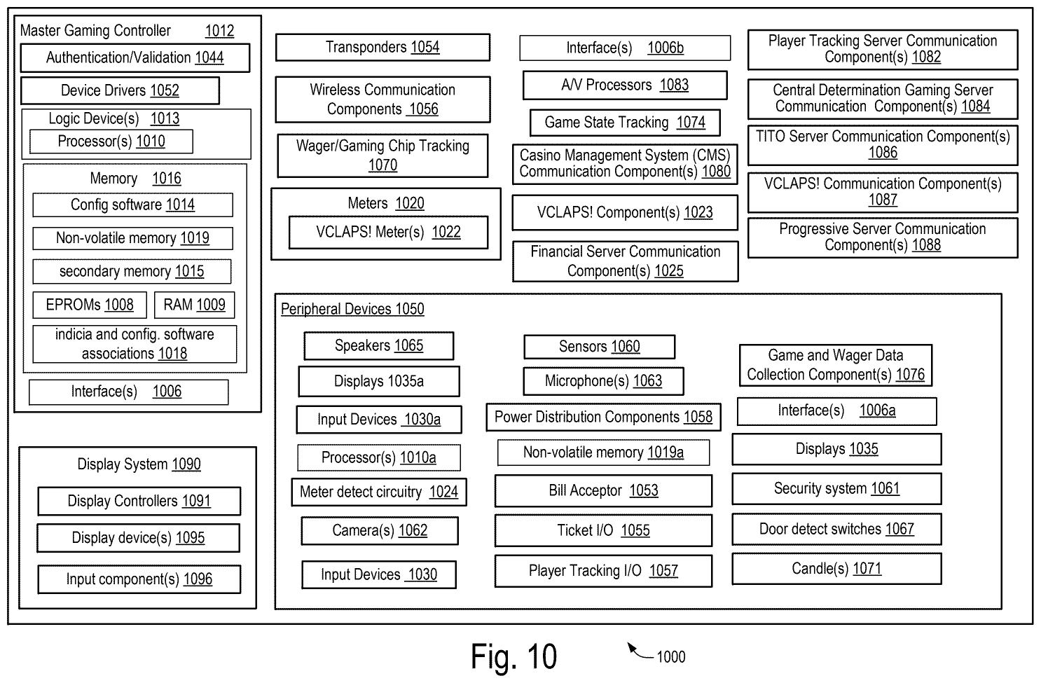

FIG. 10 is a simplified block diagram of an exemplary intelligent multi-player electronic gaming system 1000 in accordance with a specific embodiment. In some embodiments, gaming system by hundred may be implemented as a gaming server. In other embodiments, gaming system 1000 may be implemented as an electronic gaming machine (EGM) or electronic gaming device (EGD) or electronic gaming terminal (EGT).

As illustrated in the embodiment of FIG. 10, gaming system 1000 includes at least one processor 1010, at least one interface 1006, and memory 1016. Additionally, as illustrated in the example embodiment of FIG. 10, gaming system 1000 includes at least one master gaming controller 1012, a multi-touch sensor and display system 1090, a plurality of peripheral device components 1050, and various other components, devices, systems such as, for example, one or more of the following (or combinations thereof):
Transponders 1054;
Wireless communication components 1056;
Gaming chip/wager token tracking components 1070;
Games state tracking components 1074;
Audio/video processors 1083 which, for example, may include functionality for detecting, analyzing and/or managing various types of audio and/or video information relating to various activities at the gaming system.;
Various interfaces 1006 (e.g., for communicating with other devices, components, systems, etc.);
Sensors 1060;
One or more cameras 1062;
One or more microphones 1063;
Input devices 1030a;
Peripheral Devices 1050;
Game and Wager Data Collection Component(s) 1076

One or more cameras (e.g., 1062) may be used to monitor, stream and/or record image content and/or video content relating to persons or objects within each camera's view. For example, in at least one embodiment where the gaming system is implemented as an EGD, camera 1062 may be used to generate a live, real-time video feed of a player (or other person) who is currently interacting with the EGD. In some embodiments, camera 1062 may be used to verify a user's identity (e.g., by authenticating detected facial features), and/or may be used to monitor or tract facial expressions and/or eye movements of a user or player who is interacting with the gaming system.

In at least one embodiment, display system 1090 may include one or more of the following (or combinations thereof):
Display controllers 1091;
Multipoint sensing device(s) (e.g., multi-touch surface sensors/components);
Display device(s) 1095;
Input/touch surface 1096;
Etc.

According to various embodiments, display device(s) 1095 may include one or more display screens utilizing various types of display technologies such as, for example, one or more of the following (or combinations thereof): LCDs (Liquid Crystal Display), Plasma, OLEDs (Organic Light Emitting Display), TOLED (Transparent Organic Light Emitting Display), Flexible (F)OLEDs, Active matrix (AM) OLED, Passive matrix (PM) OLED, Phosphorescent (PH) OLEDs, SEDs (surface-conduction electron-emitter display), EPD (ElectroPhoretic display), FEDs (Field Emission Displays) and/or other suitable display technology. EPD displays may be provided by E-ink of Cambridge, MA. OLED displays of the type list above may be provided by Universal Display Corporation, Ewing, NJ.

In at least one embodiment, master gaming controller 1012 may include one or more of the following (or combinations thereof):
Authentication/validation components 1044;
Device drivers 1042;
Logic devices 1013, which may include one or more processors 1010;
Memory 1016, which may include one or more of the following (or combinations thereof): configuration software 1014, non-volatile memory 1015, EPROMS 1008, RAM 1009, associations 1018 between indicia and configuration software, etc.;
Interfaces 1006;

In at least one embodiment, Peripheral Devices 1050 may include one or more of the following (or combinations thereof):
Power distribution components 1058;
Non-volatile memory 1019a (and/or other types of memory);
Bill acceptor 1053;
Ticket I/O 1055;
Player tracking I/O 1057;
Meter detect circuitry 1024;
Processor(s) 1010a;
Interface(s) 1006a;
Display(s) 1035;
Security system 1061;
Door detect switches 1067;
Input devices 1030;
Etc.

EGM Meters 1020 provide real-time tracking and display of various game metrics such as credits, bets, wins, and more. These meters serve a dual purpose: offering players transparent insights into their current game status and enabling operators to monitor machine performance and compliance with gaming regulations. By presenting information clearly, EGM Meters help players make informed decisions about their gameplay, such as managing their bets and understanding their winnings. For operators, these meters facilitate efficient management of gaming operations by ensuring accuracy in transactions and gameplay integrity. The data collected through EGM Meters are also notable for analytical purposes, allowing for the optimization of game offerings and the enhancement of player experiences based on actual usage patterns and preferences.

The VCLAPS! Meter(s) 1022 may be implemented as additional gaming meters (e.g., virtual meters or soft meters) which may be configured or designed to track and display various game metrics relating to one or more of the VCLAPS! features disclosed herein.

The Casino Management System (CMS) Communication Component(s) 1080 are notable in ensuring seamless interaction between gaming machines and the broader casino management infrastructure. These components facilitate the exchange of notable data regarding game performance, player activity, and machine status, enabling the CMS to effectively oversee and optimize the gaming floor. Through this communication, the CMS may implement changes in game configurations, update promotional offers, and monitor compliance with gaming regulations. Moreover, the data flow allows for the personalization of player experiences through targeted marketing and loyalty rewards, enhancing player satisfaction and retention. These components are desirable for maintaining the operational efficiency of casino operations, providing the backbone for real-time analytics, machine maintenance, and customer service initiatives, ultimately contributing to a superior gaming environment and improved profitability.

The VCLAPS! Component(s) 1023 represent component(s) within the EGM which are configured or designed to provide support for at least some of the VCLAPS!-related features disclosed herein.

Player Tracking Server Communication Component(s) 1082 facilitate the notable exchange of data between gaming machines and the player tracking server, desirable for the implementation of loyalty programs and personalized gaming experiences. These components capture and transmit player activity data, including game play duration, bet amounts, and winnings, to the tracking server, which then analyzes this information to tailor rewards, offers, and communications to individual player preferences and behaviors. This targeted approach not only enhances player engagement by rewarding loyalty and encouraging repeat visits but also allows casinos to optimize their marketing strategies and improve overall customer satisfaction. By ensuring accurate and secure data transmission, these components play a notable role in maintaining the integrity of player tracking systems, supporting the delivery of customized gaming experiences that meet the unique needs and expectations of each player.

Central Determination Gaming Server Communication Component(s) 1084 are desirable for ensuring that Electronic Gaming Machines (EGMs) operate in compliance with gaming regulations that mandate centralized game outcome determination. These components enable secure and reliable communication between EGMs and the central determination gaming server, which is responsible for generating game outcomes based on a predetermined pool of results. This system ensures fairness and transparency in gaming by centralizing the outcome determination process, removing the randomness from individual machines, and complying with regulatory requirements. The communication components are notable for the seamless operation of this system, providing real-time connectivity that allows for immediate game outcome delivery to EGMs, ensuring a smooth and uninterrupted player experience. By facilitating this notable communication, these components uphold the integrity of the gaming operation and maintain player trust in the fairness of the game.

TITO Server Communication Component(s) 1086 play a notable role in the gaming ecosystem by enabling seamless interaction between Electronic Gaming Machines (EGMs) and the Ticket-In, Ticket-Out (TITO) server. These components ensure efficient and secure processing of TITO transactions, allowing players to easily cash out their winnings or move credits between machines. By facilitating the accurate exchange of data related to ticket validations, redemptions, and issuances, these communication components enhance the player experience by providing convenience and reducing wait times for ticket transactions. Furthermore, the integrity of the TITO system is maintained through the secure and reliable communication provided by these components, ensuring that all transactions are processed accurately, thereby preventing fraud and maintaining the trust of players in the gaming operation.

VCLAPS! Communication Component(s) 1087 facilitate communications between the EGM and other components and/or systems of the Casino Gaming Network. VCLAPS! Communication Component(s) 987 facilitate efficient data exchange, and help ensure that all transactions and communications are processed accurately and swiftly, enhancing the player's experience by minimizing wait times and preventing transaction errors. Furthermore, the communication components play a notable role in maintaining the gaming environment's security, safeguarding against fraud and unauthorized voucher use, thereby preserving the system's integrity and the players' confidence in the gaming establishment.

Progressive Server Communication Component(s) 1088 are desirable in linking Electronic Gaming Machines (EGMs) with the progressive server, which manages the accumulation and payout of progressive jackpots. These components ensure real-time, secure communication of data related to jackpot contributions and awards, enabling the seamless update and display of progressive jackpot values across the networked machines. By facilitating accurate and timely information exchange, these communication components play a notable role in maintaining the excitement and attractiveness of progressive jackpot games, where the potential for life-changing wins adds a significant draw for players. Moreover, the integrity of the progressive jackpot system is upheld through the reliable operation of these components, ensuring that jackpots are awarded correctly and transparently, thereby fostering player confidence in the fairness and reliability of the gaming operation.

In one implementation, processor 1010 and master gaming controller 1012 are included in a logic device 1013 enclosed in a logic device housing. The processor 1010 may include any conventional processor or logic device configured to execute software allowing various configuration and reconfiguration tasks such as, for example: a) communicating with a remote source via communication interface 1006, such as a server that stores authentication information or games; b) converting signals read by an interface to a format corresponding to that used by software or memory in the gaming system; c) accessing memory to configure or reconfigure game parameters in the memory according to indicia read from the device; d) communicating with interfaces, various peripheral devices and/or I/O devices; e) operating peripheral devices such as, for example, card readers, paper ticket readers, etc.; f) operating various I/O devices such as, for example, displays 1035, input devices 1030; etc. For instance, the processor 1010 may send messages including game play information to the displays 1035 to inform players of cards dealt, wagering information, and/or other desired information.

In at least one implementation, the gaming system may include card readers such as used with credit cards, or other identification code reading devices to allow or require player identification in connection with play of the card game and associated recording of game action. Such a player identification interface can be implemented in the form of a variety of magnetic card readers commercially available for reading a player-specific identification information. The player-specific information can be provided on specially constructed magnetic cards issued by a casino, or magnetically coded credit cards or debit cards frequently used with national credit organizations such as VISA, MASTERCARD, AMERICAN EXPRESS, or banks and other institutions.

The gaming system may include other types of participant identification mechanisms which may use a fingerprint image, eye blood vessel image reader, or other suitable biological information to confirm identity of the player. Still further it is possible to provide such participant identification information by having the dealer manually code in the information in response to the player indicating his or her code name or real name. Such additional identification could also be used to confirm credit use of a smart card, transponder, and/or player's personal player input device (UID).

The gaming system 1000 also includes memory 1016 which may include, for example, volatile memory (e.g., RAM 1009), non-volatile memory 1019 (e.g., disk memory, FLASH memory, EPROMs, etc.), unalterable memory (e.g., EPROMs 1008), etc. The memory may be configured or designed to store, for example: 1) configuration software 1014 such as all the parameters and settings for a game playable on the gaming system; 2) associations 1018 between configuration indicia read from a device with one or more parameters and settings; 3) communication protocols allowing the processor 1010 to communicate with peripheral devices and I/O devices 1011; 4) a secondary memory storage device 1015 such as a non-volatile memory device, configured to store gaming software related information (the gaming software related information and memory may be used to store various audio files and games not currently being used and invoked in a configuration or reconfiguration); 5) communication transport protocols (such as, for example, TCP/IP, USB, Firewire, IEEE1394, Bluetooth, IEEE 802.11x (IEEE 802.11 standards), hiperlan/2, HomeRF, etc.) for allowing the gaming system to communicate with local and non-local devices using such protocols; etc. In one implementation, the master gaming controller 1012 communicates using a serial communication protocol. A few examples of serial communication protocols that may be used to communicate with the master gaming controller include but are not limited to USB, RS-232 and Netplex (a proprietary protocol developed by IGT, Reno, NV).

A plurality of device drivers 1042 may be stored in memory 1016. Example of different types of device drivers may include device drivers for gaming system components, device drivers for gaming system components, etc. Typically, the device drivers 1042 utilize a communication protocol of some type that enables communication with a particular physical device. The device driver abstracts the hardware implementation of a device. For example, a device drive may be written for each type of card reader that may be potentially connected to the gaming system. Examples of communication protocols used to implement the device drivers include Netplex, USB, Serial, Ethernet 1075, Firewire, I/O debouncer, direct memory map, serial, PCI, parallel, RF, Bluetooth™, near-field communications (e.g., using near-field magnetics), 802.11 (WiFi), etc. Netplex is a proprietary IGT standard while the others are open standards. According to a specific embodiment, when one type of a particular device is exchanged for another type of the particular device, a new device driver may be loaded from the memory 1016 by the processor 1010 to allow communication with the device. For instance, one type of card reader in gaming system 1000 may be replaced with a second type of card reader where device drivers for both card readers are stored in the memory 1016.

In some embodiments, the software units stored in the memory 1016 may be upgraded as needed. For instance, when the memory 1016 is a hard drive, new games, game options, various new parameters, new settings for existing parameters, new settings for new parameters, device drivers, and new communication protocols may be uploaded to the memory from the master gaming controller 1012 or from some other external device. As another example, when the memory 1016 includes a CD/DVD drive including a CD/DVD designed or configured to store game options, parameters, and settings, the software stored in the memory may be upgraded by replacing a first CD/DVD with a second CD/DVD. In yet another example, when the memory 1016 uses one or more flash memory 1019 or EPROM 1008 units designed or configured to store games, game options, parameters, settings, the software stored in the flash and/or EPROM memory units may be upgraded by replacing one or more memory units with new memory units which include the upgraded software. In another embodiment, one or more of the memory devices, such as the hard-drive, may be employed in a game software download process from a remote software server.

In some embodiments, the gaming system 1000 may also include various authentication and/or validation components 1044 which may be used for authenticating/validating specified gaming system components such as, for example, hardware components, software components, firmware components, information stored in the gaming system memory 1016, etc. Examples of various authentication and/or validation components are described in U.S. Pat. No. 6,620,047, entitled, “ELECTRONIC GAMING APPARATUS HAVING AUTHENTICATION DATA SETS,” incorporated herein by reference in its entirety for all purposes.

Sensors 1060 may include, for example, optical sensors, pressure sensors, RF sensors, Infrared sensors, motion sensors, audio sensors, image sensors, thermal sensors, biometric sensors, etc. As mentioned previously, such sensors may be used for a variety of functions such as, for example: detecting the presence and/or monetary amount of gaming chips which have been placed within a player's wagering zone; detecting (e.g., in real time) the presence and/or monetary amount of gaming chips which are within the player's personal space; etc.

In one implementation, at least a portion of the sensors 1060 and/or input devices 1030 may be implemented in the form of touch keys selected from a wide variety of commercially available touch keys used to provide electrical control signals. Alternatively, some of the touch keys may be implemented in another form which are touch sensors such as those provided by a touchscreen display. For example, in at least one implementation, the gaming system player may include input functionality for enabling players to provide their game play decisions/instructions (and/or other input) to the dealer using the touch keys and/or other player control sensors/buttons. Additionally, such input functionality may also be used for allowing players to provide input to other devices in the casino gaming network (such as, for example, player tracking systems, side wagering systems, etc.)

Wireless communication components 1056 may include one or more communication interfaces having different architectures and utilizing a variety of protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetic communication protocols, etc. The communication links may transmit electrical, electromagnetic or optical signals which carry digital data streams or analog signals representing various types of information.

An example of a near-field communication protocol is the ECMA-340 “Near Field Communication—Interface and Protocol (NFCIP-1)”, published by ECMA International (www.ecma-international.org), herein incorporated by reference in its entirety for all purposes. It will be appreciated that other types of Near Field Communication protocols may be used including, for example, near field magnetic communication protocols, near field RF communication protocols, and/or other wireless protocols which provide the ability to control with relative precision (e.g., on the order of centimeters, inches, feet, meters, etc.) the allowable radius of communication between at least two devices using such wireless communication protocols.

Power distribution components 1058 may include, for example, components or devices which are operable for providing wireless power to other devices. For example, in one implementation, the power distribution components 1058 may include a magnetic induction system which is adapted to provide wireless power to one or more portable UIDs at the gaming system. In one implementation, a UID docking region may include a power distribution component which is able to recharge a UID placed within the UID docking region without requiring metal-to-metal contact.

In at least one embodiment, motion/gesture detection component(s) 1051 may be configured or designed to detect player (e.g., player, dealer, and/or other persons) movements and/or gestures and/or other input data from the player. In some embodiments, each gaming system may have its own respective motion/gesture detection component(s). In other embodiments, motion/gesture detection component(s) 1051 may be implemented as a separate sub-system of the gaming system which is not associated with any one specific gaming system or device.

Game And Wager Data Collection Component(s) 1076 may include functionality for facilitating, enabling, initiating, and/or performing collection and reporting of various types of information relating to conditions and/or events occurring at an associated gaming device and/or gaming table game, such as, for example: game-related information, player tracking information, wager-related information (e.g., including financial transaction events), and/or other types of data/information described and/or referenced herein.

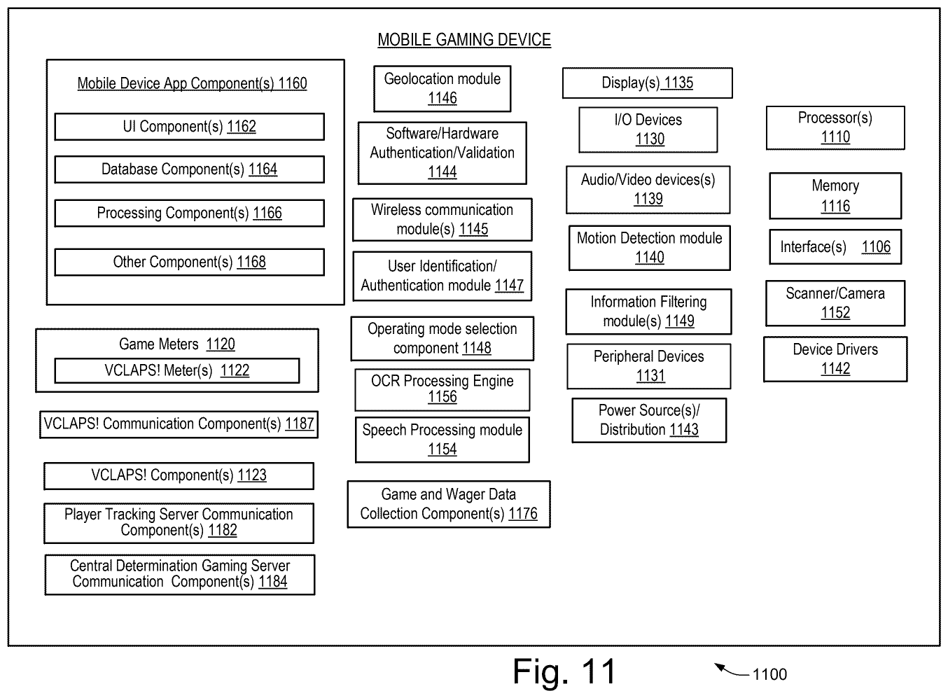

FIG. 11 is a simplified block diagram of an example mobile gaming device 1100 in accordance with a specific embodiment. In at least one embodiment, one or more players may participate in a live, multiplayer, wager-based, virtual table game session using mobile gaming devices. In at least some embodiments, the mobile gaming device may be configured or designed to include or provide functionality which is similar to that of an electronic gaming device (EGD) such as that described, for example, in FIGS. 9 and 10.

As illustrated in the example of FIG. 11, mobile gaming device 1100 may include a variety of components, modules and/or systems for providing various functionality. For example, as illustrated in FIG. 11, mobile gaming device 1100 may include Mobile Device Application components (e.g., 1160), which, for example, may include, but are not limited to, one or more of the following (or combinations thereof):
UI Components 1162 such as those illustrated, described, and/or referenced herein.
Database Components 1164 such as those illustrated, described, and/or referenced herein.
Processing Components 1166 such as those illustrated, described, and/or referenced herein.
Other Components 1168 which, for example, may include components for facilitating and/or enabling the mobile gaming device to perform and/or initiate various types of operations, activities, functions such as those described herein.

In at least one embodiment, the mobile gaming device may include Mobile Device App Component(s) which have been configured or designed to provide functionality for enabling or implementing at least a portion of the various automated money laundering detection and reporting techniques at the mobile gaming device.

According to specific embodiments, various aspects, features, and/or functionalities of the mobile gaming device may be performed, implemented and/or initiated by one or more of the following types of systems, components, systems, devices, procedures, processes, etc. (or combinations thereof):
Processor(s) 1110
Device Drivers 1142
Memory 1116
Interface(s) 1106
Power Source(s)/Distribution 1143
Geolocation module 1146
Display(s) 1135
I/O Devices 1130
Audio/Video devices(s) 1139
Peripheral Devices 1131
Motion Detection module 1140
User Identification/Authentication module 1147
Client App Component(s) 1160
Other Component(s) 1168
UI Component(s) 1162
Database Component(s) 1164
Processing Component(s) 1166
Software/Hardware Authentication/Validation 1144
Wireless communication module(s) 1145
Information Filtering module(s) 1149
Operating mode selection component 1148
Speech Processing module 1154
Scanner/Camera 1152
OCR Processing Engine 1156
Game and Wager Data Collection Component(s) 1176

Game Meters 1120 are notable display components within Electronic Gaming Machines (EGMs), tasked with presenting various game-related statistics such as current credit balance, bet amounts, winnings, and more. These meters provide players with immediate, clear information about their game status, facilitating informed gaming decisions. The transparency afforded by these meters is desirable for a trustworthy gaming experience, allowing players to monitor their progress and manage their resources effectively. Beyond player benefits, Game Meters 1120 assist casino operators in ensuring gaming integrity and regulatory compliance by accurately tracking and reporting desirable game metrics. The real-time data captured by these meters also offer valuable insights for casino management, enabling the optimization of gaming operations and the tailoring of promotions to player behaviors and preferences. Essentially, Game Meters 1120 bridge the information gap between the gaming machine's internal mechanics and the player's understanding, enhancing the gaming experience for all parties involved.

VCLAPS! Meter(s) 1122 may be implemented as additional gaming meters (e.g., virtual meters or soft meters) which may be configured or designed to track and display various game metrics relating to one or more of the VCLAPS! features disclosed herein.

The VCLAPS! Communication Component(s) 1187 facilitate communications between the EGM and other components and/or systems of the Casino Gaming Network.

The VCLAPS! Component(s) 1123 represent component(s) within a mobile electronig gaming device (EGD) which are configured or designed to provide support for at least some of the VCLAPS!-related features disclosed herein.

Player Tracking Server Communication Component(s) 1182 are desirable for the efficient and secure exchange of data between gaming machines and the player tracking server. This communication is notable for implementing sophisticated player loyalty programs and delivering a personalized gaming experience. By accurately capturing and transmitting detailed information on player behavior, preferences, and activities at the gaming machines, these components enable the player tracking server to analyze data and tailor rewards, promotions, and communications to individual player profiles. The result is a highly engaging and rewarding casino experience that encourages player loyalty and repeat visits. The reliability and security of these communication components ensure that player data is handled with the utmost integrity, maintaining player trust and compliance with data protection regulations. Through the facilitation of targeted rewards and personalized gaming experiences, Player Tracking Server Communication Component(s) 1182 play a notable role in enhancing player satisfaction and casino profitability.

Central Determination Gaming Server Communication Component(s) 1184 ensure the flawless and secure transmission of game outcome data between the central determination gaming server and individual gaming machines. This system, notable for jurisdictions that may require game outcomes to be determined centrally rather than by the individual machine, guarantees fairness and compliance with gaming regulations. These communication components are notable for the integrity of the gaming experience, as they allow for real-time delivery of predetermined game outcomes to machines, ensuring that each player's experience is both random and compliant with regulatory standards. By maintaining a consistent and secure line of communication, these components ensure that the gaming experience remains seamless for players, without noticeable delays or discrepancies in game play. The Central Determination Gaming Server Communication Component(s) 1184 thus play a notable role in upholding the trust and confidence of players in the fairness and reliability of the gaming operation.

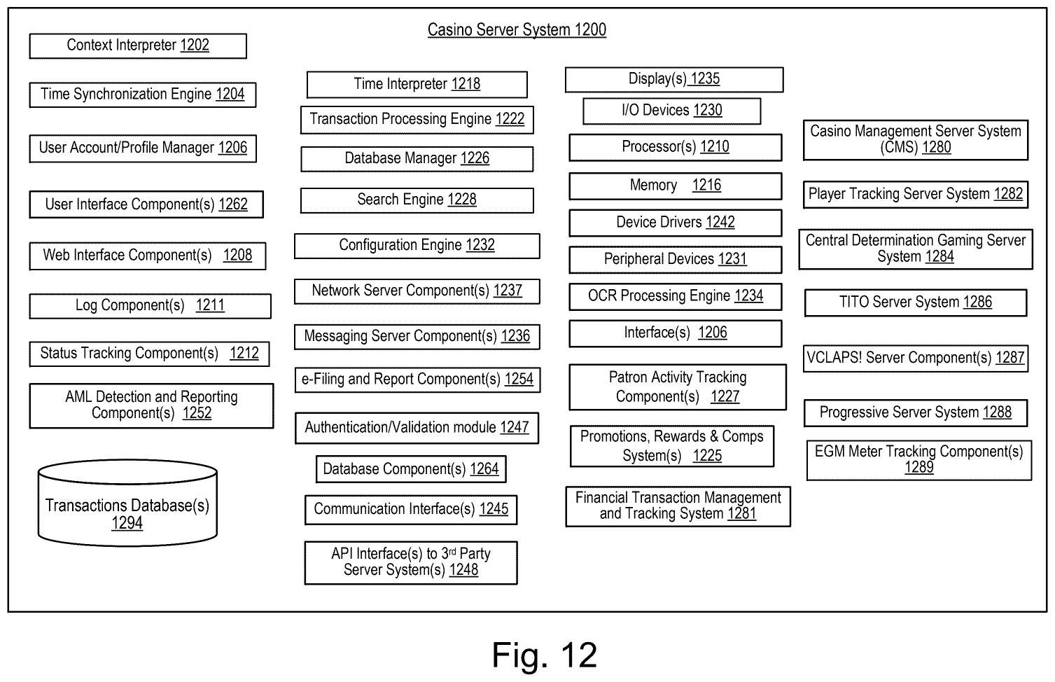

FIG. 12 illustrates an example of a functional block diagram of a Casino Server System in accordance with a specific embodiment. In at least one embodiment, the Casino Server System may be operable to perform and/or implement various types of functions, operations, actions, and/or other features, such as, for example, one or more of those described and/or referenced herein.

In at least one embodiment, the Casino Server System may include a plurality of components operable to perform and/or implement various types of functions, operations, actions, and/or other features such as, for example, one or more of the following (or combinations thereof):
Context Interpreter (e.g., 1202) which, for example, may be operable to automatically and/or dynamically analyze contextual criteria relating to a detected set of event(s) and/or condition(s), and automatically determine or identify one or more contextually appropriate response(s) based on the contextual interpretation of the detected event(s)/condition(s). According to different embodiments, examples of contextual criteria which may be analyzed may include, but are not limited to, one or more of the following (or combinations thereof):
   location-based criteria (e.g., geolocation of mobile gaming device, geolocation of EGD, etc.)
   time-based criteria
   identity of user(s)
   user profile information
   transaction history information
   recent user activities
   etc.
Time Synchronization Engine (e.g., 1204) which, for example, may be operable to manages universal time synchronization (e.g., via NTP and/or GPS)
Search Engine (e.g., 1228) which, for example, may be operable to search for transactions, logs, game history information, player information, automated money laundering detection and reporting information, etc., which may be accessed from one or more local and/or remote databases.
Configuration Engine (e.g., 1232) which, for example, may be operable to determine and handle configuration of various customized configuration parameters for one or more devices, component(s), system(s), process(es), etc.
Time Interpreter (e.g., 1218) which, for example, may be operable to automatically and/or dynamically modify or change identifier activation and expiration time(s) based on various criteria such as, for example, time, location, transaction status, etc.
Authentication/Validation Component(s) (e.g., 1247) (password, software/hardware info, SSL certificates) which, for example, may be operable to perform various types of authentication/validation tasks such as one or more of those described and/or referenced herein.
Transaction Processing Engine (e.g., 1222) which, for example, may be operable to handle various types of transaction processing tasks such as, for example, one or more of those described and/or referenced herein.
OCR Processing Engine (e.g., 1234) which, for example, may be operable to perform image processing and optical character recognition of images such as those captured by a gaming device camera, for example.
Database Manager (e.g., 1226) which, for example, may be operable to handle various types of tasks relating to database updating, database management, database access, etc. In at least one embodiment, the Database Manager may be operable to manage game history databases, player tracking databases, etc.
Log Component(s) (e.g., 1211) which, for example, may be operable to generate and manage transactions history logs, system errors, connections from APIs, etc.
Status Tracking Component(s) (e.g., 1212) which, for example, may be operable to automatically and/or dynamically determine, assign, and/or report updated transaction status information based, for example, on the state of the transaction.
Gateway Component(s) (e.g., 1214) which, for example, may be operable to facilitate and manage communications and transactions with external Payment Gateways.
Web Interface Component(s) (e.g., 1208) which, for example, may be operable to facilitate and manage communications and transactions with virtual live game table web portal(s).
API Interface(s) to Casino Server System(s) (e.g., 1246) which, for example, may be operable to facilitate and manage communications and transactions with API Interface(s) to Server System(s) of various casino networks.
API Interface(s) to 3rd Party Server System(s) (e.g., 1248) which, for example, may be operable to facilitate and manage communications and transactions with API Interface(s) to 3rd Party Server System(s)
At least one processor 1210. In at least one embodiment, the processor(s) 1210 may include one or more commonly known CPUs which are deployed in many of today's consumer electronic devices, such as, for example, CPUs or processors from the Motorola or Intel family of microprocessors, etc. In an alternative embodiment, at least one processor may be specially designed hardware for controlling the operations of a gaming system. In a specific embodiment, a memory (such as non-volatile RAM and/or ROM) also forms part of CPU. When acting under the control of appropriate software or firmware, the CPU may be responsible for implementing specific functions associated with the functions of a desired network device. The CPU preferably accomplishes all these functions under the control of software including an operating system, and any appropriate applications software.
Memory 1216, which, for example, may include volatile memory (e.g., RAM), non-volatile memory (e.g., disk memory, FLASH memory, EPROMs, etc.), unalterable memory, and/or other types of memory. In at least one implementation, the memory 1216 may include functionality similar to at least a portion of functionality implemented by one or more commonly known memory devices such as those described herein and/or generally known to one having ordinary skill in the art. According to different embodiments, one or more memories or memory modules (e.g., memory blocks) may be configured or designed to store data, program instructions for the functional operations of the mobile gaming system and/or other information relating to the functionality of the various Mobile Transaction techniques described herein. The program instructions may control the operation of an operating system and/or one or more applications, for example. The memory or memories may also be configured to store data structures, metadata, identifier information/images, and/or information/data relating to other features/functions described herein.
Interface(s) 1206 which, for example, may include wired interfaces and/or wireless interfaces. In at least one implementation, the interface(s) 1206 may include functionality similar to at least a portion of functionality implemented by one or more computer system interfaces such as those described herein and/or generally known to one having ordinary skill in the art.
Device driver(s) 1242. In at least one implementation, the device driver(s) 1242 may include functionality similar to at least a portion of functionality implemented by one or more computer system driver devices such as those described herein and/or generally known to one having ordinary skill in the art.
One or more display(s) 1235.
Messaging Server Component(s) 1236, which, for example, may be configured or designed to provide various functions and operations relating to messaging activities and communications.
Network Server Component(s) 1237, which, for example, may be configured or designed to provide various functions and operations relating to network server activities and communications.
AML Detection and Reporting Component(s) 1252. In at least one embodiment, the AML Detection and Reporting components may be configured or designed to include functionality for facilitating, aggregating data, enabling, initiating, and/or performing various types of financial transaction analysis, AML analysis and detection, and reporting operation(s), action(s), and/or feature(s) such as one or more of those described herein.
E-Filing and Report Component(s) 1254. In at least one embodiment, the e-Filing and Report Component(s) may be configured or designed to include functionality for facilitating, enabling, initiating, and/or performing various types of reporting and notification activities such as, for example:
   automated electronic filing of detected suspicious ML activities at appropriate governmental agencies;
   automated generation and/or transmission of notifications and alerts (e.g., such as those relating to detected suspicious ML activities) to appropriate authorities (e.g., police, Federal agencies, local law enforcement, casino security personnel, casino employees, etc.);
   and/or other types of types of reporting and notification activities such as those described herein.
Suspicious Activity/ML Activity Pattern Database(s). In at least one embodiment, the Suspicious Activity/ML Activity Pattern Database(s) may be configured or designed to include functionality for storing and/or providing access to various types of information relating to suspicious activity pattern and ML pattern analysis and detection, and/or other types of information described and/or referenced herein.
Transactions Database(s) 1294. In at least one embodiment, the Transactions Database(s) may be configured or designed to include functionality for storing and/or providing access to various types of information, events, and/or conditions such as, for example, one or more of the following (or combinations thereof): casino-related information, game play information, wager information, financial transaction information, and/or other types of information described and/or referenced herein.

Patron Activity Tracking Component(s) 1227 are notable for casinos aiming to offer a personalized and engaging gaming experience. These components meticulously collect data on every aspect of a patron's activities within the casino, from gaming habits to transaction history and participation in promotional events. This comprehensive data collection allows for deep insights into patron preferences and behavior, enabling casinos to tailor services, offers, and communications effectively. The utilization of this data significantly enhances customer relationship management strategies, promoting increased customer loyalty and satisfaction. By identifying trends and preferences, casinos may optimize their gaming floor, adjust their marketing strategies, and develop targeted promotions that resonate with their patrons. Furthermore, these tracking components are desirable for responsible gaming initiatives, allowing casinos to monitor player behavior for signs of problematic gaming patterns and intervene when necessary.

Promotions, Rewards & Comps System(s) 1225 are designed to enrich the casino experience for patrons by offering a variety of incentives that reward gaming activity and loyalty. These systems manage the distribution of promotions, rewards, and complimentary services or items to patrons based on their level of engagement and play. Through a strategic blend of immediate rewards, tiered loyalty programs, and targeted promotions, these systems encourage continued patronage by enhancing the perceived value of gaming and visits. The dynamic nature of these systems allows for customization and adaptation to patron preferences, ensuring that offers remain relevant and appealing. Additionally, they serve as a powerful marketing tool, driving foot traffic, increasing play time, and promoting higher spending. Effective management of these systems fosters a sense of appreciation among patrons, bolstering loyalty, and creating a competitive edge in the gaming and entertainment industry.

The Casino Management Server System (CMS) 1280 is the technological backbone of modern casino operations, orchestrating the seamless integration of gaming machines, patron management, financial transactions, and regulatory compliance. This centralized system provides a comprehensive suite of tools for managing every aspect of the casino floor, including game monitoring, accounting, security, and customer relations. By aggregating data from various sources, the CMS offers valuable insights into operational efficiency, player behavior, and revenue generation. This enables casino operators to make informed decisions, optimize game offerings, and personalize player experiences. The CMS also plays a notable role in ensuring compliance with gaming regulations, facilitating audits, and maintaining data security. Its scalable and modular design allows for flexibility and growth, ensuring that casinos may adapt to evolving market demands and technological advancements, thereby maintaining operational excellence and competitive advantage.

The Player Tracking Server System 1282 is a dedicated platform that centralizes the collection, analysis, and application of data related to casino patrons' gaming behaviors and preferences. This system is instrumental in supporting loyalty programs, enabling casinos to recognize and reward frequent players with offers tailored to their interests and play patterns. By leveraging detailed analytics, the Player Tracking Server System enhances customer engagement strategies, driving repeat business and increasing player satisfaction. It allows casinos to segment their customer base effectively, delivering personalized promotions, events invitations, and comps that resonate with individual preferences. Additionally, this system provides notable insights for optimizing game floor layouts, promotional offerings, and operational strategies. Its role in fostering strong customer relationships and loyalty is invaluable, directly impacting the casino's bottom line by promoting a loyal and engaged patron base.

The Central Determination Gaming Server System 1284 is a specialized server that centralizes the outcome determination for gaming machines, ensuring fairness and compliance with regulatory standards that mandate central random number generation. This system is notable in jurisdictions where gaming outcomes must not be determined by the individual machines but instead by a centralized, secure, and auditable source. By pooling the outcomes, the Central Determination Gaming Server System guarantees that each play is random and unbiased, reinforcing the integrity of the gaming experience. This system supports a variety of games and may be dynamically updated to introduce new content, maintaining player interest and engagement. Additionally, it provides casinos with the ability to monitor and manage the performance of games in real-time, optimizing their offerings and maximizing revenue while ensuring compliance with gaming regulations.

The TITO (Ticket-In, Ticket-Out) Server System 1286 is an desirable component of casino operations, facilitating the efficient and secure handling of paper-based transactions within the gaming environment. This system manages the issuance, acceptance, and validation of TITO vouchers, streamlining the process for both patrons and casino staff. By eliminating the need for physical coins or tokens, the TITO Server System enhances the customer experience, reducing wait times for machine refills and cashier interactions. It also improves operational efficiency by automating cash flow management and reducing machine downtime. The system's robust security features prevent fraud and duplication of vouchers, ensuring the integrity of transactions. Additionally, the TITO Server System collects transactional data, providing valuable insights into player behavior and machine performance, which may be used to optimize floor operations and marketing strategies.

The VCLAPS! Server Components 1287 represent component(s) within the casino server system and/or casino gaming network which are configured or designed to provide support for at least some of the VCLAPS!-related features disclosed herein.

The Progressive Server System 1288 manages the accumulation and distribution of progressive jackpots across a network of gaming machines. This system is central to the operation of progressive games, which offer increasing jackpot amounts that grow with each wager until won. By pooling contributions from multiple machines, the Progressive Server System may offer significantly larger jackpots, enhancing the attractiveness of the games and driving player interest and engagement. The system ensures the accurate and timely update of jackpot amounts displayed to players, maintaining excitement and anticipation. It also guarantees the integrity and fairness of jackpot awards, with robust security measures to prevent tampering and ensure compliance with regulatory standards. The data collected by the Progressive Server System provides casinos with insights into the performance of progressive games, enabling strategic decisions about game placement and promotional activities to maximize player attraction and retention.

The EGM Meter Tracking Component(s) 1289 within the Casino Server System are configured or designed for monitoring and management of data and metrics from electronic gaming machines (EGMs). EGM Meter Tracking Component(s) 1289 may collect a comprehensive range of EGM meter data, including metrics such as coin-in (total amount wagered), coin-out (total winnings paid), total bets placed, and the overall number of games played. Additionally, it tracks VCLAPS!-specific metrics, which are integral to understanding the engagement and performance of VCLAPS! related features. These may include data on multiplayer interactions, progressive jackpot contributions from each linked game, and usage statistics of unique game features like multi-game and dynamic game allocation. This tracking facilitates precise financial accounting, regulatory compliance, and effective game management by providing insights into player behavior and machine performance, which are critical for optimizing the gaming floor layout and enhancing player engagement strategies.

In at least one embodiment, the server system includes at least one network device, and at least one storage device (such as, for example, a direct attached storage device). In one embodiment, server system may be suitable for implementing at least some of the automated money laundering detection and reporting techniques described herein.

In according to one embodiment, network device may include a master central processing unit (CPU), interfaces, and a bus (e.g., a PCI bus). When acting under the control of appropriate software or firmware, the CPU may be responsible for implementing specific functions associated with the functions of a desired network device. For example, when configured as a server, the CPU may be responsible for analyzing packets; encapsulating packets; forwarding packets to appropriate network devices; instantiating various types of virtual machines, virtual interfaces, virtual storage volumes, virtual appliances; etc. The CPU preferably accomplishes at least a portion of these functions under the control of software including an operating system (e.g. Linux), and any appropriate system software (such as, for example, AppLogic™ software).

CPU may include one or more processors such as, for example, one or more processors from the AMD, Motorola, Intel and/or MIPS families of microprocessors. In an alternative embodiment, processor may be specially designed hardware for controlling the operations of server system. In a specific embodiment, a memory (such as non-volatile RAM and/or ROM) also forms part of CPU. However, there may be many different ways in which memory could be coupled to the system. Memory block may be used for a variety of purposes such as, for example, caching and/or storing data, programming instructions, etc.

The interfaces may be typically provided as interface cards (sometimes referred to as “line cards”). Alternatively, one or more of the interfaces may be provided as on-board interface controllers built into the system motherboard. Generally, they control the sending and receiving of data packets over the network and sometimes support other peripherals used with the server system. Among the interfaces that may be provided may be FC interfaces, Ethernet interfaces, frame relay interfaces, cable interfaces, DSL interfaces, token ring interfaces, Infiniband interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like. Other interfaces may include one or more wireless interfaces such as, for example, 802.11 (WiFi) interfaces, 802.15 interfaces (including Bluetooth™), 802.16 (WiMax) interfaces, 802.22 interfaces, Cellular standards such as CDMA interfaces, CDMA2000 interfaces, WCDMA interfaces, TDMA interfaces, Cellular 3G/4G/5G interfaces, etc.

Generally, one or more interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor to efficiently perform routing computations, network diagnostics, security functions, etc.

In at least one embodiment, some interfaces may be configured or designed to allow the server system to communicate with other network devices associated with various local area network (LANs) and/or wide area networks (WANs). Other interfaces may be configured or designed to allow network device to communicate with one or more direct attached storage device(s).

In at least one embodiment, an architecture having a single processor that handles communications as well as routing computations, etc. may be used. Further, other types of interfaces and media could also be used with the network device.

Regardless of network device's configuration, it may employ one or more memories or memory modules (such as, for example, memory block, which, for example, may include random access memory (RAM)) configured to store data, program instructions for the general-purpose network operations and/or other information relating to the functionality of the various automated money laundering detection and reporting techniques described herein. The program instructions may control the operation of an operating system and/or one or more applications, for example. The memory or memories may also be configured to store data structures, and/or other specific non-program information described herein.

Because such information and program instructions may be employed to implement the systems/methods described herein, one or more embodiments relates to machine readable media that include program instructions, state information, etc. for performing various operations described herein. Examples of machine-readable storage media include, but are not limited to, magnetic media such as hard disks, floppy disks, and magnetic tape; optical media such as CD-ROM disks; magneto-optical media such as floptical disks; and hardware devices that may be specially configured to store and perform program instructions, such as read-only memory devices (ROM) and random access memory (RAM). Some embodiments may also be embodied in transmission media such as, for example, a carrier wave travelling over an appropriate medium such as airwaves, optical lines, electric lines, etc. Examples of program instructions include both machine code, such as produced by a compiler, and files containing higher level code that may be executed by the computer using an interpreter.

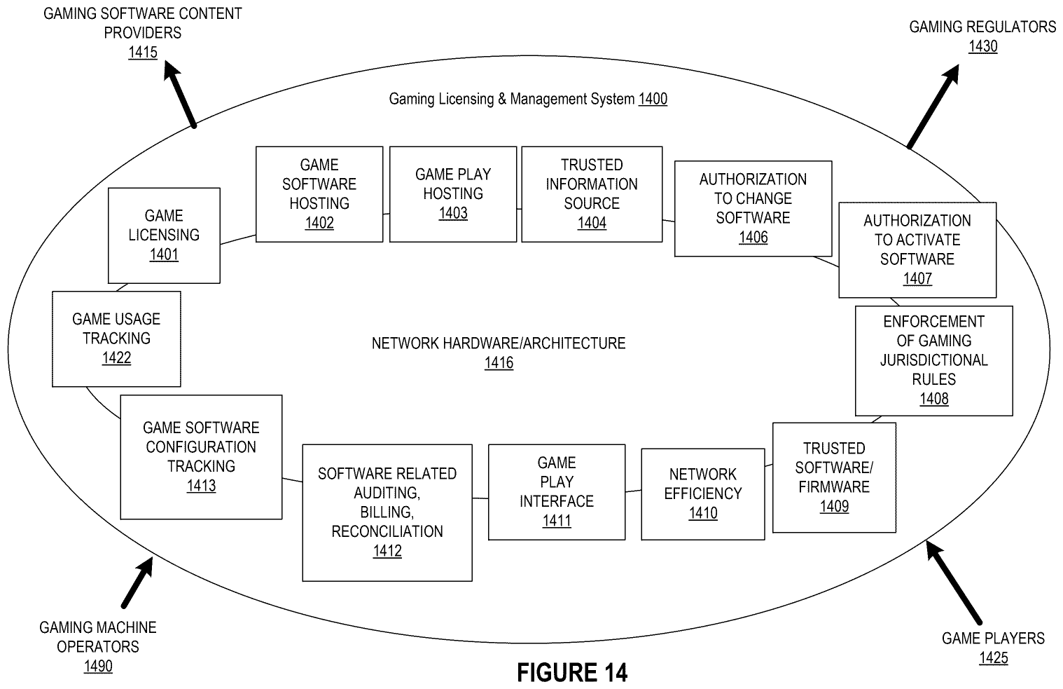

FIG. 14 shows a block diagram illustrating components of a gaming system which may be used for implementing various aspects of example embodiments. In FIG. 14, the components of a gaming system for providing game software licensing and downloads are described functionally. The described functions may be instantiated in hardware, firmware and/or software and executed on a suitable device. In the system, there may be many instances of the same function, such as multiple game play interfaces 1411. Nevertheless, in FIG. 14, only one instance of each function is shown. The functions of the components may be combined. For example, a single device may comprise the game play interface and include trusted memory devices or sources 1409.

The gaming system may receive inputs from different groups/entities and output various services and or information to these groups/entities. For example, game players primarily input cash or indicia of credit into the system, make game selections that trigger software downloads, and receive entertainment in exchange for their inputs. Game software content providers provide game software for the system and may receive compensation for the content they provide based on licensing agreements with the gaming machine operators. Gaming machine operators select game software for distribution, distribute the game software on the gaming devices in the system, receive revenue for the use of their software and compensate the gaming machine operators. The gaming regulators may provide rules and regulations that must be applied to the gaming system and may receive reports and other information confirming that rules are being obeyed.

In the following paragraphs, details of each component and some of the interactions between the components are described with respect to FIG. 14. The game software license host may be a server connected to a number of remote gaming devices that provides licensing services to the remote gaming devices. For example, in other embodiments, the license host may 1) receive token requests for tokens used to activate software executed on the remote gaming devices, 14) send tokens to the remote gaming devices, 3) track token usage and 4) grant and/or renew software licenses for software executed on the remote gaming devices. The token usage may be used in utility based licensing schemes, such as a pay-per-use scheme.

In another embodiment, a game usage-tracking host may track the usage of game software on a plurality of devices in communication with the host. The game usage-tracking host may be in communication with a plurality of game play hosts and gaming machines. From the game play hosts and gaming machines, the game usage tracking host may receive updates of an amount that each game available for play on the devices has been played and on amount that has been wagered per game. This information may be stored in a database and used for billing according to methods described in a utility based licensing agreement.

The game software host may provide game software downloads, such as downloads of game software or game firmware, to various devious in the game system 1400. For example, when the software to generate the game is not available on the game play interface, the game software host may download software to generate a selected game of chance played on the game play interface. Further, the game software host may download new game content to a plurality of gaming machines via a request from a gaming machine operator.

In one embodiment, the game software host may also be a game software configuration-tracking host 1413. The function of the game software configuration-tracking host is to keep records of software configurations and/or hardware configurations for a plurality of devices in communication with the host (e.g., denominations, number of paylines, paytables, max/min wagers). Details of a game software host and a game software configuration host that may be used with example embodiments are described in co-pending U.S. Pat. No. 6,645,077, by Rowe, titled, “Gaming Terminal Data Repository and Information System,” filed Dec. 12, 2000, which is incorporated herein in its entirety and for all purposes.

A game play host device may be a host server connected to a plurality of remote clients that generates games of chance that are displayed on a plurality of remote game play interfaces 1411. For example, the game play host device may be a server that provides central determination for a bingo game play played on a plurality of connected game play interfaces 1411. As another example, the game play host device may generate games of chance, such as slot games or video card games, for display on a remote client. A game player using the remote client may be able to select from a number of games that are provided on the client by the host device 1403. The game play host device may receive game software management services, such as receiving downloads of new game software, from the game software host and may receive game software licensing services, such as the granting or renewing of software licenses for software executed on the device, from the game license host 1401.

In particular embodiments, the game play interfaces or other gaming devices in the gaming system may be portable devices, such as electronic tokens, cell phones, smart cards, tablet PC's and PDA's. The portable devices may support wireless communications and thus, may be referred to as wireless mobile devices. The network hardware architecture may be enabled to support communications between wireless mobile devices and other gaming devices in gaming system. In one embodiment, the wireless mobile devices may be used to play games of chance.

The gaming system may use a number of trusted information sources. Trusted information sources may be devices, such as servers, that provide information used to authenticate/activate other pieces of information. CRC values used to authenticate software, license tokens used to allow the use of software or product activation codes used to activate software are examples of trusted information that might be provided from a trusted information source 1404. Trusted information sources may be a memory device, such as an EPROM, that includes trusted information used to authenticate other information. For example, a game play interface may store a private encryption key in a trusted memory device that is used in a private key-public key encryption scheme to authenticate information from another gaming device.

When a trusted information source is in communication with a remote device via a network, the remote device will employ a verification scheme to verify the identity of the trusted information source. For example, the trusted information source and the remote device may exchange information using public and private encryption keys to verify each other's identities. In another example of an embodiment, the remote device and the trusted information source may engage in methods using zero knowledge proofs to authenticate each of their respective identities. Details of zero knowledge proofs that may be used with example embodiments are described in U.S. Pat. No. 6,962,530, by Jackson, filed on Apr. 25, 2002 and titled, “Authentication in a Secure Computerized Gaming System, which is incorporated herein in its entirety and for all purposes.

Gaming devices storing trusted information might utilize apparatus or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

The gaming system of example embodiments may include devices that provide authorization to download software from a first device to a second device and devices that provide activation codes or information that allow downloaded software to be activated. The devices, and, may be remote servers and may also be trusted information sources. One example of a method of providing product activation codes that may be used with example embodiments is describes in previously incorporated U.S. Pat. No. 6,264,561.

A device that monitors a plurality of gaming devices to determine adherence of the devices to gaming jurisdictional rules may be included in the system 1400. In one embodiment, a gaming jurisdictional rule server may scan software and the configurations of the software on a number of gaming devices in communication with the gaming rule server to determine whether the software on the gaming devices is valid for use in the gaming jurisdiction where the gaming device is located. For example, the gaming rule server may request a digital signature, such as CRC's, of particular software components and compare them with an approved digital signature value stored on the gaming jurisdictional rule server.

Further, the gaming jurisdictional rule server may scan the remote gaming device to determine whether the software is configured in a manner that is acceptable to the gaming jurisdiction where the gaming device is located. For example, a maximum wager limit may vary from jurisdiction to jurisdiction and the rule enforcement server may scan a gaming device to determine its current software configuration and its location and then compare the configuration on the gaming device with approved parameters for its location.

A gaming jurisdiction may include rules that describe how game software may be downloaded and licensed. The gaming jurisdictional rule server may scan download transaction records and licensing records on a gaming device to determine whether the download and licensing was carried out in a manner that is acceptable to the gaming jurisdiction in which the gaming device is located. In general, the game jurisdictional rule server may be utilized to confirm compliance to any gaming rules passed by a gaming jurisdiction when the information needed to determine rule compliance is remotely accessible to the server.

Game software, firmware or hardware residing a particular gaming device may also be used to check for compliance with local gaming jurisdictional rules. In one embodiment, when a gaming device is installed in a particular gaming jurisdiction, a software program including jurisdiction rule information may be downloaded to a secure memory location on a gaming machine or the jurisdiction rule information may be downloaded as data and utilized by a program on the gaming machine. The software program and/or jurisdiction rule information may check the gaming device software and software configurations for compliance with local gaming jurisdictional rules. In another embodiment, the software program for ensuring compliance and jurisdictional information may be installed in the gaming machine prior to its shipping, such as at the factory where the gaming machine is manufactured.

The gaming devices in game system may utilize trusted software and/or trusted firmware. Trusted firmware/software is trusted in the sense that is used with the assumption that it has not been tampered with. For instance, trusted software/firmware may be used to authenticate other game software or processes executing on a gaming device. As an example, trusted encryption programs and authentication programs may be stored on an EPROM on the gaming machine or encoded into a specialized encryption chip. As another example, trusted game software, e.g., game software approved for use on gaming devices by a local gaming jurisdiction may be required on gaming devices on the gaming machine.

In example embodiments, the devices may be connected by a network with different types of hardware using different hardware architectures. Game software can be quite large and frequent downloads can place a significant burden on a network, which may slow information transfer speeds on the network. For game-on-demand services that require frequent downloads of game software in a network, efficient downloading is essential for the service to viable. Thus, in example embodiments, network efficient devices may be used to actively monitor and maintain network efficiency. For instance, software locators may be used to locate nearby locations of game software for peer-to-peer transfers of game software. In another example, network traffic may be monitored and downloads may be actively rerouted to maintain network efficiency.

One or more devices in example embodiments may provide game software and game licensing related auditing, billing and reconciliation reports to server 1412. For example, a software licensing billing server may generate a bill for a gaming device operator based upon a usage of games over a time period on the gaming devices owned by the operator. In another example, a software auditing server may provide reports on game software downloads to various gaming devices in the gaming system and current configurations of the game software on these gaming devices.

At particular time intervals, the software auditing server may also request software configurations from a number of gaming devices in the gaming system. The server may then reconcile the software configuration on each gaming device. In one embodiment, the software auditing server may store a record of software configurations on each gaming device at particular times and a record of software download transactions that have occurred on the device. By applying each of the recorded game software download transactions since a selected time to the software configuration recorded at the selected time, a software configuration is obtained. The software auditing server may compare the software configuration derived from applying these transactions on a gaming device with a current software configuration obtained from the gaming device. After the comparison, the software-auditing server may generate a reconciliation report that confirms that the download transaction records are consistent with the current software configuration on the device. The report may also identify any inconsistencies. In another embodiment, both the gaming device and the software auditing server may store a record of the download transactions that have occurred on the gaming device and the software auditing server may reconcile these records.

There are many possible interactions between the components described with respect to FIG. 14. Many of the interactions are coupled. For example, methods used for game licensing may affect methods used for game downloading and vice versa. For the purposes of explanation, details of a few possible interactions between the components of the system relating to software licensing and software downloads have been described. The descriptions are selected to illustrate particular interactions in the game system 1400. These descriptions are provided for the purposes of explanation only and are not intended to limit the scope of example embodiments described herein.

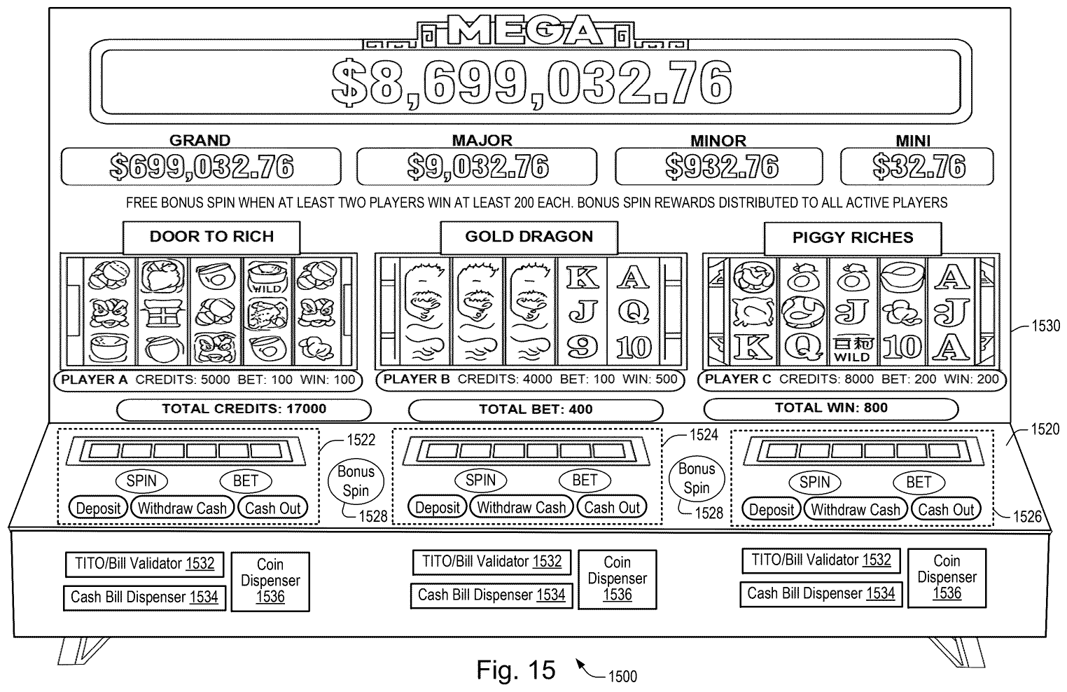

FIG. 15 shows an example embodiment of a VCLAPS! Multiplayer EGM with shared multiplayer interface and shared unitary game display.

### VCLAPS! Multiplayer EGM (1500)

The VCLAPS! Multiplayer Electronic Gaming Machine (EGM) (1500) represents a complete and integrated physical gaming apparatus engineered to embody the core principles of the VCLAPS! architecture. Its primary purpose is to solve the technical problems of inefficient floor space utilization and limited player choice by enabling multiple, independent, and concurrent wager-based gaming sessions on a single hardware chassis. This system is physically realized as a multiplayer gaming table or terminal that integrates a large, shared unitary game display (1530) with an adaptable shared multiplayer touchscreen control interface (1520). One aspect of novelty of this EGM lies in its specific system-level integration of hardware and software components that facilitate a true parallel gaming environment. It is configured to execute a plurality of distinct game applications simultaneously, such as the “DOOR TO RICH,” “GOLD DRAGON,” and “PIGGY RICHES” sessions depicted. The machine's unified design incorporates shared physical hardware resources that are logically segmented and managed by the central system to service the independent player sessions. For instance, while there is a single overarching EGM (1500), it contains dedicated sets of player-specific peripherals, such as individual TITO/Bill Validators (1532), Cash Bill Dispensers (1534), and Coin Dispensers (1536), with each set being mapped to a corresponding player station and its associated virtual meter. This physical and logical segmentation, controlled by the VCLAPS! server and onboard components, is a significant technical improvement over conventional EGMs. It provides the important advantage of allowing multiple players to manage their funds, play different games, and have a complete, independent gaming experience while sharing a single machine, thereby maximizing machine utility and fostering a novel, social, and highly interactive casino environment.

### Adaptable Shared Multiplayer Touchscreen Control Interface (1520)

The adaptable shared multiplayer touchscreen control interface (1520) is an important human-computer interaction component of the VCLAPS! EGM (1500), specifically designed to solve the technical problem of supporting multiple, independent player sessions concurrently on a single physical screen. This innovation addresses the rigidity of traditional EGM hardware by creating a multi-zone touchscreen interface where different regions of the same display are independently and concurrently mapped to different players engaged in their own wager-based gameplay. The system's underlying software controller, or Game Management System (GMS), intelligently recognizes the active multiplayer mode and dynamically assigns inputs from multiple sets of virtual buttons to these distinct player sessions, ensuring complete control isolation. The implementation relies on a sophisticated UI management system that virtualizes input segmentation. When a player touches a control within a specific region (e.g., 1522), the system processes this input by first identifying the precise screen coordinates of the touch. It then maps these coordinates to the defined boundary of the player's segment and the specific virtual control activated within it. This input command is then routed exclusively to the appropriate player's game logic engine. This process guarantees that one player's actions, such as placing a bet or spinning the reels, have no effect on any other concurrent game session. This concept's contribution to novelty and its technical improvement lie in this unique and flexible human-computer interaction model. It effectively transforms the EGM's touchscreen from a singular input device into a true parallel gaming console for multiple users, which significantly enhances machine utility, optimizes casino floor space, and creates an entirely new social and interactive gaming environment on a single machine.

### Dynamically Segmented Interactive Player Input/Control Interface Regions (1522, 1524, 1526)

The dynamically segmented interactive player input/control interface regions (1522, 1524, 1526) are the software-defined, player-specific control stations presented on the shared multiplayer touchscreen interface (1520). Each region is exclusively mapped to a single active player and their corresponding game session, as shown with region 1522 mapped to Player A, 1524 to Player B, and 1526 to Player C. The core purpose of these segmented regions is to provide each player with a complete, independent set of virtual controls to manage their individual gameplay and financial transactions without interfering with other players on the same EGM. Each region contains a customized set of virtual buttons that are linked to the specific player, their distinct virtual meter, and their associated player account managed by the First Server System. The virtual buttons include standard game controls like SPIN, to initiate a game round, and BET, to adjust wager amounts. More significantly, they include controls that leverage the novel “EGM-as-ATM” functionality. The ‘Deposit’ button allows a player to add funds to their specific session's virtual meter or directly to their main casino player account. The ‘Cash Out’ button facilitates credit redemption as a standard TITO voucher or a direct deposit back to their player account. Crucially, the ‘Withdraw Cash’ button initiates a secure, server-authorized withdrawal of funds from the player's main casino account, which are then dispensed as physical currency by that player's dedicated Cash Bill Dispenser (1534). This integration of direct player account financial management into the control interface of a live game session is a significant technical improvement, solving the problem of inconvenient fund transfers and transforming the EGM into a multi-functional financial terminal for each player. The advantage is a seamless, highly personalized, and secure gaming and banking experience for each user within a shared environment.

### Bonus Spin Interactive Player Input/Control Interface (1528)

The Bonus Spin interactive player input/control interface (1528) is a novel UI element designed to foster community engagement and collaborative excitement among players on the VCLAPS! EGM (1500). Unlike the player-specific control regions (1522, 1524, 1526), the Bonus Spin interface (1528) is a shared resource that is not permanently mapped to any single player. Its primary purpose is to serve as the trigger for a collective bonus event, which becomes available only when certain cooperative or competitive conditions are met by the group of players. As detailed by the promotional content on the shared display (1530), this feature may be activated when at least two players achieve a win of a certain threshold, such as 200 credits. This functionality represents a technical improvement over standard, isolated bonus features by creating a game mechanic that is dependent on and rewarding to the entire group of active players. Operationally, the VCLAPS! Game Management System and Server monitor the outcomes of all active sessions. When the predefined group condition is met, the system activates the Bonus Spin interface (1528), making it available for interaction. The system's logic may be configured with various rules for its use; for example, it may become a “first-come, first-served” button for any active player, or, as a more advanced implementation, the EGM may allocate resources to enable a specifically designated player (such as the one who completed the final requirement) to interact with the Bonus Spin for a limited time. This dynamic, event-driven activation and potential for temporary player-specific mapping provides a unique advantage by adding a layer of social competition and cooperation, encouraging players to be aware of and root for each other's success, thereby enhancing the overall engagement and entertainment value of the multiplayer experience.

### Shared Unitary Game Display (1530)

The shared unitary game display (1530) is the primary visual interface of the VCLAPS! EGM (1500), designed to present a rich, composite view of all concurrent gameplay and system information to multiple players simultaneously. Its core function is to serve as the physical embodiment of the system's ability to run parallel, independent game sessions while maintaining both granular and aggregated financial transparency. This display is a significant technical improvement as it visually integrates the two distinct layers of the novel dual-architecture metering system. It concurrently displays player-specific data—such as PLAYER A CREDITS: 5000, PLAYER B CREDITS: 4000, and PLAYER C CREDITS: 8000—which are direct visual representations of the individual virtual VCLAPS! meters (soft meters) managed by the First Server System. Simultaneously, it presents aggregated totals like TOTAL CREDITS: 17000, TOTAL BET: 400, and TOTAL WIN: 800, which correspond to the single unified regulatory meter (hard meter) for the entire EGM. This dual presentation solves the technical problem of providing players with clear, individualized session feedback while also displaying the consolidated data required for operational oversight and regulatory compliance. Furthermore, the display (1530) is dynamically segmented to show the active wager-based gaming session for each player, such as “DOOR TO RICH” for Player A and “GOLD DRAGON” for Player B, allowing all players to view their own and others' game progress. It also serves as a platform for shared, community-focused content, including progressive jackpot information (MEGA, GRAND, MAJOR, etc.) and promotional messages that drive cooperative play, like the “FREE BONUS SPIN” condition. The advantage of this unified, multi-faceted display is the creation of a transparent, engaging, and social gaming environment that is information-rich and supports the full spectrum of the VCLAPS! system's single-player and multi-player functionalities.

### Segmented EGM Components (1532, 1534, 1536)

The segmented EGM components, including the TITO/Bill Validator (1532), Cash Bill Dispenser (1534), and Coin Dispenser (1536), represent a novel hardware configuration where a single VCLAPS! EGM (1500) cabinet is physically partitioned to provide dedicated peripheral sets for each player station. As depicted in the figure, there is a distinct set of these components associated with each player's control interface region (1522, 1524, 1526). The purpose of this design is to solve the important technical problem of enabling multiple players on a single machine to manage their funds independently and securely. The TITO/Bill Validator (1532) for each station allows a specific player to insert cash or tickets, with the system logic ensuring those funds are credited exclusively to that player's associated virtual meter. The Coin Dispenser (1536) handles smaller, traditional coin-based payouts for its designated player. The most significant technical innovation in this grouping is the dedicated Cash Bill Dispenser (1534) at each station. This component directly facilitates the “EGM-as-ATM” functionality for each individual player. When a player initiates a “Withdraw Cash” command from their control segment, this specific dispenser is activated by a secure command from the VCLAPS! Server to dispense physical currency, with the funds being debited from that unique player's central casino account. This physically and logically segregated hardware arrangement is a major improvement over single-interface EGMs, providing the advantage of true financial autonomy for each user in a shared environment. It prevents any commingling of funds or transactional confusion, enhances security by linking physical cash flows to specific authenticated player sessions, and is desirable for realizing the full potential of the VCLAPS! multi-player and individualized financial service offerings.

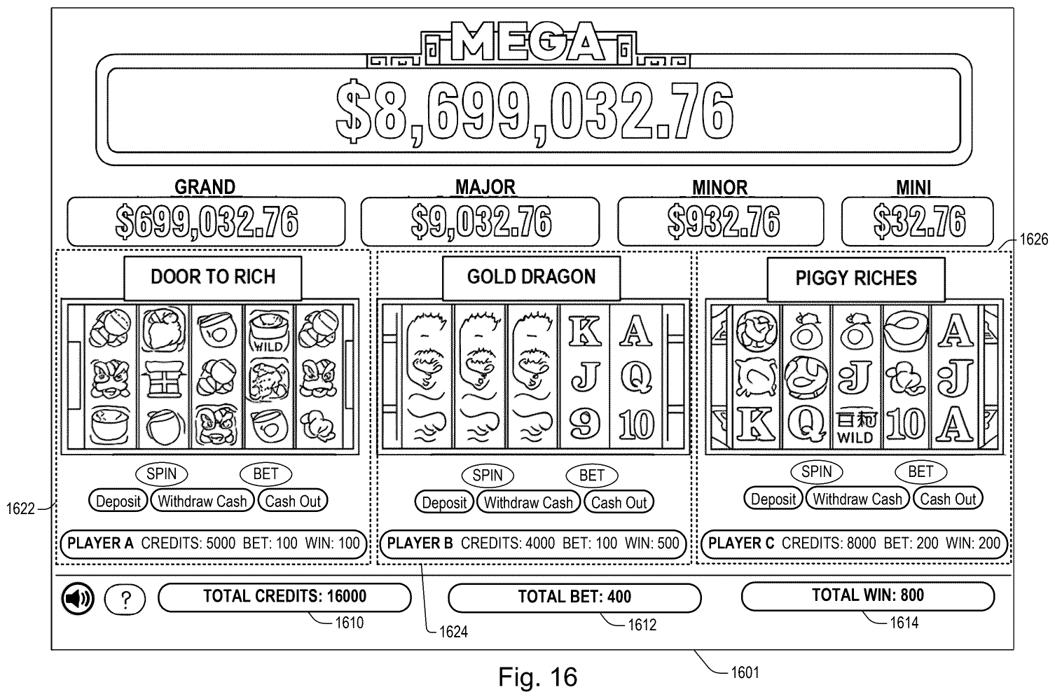

FIG. 16 shows an alternate example embodiment of a VCLAPS! Multiplayer EGM with shared multiplayer shared unitary game display and integrated multiplayer touchscreen interface.

VCLAPS! Multiplayer EGM with Shared Unitary Game Display (1601)

The VCLAPS! Multiplayer Electronic Gaming Machine (EGM) (1601) shown in FIG. 16 illustrates an alternate and highly integrated embodiment of the VCLAPS! system architecture. The core purpose of this configuration is to provide a complete, multi-player gaming environment within a single, unified hardware interface, such as an electronic gaming table or a large-format bar-top installation. This design solves the technical problem of maximizing player density and interaction in a compact physical footprint by merging the game display and player controls into a cohesive, shared unitary game display with an integrated multiplayer touchscreen interface. Unlike the embodiment in FIG. 15 which separates the main game display from the player control interfaces, this version creates a more seamless and direct interaction model. The EGM (1601) is engineered to support multiple, concurrent, and independent wager-based gaming sessions by dynamically segmenting its single touchscreen display into distinct regions (1622, 1624, 1626), with each region allocated to a different active player. A notable technical improvement of this embodiment is its ability to present a complete, self-contained gaming station for each player within their designated screen segment, including game-specific content, individual financial meters, and a full suite of interactive controls. While the player-facing layout is integrated, the underlying functionality relies on the same robust and novel VCLAPS! backend architecture. It fully supports the dual-architecture metering system, with server-managed virtual meters for each player session and an aggregated regulatory meter for compliance. Furthermore, it facilitates advanced features such as direct-to-account financial transactions (EGM-as-ATM) and shared, community-based bonus content like progressive jackpots, all managed through a single, elegant interface. The primary advantage is the creation of a streamlined, all-in-one multiplayer terminal that enhances social interaction and operational efficiency without compromising the individualized control and financial autonomy desirable to the VCLAPS! concept.

### Dynamically Segmented Player Interface Regions (1622, 1624, 1626)

The dynamically segmented interactive player interface regions (1622, 1624, 1626) are the cornerstone of the user experience in the EGM embodiment (1601). These software-defined zones on the unitary touchscreen display represent a significant technical improvement in human-computer interaction for multiplayer gaming, as each region functions as a complete, independent virtual EGM for a specific player. Region 1622 is mapped to Player A, 1624 to Player B, and 1626 to Player C, and the system's Game Management Software ensures that all inputs and display updates are isolated entirely within the boundaries of the respective region. The core purpose of this design is to solve the challenge of providing a full-featured, personalized gaming experience to multiple users on a single shared screen. Each segmented region contains a rich set of customized and interactive content, including the visual display of the active wager-based game session itself. Crucially, each region also integrates a full suite of virtual buttons, allowing players to manage their gameplay and finances. Standard controls like SPIN and BET are provided for game interaction. The interface also includes buttons that leverage the system's most novel capabilities, directly linking the game session to the player's central casino account. The ‘Deposit’ button facilitates adding funds to the EGM or the player's account, while the ‘Withdraw Cash’ button initiates a secure, server-authorized ATM-like withdrawal from the player's account balance, a notable feature of the VCLAPS! architecture. Furthermore, each region displays individual player meters for CREDITS, BET, and WIN, which are visual representations of the granular virtual meters managed by the VCLAPS! Server. This deep integration of game content, control, and individualized financial management into discrete, parallel interfaces on a single screen provides the unique advantage of offering a robust, autonomous player station within a collaborative, social gaming environment.

### Aggregated Total Meters (1610, 1612, 1614)

The aggregated total meters, including TOTAL CREDITS (1610), TOTAL BET (1612), and TOTAL WIN (1614), are desirable UI elements that visually represent the consolidated financial status of the entire VCLAPS! EGM (1601). Their primary function is to serve as the player-facing manifestation of the machine's single unified regulatory meter, a core component of the patented dual-architecture metering system. While the individual player interface regions (1622, 1624, 1626) display the granular credit, bet, and win values corresponding to each player's distinct server-managed virtual meter, these aggregated meters (1610, 1612, 1614) provide a real-time summation of those values across all active sessions. For example, TOTAL CREDITS (1610) is the sum of all available credits across every active player's virtual meter, TOTAL BET (1612) is the sum of all current wagers placed by all players, and TOTAL WIN (1614) is the sum of recent wins awarded to all players. This feature provides a significant technical improvement by solving the problem of how to maintain financial transparency and meet regulatory requirements on a complex multi-session device. By performing a data transformation that aggregates the multiple, independent virtual meter streams into a single, simple-to-understand set of totals, the system offers a clear financial overview of the EGM's performance as a single entity. This provides a distinct advantage for both players and operators. For players, it offers a quick glance at the overall action and excitement occurring on the machine. For casino operators and regulators, these aggregated meters provide the important, machine-wide accounting figures necessary for standardized auditing and compliance, ensuring that the EGM, despite its advanced internal complexity, adheres to all jurisdictional reporting requirements in a straightforward manner.

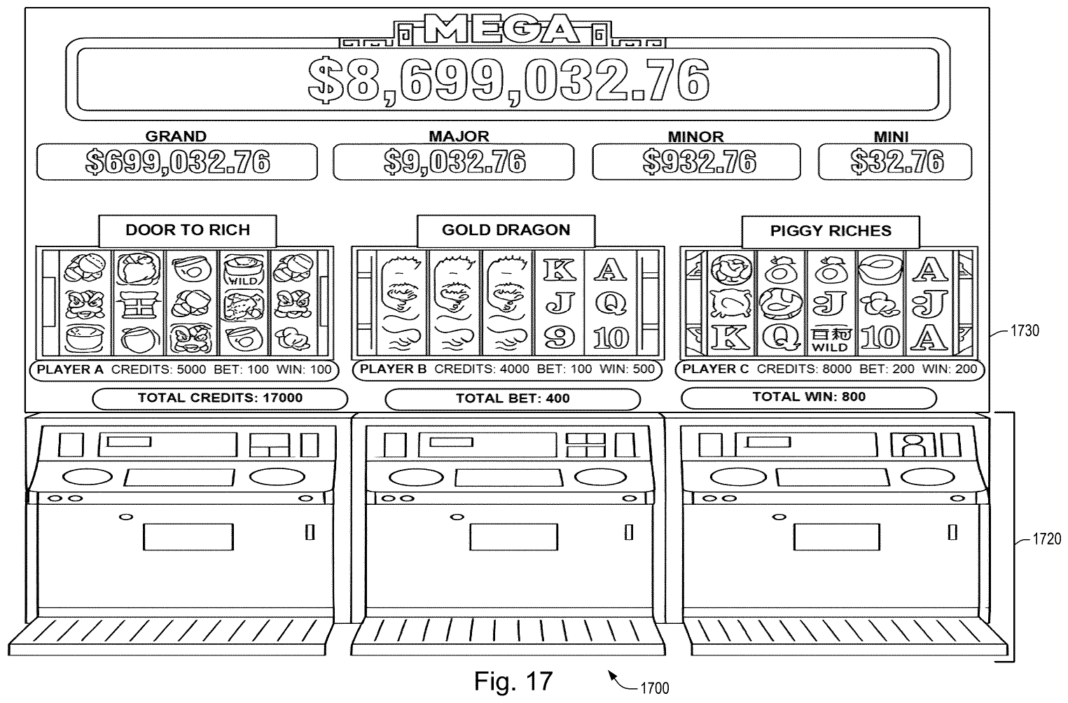

FIG. 17 shows an alternate example embodiment of a VCLAPS! Multiplayer EGM comprising shared unitary game display and individualized player game console interfaces.

### Shared Unitary Game Display (1730)

The shared unitary game display (1730) serves as the high-impact, communal visual centerpiece of the VCLAPS! Multiplayer EGM embodiment shown in FIG. 17. Unlike fully integrated touchscreen interfaces where player controls and game visuals coexist, the primary purpose of this large-format display is to create a cinematic, shared viewing experience for all players situated at their individual game consoles (1720). It aggregates and presents the visual outputs from multiple, concurrent, and independent game sessions, allowing each player to see their own game progression alongside that of their fellow participants. For example, the display (1730) simultaneously renders the active wager-based gaming sessions for Player A (“DOOR TO RICH”), Player B (“GOLD DRAGON”), and Player C (“PIGGY RICHES”), fostering a social and competitive environment. A notable technical improvement of this component is its ability to synchronize and render these multiple independent game states, managed by the VCLAPS! server system, into a single cohesive presentation. Furthermore, the display is the primary vehicle for presenting community-focused content that is common to all players. This includes high-visibility progressive jackpot information, such as the overarching MEGA jackpot and the tiered GRAND, MAJOR, MINOR, and MINI prizes, which helps to build collective excitement and anticipation. It also displays individual player financial information, such as credits, bets, and wins for each session, directly reflecting the data from each player's distinct server-managed virtual meter. This provides transparency and allows for at-a-glance comparison of performance. The advantage of decoupling the main display from the individual controls is the creation of a stadium-style gaming atmosphere, which may enhance player engagement, encourage social interaction, and make the overall experience more compelling and event-like, thereby solving the problem of creating a scalable and visually impressive multiplayer attraction on the casino floor.

### Individualized Player Game Console Interfaces/Gaming Cabinets (1720)

The individualized player game console interfaces and gaming cabinets (1720) represent the personal player stations within the VCLAPS! multiplayer EGM system (1700). In this embodiment, the system architecture is physically distributed, separating the shared game display (1730) from the individual points of player interaction. Each console (1720) functions as a complete, secure client terminal that is communicatively coupled to the central VCLAPS! server system. The core purpose of these individual cabinets is to provide each player with a private and fully-featured interface for controlling their game session and managing their personal funds, thereby solving the technical problem of ensuring player autonomy and security within a shared gaming experience. Each console is equipped with its own dedicated set of EGM components. This includes a Player Tracking Card Reader for authenticating the player and linking the session to their specific casino account and virtual meter. A notable novelty is that each station has its own complete set of cash handling peripherals. The TITO/Bill Validator allows the player to deposit funds that are credited exclusively to their session. The Coin Dispenser handles smaller coin-based payouts. Most significantly, each console includes its own Cash Bill Dispenser, which is desirable for facilitating the novel “EGM-as-ATM” functionality. This allows a player at their specific console (1720) to initiate a secure, server-authorized withdrawal of physical cash directly from their central player account. This physical partitioning of financial peripherals for each player station is a major technical improvement that guarantees transactional independence and prevents any commingling of funds or operational conflicts between players. The advantage of this design is that it offers the best of both worlds: the privacy, security, and full functionality of a personal EGM combined with the excitement and social interaction of a large-scale, shared community game.

### Additional Details Relating to Selected Figure Components

### VCLAPS! Server 430

The VCLAPS! Server (430) represents the central nervous system of the entire VCLAPS! ecosystem, functioning as a specialized, high-performance computing system engineered to orchestrate the novel transactional and gameplay functionalities of the connected Electronic Gaming Machines (EGMs). Its core purpose is to implement the server-side logic of the patented dual-architecture metering system, an important technical improvement over conventional EGM accounting. The server is responsible for establishing and maintaining, within its non-transient memory, a plurality of distinct virtual meters, where each virtual meter is exclusively and dynamically associated with a specific, concurrent game session initiated on an EGM. This creates a granular and secure data structure that enables individualized financial accounting for each session, a foundational element for the system's advanced capabilities. The VCLAPS! Server (430) directly integrates with other important backend systems, such as the Player Tracking Server (45) and the Game Server (47), acting as an intelligent intermediary that separates financial transaction processing from game state management. For instance, when a player initiates a deposit to or withdrawal from their personal casino account via the EGM interface, the VCLAPS! Server (430) receives a secure request from the EGM. It then validates the request, authenticates the player—potentially using advanced biometric data verification as described in the disclosure's novel elements by comparing a live template from the EGM's sensor against a stored template in the player account database—and processes the financial transaction by causing a corresponding update to the specific virtual meter associated with that player's session and initiating a secure update to the player's central account via the Player Tracking Server (45). This novel functionality effectively transforms the EGM into a secure ATM for the player's casino account, a significant technical leap that improves underlying computer system functionality by providing secure, real-time, and individualized financial control directly at the point of play. Furthermore, the server's design inherently offers superior scalability and security, using protocols like TLS to encrypt communications and centralizing the most sensitive logic, thereby reducing the EGM's attack surface and streamlining regulatory compliance and auditing processes.

### VCLAPS! Component(s) 410

The VCLAPS! Component(s) (410), housed within the processing architecture of the physical Electronic Gaming Machine (EGM) (100), constitute the client-side software modules and executable instructions that bring the advanced functionalities of the VCLAPS! system to life for the end-user. These components serve as the primary operational liaison between the EGM's physical hardware—such as the segmented touchscreen display, credit input devices, and cash dispensers—and the sophisticated server-side logic managed by the VCLAPS! Server (430). A principal function of the VCLAPS! Component(s) (410) is to render and manage the intelligent, dynamically segmented unitary touchscreen display. This involves interpreting layout commands from the server to present multiple, distinct interface segments concurrently, with each segment being mapped to a different selectable game. The component(s) are engineered to process player interactions within these discrete segments, such as a touch input, and route the corresponding game control command exclusively to the correct game application and, subsequently, to the central game server, ensuring that simultaneous gameplay sessions do not interfere with one another. This provides a direct technical solution to the problem of offering independent, concurrent game sessions on a single physical device. In addition to UI management, the VCLAPS! Component(s) (410) are important for initiating and securing financial transactions. They interface directly with the EGM's card reader and biometric sensors to capture player identification data, which is then securely transmitted to the VCLAPS! Server (430) for authentication. When a player requests a financial transaction, these components generate a secure, encrypted request packet containing the transaction details and the associated virtual meter identifier for processing by the server. They also manage the local hardware response upon receiving an authorization command from the server, such as activating the cash dispenser to fulfill a withdrawal request. This tight integration represents a significant advantage, as it enables complex, account-based financial operations that are novel for a physical EGM, solving the technical challenge of bridging player casino accounts with live wagering sessions in a secure and regulated manner.

### VCLAPS! Meter(s) 420

The VCLAPS! Meter(s) (420) represent the on-machine, EGM-resident facet of the system's groundbreaking dual-architecture metering framework. Located within the EGM (100) and tightly integrated with the VCLAPS! Component(s) (410), this element serves a distinct and important purpose: to provide the unified, consolidated regulatory metering required for compliance, while simultaneously reflecting the state of the server-managed virtual meters for the player. The primary function of the VCLAPS! Meter(s) (420) is to act as the single, authoritative source of financial data for the physical EGM as a whole, aggregating the financial activities from all concurrent, independent game sessions occurring on the device. This solves a significant technical problem for casino operators and regulators by ensuring that, despite the system's ability to support multiple individual player sessions and direct account transactions, a single, auditable, and compliant regulatory meter is maintained for the entire hardware instance. This unified regulatory meter tracks the total coin-in, coin-out, jackpots, and net win/loss for the physical machine, consistent with established gaming industry standards. Operationally, the VCLAPS! Component(s) (410) receive real-time updates for each distinct virtual meter from the VCLAPS! Server (430). The VCLAPS! Meter(s) (420) then aggregate the transactional data from these individual virtual streams into its own consolidated data structure. This aggregated data is then available for inspection, auditing, and reporting to casino accounting and regulatory systems. A notable novelty and technical improvement lies in this two-tiered structure; while the VCLAPS! Server (430) manages the granular, per-session, per-player virtual meters that enable individualized account transactions, the EGM-resident VCLAPS! Meter(s) (420) provide a separate, robust, and unified layer of accounting. This separation provides a tangible advantage by enabling unprecedented player-centric financial features without compromising the integrity or simplicity of regulatory oversight, representing a non-obvious solution that enhances the EGM's underlying functionality.

### VCLAPS! Meter(s) 906

The VCLAPS! Meter(s) (906), as depicted within the architectural diagram of the VCLAPS! System (900), represent the server-side core of the novel dual-architecture metering system, specifically embodying the plurality of distinct virtual meters managed within the memory of the VCLAPS! Server (430). This component is fundamentally a specialized data structure, and the associated logic to manage it, that enables the system's most innovative functionalities. Its primary purpose is to create and maintain a one-to-one mapping between an individual, concurrent game session on an EGM and a unique, isolated financial ledger. This technical approach directly solves the long-standing problem of how to facilitate granular, per-player financial activities, including direct-to-account deposits and withdrawals, on a shared, multi-game physical EGM. Unlike conventional systems that rely on a single, consolidated credit meter for the entire machine, the VCLAPS! Meter(s) (906) allow for the parallel existence of multiple financial contexts on one device. When a player initiates a new game session, the VCLAPS! Server (430) instantiates a new virtual meter within this system, associating it with the player's account (identified via a card reader or biometrics) and the specific game interface segment they selected. All subsequent financial activities for that session—wagers, wins, losses, deposits, and withdrawals—are recorded exclusively against this dedicated virtual meter. This server-side management provides a significant technical advantage by centralizing financial control and security. It allows the EGM to function as a stateless terminal for financial transactions, with the VCLAPS! Server (430) acting as the authoritative state machine. This architecture is a unique and non-obvious solution; it not only facilitates the “EGM-as-ATM” functionality but also enables advanced features such as server-based anti-money laundering (AML) analysis, where the server may calculate wager-to-deposit ratios for a specific virtual meter and trigger alerts, thereby improving the security and compliance functions of the host computer system.

### VCLAPS! Component(s) 952

The VCLAPS! Component(s) (952) are specialized software modules residing on the Game Server (47), engineered to integrate seamlessly within the VCLAPS! architecture. The core function of this component is to manage the game logic, state, and outcome generation for the diverse portfolio of games accessible on the VCLAPS! EGM (100), while operating in coordination with the transaction-focused VCLAPS! Server (430). This component is responsible for executing the specific rules, random number generation (RNG), and event triggers for each game instance. A notable technical improvement it provides is the decoupling of game execution from financial authorization. In a typical operation, the Game Server (47), via the VCLAPS! Component(s) (952), receives a game event trigger, such as a “spin” command originating from a specific interface segment on the EGM. However, before executing the wager, the component communicates with the VCLAPS! Server (430) to ensure sufficient funds exist in the corresponding virtual meter (906) and to receive authorization to proceed. Upon receiving authorization, the VCLAPS! Component(s) (952) executes the game round, determines the outcome, and reports the result (e.g., win amount, bonus feature triggered) back to the VCLAPS! Server (430). The VCLAPS! Server then updates the player's virtual meter accordingly. This operational flow is a novel solution that enhances system security and integrity; the Game Server never directly handles or modifies player account funds or EGM credit balances. This separation of concerns is a significant advantage, as it allows for a modular and scalable system where new games may be developed and deployed on the Game Server (47) via new VCLAPS! Component(s) (952) without needing to alter the secure financial transaction and metering logic of the core VCLAPS! Server (430). This architecture improves the underlying functionality of the gaming network by creating a more robust, secure, and flexible environment for both single-player and complex multi-player or head-to-head game scenarios.

### VCLAPS! Communication Component(s) 987

The VCLAPS! Communication Component(s) (987), situated within the Player Tracking Server (45), serves as a dedicated and secure API gateway or communication service specifically designed to interface with the VCLAPS! Server (430). Its primary purpose is to bridge the gap between the real-time, session-based transactional world of the VCLAPS! system and the persistent, long-term player data managed by the casino's core player loyalty and accounting system. This component solves the important technical challenge of enabling direct, secure, and real-time financial interactions between a live EGM session and a player's central casino account, a feature central to the “EGM-as-ATM” concept. When the VCLAPS! Server (430) receives a request for a player-centric action, such as authentication or a financial transfer, it communicates with the Player Tracking Server (45) via this specialized VCLAPS! Communication Component(s) (987). For example, during biometric authentication, the VCLAPS! Server (430) would pass a live biometric template to this component, which would then handle the lookup and comparison against the enrolled template stored in the player's account record. For a financial transaction, the VCLAPS! Server (430) would send a securely authenticated request to this component to debit or credit the player's actual casino account balance, with the Communication Component (987) being responsible for executing this change within the Player Tracking Server's database. One aspect of novelty of this component lies in its role as a trusted intermediary that extends the capabilities of a standard Player Tracking Server beyond simple points and ratings calculation. It effectively transforms the player account into a demand deposit account accessible from the gaming floor. This provides a substantial advantage by creating a deeply integrated player experience and streamlining casino operations, representing a non-obvious technical improvement that enhances the function of both the EGM and the backend player management systems by creating a secure, high-speed channel for complex financial operations.

### VCLAPS! Component(s) 1023

The VCLAPS! Component(s) (1023), situated within the intelligent multi-player electronic gaming system (1000), represent the core client-side software and firmware that enable the execution of the VCLAPS! architecture on the physical Electronic Gaming Machine (EGM). The primary purpose of these components is to manage the EGM's local operations in tight, secure coordination with the backend server systems, transforming a standard EGM into a versatile, multi-session financial terminal. Its core functionality includes rendering and managing the dynamically segmented unitary touchscreen display (1090), where it presents multiple, independent game interfaces concurrently and processes player inputs with spatial awareness, isolating touch commands to their respective game segments to prevent cross-session interference. This feature, a significant technical improvement to EGM design, allows for novel human-computer interactions, such as a single player managing several games or multiple players engaging in simultaneous, independent sessions on one machine. Operationally, the VCLAPS! Component(s) (1023) integrate directly with all of the EGM's peripheral devices (1050), including the bill acceptor (1053), ticket I/O (1055), and player tracking I/O (1057). A novel aspect of their operation is the management of these shared hardware resources for multiple distinct sessions; for example, when funds are inserted, these components may prompt the user to allocate the credits to a specific active virtual meter. Furthermore, they are responsible for executing the client-side logic of the integrated Anti-Money Laundering (AML) monitoring, collecting transactional and behavioral data at the point of origin for real-time analysis. The notable advantage of this component set is its ability to facilitate the advanced VCLAPS! features locally on the EGM, ensuring a responsive and seamless user experience while maintaining robust security and data integrity through constant, secure communication with the backend servers.

### VCLAPS! Communication Component(s) 1087

The VCLAPS! Communication Component(s) (1087) constitute the specialized networking hardware and software stack within the EGM (1000) that facilitates secure, high-speed data exchange with the VCLAPS! Server (430) and the broader casino network. The core function of this component is to manage the proprietary communication protocols necessary to support the system's dual-architecture metering and advanced transactional capabilities, representing a technical improvement over standard EGM networking interfaces that handle simpler, state-based reporting. This component is responsible for establishing and maintaining a persistent, encrypted communication channel, using Transport Layer Security (TLS), with the backend servers. Its operational features include the real-time transmission of granular data from the EGM's various client-side modules, such as the VCLAPS! Component(s) (1023). A novel aspect of its function is the handling of distinct data streams for financial transactions versus gameplay events; it securely packages and transmits requests for direct player account deposits or withdrawals to the VCLAPS! Server, while separately communicating wager and win information for virtual meter updates. The VCLAPS! Communication Component(s) (1087) also receive and interpret specific, low-level hardware control commands from the server, such as an encrypted packet instructing the cash dispensing device to dispense a precise amount of currency for an authorized ATM-like withdrawal. This ability to facilitate secure, server-driven control over physical EGM peripherals is a unique advantage of the VCLAPS! system. By ensuring the integrity, confidentiality, and reliability of this complex data exchange, the component provides the foundational communication layer upon which the entire VCLAPS! architecture is built, enabling a level of interactivity, security, and financial integration not achievable with conventional EGM communication systems.

### VCLAPS! Meter(s) 1022

The VCLAPS! Meter(s) (1022), as an integral part of the EGM's internal architecture (1000), represent the physical EGM's implementation of the dual-architecture metering system. This component serves two distinct but related functions that are novel compared to traditional EGM metering. First, it acts as the display and local management interface for the individual virtual meters that are authoritatively maintained by the VCLAPS! Server (430). In this role, it receives real-time updates from the server via the VCLAPS! Communication Component(s) (1087) and presents the credit balance for each active, independent game session on the EGM's segmented display. This allows a player managing multiple games, or multiple players on the same machine, to have a clear, isolated view of their funds for each specific session. Second, and more critically for regulatory purposes, the VCLAPS! Meter(s) (1022) are responsible for performing the aggregation of data from all active virtual meters into the single, unified ‘physical’ or regulatory meter set for the EGM. This aggregation is a notable data transformation; it processes a stream of granular, per-session transaction events (e.g., Player A wagered $1, Player B won $5) and consolidates them into the standard, machine-wide metrics (e.g., total coin-in, total coin-out) that casino management and regulators may require. This novel two-tiered approach provides the significant technical advantage of enabling complex, individualized financial tracking and player account interactions on the frontend, while presenting a simple, compliant, and easily auditable single-machine financial summary on the backend. This solves the technical problem of how to offer advanced, multi-session functionality without overhauling established regulatory reporting structures, thereby improving the EGM's overall operational and compliance efficiency.

### Casino Management System (CMS) Communication Component(s) 1080

The Casino Management System (CMS) Communication Component(s) (1080) is the dedicated hardware and software interface within the Electronic Gaming Machine (EGM) (1000) responsible for managing the flow of standardized, aggregated data to the main casino floor management system (CMS) (1280). Its primary purpose is to ensure that the EGM, despite its advanced multi-session and multi-player capabilities enabled by the VCLAPS! architecture, remains fully compliant and visible within the casino's existing operational and regulatory reporting framework. This component operates in parallel with, but is functionally distinct from, the VCLAPS! Communication Component(s) (1087). While the VCLAPS! component handles the high-frequency, granular, and player-specific transactional data for the virtual meters, the CMS Communication Component (1080) is tasked with transmitting the final, aggregated data from the EGM's single unified regulatory meter. This includes the consolidated machine-wide totals for coin-in, coin-out, drop, jackpots, and net win, as required by standard casino accounting and jurisdictional regulations. Its integration within the VCLAPS! architecture is important; it ensures that the innovative features facilitated by the dual-architecture metering system do not disrupt the casino's established reporting pipeline. The technical improvement offered by this well-defined separation of communication channels is significant: it allows the EGM to leverage a sophisticated, real-time server connection for advanced player services while simultaneously using a standard, robust communication protocol to report its overall financial performance as a single, compliant device. This provides the advantage of backward compatibility with existing casino infrastructures, reduces the complexity of regulatory certification, and allows casinos to adopt the advanced VCLAPS! technology without needing to completely overhaul their central management systems.

### Player Tracking Server Communication Component(s) 1082

The Player Tracking Server Communication Component(s) (1082) is a specialized module within the Electronic Gaming Machine (EGM) (1000) designed to manage communications specifically with the casino's Player Tracking Server System (1282). While working in close concert with the VCLAPS! Communication Component(s) (1087), its function is distinct and focused on player loyalty and identification. The primary purpose of this component is to handle the exchange of traditional player tracking information, such as reading data from a player's loyalty card via the player tracking I/O (1057), transmitting this data to the server for player identification, and receiving back loyalty-related information like player tier, comp points balance, and available promotional offers. A novel aspect of its integration within the VCLAPS! system is how it supports the more advanced financial functionalities. For instance, when a player inserts their card, this component facilitates the initial handshake with the Player Tracking Server to identify the player. This identification is then used by the VCLAPS! system to link the session to the correct player account for secure ATM-like transactions. It also enables personalization features, such as loading a player's saved custom UI layout for the segmented touchscreen, by retrieving that configuration data from the player's profile via the Player Tracking Server. The notable advantage and technical improvement offered by this component is its ability to seamlessly blend standard, industry-wide loyalty functions with the proprietary, high-security financial transaction capabilities of the VCLAPS! architecture. It ensures that the player's familiar loyalty experience is maintained and enhanced, while also providing the secure authentication and identification foundation necessary for the EGM to function as a personal financial terminal for their casino account, thereby solving the problem of integrating novel transactional systems with existing player relationship management platforms.

### Financial Server Communication Component(s) 1025

The Financial Server Communication Component(s) (1025) represent the dedicated EGM-side module responsible for handling all communications related to direct financial transactions processed by the VCLAPS! Server (430), which acts as the authoritative financial server in this architecture. This component's core function is to securely package, encrypt, and transmit financial requests originating from the player's interaction with the EGM, and to securely receive and act upon financial authorizations from the server. Its operations are distinct from general game state or player tracking communications, focusing exclusively on the integrity of monetary transactions. This component is instrumental in enabling the novel “EGM-as-ATM” feature. When a player requests to withdraw cash from their casino account, the Financial Server Communication Component(s) (1025) formulate the secure message to the server, including authenticated player data and the requested amount. Crucially, upon receiving an encrypted authorization command back from the server, this component is responsible for interpreting that specific command and interfacing with the EGM's internal logic to activate the cash dispensing device (137). This represents a significant technical improvement, as it facilitates a closed-loop, server-authorized physical action, ensuring that no funds are dispensed without explicit, verified approval from the central financial authority. The primary advantage of this dedicated component is enhanced security and reliability. By isolating financial communications into a specialized, hardened channel, the system minimizes the attack surface and ensures that all monetary operations adhere to a strict, auditable protocol. This solves the technical problem of securely integrating direct-to-account financial services into a physical gaming machine, providing a robust framework that supports the advanced, multi-faceted transactional capabilities of the VCLAPS! system.

### VCLAPS! Server Component(s) 1287

The VCLAPS! Server Component(s) (1287), operating within the broader Casino Server System (1200), represent the primary application logic and processing engine of what the disclosure refers to as the “First Server System.” These components are the definitive server-side counterpart to the EGM-based VCLAPS! modules and are the centerpiece of the invention's novel architecture. Their core functionality is to manage the entire lifecycle of the distinct virtual meters, enabling individualized player account transactions and advanced multi-game session management. When a player initiates a session on a connected EGM, these server components establish a unique virtual meter, exclusively associating it with that session and player account. The VCLAPS! Server Component(s) (1287) then process all financial and game activity data received from the EGM in real-time. A notable data transformation occurs here: raw transaction requests are converted into secure, authenticated database commands that update both the specific virtual meter and the player's central casino account, which is maintained separately from EGM operational funds. This novel process is what enables the EGM to function as a secure ATM for player accounts, a significant technical improvement over conventional EGM systems. Further, these components orchestrate advanced game modes, such as calculating proportional awards in cooperative games by tracking and weighting specific in-game actions, and managing inter-session communication for features like player-triggered bonus unlocks. They also host the server-side AML detection logic, analyzing transaction patterns within individual virtual meters to identify suspicious behavior at its origin. The paramount advantage of the VCLAPS! Server Component(s) (1287) is the centralization of complex financial and session logic, which enhances security, ensures data integrity, and provides the scalability needed to manage a floor of multi-functional EGMs, thereby solving the immense technical challenge of offering granular, player-centric services within a regulated, shared-terminal environment.

### Casino Management Server System (CMS) 1280

The Casino Management Server System (CMS) (1280) functions as what the disclosure describes as the “Second Server System” within the VCLAPS! ecosystem. Its primary purpose is to perform the high-level, casino-wide operational, accounting, and regulatory functions, and its notable interaction with the VCLAPS! architecture is as the recipient of aggregated financial data. The CMS (1280) is distinct from the VCLAPS! Server (or “First Server System”), which handles the granular, player-specific virtual meters. The CMS (1280) is concerned with the EGM as a single, physical asset on the casino floor. It receives data from the EGM's unified regulatory meter, which is a consolidation of all the financial activity from the various independent sessions being run on that machine. This integration point is an important and novel aspect of the VCLAPS! architecture. It allows the innovative, multi-session, multi-player activities, with their complex virtual meter accounting, to be neatly packaged into a standard reporting format that the CMS (1280) is already designed to handle. This provides the significant advantage of allowing a casino to adopt the advanced VCLAPS! EGMs without needing to fundamentally re-engineer its core, casino-wide management and accounting platform. The technical improvement lies in the system's ability to maintain a dual-data stream: one, a highly detailed, real-time transactional stream for player-centric services managed by the VCLAPS! Server, and a second, a simplified, aggregated stream for traditional machine performance and regulatory reporting managed by the CMS (1280). This solves the problem of how to innovate at the player-experience level while maintaining stability and compatibility at the enterprise and regulatory level, thereby improving the overall functionality and deployability of the casino's computer network.

### Player Tracking Server System 1282

The Player Tracking Server System (1282) is an important backend component that works in direct partnership with the VCLAPS! Server Component(s) (1287) to enable the system's advanced personalization and secure financial transaction features. While a standard Player Tracking Server's primary function is to manage loyalty points and player ratings, within the VCLAPS! architecture its role is significantly enhanced, making it a cornerstone of the “First Server System” functionality. Its core purpose is to serve as the master database and authority for all player-specific data, including not only loyalty status but, crucially, their secure casino account information, financial balances, authentication credentials (like PINs and stored biometric templates), and saved user preferences, such as custom EGM screen layouts. One aspect of novelty of its integration lies in how it facilitates direct, real-time financial transactions initiated from an EGM. When the VCLAPS! Server receives a request for an “EGM-as-ATM” withdrawal, it queries the Player Tracking Server System (1282) to verify the player's identity and confirm sufficient funds in their account. The Player Tracking Server System (1282) then processes the debit from the player's account upon authorization. This represents a major technical improvement, transforming the player account from a simple loyalty ledger into a transactional financial account. This provides the significant advantage of creating a unified player profile that encompasses loyalty, gameplay history, and direct financial management, all accessible from the EGM. This solves the problem of fragmented player data and inconvenient fund management, leading to a more streamlined and engaging player experience and more powerful data analytics for the casino operator.

### Financial Transaction Management and Tracking System 1281

The Financial Transaction Management and Tracking System (1281) represents a logical subsystem, operating as part of the VCLAPS! Server Component(s) (1287), dedicated to ensuring the integrity, security, and auditability of every monetary event within the VCLAPS! ecosystem. The core purpose of this system is to process, log, and reconcile all financial transactions associated with the plurality of virtual meters. This includes handling wagers, processing wins, managing direct deposits to and withdrawals from player accounts via the EGM-as-ATM functionality, and tracking contributions to cooperative game “team banks.” A notable operational feature is its role in the data transformation process. It takes raw transaction event data (e.g., “Player A bets $1 on Game X) and transforms it into immutable, timestamped entries in a secure financial ledger. This system is responsible for ensuring that for every debit from one virtual meter, there is a corresponding credit elsewhere or an outflow event (like a cash-out), maintaining a balanced and auditable system. The technical improvement provided by this dedicated system is the establishment of a robust, centralized financial transaction processing engine that is separate from the game logic itself. This separation is a novel approach compared to monolithic EGM software and provides the significant advantage of enhanced security and reliability. By centralizing the tracking of all financial movements, the system simplifies auditing, aids in dispute resolution, and provides the foundational data for the AML Detection and Reporting Services (1360). It solves the important technical problem of maintaining accurate financial records across a complex environment of multiple concurrent, independent gaming sessions on a single hardware platform, thereby improving the overall functionality and trustworthiness of the casino's computer systems.

### AML Detection and Reporting Services 1360

The AML Detection and Reporting Services (1360) component is a specialized, server-side system engineered to provide proactive, real-time Anti-Money Laundering monitoring within the VCLAPS! network. As described in the novel elements of the disclosure, its core function is to analyze financial transaction data and gameplay behavior at the point of origin—the individual EGM—to detect and flag suspicious patterns indicative of financial crime. This represents a significant technical improvement over traditional AML systems that often rely on delayed, backend analysis of aggregated data. This service integrates directly with the VCLAPS! Server, accessing the rich, granular data stream from the individual virtual meters. Its algorithms are designed to identify specific suspicious activities; for example, it calculates the ratio of a total wagered amount to a total deposited amount for a distinct game session and generates an alert if this ratio falls below a predefined “minimal play” threshold. Another specified algorithm monitors for structuring patterns, such as a series of cash-in transactions that are individually below a monetary threshold but collectively exceed a larger threshold within a defined time window. Upon detecting such a pattern, the service automatically generates an AML alert, which may be routed to casino compliance officers for immediate investigation. The practical advantage of this integrated, EGM-level monitoring is the ability to intervene in or investigate suspicious activity as it happens, rather than after the fact. By leveraging the detailed virtual meter data, the system may perform a more nuanced and effective analysis than systems that only see EGM-level totals. This solves the important problem of detection latency and improves the casino's ability to meet stringent regulatory requirements, thereby enhancing the security and integrity of the entire gaming operation.

### Financial Server 1312

The Financial Server (1312), as depicted in the network diagram, is the central server-side component responsible for the authoritative management of all financial aspects of the VCLAPS! system. It is functionally analogous to the “First Server System” described in the novel elements and embodies the core logic of the VCLAPS! Server Component(s) (1287). The primary purpose of the Financial Server (1312) is to host and manage the plurality of distinct virtual meters, each corresponding to an independent game session on a connected EGM. It processes all financial transactions, including wagers, wins, and importantly, the novel “EGM-as-ATM” functions. When a player initiates a deposit or withdrawal from their casino account at an EGM, the Financial Server (1312) receives the secure request, communicates with the Player Tracking Server (1314) to authenticate the player and verify/update their account balance, and sends an authorization command back to the EGM to complete the transaction (e.g., by activating the cash dispenser). A notable technical improvement and novelty of this server is its implementation of the dual-architecture metering system. It manages the granular, per-session virtual meters that enable individualized financial control, while also providing the necessary data from these meters to be aggregated into the distinct, unified regulatory meter required for compliance. This separation of concerns provides the significant advantage of enabling advanced, player-centric financial features without disrupting standard regulatory reporting pipelines. By centralizing the most important financial logic, the Financial Server (1312) enhances the security, scalability, and auditability of the entire gaming network, solving the complex technical problem of offering diverse and independent financial services on a shared, regulated gaming terminal.

### Player Tracking Server 1314

The Player Tracking Server (1314) is a foundational backend system that serves as the authoritative database of record for all player-specific information within the VCLAPS! gaming network. Its core function is to maintain comprehensive player profiles, which include not only traditional loyalty data like points and tier status, but also the important information needed to enable the advanced features of the VCLAPS! system. In this enhanced role, the Player Tracking Server (1314) stores and protects sensitive player account information, including financial balances for their casino accounts, authentication credentials such as PINs, and, as detailed in the novel elements, potentially secure biometric templates for advanced verification. It works in direct, secure communication with the Financial Server (1312). When a player attempts a transaction at an EGM, the Financial Server (1312) queries the Player Tracking Server (1314) to authenticate the player's identity and to confirm their account has sufficient funds for a withdrawal. Upon successful completion of a deposit or withdrawal, the Player Tracking Server (1314) is responsible for processing the final debit or credit to the player's account balance. A novel aspect of its functionality is storing user-specific UI customization data, allowing a player's preferred multi-game screen layout to be saved to their profile and recalled on any VCLAPS! EGM they use. This deep integration represents a significant technical improvement, transforming the Player Tracking Server from a passive loyalty database into an active, desirable component of a secure financial transaction and personalization ecosystem. The primary advantage is the creation of a truly unified and portable player experience, where a player's identity, funds, and preferences are securely managed and instantly accessible across the gaming floor, solving the problem of disconnected player services.

### Expanded Details of Example Features/Concepts

### Dual-Architecture Metering System for Individual Player Account Transactions at a Physical EGM

In at least one embodiment, the VCLAPS! Electronic Gaming Machine (EGM) system incorporates a novel dual-architecture metering system designed to manage individual player account transactions within a physical casino EGM environment. This system addresses the technical challenge of enabling multiple concurrent game sessions, which may be single-player or multiplayer, on a unified EGM interface while facilitating direct financial interactions with individual player casino accounts. The core purpose is to provide granular financial control for each player or game session through virtual meters managed by a first server system, and simultaneously ensure consolidated regulatory reporting through a distinct, unified regulatory meter, potentially managed by the EGM or a second server system. This architecture offers a practical application by improving EGM functionality, allowing for complex individual financial transactions such as deposits to and withdrawals from a player's personal casino account directly at the EGM, a capability not clearly offered by conventional consolidated EGM accounting methods. The system is computer-integral, relying on processors and memory within the EGM and server systems to manage these distinct metering layers and associated data flows. This technological improvement enhances player convenience and casino operational efficiency by treating the EGM, in part, as a transactional access point for player accounts, distinct from the EGM's operational funds.

The implementation involves a first server system, which may be akin to a Player Tracking (PT) server, maintaining a plurality of virtual (soft) meters. Each virtual meter is associated with a distinct game session or player. This first server system processes financial transactions requested from the EGM, such as cash-ins via a credit input device or cash-outs via a cash dispensing device, by updating the relevant virtual meter and initiating a corresponding update to the player's associated casino account. Game activity data from player interactions within these concurrent game sessions also leads to updates in the respective virtual meters. Concurrently, data derived from this plurality of virtual meters is provided for aggregation into a separate, unified regulatory (hard) meter. This regulatory meter, which may be managed by the EGM itself or a second server system comparable to a Casino Management System (CMS), serves the purpose of consolidated regulatory reporting. This dual structure directly addresses the problem of individualized financial control and player account management on a shared physical EGM.

### Sequence Diagram Components:

In at least one embodiment, the notable components interacting within the dual-architecture metering system include the Physical EGM, Player, First Server System (e.g., Player Tracking Server), and Second Server System (e.g., Casino Management System).

The Physical EGM is the terminal where players interact with games and initiate financial transactions. It comprises a display interface, credit input devices (like a bill validator), and cash dispensing devices. The EGM communicates with the First Server System to manage virtual meters and player account transactions. It also provides data for or manages the unified regulatory meter.

The Player is an individual interacting with the EGM, engaging in game sessions, and performing financial transactions linked to their personal casino account.

The First Server System, analogous to a Player Tracking server, is responsible for maintaining and managing the plurality of virtual meters. It processes requests for financial transactions from the EGM, updates virtual meters based on these transactions and game activity, and initiates updates to player accounts. This server also provides data from the virtual meters for aggregation into the unified regulatory meter.

The Second Server System, or a Casino Management System, is responsible for receiving aggregated data from the virtual meters (via the EGM or First Server System) to maintain the unified regulatory meter for overall EGM reporting and compliance purposes.

### Implementation Details:

In at least one embodiment, the dual-architecture metering system is implemented through a specific configuration of hardware and software components. The EGM itself is equipped with a processor and memory, a credit input device such as a bill validator or ticket reader, a cash dispensing device, and a network interface for communication with server systems. The display interface is typically a touchscreen capable of presenting multiple game sessions, potentially in segmented views.

The First Server System, which may be a dedicated Player Tracking server or a similar system component, includes processors and non-transient memory storing instructions for managing player accounts and virtual meters. It maintains a database of player accounts, each distinct from the EGM's operational funds. Communication protocols, such as secure TCP/IP, are used for data exchange between the EGM and the First Server System. When a player initiates a cash-in transaction at the EGM (e.g., inserting cash into the bill validator 128, 601), the EGM transmits a request to the First Server System. The First Server System then creates or updates a virtual meter associated with the player's session and initiates a credit to, or confirms funds from, the player's casino account. For cash-out transactions, the First Server System processes a request from the EGM, decreases the virtual meter balance, initiates a debit from the player's casino account, and instructs the EGM's cash dispensing device 137 to dispense the specified amount. Game activity, such as bets placed and wins awarded, is reported by the EGM to the First Server System, which updates the corresponding virtual meter in real-time.

The unified regulatory meter, which may be managed by the EGM's internal systems or a Second Server System (e.g., a Casino Management System server 296), aggregates data from all active virtual meters associated with that EGM. This aggregation process involves summing up relevant financial data points (e.g., total cash-in, total cash-out, total wagers, total wins) from the individual virtual meters to provide a consolidated view for regulatory reporting. Secure protocols ensure the integrity and confidentiality of data exchanged between the EGM, the First Server System, and the Second Server System. The clear articulation of how these components interact to maintain distinct virtual and regulatory metering layers addresses a specific technological improvement to EGM functionality, particularly for managing individual finances in a multi-session environment while ensuring overall compliance.

### Player Interaction:

In at least one embodiment, a player approaches the VCLAPS! EGM and may initiate a session by inserting a player tracking card into the EGM's player tracking card reader 138 or by other identification means. If the player wishes to fund their play using their casino player account, they may select an option on the EGM's interface to deposit funds from their account or to deposit physical cash/ticket into their account via the EGM. For a cash deposit to their account via the EGM, the player inserts cash into the bill validator 128 or a ticket into the ticket reader 224. The EGM communicates this transaction to the First Server System, which updates a virtual meter tied to the player's current session and initiates a credit to the player's casino account. The EGM's display interface will show the updated balance on their active virtual meter.

The player then selects a game from the potentially multiple games offered on the EGM's interface. As the player engages in gameplay, placing wagers and receiving awards, these amounts are tracked by the specific virtual meter associated with their game session. If the player wishes to cash out, they may choose to withdraw funds back to their player casino account or receive a physical cash payout from the EGM's cash dispensing device 137. If cashing out to their account or receiving cash, the player initiates this via the EGM interface. The EGM sends a request to the First Server System, which processes the withdrawal by decreasing the virtual meter balance, initiating a debit from the player's casino account, and, if physical cash is requested, authorizing the EGM to dispense the funds. Throughout this process, the player interacts with a single EGM which provides access to their casino account funds for deposits and withdrawals, in addition to standard gaming activities.

### Distinguishing Novel Elements:

The dual-architecture metering system is distinguished from prior art by its specific two-part structure operating within a single physical EGM environment for individualized financial control alongside regulatory compliance. Conventional systems may offer consolidated accounting for multi-game EGMs or may require cumbersome cash-out and re-buy-in processes for player changes, rather than facilitating direct, individual transactions with a player's dedicated casino account through the EGM itself.

The first novel aspect is the First Server System's management of multiple, distinct virtual meters, where each virtual meter is tied to an individual game session or player on the EGM. This server enables direct fund transfers—both deposits and withdrawals—between a player's specific casino account (which is distinct from the EGM's operational funds) and their active virtual meter at the EGM. This allows the EGM to function akin to a personal ATM for the player's casino funds.

The second novel aspect is the concurrent operation of a separate, unified regulatory meter. This regulatory meter aggregates data from the plurality of virtual meters, providing a consolidated financial overview of the EGM's total activity for casino management and regulatory reporting purposes. This unified regulatory meter is explicitly distinct from the individual virtual meters.

This combination of individualized, player account-linked virtual metering (facilitating direct deposits/withdrawals at the EGM) with a separate, aggregated regulatory meter provides a specific technical solution to the problem of managing granular player finances on a shared physical EGM while ensuring comprehensive regulatory oversight. It improves EGM functionality by enabling complex, individual financial interactions seamlessly alongside gaming activities.

### Technical Improvements to Existing Technical Problems:

The dual-architecture metering system provides several technical improvements to existing problems in the operation and management of EGMs in physical casinos.

One existing technical problem is the inefficient management of player funds on multi-game or multi-player EGMs. Traditional systems often consolidate all credits into a single machine balance, which may necessitate complex cash-out and re-buy-in procedures if one player in a multi-player session wishes to leave, or if a player wants to segregate funds for different games distinctly. The VCLAPS! system solves this by enabling direct, individual transactions to and from a player's dedicated casino account via the EGM, using distinct virtual meters managed by the First Server System. This offers a more streamlined and user-friendly way for players to manage their funds at the EGM.

Another technical problem is the lack of granular individual player financial tracking on shared EGM devices when attempting to maintain simplified regulatory compliance. While EGMs must report overall financial performance, tracking individual player transactions to and from their casino accounts with precision on a machine that may host multiple simultaneous sessions may be complex. The dual-architecture system addresses this by having the First Server System manage these detailed individual virtual meters and player account transactions, while data from these virtual meters is then aggregated into a distinct unified regulatory meter for consolidated reporting. This separation provides both the required granularity for player account management and the aggregated data needed for regulatory compliance, improving the EGM's accounting and reporting capabilities.

Furthermore, conventional EGMs do not typically function as direct transactional points for a player's broader casino account balance beyond loading credits for immediate play. The disclosed system transforms the EGM into a more versatile financial tool, allowing players to make deposits to or withdrawals from their casino accounts directly at the gaming machine, independent of immediate wagering activity. This enhances the EGM's utility and the player's convenience within the casino environment. The specific interaction between the EGM, the First Server System managing player-specific virtual meters and account links, and the separate regulatory meter infrastructure constitutes a technical improvement to how EGMs function and integrate with casino financial ecosystems.

### Component Interactions and Procedural Steps:

In at least one embodiment, the process begins when a player initiates a session at the VCLAPS! EGM, often by using a player tracking card at the EGM's player tracking card reader 138.
1. Player Account Linking and Virtual Meter Initialization: The EGM communicates with the First Server System (e.g., PT Server). The First Server System verifies the player and links their player account, which is distinct from the EGM's operational funds, to the session. A virtual meter is established and associated with this specific game session or player by the First Server System.
2. Financial Transaction (e.g., Cash-In/Deposit):
   The player initiates a cash-in transaction, either by inserting cash/ticket into the EGM's credit input device (e.g., bill validator 128) or by requesting a fund transfer from their linked player account.
   The EGM sends a request for this financial transaction to the First Server System.
   The First Server System processes the transaction: it updates (increases) the balance of the player's virtual meter and initiates a corresponding update (credit or confirmation of funds) to the player's casino account. The EGM's display reflects the new virtual meter balance.
3. Gameplay Activity:
   The player interacts with one or more of the concurrent game sessions presented on the EGM's display interface.
   The EGM transmits game activity data (e.g., wagers placed, wins achieved) to the First Server System.
   The First Server System updates the player's virtual meter(s) in real-time based on this game activity data.
4. Financial Transaction (e.g., Cash-Out/Withdrawal):
   The player initiates a cash-out transaction from their virtual meter, potentially to their player account or as physical cash via the EGM's cash dispensing device 137.
   The EGM sends a request for this financial transaction to the First Server System.
   The First Server System processes the transaction: it updates (decreases) the balance of the player's virtual meter, initiates a corresponding debit from the player's casino account, and if physical cash is requested, instructs the EGM to dispense the amount.
5. Data Aggregation for Regulatory Meter:
   Concurrently or periodically, the First Server System provides data derived from the plurality of virtual meters (reflecting all individual player/session activities) for aggregation.
   This data is aggregated into a unified regulatory meter associated with the EGM. This regulatory meter is distinct from the virtual meters and is used for reporting to a casino management system (CMS) or a Second Server System. The EGM itself or the Second Server System may manage this aggregation and the regulatory meter.
6. Session End and Reset: Upon a player cashing out completely or ending their session, the EGM interface and the specific virtual meter may be reset to prepare for a subsequent player or session. The First Server System finalizes any pending transactions for the player's account.

Throughout these steps, robust error-checking mechanisms are implemented to detect and resolve transaction discrepancies, and security protocols are employed to prevent fraud and tampering, ensuring secure data exchange between the EGM, the First Server System, and any Second Server System involved.

Data Input: In at least one embodiment, the dual-architecture metering system processes several types of data inputs.

From the player via the EGM interface, inputs include:
Player identification data, often from a player tracking card inserted into a reader 138.
Cash or ticket inputs via the EGM's credit input device (e.g., bill validator 128, ticket reader 224) for funding activities or depositing into a player account.
Requests for financial transactions, such as depositing funds to a player account, withdrawing funds from a player account, or cashing out credits from a virtual meter.
Game selections from the plurality of concurrent game sessions available on the EGM display.
In-game decisions, such as bet amounts, payline selections, or other game-specific interactions.

From the EGM to the First Server System, inputs include:
Requests for financial transactions initiated by the player at the EGM.
Game activity data, detailing player interactions within game sessions, including wagers, game outcomes, and awards.
Player identification information obtained through EGM peripherals.

From the First Server System, inputs include:
Data derived from the plurality of virtual meters, provided for aggregation into the unified regulatory meter.

This data represents the financial activities tracked by individual virtual meters.

These inputs are desirable for the system to manage individual player accounts, update virtual meters, process game outcomes, and ensure accurate aggregation for regulatory reporting.

### Data Processing:

In at least one embodiment, the data processing within the dual-architecture metering system involves several notable operations performed by the EGM and the server systems.

The First Server System (e.g., PT Server) is central to processing data related to individual player sessions and accounts. When it receives a request for a financial transaction from the EGM (e.g., a cash-in or cash-out request associated with a player account and a specific virtual meter), its processor executes instructions to:
Validate the transaction request.
Update the corresponding virtual meter by increasing or decreasing its credit balance.
Initiate an update to the associated first player account, which is distinct from the EGM's operational funds. This may involve communicating with a player accounting database or system.

When the First Server System receives game activity data from the EGM (such as bets placed and wins awarded), it processes this data to:
Identify the correct virtual meter associated with the game session.
Update the balance of that virtual meter according to the game outcomes (e.g., decreasing for bets, increasing for wins).

The EGM or a Second Server System (e.g., CMS) processes data for the unified regulatory meter. This involves:
Receiving data derived from the plurality of virtual meters, as provided by the First Server System or the EGM.
Aggregating this data. This aggregation typically involves summing notable financial metrics (like total wagers, total payouts, net win/loss) from all individual virtual meters associated with the EGM to produce a single set of figures representing the EGM's overall performance.
Maintaining and updating the unified regulatory meter with these aggregated figures for reporting to the casino management system.

Throughout these processes, data transformations occur. For example, raw transaction requests are transformed into updates on virtual meter balances and player account balances. Game event data (spins, card deals, symbol combinations) is transformed into financial outcomes (wins, losses) that adjust virtual meter values. Data from numerous individual virtual meters are transformed (aggregated) into a consolidated set of data for the regulatory meter. These processing steps ensure that financial activities are accurately tracked at both the individual player/session level and the overall EGM regulatory level, representing a specific technological solution to managing complex EGM operations.

### Outputs and Responses:

In at least one embodiment, the dual-architecture metering system generates several outputs and responses to players and other system components.

To the player via the EGM's display interface:
Real-time updates to the credit balance displayed on their active virtual meter, reflecting cash-ins, cash-outs, wagers, and winnings.
Confirmation messages for financial transactions, such as successful deposits to or withdrawals from their player account via the EGM.
Dispensing of physical cash via the EGM's cash dispensing device 137 upon a successful cash-out transaction from their virtual meter or player account.
Presentation of game outcomes and any associated awards or changes to their virtual meter balance.

From the First Server System:
Instructions to the EGM to dispense cash via its cash dispensing device following an approved withdrawal transaction.
Updates to the player's casino account reflecting deposits or withdrawals processed via the EGM.
Data derived from the plurality of virtual meters, which is provided for aggregation into the unified regulatory meter. This data represents the summarized financial activities of individual sessions.
Alerts, if configured for AML purposes, based on analysis of transaction patterns associated with virtual meters. From the EGM or Second Server System (managing the regulatory meter):
The unified regulatory meter data is outputted or made available for reporting to the casino management system. This output provides a consolidated view of the EGM's financial performance for regulatory compliance and auditing.

These outputs and responses ensure that players are informed of their financial status and transaction outcomes, and that the casino and regulatory bodies receive accurate financial data from the EGM's operations.

### Data Storage and Reporting:

In at least one embodiment, data storage and reporting are important functions of the dual-architecture metering system.

The First Server System is responsible for storing data related to individual player accounts and their associated virtual meters. This includes:
Player account details and balances.
Transaction histories for each virtual meter, including cash-ins, cash-outs, wagers, wins, and adjustments.
Associations between virtual meters, game sessions, and player accounts.
Logs of game activity data received from the EGM. This data is stored in a centralized database managed by the First Server System, facilitating auditing, player dispute resolution, and personalized player services.

The EGM itself, or a Second Server System (e.g., Casino Management System), stores the data for the unified regulatory meter. This regulatory meter contains aggregated financial data derived from the individual virtual meters. This data includes:
Total amounts for coin-in, coin-out, bets placed, and wins awarded across all game sessions on the EGM for a reporting period.
Other consolidated metrics required for regulatory compliance and casino accounting. This aggregated data is stored securely and is used to generate reports for casino management and regulatory authorities.

Reporting functionalities include:
Generation of financial reports from the unified regulatory meter for submission to gaming regulators.
Provision of detailed transaction histories to players upon request, related to their specific virtual meter activity and player account transactions.
Internal auditing reports for casino management to monitor EGM performance and financial integrity.
If AML features are integrated, reports of flagged suspicious activities are generated for review.

Secure and robust data storage mechanisms are employed, using non-transient memory, to ensure data integrity, prevent unauthorized access, and comply with data retention policies. Regular backups and data reconciliation procedures may also be part of the data management strategy.

### Error Handling and Security Measures:

In at least one embodiment, robust error-checking mechanisms and security protocols are implemented throughout the dual-architecture metering system to ensure transactional integrity, data accuracy, and fraud prevention.

Error handling mechanisms are designed to detect and resolve transaction discrepancies. This includes:
Validation checks for all financial inputs, such as currency validation by the EGM's bill validator 128 and ticket validation.
Communication error detection and re-transmission protocols between the EGM and the First Server System, and between server systems, to ensure messages are accurately sent and received (addressing Disclosure Gap for server interaction). This may involve checksums, acknowledgments, and timeout handling.
Mechanisms for reconciling balances between virtual meters and player accounts, and between the sum of virtual meters and the unified regulatory meter, to identify and flag discrepancies.
Logging of all errors and exceptions for auditing and troubleshooting.
Procedures for manual intervention or automated correction in case of unresolved discrepancies, where permissible by regulations.

Security protocols are employed to prevent fraud and tampering. This includes:
Secure authentication of players, particularly for transactions involving their casino accounts (addressing Disclosure Gap for EGM as ATM security). This may involve multi-factor authentication, PIN verification, or biometric checks in conjunction with player tracking cards.
Encryption of sensitive data, both in transit (e.g., using TLS/SSL for communication between EGM and servers) and at rest (e.g., encrypting player account information and financial logs in databases).
Access controls and authorization mechanisms to ensure that only legitimate users and system components may perform specific actions (e.g., EGM requests to First Server System are authenticated).
Tamper-evident hardware for EGM components like cash handling devices (bill validator 128, cash dispensing device 137, cash box).
Regular security audits and vulnerability assessments of the EGM software, server software, and network infrastructure.
For the unified regulatory meter, measures to ensure its integrity and prevent unauthorized modification, as this is important for compliance.

These measures contribute to a secure and reliable gaming environment, protecting both player assets and casino operations, and ensuring compliance with financial regulations.

Unified Multi-Game and Multi-Player Management on a Single Physical EGM with Segmented Unitary Touchscreen and Shared Hardware, Integrated with Dual-Architecture Metering

In at least one embodiment, the VCLAPS! Electronic Gaming Machine (EGM) system introduces a unified management system for multi-game and multi-player operations on a single physical EGM, featuring a segmented unitary touchscreen and shared physical hardware, all integrated with the dual-architecture metering system detailed in Novel Element 1. This novel element allows multiple, potentially different, games—each with unique paytables and volatilities—to operate concurrently. These games may be controlled independently either by a single player managing several games simultaneously or by multiple players each engaging in their own distinct game session on the same EGM. The unitary touchscreen display is capable of being dynamically segmented, with each segment mapped to an independent game instance and featuring its own set of virtual controls. All these concurrent and independent sessions utilize the EGM's single set of physical hardware components, such as a single bill acceptor, a single printer, and a single player tracking reader. Critically, the financial aspects of these sessions are managed through individual virtual meters (associated with each game or player session and handled by a First Server System) that subsequently roll up to the single unified regulatory meter for the EGM.

The core purpose of this novel element is to maximize machine utility and player choice within a physical casino setting by providing a unique and integrated solution for diverse gaming experiences on a single hardware unit. The practical application lies in the EGM's ability to offer, for example, three different slot games side-by-side on one large screen (e.g., as depicted in FIGS. 15, 18), each playable independently, or allowing two players to engage in separate games concurrently on the same EGM. This integration addresses the technical challenge of managing concurrent, independent game logic, user inputs from distinct screen segments, shared peripheral access, and individualized financial accounting while maintaining overall regulatory compliance. The system is computer-integral, relying on processors within the EGM and server systems, and specialized software logic for touchscreen segmentation, input processing, and game session management in conjunction with the dual-architecture metering. This represents a specific technological improvement to EGM functionality by creating a highly flexible and efficient gaming platform.

### Sequence Diagram Components:

In at least one embodiment, the notable components for managing unified multi-game and multi-player operations include: Player(s), the Physical EGM, a Game Management System (which may reside within the EGM or be partially managed by a server), Individual Game Logic Engines, the First Server System (e.g., Player Tracking Server), and potentially a Second Server System (e.g., Casino Management System).

The Player(s) are the individuals interacting with the EGM, either a single player managing multiple games or multiple players each playing their own game on a segment of the EGM's unitary touchscreen.

The Physical EGM is the single hardware unit equipped with a unitary (often large) touchscreen display capable of segmentation, a processor capable of running multiple game instances, and shared peripherals like a single bill acceptor, printer, and player tracking card reader.

The Game Management System orchestrates the concurrent game sessions, manages resource allocation, handles the dynamic segmentation of the touchscreen, and routes player inputs to the correct game instance.

Individual Game Logic Engines are software instances, each responsible for the rules, paytables, and operation of a specific game being played concurrently on the EGM.

The First Server System manages the individual virtual meters associated with each concurrent game session or player, processes player account transactions, and provides data for aggregation.

The Second Server System or Casino Management System receives aggregated data from the virtual meters (via the EGM or First Server System) to maintain the unified regulatory meter.

### Implementation Details:

In at least one embodiment, the EGM is a physical unit comprising a high-resolution unitary touchscreen display (e.g., as illustrated in FIGS. 15, 17, 18), a robust processing system (e.g., processor 12 or 204) capable of executing multiple game applications simultaneously, and a single set of shared hardware peripherals including a bill validator 128, 234, 601, a ticket printer 136, 222, and a player tracking card reader 138, 230, 326.

The core of this novel element is the software architecture enabling the dynamic segmentation of the unitary touchscreen. This software logic divides the screen into several distinct active regions, each capable of displaying the full user interface of an independent game, including its specific virtual controls (e.g., virtual buttons for spin, bet adjustment, paytable access, as described in KF1 concept 1.5). The system processes touch inputs by identifying the coordinates of the touch and mapping them to the specific game segment and virtual control activated within that segment. This ensures that inputs intended for one game do not affect others. This detailed software logic for dynamic segmentation, independent input processing from different segments, and concurrent rendering of multiple game UIs without interference directly addresses a specified disclosure gap.

A Game Management System, which may operate on the EGM's processor or in conjunction with the First Server System, is responsible for launching, managing, and terminating these concurrent game instances. It ensures that each game operates with its specified paytable and volatility level (as described in KF1 concept 1.13). When a player initiates a transaction using shared peripherals, such as inserting money into the single bill acceptor 128, the Game Management System, in coordination with the First Server System, routes the funds to the virtual meter associated with the player-selected game session or active player. For instance, upon cash insertion, the player may be prompted on the touchscreen to select which active game session to credit.

The integration with the dual-architecture metering system is important. Each concurrently running game, whether played by a single player managing multiple games or by different players, is linked to a distinct virtual meter managed by the First Server System. This virtual meter handles all financial accounting for that specific game session, including wagers from and payouts to the associated player or player account. Data from all such active virtual meters on the EGM are then aggregated to update the single, unified regulatory meter for overall EGM financial reporting. This ensures both granular financial tracking for individual sessions and consolidated reporting for regulatory compliance.

### Example Walk-Through Scenario:

In at least one embodiment, consider a VCLAPS! EGM configured with a large unitary touchscreen display, capable of showing three distinct game interfaces simultaneously (as suggested by KF1 FIGS. 15 and 18 and KF1 concept 1.5).

### Scenario A: Single Player, Multiple Games.

A player, John, approaches the EGM. He inserts his player tracking card into the single player tracking reader 138. He then inserts $100 cash into the single bill acceptor 128. The EGM, via the Game Management System and First Server System, credits this amount, and John sees a general balance or is prompted to allocate it. John decides to play three different slot games concurrently. The EGM's touchscreen displays three segments: Segment 1 shows “Pharaoh's Fortune,” Segment 2 shows “Cosmic Reels,” and Segment 3 shows “Jungle Adventure.” Each segment has its own set of virtual buttons for bet controls and spin. John makes a $1 bet on “Pharaoh's Fortune” using its virtual controls, a $2 bet on “Cosmic Reels,” and a $0.50 bet on “Jungle Adventure.” The First Server System manages three separate virtual meters (VM1, VM2, VM3) linked to John's account for these sessions. Winnings from “Pharaoh's Fortune” are credited to VM1, wagers on “Cosmic Reels” debit VM2, and so on. All transactions from VM1, VM2, and VM3 are also aggregated into the EGM's single unified regulatory meter.

### Scenario B: Multiple Players, Multiple Games (as Supported by KF1 Concept 1.3 and 1.12).

Two players, Alice and Bob, are at the same VCLAPS! EGM. Alice inserts her player tracking card for Segment 1, and Bob inserts his for Segment 2. Alice chooses to play “Lucky Sevens” in Segment 1, and Bob chooses “Space Pirates” in Segment 2. (Segment 3 may be inactive or used by a third player). Alice uses the single bill acceptor to load $50, which is directed to her virtual meter (VM-Alice) associated with her session in Segment 1. Bob uses his existing player account balance, confirmed via the First Server System, for his virtual meter (VM-Bob) in Segment 2. Alice and Bob play their respective games independently, using the virtual controls within their screen segments. Their financial transactions are tracked by VM-Alice and VM-Bob respectively, managed by the First Server System and linked to their individual player accounts. Data from both VM-Alice and VM-Bob contribute to the EGM's single unified regulatory meter. If Alice wins and decides to print a ticket, she initiates this from her segment, and the single printer 136 issues her ticket.

### Player Interaction:

In at least one embodiment, players interact with the unified multi-game and multi-player EGM primarily through its large, segmented unitary touchscreen display and the EGM's shared physical peripherals. The touchscreen is the main interface for game selection and gameplay.

The unitary touchscreen is dynamically divided into multiple segments, with each segment capable of displaying a complete and independent game interface. Players may see and interact with multiple games at once. For instance, as shown in FIGS. 15 and 18, multiple distinct game reel displays may be presented side-by-side on the unitary game display. Each segment contains its own set of virtual game controls (e.g., spin, bet up/down, line select, help/paytable buttons) that are specific to the game running in that segment, as conceptualized in KF1 concept 1.5.

If a single player is managing multiple games, they interact with the virtual controls in each segment to play the respective games, effectively multitasking across different game instances (KF1 concept 1.3). The system ensures that an input in one segment only affects the game in that segment.

In a multi-player scenario, different players may be assigned or select different segments of the touchscreen for their individual game sessions (KF1 concept 1.3). Each player would then interact with the virtual controls within their allocated segment.

Shared physical peripherals, such as the single bill acceptor 128, single printer 136, and single player tracking reader 138, are used by all players or game sessions. The system includes logic to manage access to these shared resources. For example, when funds are inserted into the single bill acceptor, the player may be prompted via the touchscreen to assign those credits to one of their active game sessions or to a specific player's virtual meter if multiple players are logged in. Similarly, when a player tracking card is inserted into the single reader, the system associates that player with a specific segment or allows them to choose which game session to link to.

### Distinguishing Novel Elements:

The core novel element here is the specific and comprehensive integration of multiple features onto a single physical EGM platform, managed financially by the unique dual-architecture metering system. While individual aspects like multi-game platforms, segmented displays, or shared EGM resources may be known in some contexts, their combination and interaction as described create a distinct solution.

The distinguishing features are:
1. Unified Multi-Game and Multi-Player Operation on a Single EGM: The capability to run multiple, potentially different games (with unique paytables and volatilities) concurrently, which may be managed independently by a single player or by multiple players simultaneously engaging in their own sessions on that one EGM.
2. Dynamically Segmented Unitary Touchscreen with Independent Virtual Controls: A single, large touchscreen display that is dynamically divided into segments, each mapped to an independent game and featuring its own complete set of virtual game controls. Player input within one segment is isolated to that game.
3. Shared Single Set of Physical Hardware Peripherals: All concurrent game sessions share the EGM's single bill acceptor, single printer, and single player tracking reader.
4. Integrated Financial Management via Dual-Architecture Metering: Crucially, the financial operations of all these independent, concurrent sessions are managed through individual virtual meters (linked to each game/player and managed by the First Server System) which then aggregate into the single unified regulatory meter for the EGM. This specific financial backbone enables the true independent operation and accounting of concurrent sessions on shared hardware.

This particular combination provides a unique technical solution to maximizing EGM utility, player choice, and personalized financial management in a physical casino setting, which is not generally taught by prior art that may describe multi-game displays without this specific integrated control and dual-metering financial architecture for concurrent, independent sessions.

### Technical Improvements to Existing Technical Problems:

This novel element provides several technical improvements to existing problems in the design and operation of EGMs within physical casino environments.

One significant technical problem is the inefficient utilization of valuable casino floor space. Typically, offering a wide variety of game types or accommodating multiple players may require multiple distinct physical EGM units. The VCLAPS! system, by enabling a single physical EGM to host multiple, different, concurrently operating games (potentially for different players or a single player managing several games), significantly improves machine utility per square foot. This is a direct technical improvement in how EGM hardware resources are managed and leveraged.

Another problem is the limited player choice and convenience on a single machine. Players often need to move between different EGMs to experience different games or if a machine is occupied. The VCLAPS! EGM, with its segmented unitary touchscreen presenting multiple independent games, allows a single player to engage with diverse gaming experiences (e.g., games with different paytables and volatilities) without changing machines, or allows multiple players to play their preferred game on the same EGM if it is configured as a multiplayer station. This enhances player engagement and satisfaction.

A further technical challenge is the complex financial accounting and regulatory compliance required when multiple game activities occur on a single piece of hardware, especially if they are independent or involve different players. The integration of the dual-architecture metering system (as described in Novel Element 1) provides the technical solution: individual virtual meters track each game session's finances precisely and may link to individual player accounts, while the unified regulatory meter ensures overall EGM compliance. This structured financial management for truly independent concurrent sessions on shared hardware is a technical improvement over simpler consolidated EGM accounting.

Finally, providing distinct, non-interfering control interfaces for multiple concurrent games or players on a single screen presents a technical hurdle. The dynamic segmentation of the touchscreen with independent virtual controls for each segment offers a specific, improved technical means for user interaction in such an environment, enhancing the functionality of the EGM's primary input and display device. This approach is a specific improvement to computer (EGM) functionality, addressing concrete problems in casino operations regarding machine utility, player experience, and financial management on shared devices.

### Data Input:

In at least one embodiment, for the unified multi-game and multi-player management system, the following data inputs are processed:
Player Identification Data: Input via the single player tracking reader 138, allowing the system to associate gameplay and financial transactions with specific player accounts, especially in multi-player scenarios or for personalized single-player experiences.
Credit Input Data: Monetary value input through the single bill acceptor 128 (cash, tickets) or from a player's casino account via the First Server System. The system needs to know which virtual meter/player session to allocate these credits to if multiple are active.
Game Selection Data: Player inputs selecting which games to play from the available options presented on the EGM's segmented unitary touchscreen.
Touchscreen Input Data: Coordinates and types of touch interactions (taps, swipes, etc.) within each distinct segment of the unitary touchscreen. These inputs correspond to activations of virtual controls for the specific game displayed in that segment.
Mode Selection Data: If applicable, player input selecting between a single-player multi-game mode or a multi-player mode utilizing different segments of the screen.
Betting Information: Inputs for bet amounts, number of lines, or other wager-related parameters for each concurrently played game, entered via the virtual controls in the respective game's touchscreen segment.
Game Control Inputs: Player interactions with game-specific virtual buttons (e.g., “spin,” “deal,” “hold,” feature activation) within each active game segment.

These inputs are processed by the EGM's Game Management System and the First Server System to manage the concurrent game states, update individual virtual meters, and ultimately contribute to the unified regulatory meter.

### Component Interactions and Procedural Steps:

In at least one embodiment, the unified multi-game and multi-player management on a single physical EGM involves intricate interactions and procedural steps:
1. Session Initiation & Player/Game Assignment:
   A player (or multiple players) initiates a session, potentially using the single player tracking reader 138. If multiple players, the system assigns or allows selection of distinct segments on the unitary touchscreen 116 to each player.
   Players select games for their respective segments or for multiple segments if a single player is playing multiple games. The Game Management System launches the corresponding Individual Game Logic Engines for each selected game.
   The First Server System establishes or links individual virtual meters to each active game session/player.
2. Funding and Credit Allocation:
   Funds are inserted via the single bill acceptor 128 or transferred from a player account. The EGM's Game Management System, in coordination with the First Server System, allocates these credits to the appropriate virtual meter based on player selection or active segment.
3. Gameplay Interaction:
   Players interact with the virtual controls displayed within their assigned touchscreen segment(s).
   The EGM's UI Management software captures these touch inputs, identifies the source segment, and routes the input to the correct Individual Game Logic Engine.
   The respective Game Logic Engine processes the input (e.g., initiates a spin, makes a game decision), determines the outcome, and updates its game state.
   The Game Logic Engine communicates display updates back to the UI Management software, which renders the changes within the specific touchscreen segment.
4. Financial Transaction Processing (Dual-Architecture Metering):
   For each wager or win within a game segment, the corresponding Game Logic Engine communicates the financial event to the Game Management System.
   The Game Management System relays this to the First Server System, which updates the specific individual virtual meter associated with that game session/player.
   The First Server System also processes any direct player account transactions (deposits/withdrawals) linked to a virtual meter, as per Novel Element 2.
   Data from all active virtual meters is periodically or continuously provided by the First Server System for aggregation into the EGM's unified regulatory meter, which may be managed by the EGM itself or a Second Server System.
5. Shared Peripheral Management:
   If a player initiates a print request (e.g., cash-out ticket), the request from their game segment is routed to the single printer 136 via the Game Management System.
Access to the single player tracking reader 138 is managed to identify different players for different sessions if in a multi-player configuration.
6. Session Termination:
   When a game session ends or a player cashes out, the First Server System finalizes the transactions for the associated virtual meter and player account.
The specific segment on the touchscreen may become available for a new game or player. The overall EGM continues to manage other active sessions.

This process allows for independent and concurrent gameplay experiences on a single physical EGM, all tied into a coherent financial management framework.

### Data Processing:

In at least one embodiment, the data processing for the unified multi-game and multi-player management system involves several layers within the EGM and associated server systems.

Within the EGM, the main processor(s) (e.g., processor 12 or 204) executes the Game Management System software. This system is responsible for:
Concurrent Game Execution: Managing the simultaneous operation of multiple Individual Game Logic Engines. This includes allocating CPU time, memory, and graphics processing resources to each game instance.
Touchscreen Segmentation and Input Routing: Processing raw touch data from the unitary touchscreen display 116. Software logic dynamically defines active segments, maps touch coordinates to these segments, and identifies activated virtual controls. The input data (e.g., “spin button pressed in segment 1”) is then routed to the appropriate Game Logic Engine. This involves transforming coordinate data into game-specific commands.
UI Rendering Management: Coordinating with each Game Logic Engine to render its distinct user interface within its assigned touchscreen segment. This may require managing potentially different graphical assets and display requirements for each concurrent game.
Shared Peripheral Arbitration: Managing requests to and data from shared hardware like the single bill acceptor 128, printer 136, and player tracking reader 138, ensuring data is correctly associated with the initiating player or game session.

The First Server System processes financial data and player account information. This includes:
Virtual Meter Management: Receiving financial event data (bets, wins, deposits, withdrawals) from the EGM for each game session/player. It processes these by updating the balance of the corresponding individual virtual meter.
Player Account Transactions: Processing requests for deposits to or withdrawals from linked player casino accounts, involving communication with a player account database.
Data Aggregation Preparation: Compiling data from all individual virtual meters associated with a particular EGM to be provided for aggregation into the unified regulatory meter.

The EGM itself or a Second Server System (e.g., CMS) processes the data for the unified regulatory meter by:
Aggregating the financial totals (e.g., total wagers, total wins) from the individual virtual meter data into a single set of EGM-wide regulatory figures.

These processing tasks involve significant data transformation, state management for multiple concurrent sessions, and secure communication between the EGM and server systems to enable the complex, integrated functionality. This addresses the § 101 support disclosure gap by detailing how specific software and hardware components are configured and interact to achieve practical, improved EGM operations.

Outputs and Responses: In at least one embodiment, the unified multi-game and multi-player EGM system generates various outputs and responses tailored to players and casino operational systems.

To the Player(s) via the EGM's Unitary Touchscreen Display 116:
Multiple Independent Game Interfaces: Each assigned segment of the touchscreen displays a distinct game's visual interface, including game-specific graphics, animations, reel displays, or card hands. Examples are shown in FIGS. 15, 17, and 18.
Real-Time Game State Updates: Each game segment updates independently to reflect the outcomes of player interactions (e.g., spinning reels, card reveals, bonus feature initiations) for that specific game.
Individual Virtual Control Feedback: Activation of virtual buttons within a segment (e.g., spin, bet change) provides immediate visual or auditory feedback within that segment.
Individual Financial Information: Each game segment, or an associated area of the display, may show the balance of the virtual meter linked to that specific game session or player. Players may see their credits for each game they are playing.
Notifications and Prompts: System messages, prompts for shared peripheral use (e.g., “Player 1, insert cash”), or game-specific alerts are displayed, potentially localized to the relevant screen segment.

To the Player(s) via Shared EGM Peripherals:
Printed Tickets: From the single printer 136, reflecting cash-outs from a specific virtual meter/player session.
Dispensed Cash: From the single cash dispensing device 137, if supported for withdrawals related to a specific virtual meter/player account.

To Casino Systems (First Server System, Second Server System/CMS):
Individual Virtual Meter Data: The First Server System receives and processes detailed financial transaction data (bets, wins, cash-ins, cash-outs) for each distinct virtual meter associated with a concurrent game session or player on the EGM.
Player Tracking Data: Information from the single player tracking reader 138 is linked to specific player sessions and their virtual meter activity, transmitted to the First Server System (PT Server).
Aggregated Regulatory Meter Data: The EGM or Second Server System (CMS) receives or computes data for the unified regulatory meter, which represents the consolidated financial performance of the entire EGM across all concurrent sessions.
Operational Status and Alerts: The EGM may output status information regarding active sessions, peripheral usage, and any errors to centralized monitoring systems.

These outputs collectively ensure that players have clear and independent control and feedback for each game they are engaged with, while the casino maintains both granular and consolidated views of EGM activity for financial management and regulatory compliance.

### Data Storage and Reporting:

In at least one embodiment, the unified multi-game and multi-player management system may require robust data storage and reporting capabilities to support its complex operations and meet regulatory requirements.

### Data Storage:

First Server System (e.g., Player Tracking Server): This server is responsible for storing detailed data for each individual virtual meter. This includes:
   A record of every transaction (bets, wins, deposits, withdrawals) associated with each virtual meter, linked to the specific game instance, player ID (if applicable), and timestamp.
   Player account information and the history of transactions to and from these accounts via the EGM.
   Configuration data for each game that may be run concurrently, including their distinct paytables and volatilities.
EGM Local Storage: The EGM may store:
   Current state information for each active game session.
   Short-term transaction logs for resilience and immediate display purposes.
   Configuration data for touchscreen segmentation and virtual control layouts.
Unified Regulatory Meter Storage (EGM or Second Server System/CMS): This system stores the aggregated financial data that constitutes the unified regulatory meter for the EGM. This includes consolidated totals for coin-in, coin-out, net win, etc., for defined reporting periods.

### Reporting:

Individual Player/Session Reports: The First Server System may generate reports detailing the activity of specific virtual meters, useful for player account statements, dispute resolution, and personalized analytics.
EGM Regulatory Reports: The system managing the unified regulatory meter generates standard reports required by gaming regulatory bodies, reflecting the overall financial performance of the EGM as a single entity, despite potentially hosting multiple independent activities. This simplified regulatory reporting is a notable benefit.
Operational Reports for Casino Management: Casinos may generate reports on machine utilization, popularity of different games offered concurrently, financial performance per game segment, and usage patterns of shared peripherals.
Multi-Player Game Reports: For competitive or cooperative game modes, specific reports on scores, team contributions, and resulting payouts may be generated.

All stored data is maintained in non-transient memory with appropriate security measures, including access controls, encryption, and audit trails, to ensure data integrity and compliance with financial and privacy regulations.

### Error Handling and Security Measures:

In at least one embodiment, managing multiple concurrent games and potentially multiple players on a single EGM with shared hardware necessitates robust error handling and security measures.

### Error Handling:

Game Session Isolation: If an error occurs within one game instance (e.g., a software fault in one Game Logic Engine), the system is designed to isolate this error to the affected game segment, preventing it from crashing or impacting other concurrently running game sessions on the same EGM.
Input Processing Errors: The system includes logic to correctly attribute touch inputs to the intended game segment, especially on a busy segmented touchscreen. Mechanisms to handle ambiguous or overlapping touches, or to recalibrate touch sensitivity, may be implemented. This addresses part of the “Segmented Touchscreen Logic” disclosure gap.
Shared Peripheral Conflicts: If multiple sessions attempt to use a shared peripheral (e.g., the printer 136) simultaneously, a queuing or arbitration logic within the Game Management System manages these requests sequentially, providing appropriate feedback to the players.
Transaction Errors: Errors in financial transactions with virtual meters (e.g., failure to communicate with the First Server System) are handled gracefully, with attempts to retry, void the transaction, or alert casino staff, ensuring that player balances and regulatory meters remain accurate.
Data Synchronization Failures: If synchronization between a virtual meter and the unified regulatory meter, or between a virtual meter and a player account, encounters issues, alerts are generated, and reconciliation procedures are initiated.

### Security Measures:

Secure Segmentation: The software ensuring touchscreen segmentation and independent input processing for different game UIs may be robust to prevent any cross-segment interference or unauthorized access to another game's controls or data.
Virtual Meter Integrity: Each virtual meter, managed by the First Server System, is secured to prevent unauthorized adjustments. All transactions affecting a virtual meter are authenticated and logged.
Player Session Security: In multi-player scenarios, the system ensures that each player's session, data, and funds are kept separate and secure from other players using the same EGM. This includes secure authentication via the single player tracking reader 138 and association with the correct virtual meter.
Shared Hardware Security: The single bill acceptor 128, printer 136, and player tracking reader 138 are hardened against tampering and unauthorized access. Communications related to these devices are secured.
Regulatory Compliance: The integrity of the data feeding into the unified regulatory meter from the multiple virtual meters is paramount. Secure aggregation processes and audit trails ensure that all financial activity is accurately reported.
Software Updates and Integrity: Secure mechanisms are used for updating game software and the EGM's operating system to prevent the introduction of malicious code that may compromise game integrity or financial security.

These measures collectively ensure that the complex operations of a multi-game, multi-player EGM remain stable, fair, and secure.

### Integrated EGM-Level Anti-Money Laundering (AML) Monitoring

In at least one embodiment, the VCLAPS! Electronic Gaming Machine (EGM) system incorporates integrated Anti-Money Laundering (AML) monitoring mechanisms directly within the physical EGM itself or in close conjunction with the First Server System managing the EGM's virtual meters. This novel element focuses on performing real-time or near real-time analysis of player behavior and financial transactions—such as cash-ins, bet patterns, and cash-outs—occurring at that specific EGM. The system leverages the granular data available from the individual virtual meters associated with each game session or player, as well as data from the EGM's transaction peripherals. The core purpose is to identify and flag suspicious activities indicative of potential money laundering at their point of origin, providing a more immediate layer of security and compliance compared to relying solely on broader, centralized casino-wide AML systems.

The practical application of this integrated EGM-level AML monitoring is the enhanced security and more rapid identification and potential interdiction of illicit financial activities directly at the gaming terminal. By processing transactional and gameplay data against predefined AML rules and patterns, the EGM may detect anomalies and generate alerts promptly. This localized detection capability, tightly coupled with the EGM's transactional systems and the detailed data from virtual meters, offers a significant improvement in the casino's ability to meet regulatory AML obligations. The system is computer-integral, utilizing the EGM's processing capabilities and memory, potentially augmented by the First Server System, to execute the AML analysis. This represents a technological improvement to EGM functionality, addressing the specific problem of timely AML detection at the individual machine level.

### Sequence Diagram Components:

In at least one embodiment, the components involved in the integrated EGM-level AML monitoring include the Player, the Physical EGM (equipped with an AML monitoring module), Virtual Meters, the First Server System, and potentially a Casino AML Compliance System or Security Personnel.

The Player is the individual whose transactional and gameplay behavior at the EGM is being monitored.

The Physical EGM is the terminal where transactions occur. It contains an integrated AML monitoring module (software, potentially utilizing dedicated hardware resources) that accesses data from its peripherals (e.g., bill validator 128, cash dispenser 137) and from the virtual meters.

Virtual Meters, managed by the First Server System, provide granular financial data for each game session or player on the EGM, including bets, wins, and credit flow. This data is a notable input for the AML monitoring module.

The First Server System may work in close conjunction with the EGM's AML module by providing necessary data from virtual meters, player account information, or even by performing parts of the AML analysis based on data relayed from the EGM. It may also receive alerts from the EGM.

The Casino AML Compliance System or authorized Security Personnel are the recipients of alerts or reports generated by the EGM-level AML system when suspicious activity is detected, allowing for further investigation or intervention.

### Implementation Details:

In at least one embodiment, the EGM-level AML monitoring system is implemented as a software module running on the EGM's processor or on the First Server System in close communication with the EGM. This module has access to real-time data streams from various EGM sources:
Transaction Peripherals: Data from the bill validator 128 (cash-in amounts, denomination, frequency), ticket reader 224 (TITO ticket information), and cash dispensing device 137 (cash-out amounts, frequency).
Virtual Meters: Detailed financial flow for each player/session, including amounts wagered, win/loss patterns, and velocity of funds through the virtual meter.
Player Tracking System: If a player card is used, data such as player identity, historical play, and known risk profiles may be factored in.
Game Activity Data: Information about the games played, session duration, bet sizes relative to game volatility, and patterns of play (e.g., minimal play).

The AML module employs a rule engine and pattern recognition algorithms to analyze this data against a configurable set of AML rules, thresholds, and known suspicious activity indicators. These rules may address scenarios such as:
Structuring: Multiple small cash-ins or cash-outs designed to stay below reporting thresholds.
Minimal Play/Money Cycling: Large cash-ins followed by minimal or no gameplay, then a large cash-out.
Rapid Velocity of Funds: Quick turnover of funds through the EGM with little legitimate gaming activity.
Unusual Transaction Sizes: Transactions significantly deviating from the player's established betting patterns or typical EGM usage.
Use of Multiple Accounts/Cards: (If detectable at the EGM level) attempts to use different player cards or payment methods in a coordinated suspicious manner. This addresses the disclosure gap regarding AML algorithms by outlining the types of data analyzed and the nature of the rules applied.

Upon detection of a transaction or behavior pattern that breaches a predefined rule or threshold, the AML module generates an alert. This alert is logged locally on the EGM and/or transmitted securely to the First Server System and/or a centralized Casino AML Compliance System. The alert may contain details of the player (if known), EGM ID, timestamp, specific activity flagged, and the AML rule triggered. Depending on the severity and casino policy, the EGM may also be programmed to take automated actions, such as temporarily suspending further transactions pending review by casino staff, or displaying a message requesting the player to see an attendant.

### Example Walk-Through Scenario:

In at least one embodiment, a player approaches a VCLAPS! EGM and initiates a session by inserting a player tracking card. The player then inserts $3000 in $20 bills into the EGM's bill validator 128 over a short period, in multiple small deposits (e.g., six separate insertions of $500). This cash-in activity is recorded by the EGM and associated with the player's active virtual meter, managed by the First Server System.

The player then proceeds to play a slot game, making only a few small wagers (e.g., $1 per spin for 10 spins, totaling $10 wagered). After approximately five minutes of such minimal play, the player attempts to cash out $2980 from the EGM.

The EGM's integrated AML monitoring module, which is continuously analyzing transaction data from the bill validator 128 and the virtual meter associated with this player's session, detects this sequence of events: multiple small cash-ins accumulating to a significant sum, followed by very low gameplay relative to the deposited amount, and then an attempt to cash out nearly the entire sum. This pattern matches a predefined AML rule for “potential structuring and money cycling.”

The EGM's AML module immediately generates an internal flag and transmits an alert to the casino's central AML compliance system via the First Server System or a direct network connection. The alert includes the EGM ID, player ID, details of the cash-in transactions, the minimal play observed, and the pending cash-out request. Casino policy may then dictate that the EGM temporarily suspends the cash-out and displays a message asking the player to wait for assistance. A floor attendant or security personnel, notified by the central AML system, would then approach the player and EGM to assess the situation further, potentially requesting additional information from the player or escalating the review. All these events are logged by the EGM and the server systems for audit and reporting purposes.

### Player Interaction:

In at least one embodiment, the EGM-level AML monitoring is designed to be largely transparent to players engaging in legitimate gameplay and transactions. There are typically no specific UI elements for the player to interact with regarding the AML system itself.

However, if the AML module flags a transaction or activity as suspicious, player interaction may be indirectly affected based on the casino's predefined response protocols. For instance:
Delayed Transaction: The EGM interface may display a message such as, “Transaction is being processed, please wait,” or “Assistance is required to complete this transaction. Please wait for a casino attendant.” This indicates that the transaction has been flagged and may require further review or authorization before it may proceed or be denied.
Attendant Intervention: An alert generated by the EGM may summon a casino employee (floor attendant, security, or compliance officer) to the EGM to speak with the player, verify their identity, or inquire about the nature of their transactions.
Transaction Limits or Suspension: In certain high-risk scenarios, the EGM may automatically impose temporary limits on further transactions or suspend certain functionalities for that player session pending review, with appropriate messaging provided on the display.

The primary interaction related to AML is thus not direct player control over the AML system, but rather the system's potential to interrupt or modify the normal flow of transactions or gameplay if suspicious activity is detected, and the subsequent interaction with casino staff that this may trigger.

### Distinguishing Novel Elements:

The integration of AML monitoring mechanisms directly within the physical EGM, or in close conjunction with the First Server System managing that EGM's granular virtual meters, presents several distinguishing novel elements compared to conventional AML systems in casinos:
1. Point-of-Origin Monitoring: Unlike traditional AML systems that often operate at a centralized, casino-wide backend level and may analyze data retrospectively or with some delay, this inventive concept enables AML analysis to occur directly at the EGM where the transactions and gameplay originate. This allows for more immediate detection of suspicious activities as they unfold.
2. Leveraging Granular Virtual Meter Data: The system utilizes the detailed, real-time data available from individual virtual meters associated with each specific game session or player on that EGM. This granular data (e.g., precise flow of funds into a game, wagers, wins, transfers between game types on the EGM, cash-outs from a specific session's balance) provides a richer dataset for identifying subtle suspicious patterns compared to systems relying solely on aggregated EGM totals or less frequent player account activity summaries.
3. Real-Time or Near Real-Time Analysis and Alerting: The processing of this granular data against predefined AML rules and patterns occurs in real-time or near real-time at the EGM level or via the closely coupled First Server System. This allows for immediate flagging of suspicious activities, rather than waiting for batch processing or end-of-day analysis.
4. Localized Detection Capability: This approach offers a more immediate and localized layer of security and compliance. It may pinpoint suspicious behavior to a specific EGM and session, facilitating quicker investigation and intervention if necessary.

While casinos universally employ AML systems, one aspect of novelty lies in embedding this intelligence directly into the EGM's operational logic and leveraging the specific data structures of the dual-architecture metering system (i.e., the virtual meters) to enhance the timeliness and specificity of AML detection at the individual terminal level.

### Technical Improvements to Existing Technical Problems:

The integrated EGM-level AML monitoring system provides specific technical improvements to address existing problems in casino AML compliance and security.

One primary technical problem is the latency in detecting suspicious activities when relying solely on centralized, backend AML systems. Such systems often analyze data after it has been aggregated or batched, leading to delays between the occurrence of a suspicious transaction and its detection. The VCLAPS! EGM-level AML monitoring solves this by performing real-time or near real-time analysis directly at the point of transaction and gameplay. This immediate processing capability is a significant technical improvement, enabling more rapid alerts and interventions, potentially preventing further illicit activity.

Another problem is the lack of granular data context in some centralized AML systems. While casino-wide systems monitor overall player accounts, they may not have immediate access to the specific nuances of a player's interaction with a particular EGM in real-time, such as the flow of funds through virtual meters for distinct concurrent game sessions, the types of bets being made, or the speed of play relative to deposits on that machine at that moment. The integrated EGM AML leverages the detailed data from its virtual meters and direct observation of gameplay and peripheral interactions, providing a richer, more contextualized dataset for identifying suspicious patterns that may be obscured in aggregated data. This enhances the accuracy and sensitivity of the detection algorithms. This is a technological improvement to the EGM's computing function, enabling it to perform sophisticated local data analysis for security purposes.

Furthermore, by flagging suspicious activities directly at the EGM, the system improves the efficiency of casino security responses. Alerts may pinpoint the exact terminal and session, allowing for targeted investigation by floor staff or security personnel. This is more efficient than investigating alerts generated from aggregated data which may require more extensive cross-referencing to locate the source.

The system also enhances regulatory compliance capabilities. By providing an additional, immediate layer of AML scrutiny at the transactional level within the EGM, casinos may demonstrate a more proactive and robust approach to fulfilling their AML obligations. The ability to log and report these EGM-level detections provides valuable data for compliance audits. This proactive, localized monitoring capability represents a tangible improvement to the technical means by which casinos manage AML risks.

### Data Input:

In at least one embodiment, the integrated EGM-level AML monitoring system utilizes a variety of data inputs originating from player interactions and EGM operations:
Financial Transaction Data:
   Cash-in amounts, denominations, and timestamps from the EGM's bill validator 128 and/or ticket reader 224.
   Cash-out amounts and timestamps from the EGM's cash dispensing device 137 or ticket printer 136.
   Fund transfer details to/from linked player casino accounts, if the EGM is used as an ATM (as in Novel Element 2).
Virtual Meter Data: Real-time data from each active virtual meter associated with game sessions on the EGM, including:
   Amounts wagered.
   Amounts won.
   Credit balance changes.
   Velocity of funds (rate of deposits, wagers, withdrawals within the session).
Gameplay Behavior Data:
   Session duration.
   Game(s) selected and played.
   Betting patterns (e.g., consistency of bet size, changes in betting strategy, max betting).
   Rate of play (e.g., number of spins or hands per unit of time).
   Ratio of gameplay to amount deposited (e.g., minimal play detection).
Player Identification Data (if available):
   Information from the player tracking card reader 138, linking the session to a specific player profile. This may include historical player data or risk scores if accessible by the EGM or First Server System.
EGM Configuration Data:
   Denomination of the EGM.
   Game types and volatility being played.
Predefined AML Rules and Thresholds: These are system inputs, configured by the casino, against which the transactional and behavioral data are compared. Examples include maximum cash-in per transaction/session before alert, minimum play-through percentage, unusual sequences of transactions.

These diverse data inputs are continuously fed into the EGM's AML monitoring module for real-time analysis.

### Component Interactions and Procedural Steps:

In at least one embodiment, the integrated EGM-level AML monitoring involves the following component interactions and procedural steps:
1. Data Collection:
   The EGM's operating system and game management software continuously collect data from its peripherals: the bill validator 128 captures cash-in details, the player tracking reader 138 captures player ID, and game applications report bets, wins, and game choices.
   This data, along with transaction details from the virtual meters (managed by the First Server System or locally by the EGM for session tracking), is fed to the EGM's integrated AML Monitoring Module.
2. Real-Time Analysis by AML Monitoring Module:
   The AML Monitoring Module, residing on the EGM or working in close conjunction with the First Server System, processes the incoming data in real-time or near real-time.
   It compares observed transaction patterns, fund velocity, and gameplay behavior against a predefined set of AML rules and suspicious activity signatures stored within its configuration. This may involve sequence analysis, threshold comparisons, and behavioral analytics.
3. Suspicious Activity Detection:
   If a rule is breached or a suspicious pattern is matched (e.g., a player makes multiple cash deposits just below a certain threshold, plays minimally, and then attempts a large cash-out), the AML Monitoring Module flags the activity.
4. Alert Generation and Logging:
   Upon flagging an activity, the AML Monitoring Module generates an alert.
   Details of the flagged activity, the specific AML rule(s) triggered, player information (if available), EGM ID, and timestamp are logged securely, often both locally on the EGM (for immediate reference or if network is down) and transmitted to the First Server System or a central Casino AML Compliance System.
5. Notification and Reporting:
   The generated alert is communicated to the designated casino system or personnel according to casino policy. This may be an automated notification to a central security console, an email/SMS to a compliance officer, or an on-screen prompt for floor staff.
   The system may compile reports of flagged activities for regulatory review and internal investigation.
6. Potential Automated EGM Actions (Optional, based on Casino Policy):
   Depending on the severity of the flagged activity and casino configuration, the EGM may be instructed by the AML module or central system to take certain actions, such as temporarily suspending the transaction, disabling further cash-ins/cash-outs for the session, or displaying a message requiring attendant intervention.
7. Continuous Monitoring:
   The AML monitoring process continues for the duration of the player's session(s) on the EGM.

This sequence ensures that potential money laundering activities are identified promptly at the EGM level, allowing for timely responses.

### Data Processing:

In at least one embodiment, the data processing for EGM-level AML monitoring involves several notable tasks performed by the EGM's processor, potentially assisted by the First Server System.
1. Data Aggregation and Normalization: The AML module receives raw data from various EGM sources: cash-in events from the bill validator 128, cash-out events from the dispenser 137, wager and win data from the active virtual meter(s), session start/end times, and player ID from the player tracking reader 138. This data is aggregated for the current session(s) on the EGM and normalized into a consistent format suitable for analysis.
2. Feature Extraction: From the aggregated and normalized data, relevant features are extracted. These features may include:
   Total cash-in amount within a defined period.
   Frequency and denomination of bills inserted.
   Total wagered amount.
   Win-to-wager ratio.
   Play duration versus deposited amount.
   Velocity of funds (e.g., time between large deposit and attempted withdrawal).
   Comparison of current session activity with historical player patterns (if player ID is available and historical data is accessible).
3. Rule-Based Evaluation: The extracted features are evaluated against a predefined set of AML rules and thresholds. These rules are typically configurable by the casino operator to align with regulatory requirements and internal risk policies. For example, a rule may be: “IF total_cash_in >$X AND total_wagered<Y % of total_cash_in AND cash_out_attempted>Z % of total_cash_in THEN flag as ‘Minimal Play/Potential Cycling’.” This directly addresses the disclosure gap for “AML Algorithms” by specifying the nature of processing.
4. Pattern Recognition: More sophisticated processing may involve pattern recognition algorithms (e.g., sequence analysis, anomaly detection) to identify complex behaviors that may not be caught by simple threshold rules but are indicative of known money laundering typologies.
5. Risk Scoring (Optional): Some implementations may assign a risk score to a session or a series of transactions based on the number and severity of triggered rules or matched patterns.
6. Alert Generation Logic: If the rule-based evaluation or pattern recognition identifies a high-risk activity or a clear rule breach, the data processing logic triggers the generation of an alert. This involves formatting the alert message with relevant details for investigators.
7. Logging: All processed data, rule evaluations, and generated alerts are meticulously logged for audit and compliance purposes.

This processing occurs in real-time or near real-time to ensure timely detection. The computational load may be handled by the EGM's main CPU or a dedicated co-processor, or offloaded to the First Server System if the analysis is complex and may require more resources or access to broader datasets like cross-EGM player activity.

### Outputs and Responses:

In at least one embodiment, the integrated EGM-level AML monitoring system generates specific outputs and responses when suspicious activity is detected or for routine logging:

### Internal System Outputs:

Flags: The AML module internally flags transactions or player sessions that meet predefined criteria for suspicious activity. These flags are associated with the transaction/session data in internal logs.
Detailed Log Entries: For every analyzed event or period, and especially for flagged activities, the system generates detailed log entries. These logs include timestamp, EGM ID, player ID (if available), specific transaction details (amounts, types), the AML rule(s) or pattern(s) triggered, and any risk score assigned.

### Outputs to Casino Personnel/Central Systems:

Real-Time Alerts: When a high-priority suspicious activity is detected, the system generates and transmits a real-time alert. This alert may be sent to:
   A central casino AML compliance system or monitoring dashboard.
   Designated security or surveillance personnel via notifications (e.g., SMS, email, on-screen pop-up at a security station).
   Floor staff via mobile devices or prompts on attendant workstations.
Reports of Flagged Activities: The system may compile reports of all flagged activities over a specified period for review by compliance officers or for investigation purposes. These reports may be generated on demand or automatically.
Data for Suspicious Activity Reports (SARs): The detailed logs and flagged activity reports provide desirable information for the casino to fulfill its regulatory obligation of filing SARs with financial intelligence units when necessary.
   Responses from the EGM (Potentially, Based on Casino Policy):
Transaction Hold/Delay: The EGM may temporarily hold a suspicious transaction (e.g., a large cash-out after minimal play) and display a message to the player indicating a processing delay or the need for attendant assistance.
Session Review Prompt: The EGM may prompt an attendant to review the session before further significant transactions are permitted.
Disabling Certain Functions: In extreme cases, certain EGM functions (e.g., cash acceptance, cash dispensing) may be temporarily disabled for the session until reviewed.

These outputs and responses are designed to ensure that suspicious activities are not only detected promptly at the EGM level but also communicated effectively to the appropriate channels for action and compliance.

Data Storage and Reporting: In at least one embodiment, data related to the integrated EGM-level AML monitoring is meticulously stored and available for reporting.

### Data Storage:

EGM Local Storage: The EGM may store a temporary or rolling log of transaction data, AML analysis results, and any alerts generated locally. This ensures some level of data persistence even during transient network outages and allows for quick access for immediate EGM-specific diagnostics. This storage is non-transient but may be of limited capacity.
First Server System/Central AML Database: The primary and long-term storage for AML-related data typically resides on the First Server System or a dedicated central AML database. This database securely stores:
   Detailed logs of all financial transactions and significant gameplay events from EGMs that are processed by the AML system.
   Records of all AML alerts generated, including the EGM ID, player ID (if available), timestamp, specific activity flagged, AML rule(s) triggered, and any associated risk scores.
   Configuration of AML rules, thresholds, and watchlists used by the EGMs.
   Audit trails of AML system operations, rule changes, and alert investigations.
Player Tracking Database: Information relevant to player risk profiling, which may be used as input to the AML system, is stored here. Conversely, AML flags related to a player may be linked back to their profile.

### Reporting:

Suspicious Activity Alerts/Notifications: Real-time or near real-time reports (alerts) are generated and sent to designated personnel or systems when high-risk activity is detected.
Shift/Daily/Periodic AML Reports: The system may generate periodic reports summarizing flagged activities, transaction volumes, and AML system performance for review by casino compliance officers.
Investigative Reports: Authorized personnel may query the AML database to generate detailed reports on specific players, EGMs, or types of transactions to support investigations into flagged activities.
Regulatory Compliance Reports: Data collected and flagged by the EGM-level AML system provides important input for Suspicious Activity Reports (SARs) that casinos are often required to file with financial regulatory bodies. The system may facilitate the compilation of data needed for these official reports.
Audit Reports: Reports may be generated to audit the functioning of the AML system itself, including rule applications and alert dispositions.

All data is stored securely with access controls, encryption, and measures to ensure data integrity and compliance with data privacy and retention regulations.

### Error Handling and Security Measures:

In at least one embodiment, the integrated EGM-level AML monitoring system incorporates robust error handling and security measures to ensure its reliability, accuracy, and integrity.

### Error Handling:

Data Input Validation: The system validates incoming data from EGM peripherals and virtual meters to ensure it is complete and in the correct format before processing for AML analysis. Corrupted or missing data may trigger an error log or alert.
AML Rule Engine Errors: If the AML rule engine encounters an issue (e.g., misconfiguration, software bug), it is designed to log the error, potentially revert to a safe state (e.g., more stringent monitoring or default flagging), and alert system administrators.
Communication Failures: If the EGM cannot communicate alerts or data to the First Server System or central AML system (e.g., due to network issues), it will securely log alerts locally. Mechanisms for queued transmission and reconciliation upon network restoration are implemented.
False Positive Management: While not strictly an “error,” the system aims to minimize false positives (incorrectly flagging legitimate activity). This is managed through careful calibration of AML rules, thresholds, and ongoing review and refinement of the detection algorithms. Feedback mechanisms may allow investigators to mark alerts as false positives, which may be used to tune the system.

### Security Measures:

AML System Integrity: The AML software module on the EGM and any associated server components are protected against unauthorized access, modification, or tampering. This may involve code signing, secure boot processes for the EGM, and restricted access to AML rule configurations.
Data Confidentiality: Sensitive data processed by the AML system (player information, transaction details, AML rules) is protected through encryption, both in transit between the EGM and servers, and at rest in databases.
Secure Alert Transmission: Alerts containing potentially sensitive information about suspicious activities are transmitted over secure, encrypted channels to authorized personnel or systems.
Access Controls: Access to AML system configurations, logs, and alert management interfaces is strictly controlled through role-based access permissions and strong authentication mechanisms.
Audit Trails: Comprehensive audit trails are maintained for all actions performed within the AML system, including rule changes, alert acknowledgments, and investigation notes. This ensures accountability and supports regulatory review.
Resilience to Tampering: The system is designed to be resilient to attempts to bypass AML checks. For example, unusual EGM resets or attempts to interfere with logging mechanisms may themselves trigger alerts.

These error handling and security measures are important for maintaining the effectiveness of the EGM-level AML monitoring system and ensuring compliance with legal and regulatory standards.

### Physical EGM as a Personal Atm for Player Tracking Accounts

In at least one embodiment, the VCLAPS! Electronic Gaming Machine (EGM) system introduces the functionality of the physical EGM serving as a personal Automated Teller Machine (ATM) for a player's specific casino tracking account. This capability is a specific application of the dual-architecture metering system described in Novel Element 1. It allows players to perform direct financial transactions, such as deposits to and withdrawals from their individual casino player accounts, using the EGM's existing cash handling peripherals, potentially independent of immediate wager-based gaming activity on that EGM. The core purpose is to enhance the EGM's utility beyond a mere gaming interface, transforming it into a versatile financial interaction point for the player within the casino environment, thereby offering a novel level of user convenience and an improved operational capability for the casino.

The practical application of this novel element lies in providing players with seamless and integrated access to their casino funds directly at the EGM, for actions such as adding funds to their player account from cash inserted at the EGM, or cashing out funds from their player account to physical cash dispensed by the EGM. This system relies on secure communication between the EGM, the first server system (akin to a Player Tracking server, as detailed in Novel Element 1) that manages player accounts and virtual meters, and the EGM's validation and cash dispensing peripherals. This functionality represents a technological improvement to conventional EGMs by integrating personal banking-like features for casino accounts directly into the gaming machine, addressing the problem of players needing to visit separate ATM kiosks or casino cages for such transactions. The system is computer-integral, utilizing processors and memory in the EGM and server systems to manage these financial operations securely and efficiently.

### Sequence Diagram Components:

In at least one embodiment, the components involved in the EGM functioning as a personal ATM for player tracking accounts include the Player, the Physical EGM, the First Server System (e.g., Player Tracking Server), and a Player Account Database.

The Player is the individual initiating financial transactions with their casino tracking account via the EGM.

The Physical EGM is the device providing the interface for these transactions. It is equipped with a user interface (e.g., touchscreen display 116), a credit input device (e.g., bill validator 128, 234, 601 or ticket reader 224), a cash dispensing device 137, 602, and a player tracking card reader 138, 230, 326. The EGM communicates player requests and transaction details to the First Server System.

The First Server System is the central component managing the player's casino tracking account and the associated virtual meters at the EGM. It processes transaction requests, authorizes deposits and withdrawals, and instructs the EGM regarding fund handling.

The Player Account Database is a data store, managed by or accessible to the First Server System, which holds the details of player casino tracking accounts, including balances and transaction histories.

### Implementation Details:

In at least one embodiment, the implementation of the EGM as a personal ATM for player tracking accounts leverages the dual-architecture metering system. The EGM is equipped with necessary hardware such as a bill validator (also referred to as a credit input device or currency acceptor) 128, 234, 601, a cash dispensing device 137, 602, a player tracking card reader 138, 230, 326, and a secure processing unit. The player initiates an ATM-like transaction by first identifying themselves, typically by inserting their player tracking card into the player tracking reader 138.

For a deposit transaction into the player's casino account via the EGM, the player inserts cash or a validated ticket into the EGM's credit input device. The EGM securely communicates the transaction details (e.g., player ID, amount) to the First Server System. The First Server System, upon validating the transaction and player, processes this by initiating a credit to the player's casino account stored in the Player Account Database and may update a corresponding virtual meter on the EGM if the funds are to be made available for play.

For a withdrawal transaction from the player's casino account via the EGM, the player uses the EGM's interface to request a specific amount. The EGM transmits this request to the First Server System. The First Server System verifies the player's identity and checks the available balance in their casino account. If funds are sufficient and the transaction is authorized, the First Server System initiates a debit from the player's casino account and sends an instruction to the EGM. The EGM's cash dispensing device 137 then dispenses the authorized amount of physical cash to the player. The corresponding virtual meter, if active for the session, is also updated.

Security is a paramount concern for this functionality. Player authentication at the EGM is an important step and may involve the player tracking card in combination with a PIN entered on a touchscreen or keypad, or potentially biometric verification if the EGM is so equipped (e.g., camera 127, 640, 950, 1062 or other sensors 638, 1060). All communications between the EGM and the First Server System concerning these financial transactions are encrypted using robust security protocols to protect sensitive data such as account numbers, balances, and transaction amounts. The EGM's cash handling peripherals (bill validator 128, cash dispensing device 137) are themselves hardened secure modules. Transaction logging occurs both at the First Server System (for player account records) and potentially at the EGM and a Second Server System (for regulatory meter aggregation and auditing). This addresses the disclosure gap concerning EGM as ATM security. These transactions may occur independent of immediate wager-based gaming activity.

### Example Walk-through Scenario:

In at least one embodiment, a player, Alice, approaches a VCLAPS! EGM. Alice wishes to withdraw funds from her casino player tracking account. She inserts her player tracking card into the EGM's player tracking card reader 138. The EGM's touchscreen display 116 then presents her with several options, including “Play Games” and “Access My Casino Account.” Alice selects “Access My Casino Account.”

The EGM prompts Alice for her PIN, which she enters via the touchscreen. The EGM transmits the card data and PIN to the First Server System for authentication. Upon successful authentication, the First Server System allows access. Alice then selects an option such as “Withdraw Funds from Account.” She is prompted to enter the amount she wishes to withdraw, say $100. She enters “100” using the touchscreen interface.

The EGM sends this withdrawal request to the First Server System. The First Server System checks Alice's player account balance in the Player Account Database. Assuming Alice has sufficient funds, the First Server System authorizes the withdrawal, debits $100 from her casino account, and sends a command to the EGM. The EGM's cash dispensing device 137 then dispenses $100 in cash to Alice. The EGM's display confirms the transaction and may show her remaining player account balance if configured to do so. Alice collects her cash and her player tracking card. This transaction occurred using the EGM as an ATM for her casino account, distinct from initiating a gaming session, although she may subsequently choose to play a game.

Alternatively, if Alice wanted to deposit $50 cash into her player account, after authenticating, she would select “Deposit to Account.” The EGM would instruct her to insert cash into the bill validator 128. She inserts a $50 bill. The bill validator 128 validates the bill and the EGM informs the First Server System. The First Server System credits Alice's casino account with $50 and confirms the transaction on the EGM display.

### Player Interaction:

In at least one embodiment, the player interacts with the EGM's ATM functionality primarily through its touchscreen display 116 and physical input devices such as the player tracking card reader 138, bill validator 128 (credit input device), and cash dispensing device 137.

Upon inserting their player tracking card, the player is typically presented with a menu on the touchscreen. This menu includes options for standard gameplay and specific options related to their casino player account, such as “Account Deposit,” “Account Withdrawal,” or “Account Balance Inquiry” (if supported).

To perform a deposit into their account, the player selects the deposit option, confirms their identity (e.g., via PIN entry on the touchscreen), and is then instructed by the EGM interface to insert cash into the bill validator 128 or a ticket into the ticket reader 224. The interface provides feedback on the amount inserted and confirms when the deposit to their player account is successful.

To perform a withdrawal from their account, the player selects the withdrawal option, authenticates, and then enters the desired withdrawal amount using a virtual keypad on the touchscreen. The EGM interface displays the transaction status (e.g., “Processing,” “Approved,” “Dispensing Cash”) and confirms completion. The physical cash is then collected from the EGM's cash dispensing device 137.

System feedback is provided visually on the touchscreen display 116, including prompts for action, confirmation messages, error messages (e.g., “Insufficient Funds,” “Transaction Failed”), and updated balance information if configured. Physical feedback includes the acceptance of cash/tickets by input devices and the dispensing of cash by the output device. This interaction model is designed to be intuitive, mimicking familiar ATM operations but integrated within the EGM environment.

### Distinguishing Novel Elements:

The functionality of a physical EGM serving as a direct, transactional ATM for a player's specific casino tracking account is a novel element, representing a specific application of the dual-architecture metering system. While ATMs for general cash access are ubiquitous and EGMs are designed for wagering, and player tracking accounts manage loyalty and credit, the inventive concept lies in the convergence of these functions within the EGM itself.

Notable distinguishing aspects include:
1. Direct Access to Specific Casino Tracking Account: The EGM facilitates deposits directly into and withdrawals directly from a player's individual casino tracking account, which is distinct from the EGM's operational funds or a mere temporary credit balance on the machine. This is different from generic cash ATMs or systems that only allow fund transfers to an EGM solely for immediate gameplay.
2. Independence from Immediate Wagering: These ATM-like transactions (deposits to/withdrawals from the player account) may be performed at the EGM independent of any requirement to immediately engage in wager-based gaming activity on that EGM.
3. Integrated EGM Peripherals for Account Transactions: The EGM's own credit input device (e.g., bill validator 128) and cash dispensing device 137 are utilized for these player account transactions, rather than requiring the player to move to a separate ATM kiosk or cashier.
4. Facilitation by Dual-Architecture Metering and Server Linkage: This ATM functionality is specifically enabled by the interaction between the EGM, the distinct virtual meter associated with the player's session (if applicable during the transaction), and the First Server System (e.g., PT Server) which manages the player's casino account. This system architecture allows for the EGM to act as a secure conduit to the player's main casino funds.

This transforms the EGM into a more versatile financial interaction point within the casino, enhancing its utility beyond just a gaming interface and offering a level of convenience not provided by conventional systems that separate these financial account management functions from the gaming machine itself.

### Technical Improvements to Existing Technical Problems:

The functionality of a physical EGM as a personal ATM for player tracking accounts provides significant technical improvements and solutions to existing problems in casino operations and player experience.

One existing problem is the fragmented access to casino funds. Players often need to visit a separate ATM kiosk for cash or the casino cage to deposit or withdraw funds from their player account, creating an interruption in their experience and potential queues. The VCLAPS! EGM addresses this by integrating these ATM-like functions directly into the gaming machine. This provides a specific technological improvement to EGM functionality by making it a multi-purpose terminal, allowing players to manage their casino account funds at the same physical location where they play games. This enhances convenience and reduces friction for the player.

Another technical problem is the limited utility of EGMs beyond direct gameplay wagering. Conventional EGMs are primarily wagering instruments. The disclosed system improves the EGM's computer functionality by enabling it to perform secure, direct financial transactions with a player's distinct casino account, controlled and audited by the First Server System. This broadens the EGM's role in the casino ecosystem.

The technical solution involves a specific configuration of the EGM's hardware (cash validator 128, dispenser 137, player tracking reader 138) and software, in secure communication with the First Server System that manages player accounts. This server-mediated approach ensures that transactions are validated, account balances are accurately updated, and security is maintained, which is an improvement over simply using an EGM as a pass-through for unverified cash to play. The system's ability to handle deposits to and withdrawals from a player's broader casino account balance, not just loading credits for play, represents a specific improvement in how EGMs manage and interact with player funds. This integration of transactional capabilities for distinct player accounts directly at the EGM provides a more efficient, secure, and convenient financial service for casino patrons, improving the overall technical capabilities of the gaming machine itself.

### Data Input:

In at least one embodiment, for the EGM to function as a personal ATM for player tracking accounts, several types of data are inputted into the system:
Player Identification Data: This is typically input via the EGM's player tracking card reader 138 when the player inserts their casino-issued player card. This data uniquely identifies the player and allows the system to access their specific casino tracking account.
Authentication Data: To secure transactions, additional authentication data may be required from the player, such as a Personal Identification Number (PIN) entered via the EGM's touchscreen interface or a keypad, or biometric data if the EGM is equipped with corresponding sensors (e.g., fingerprint scanner, camera 127 for facial recognition).
Transaction Type Selection: The player inputs their desired transaction type (e.g., “Deposit to Account,” “Withdraw from Account”) via the EGM's user interface, typically a touchscreen 116.
Transaction Amount: The player inputs the specific monetary amount for the deposit or withdrawal using a virtual keypad or selection options on the EGM's touchscreen.
Physical Currency/Ticket Input (for Deposits): For deposits into a player account via the EGM, physical cash is inserted into the EGM's bill validator 128 or a cash-out ticket is inserted into the ticket reader 224. The EGM's peripherals read and validate this input.

These data inputs are processed by the EGM and communicated securely to the First Server System to facilitate the requested financial transaction with the player's casino tracking account.

### Component Interactions and Procedural Steps:

In at least one embodiment, the EGM functions as a personal ATM through a series of interactions between the player, the EGM, the First Server System, and the Player Account Database.
1. Player Authentication: The Player inserts their player tracking card into the EGM's player tracking card reader 138. The EGM may prompt for a PIN or other authentication via its touchscreen interface 116. This data is sent from the EGM to the First Server System for verification against the Player Account Database.
2. Transaction Selection: Upon successful authentication, the Player selects an ATM-type transaction (e.g., “Deposit to Account” or “Withdraw from Account”) and specifies an amount via the EGM's touchscreen interface.
3. Deposit Process:
   If “Deposit to Account” is selected, the EGM instructs the Player to insert cash/ticket into the credit input device (e.g., bill validator 128).
   The EGM validates the input and communicates the amount and player details to the First Server System.
   The First Server System processes this by updating the Player's casino account in the Player Account Database with the deposited amount and confirms success to the EGM, which then informs the Player. A virtual meter at the EGM may also be updated.
4. Withdrawal Process:
   If “Withdraw from Account” is selected, the EGM sends the request (player ID, amount) to the First Server System.
   The First Server System checks the Player's account balance in the Player Account Database. If sufficient funds exist, it debits the Player's casino account and sends an authorization command to the EGM.
   The EGM, upon receiving authorization, instructs its cash dispensing device 137 to dispense the requested cash amount to the Player.
   The EGM confirms cash dispensation to the First Server System, and the Player is notified via the EGM interface. A virtual meter at the EGM may be updated.
5. Logging: The First Server System logs the transaction details in the Player Account Database and associated systems. The EGM may also log the transaction locally, and data related to the transaction is provided for aggregation into the unified regulatory meter.

These interactions are secured through encrypted communication channels and authentication protocols to ensure the integrity and confidentiality of financial transactions.

### Data Processing:

In at least one embodiment, when the EGM functions as a personal ATM for player tracking accounts, several data processing tasks are performed by the EGM and the First Server System.

The EGM processes inputs from the player, such as card data from the player tracking reader 138, PINs from the touchscreen 116, transaction selections, and amounts. For deposits, the EGM's credit input device (e.g., bill validator 128) processes physical currency or tickets, validating them and determining their value. This information is then formatted and transmitted securely to the First Server System. For withdrawals, the EGM receives instructions from the First Server System and processes these to control its cash dispensing device 137.

The First Server System receives transaction requests and player authentication data from the EGM. Its processors execute instructions to:
Authenticate the player against the Player Account Database.
Validate the requested transaction (e.g., check for sufficient funds in the player's casino account for a withdrawal).
For deposits, update the player's casino account balance by crediting the validated amount received via the EGM.
For withdrawals, update the player's casino account balance by debiting the requested amount and generate an authorization command for the EGM to dispense cash.
Update any associated virtual meter linked to the player's session on the EGM.
Log all transaction details, including player ID, transaction type, amount, date/time, and EGM ID, for auditing and record-keeping in the Player Account Database and for providing data to the regulatory metering system. Transformations occur as player requests are converted into database queries and updates, and instructions for EGM hardware. Financial amounts are processed, and account balances are recalculated.

### Outputs and Responses:

In at least one embodiment, when the EGM functions as a personal ATM, it provides various outputs and responses to the player and internal systems:

### Outputs to the Player:

Visual Feedback on EGM Display 116:
   Prompts for card insertion, PIN entry, transaction selection, and amount input.
   Confirmation messages for successful authentication.
   Status updates during transaction processing (e.g., “Connecting to server,” “Verifying funds,” “Processing withdrawal”).
   Confirmation of successful deposit to or withdrawal from their player account, often displaying the transaction amount and optionally the updated account balance (subject to casino policy and privacy considerations).
   Instructions for collecting dispensed cash or retrieving their player tracking card.
   Error messages in case of transaction failure (e.g., “Invalid PIN,” “Insufficient funds,” “Device error,” “Communication error”).
Physical Outputs from EGM:
   Dispensed cash from the cash dispensing device 137 for successful withdrawal transactions.
   Printed receipt for the transaction (if this feature is implemented via a printer 136, 222 on the EGM).

### Outputs to Casino Systems (via First Server System and EGM):

Transaction Authorization Requests: Sent from the EGM to the First Server System.
Transaction Confirmation/Status Updates: Sent from the First Server System back to the EGM.
Player Account Updates: The First Server System updates the Player Account Database to reflect debits for withdrawals and credits for deposits.
Virtual Meter Updates: The First Server System updates the relevant virtual meter associated with the player's EGM session.
Transaction Logs: Detailed logs of each ATM transaction (player ID, EGM ID, transaction type, amount, timestamp) are generated by the First Server System and stored in secure databases for auditing, reconciliation, and reporting purposes.
Regulatory Meter Data Contribution: Data pertaining to cash movements (even if to/from player accounts rather than direct wagers) may be appropriately factored into the data aggregated for the unified regulatory meter, ensuring overall EGM financial activity is captured as required.

These outputs and responses are designed to ensure a clear, secure, and efficient transactional experience for the player, while maintaining accurate records for the casino.

### Data Storage and Reporting:

In at least one embodiment, the EGM as a personal ATM functionality involves specific data storage and reporting mechanisms.

### Data Storage:

Player Account Database (Managed by First Server System): This is the primary repository for data related to player casino tracking accounts. For ATM transactions conducted at the EGM, this database stores:
   Player identification and authentication credentials.
   Current balances of player casino accounts.
   Detailed transaction history for each account, including deposits made and withdrawals taken via any EGM, with timestamps, EGM identifiers, and amounts.
First Server System Logs: This server maintains logs of all communications with EGMs regarding ATM transactions, authorization responses, errors, and system events for operational monitoring and auditing.
EGM Local Storage (Potentially): The EGM may temporarily store transaction details locally for resilience in case of network interruptions, to be reconciled with the First Server System once connectivity is restored. It also contributes data to the unified regulatory meter.
Unified Regulatory Meter Storage (EGM or Second Server System): While individual player account transactions are distinct, the overall cash movements at the EGM (cash-in to the system, cash-out from the system) are tracked and aggregated into the unified regulatory meter for compliance reporting. Data from ATM-like functions (e.g., total cash accepted by the EGM that was deposited to player accounts, total cash dispensed that was withdrawn from player accounts) is factored into this aggregation.

### Reporting:

Player Transaction History: Players may be able to request a history of their account transactions, which would include those made via the EGM-ATM function.
Casino Internal Auditing Reports: The casino may generate reports from the First Server System and the regulatory meter system detailing ATM transaction volumes, amounts, and activity by EGM, by player, or over time for financial control and analysis.
Regulatory Reporting: The unified regulatory meter, which includes aggregated data reflecting cash movements from ATM functions, provides the necessary data for compliance with gaming regulations.
Security and AML Reporting: Transaction logs are available for security reviews and may be used by AML systems (as per Novel Element 4) to monitor for suspicious activity related to large or unusual account deposits/withdrawals via EGMs.

All stored data is protected by security measures, including access controls and encryption, to ensure integrity and confidentiality.

### Error Handling and Security Measures:

In at least one embodiment, the operation of the EGM as a personal ATM for player tracking accounts incorporates comprehensive error handling and security measures to ensure transaction integrity, protect player funds and data, and prevent fraud.

### Error Handling:

Transaction Failures: If a transaction cannot be completed (e.g., insufficient funds in the player account for a withdrawal, communication error with the First Server System, EGM peripheral malfunction like a jam in the cash dispenser 137), the system provides a clear error message to the player via the EGM display 116 and logs the error. The transaction is typically voided or rolled back to prevent incorrect debiting/crediting.
Device Errors: The EGM monitors the status of its cash handling peripherals (bill validator 128, cash dispenser 137). If a device reports an error, ATM functions relying on that device are temporarily disabled, and an alert may be sent to casino staff.
Communication Timeouts: Timeouts are implemented for responses from the First Server System. If a response is not received within a defined period, the transaction may be cancelled, and the player notified. Retry mechanisms may be attempted for certain types of communication failures.
Data Reconciliation Errors: Mechanisms are in place to reconcile transaction logs between the EGM and the First Server System to detect any discrepancies.

### Security Measures:

Player Authentication: Strong authentication is enforced before allowing access to player account functions.

This typically involves the player tracking card combined with a PIN entered on the EGM's touchscreen or keypad. Enhanced security options may include biometric verification if the EGM is equipped with such sensors (e.g., fingerprint readers, cameras 127 for facial recognition as potentially supported by EGM hardware described in KF1 sources 638, 950, 1060, 1062).
Secure Communication: All data exchanged between the EGM and the First Server System (e.g., player credentials, transaction details, account balances) is encrypted using industry-standard protocols like TLS/SSL to prevent eavesdropping or man-in-the-middle attacks.
EGM Physical Security: Cash handling devices within the EGM (bill validator 128, cash dispenser 137, and internal cash storage) are physically secured and may include tamper-evident seals and sensors that report to the casino security system.
Transaction Limits: Predefined limits may be imposed on withdrawal amounts, deposit amounts, or the frequency of ATM transactions per player or per EGM to mitigate fraud risks.
Audit Trails: Comprehensive audit trails of all ATM transactions, authentication attempts (successful and failed), and system errors are logged securely on the First Server System and potentially the EGM for investigation and compliance purposes.
Software Integrity: The EGM's software, including the components managing ATM functionality, is protected against unauthorized modification through secure boot processes and code signing.
AML Monitoring: Transaction patterns (e.g., large deposits/withdrawals, frequency) performed via the EGM-ATM function are subject to AML monitoring (as detailed in Novel Element 4) to detect and flag suspicious activities.

These measures ensure that the EGM as an ATM function is reliable, secure, and trustworthy for both players and the casino operator.

### Server Interaction Architecture and Data Exchange

In at least one embodiment, the architecture for server interaction within the VCLAPS! Electronic Gaming Machine (EGM) system involves a tiered approach to manage distinct data flows and functionalities, primarily between the EGM, a First Server System (often analogous to a Player Tracking (PT) Server), and a Second Server System (typically a Casino Management System or CMS). The EGM itself is equipped with a processor, memory, a network interface, and software to manage game logic, user interface, and communication.

The First Server System is primarily responsible for managing individual player accounts and a plurality of virtual (soft) meters. Each virtual meter is associated with a distinct game session or player active on an EGM. This server processes financial transactions requested from the EGM, such as cash-ins (via the EGM's credit input device like a bill validator 128, 601) and cash-outs (via a cash dispensing device 137). It updates the relevant virtual meter and initiates corresponding updates to the player's associated casino account stored in a Player Account Database. Gameplay activity, including wagers and wins, is reported by the EGM to the First Server System, which then updates the respective virtual meter in real-time. Communication protocols between the EGM and the First Server System are typically secure TCP/IP-based connections, utilizing encryption standards such as TLS/SSL to protect sensitive data like player credentials, transaction details, and account balances during transit. Data exchanged includes player identification, transaction requests (deposit, withdrawal, wager, win), amounts, virtual meter updates, and game state information.

The Second Server System (CMS) is responsible for maintaining the unified regulatory (hard) meter for the EGM. This regulatory meter serves the purpose of consolidated regulatory reporting. Data derived from the plurality of virtual meters managed by the First Server System is provided for aggregation into this unified regulatory meter. This aggregation process involves summing up relevant financial data points (e.g., total cash-in, total cash-out, total wagers, total wins) from the individual virtual meters to provide a consolidated view for regulatory reporting. The EGM itself or the Second Server System may manage this aggregation and the regulatory meter. Communication between the First Server System and the Second Server System, or between the EGM and the Second Server System if the EGM performs aggregation, also utilizes secure network protocols to ensure data integrity for regulatory reporting.

Secure data exchange is paramount. Beyond encrypted communication channels (TLS/SSL), messages exchanged between the EGM and servers are often authenticated to ensure they originate from legitimate sources. This may involve digital signatures or token-based authentication. Data integrity checks, such as checksums or CRCs, are employed during transmission to detect any corruption.

Data reconciliation is achieved through several mechanisms. The First Server System reconciles transactions against player accounts and virtual meter balances. There are also mechanisms for reconciling balances between the sum of virtual meters (from the First Server System) and the unified regulatory meter (managed by the EGM or Second Server System). Discrepancies trigger alerts and initiate reconciliation procedures, which may involve comparing transaction logs from the EGM, the First Server System, and the regulatory meter records. All systems maintain detailed transaction logs with timestamps, EGM IDs, player IDs (if applicable), transaction types, and amounts to facilitate auditing and manual reconciliation if necessary. Error handling mechanisms include validation checks for financial inputs, communication error detection with re-transmission protocols, and timeout handling.

### Practical Application:

The practical application of this server interaction architecture is the creation of a robust and auditable gaming environment that supports complex, individualized player financial management directly at the EGM, while simultaneously adhering to strict regulatory reporting standards. For a casino, this means EGMs like the VCLAPS! may offer players direct access to their casino accounts for deposits and withdrawals (acting as a personal ATM), allow multiple players to engage in separate games on one machine with independent financial tracking, and still report as a single compliant entity. This enhances player convenience, improves machine utility, and streamlines casino operations. The computer systems (EGM, First Server, Second Server) are integral to this process, performing secure communication, data processing, transaction validation, and meter management that would be impossible manually. The system provides a practical solution to the technical problem of managing diverse, concurrent financial activities on a shared gaming device.

### Technological Improvement/Improved Computer Functioning:

This server interaction architecture represents a specific technological improvement to EGM systems and casino network functionalities. It improves the functioning of the EGM by transforming it from a simple game-playing device with a single cash-in/out flow into a sophisticated terminal capable of managing multiple, independent financial contexts (virtual meters linked to player accounts) simultaneously. The specific configuration of a First Server System managing granular virtual meters and player account transactions, which then feed into a distinct, aggregated regulatory meter managed by the EGM or a Second Server System, is a technological advancement over simpler, monolithic EGM accounting.

The computer's functioning is improved by enabling more complex data processing and secure communication pathways. For instance, the EGM's processor and network interface are utilized to securely manage and route different types of financial data to different server systems based on context (individual player transaction vs. aggregated regulatory data). The First Server System's ability to process numerous virtual meter updates in real-time and interact with a Player Account Database, while ensuring data integrity, enhances the overall processing capability of the casino's financial network. The defined communication protocols and security measures (encryption, authentication, data integrity checks) improve the reliability and security of data transmission within the casino network, which is a direct improvement in computer network functioning for this specific application. The reconciliation mechanisms also represent an improvement in automated financial data management and error detection.

### Example Walk-through Scenario:

Consider two players, Player A and Player B, simultaneously playing different games on a single VCLAPS!EGM. Player A inserts their player tracking card. The EGM communicates this to the First Server System (PT Server). The PT Server authenticates Player A and establishes a virtual meter (VM-A) for their session. Player A then inserts $50 cash into the EGM's bill validator. The EGM securely sends a “credit VM-A $50” message to the PT Server. The PT Server updates VM-A and Player A's casino account, then confirms to the EGM. Simultaneously, Player B, using a different segment of the EGM's touchscreen, initiates a $20 transfer from their existing casino account to their active virtual meter (VM-B). The EGM sends this request to the PT Server, which validates Player B, debits their main casino account, credits VM-B, and confirms to the EGM.

As Player A wagers $1 on their game, the EGM reports this to the PT Server, which deducts $1 from VM-A. Player B wins $5; the EGM reports this, and the PT Server adds $5 to VM-B. Periodically, or upon specific triggers, data from VM-A (e.g., $50 in, $1 bet) and VM-B (e.g., $20 in, $5 win) is securely provided by the PT Server for aggregation. This aggregated data (e.g., total EGM cash-in $50, total EGM account transfers-in $20, total EGM bets $1, total EGM wins $5) is used to update the EGM's unified regulatory meter, which may be maintained by the Second Server System (CMS) or the EGM itself. Secure communication protocols (e.g., TLS encrypted messages with authenticated endpoints) are used for all exchanges. If Player A cashes out VM-A for a printed ticket, the PT Server authorizes it, the EGM prints the ticket, and the PT Server finalizes VM-A. Reconciliation processes run by the PT Server and CMS would later compare the sum of virtual meter activities against the unified regulatory meter totals to detect any discrepancies.

### AML Detection Algorithms and LOGIC

In at least one embodiment, the integrated Electronic Gaming Machine (EGM)-level Anti-Money Laundering (AML) system utilizes a sophisticated combination of a rule engine, pattern recognition algorithms, and real-time data analysis of virtual meter data, transaction peripheral data, and gameplay behavior to detect suspicious activities. The AML monitoring module, which may operate on the EGM's processor or in close conjunction with the First Server System, processes these inputs to identify patterns indicative of potential money laundering.

The system analyzes several categories of data. Financial transaction data includes cash-in amounts, denominations, and timestamps from the EGM's bill validator 128 and/or ticket reader 224, as well as cash-out amounts and timestamps from the EGM's cash dispensing device 137 or ticket printer 136. Crucially, real-time data from each active virtual meter associated with game sessions on the EGM provides granular insights into amounts wagered, amounts won, credit balance changes, and the velocity of funds through that specific virtual meter. Gameplay behavior data, such as session duration, game(s) selected, betting patterns (consistency, changes, max betting), rate of play, and the ratio of gameplay to amount deposited, is also a notable input. If a player tracking card is used, player identification data from the reader 138, including historical play or risk profiles if accessible, may be factored in.

The AML module employs a rule engine that evaluates extracted data features against a configurable set of predefined AML rules and thresholds. Specific algorithms and logic patterns are implemented to detect various suspicious activities:
1. Structuring/Transaction Sequencing:
   Algorithm: The system monitors the frequency and amounts of cash-in and cash-out transactions within defined time windows. It looks for multiple transactions that are individually below a reporting threshold but collectively exceed it.
   Logic: IF (Count(CashIn_Transactions_Below_Threshold_X)>N_Transactions IN Time_Window_T) AND (Sum(Cashln_Amounts)>Total_Threshold_Y) THEN Flag_Structuring_CashIn. A similar logic applies to cash-outs.
   Virtual Meter Data Usage: Virtual meter data showing rapid accumulation from multiple small deposits followed by aggregation or transfer attempts would amplify this flag.
2. Minimal Play/Money Cycling:
   Algorithm: This involves tracking the ratio of total wagers to total deposits for a given session or player. It also monitors the time elapsed between significant deposits and withdrawal attempts.
   Logic: IF (Total_Cash_In>Amount_A) AND (Total_Wagered<Percentage_B_of_Total_Cash_In) AND (Time_Played<Duration_C) AND (Cash_Out_Attempted>Percentage_D_of_Total_Cash_In) THEN Flag_Minimal_Play_Cycling.
   Virtual Meter Data Usage: The virtual meter provides precise data on Total_Wagered versus Total_Cash_In for that specific session, enabling accurate calculation of the play-through percentage.
3. Rapid Velocity of Funds:
   Algorithm: The system measures the rate at which funds enter a virtual meter (or player account via EGM) and are then withdrawn, with minimal intervening gameplay.
   Logic: IF (Time_Between_Large_Deposit_And_Withdrawal_Attempt<Duration_V) AND (Play_Activity_During_Interval==Low) THEN Flag_Rapid_Velocity.
   Virtual Meter Data Usage: Virtual meter transaction timestamps and wager logs are desirable for calculating this velocity and assessing intermediate play.
4. Unusual Transaction Sizes or Frequencies:
   Algorithm: This involves establishing a baseline of normal transaction activity for the EGM or for a known player (if player tracking is active). Deviations from this baseline trigger scrutiny.
   Logic: IF (Current_Transaction_Amount>(Average_Player_Transaction_Amount+K_Std_Deviations)) OR (Frequency_of_Transactions_Today>(Average_Player_Frequency+L_Std_Deviations)) THEN Flag_nusual_Transaction.
   Virtual Meter Data Usage: Historical data from a player's virtual meter interactions across sessions (if available via player tracking) helps establish this baseline. For anonymous play, EGM-specific averages are used.
5. Anomalous Betting Patterns:
   Algorithm: The system analyzes betting patterns in relation to game type, game volatility, and, if known, player history. Sudden shifts from low to very high bets, or consistently betting maximum amounts without regard to game state, may be flagged.
   Logic: IF (Bet_Volatility_Spike>Threshold_S) OR (Consistent_Max_Betting_On_Low_Return_Game_Without_Strategy_Change) THEN Flag_Anomalous_Betting.
   Virtual Meter Data Usage: The virtual meter tracks every bet amount and game played, allowing for detailed pattern analysis.

Feature extraction is a notable processing step where raw data is converted into these analyzable metrics (e.g., Total_Cash_In, Percentage_B_of_Total_Cash_In, Time_Played). More sophisticated processing may involve pattern recognition algorithms like sequence analysis (to detect structured series of actions) or anomaly detection (to identify deviations from established norms without predefined rules for every scenario) to identify complex behaviors. Risk scoring may also be implemented, assigning weighted scores to different triggered rules or matched patterns, with a cumulative score determining the final alert level.

### Practical Application:

The practical application of these detailed AML algorithms is the proactive identification of potential financial crimes occurring at the EGM level. By embedding these analytical capabilities directly within the EGM or its closely coupled First Server System, casinos may detect and respond to suspicious activities much faster than relying solely on centralized, after-the-fact analysis. This allows for immediate intervention if necessary, such as alerting floor staff, delaying a suspicious transaction pending review, or gathering more information about the player. This significantly strengthens a casino's AML compliance posture and protects its operations from illicit use. The computer (EGM/server) is integral, as this level of real-time data analysis, rule application, and pattern recognition is computationally intensive and may require automated processing.

### Technological Improvement/Improved Computer Functioning:

The use of these specific AML algorithms and data analysis techniques within the EGM system constitutes a technological improvement to the EGM's functionality and the casino's security infrastructure. It improves the functioning of the EGM's computer by enabling it to perform localized, intelligent data analysis for security and compliance purposes, beyond its primary function of game execution.
1. Enhanced Data Processing: The EGM or associated server system is improved to process diverse data streams (financial, gameplay, player) in real-time, extract meaningful AML-relevant features, and apply complex rule logic or machine learning models. This is a more sophisticated data processing task than standard EGM operations.
2. Real-Time Analytical Capability: The ability to perform on-the-fly analysis of virtual meter data and player behavior to detect complex patterns like structuring or money cycling represents an improvement in the EGM system's analytical capabilities.
3. Automated Alerting and Reporting: The system's computer functionality is enhanced to automatically generate detailed alerts and logs when suspicious patterns are detected, improving the efficiency and reliability of AML incident management.
4. Adaptive Security: By analyzing virtual meter data, the system may adapt its scrutiny based on granular session-specific financial flows, offering a more nuanced and effective detection mechanism than systems looking only at overall machine totals.

This sophisticated, localized analytical capability transforms the EGM into an active node in the casino's AML defense network, representing a clear improvement in how gaming technology addresses financial crime risks.

### Example Walk-through Scenario:

A new, uncarded player (Player X) approaches a VCLAPS! EGM.
1. Initial Transactions: Player X inserts $300 into the bill validator 128 in six separate $50 bill transactions over two minutes. The EGM's AML module logs these transactions. The “Structuring” algorithm notes: Count(Cashln_Transactions_Below_Threshold_X ($100))=6 IN Time_Window_T (2 mins) and Sum(CashIn_Amounts)=$300. This may trigger a low-level flag or begin heightened monitoring. A virtual meter (VM-X) for this anonymous session shows a $300 balance.
2. Minimal Gameplay: Player X selects a low-volatility slot game and plays for three minutes, making ten spins at $0.50 per spin. Total wagered=$5.00. VM-X reflects these wagers.
3. Withdrawal Attempt: Player X then attempts to cash out $290.
4. AML Algorithm Trigger: The “Minimal Play/Money Cycling” algorithm evaluates:
   Total_Cash_In ($300)>Amount_A ($100)−TRUE
   Total_Wagered ($5)<Percentage_B (e.g., 20%) of Total_Cash_In ($300*0.20=$60)−TRUE ($5<$60)
   Time_Played (3 mins)<Duration_C (e.g., 10 mins)−TRUE
   Cash_Out_Attempted ($290)>Percentage_D (e.g., 80%) of Total_Cash_In ($300*0.80=$240)−TRUE ($290>$240) Since all conditions are met, the algorithm Flag_Minimal_Play_Cycling.
5. System Response: The EGM's AML module generates a high-priority alert, including EGM ID, session ID (for VM-X), timestamps of deposits, details of minimal play (total wagered, duration), and the cash-out attempt. This alert is sent to the central Casino AML Compliance System. The EGM may display a message: “Transaction may require attendant assistance. Please wait.” The $290 cash-out is temporarily suspended.
6. Intervention: Casino floor staff are notified and approach Player X to make inquiries as per casino policy, potentially asking for identification or an explanation of the transaction pattern. All data is logged for potential regulatory reporting.

### Intelligent Shared Multiplayer Touchscreen Control Interface

In at least one embodiment, the VCLAPS! EGM includes an intelligent shared multiplayer touchscreen control interface which provides a specific technical solution to the problem of supporting multiple, independent player sessions concurrently via a shared touchscreen control interface. A core purpose of this interface is to transform a standard EGM from a solitary device into a parallel gaming station, enabling multiple players to engage in distinct, wager-based gameplay simultaneously without operational conflict. The implementation of this element within the Wager-Based Gaming System involves a unitary touchscreen display that is dynamically segmented by a Game Management System (GMS). Each segment is independently and concurrently mapped to a different player's game session, displaying a unique game interface and a dedicated set of virtual controls. The system intelligently processes inputs by identifying the source of an interaction—either from distinct sets of physical buttons or from specific coordinates on the segmented touchscreen—and isolates the command to affect only the corresponding player's game logic engine. This is a practical application that directly improves the functionality of the EGM, solving the challenges of floor space underutilization and the lack of social, parallel play on traditional slot machines. The computer is integral to the inventive nature of this element, as it performs the complex, real-time tasks of dynamic UI segmentation, isolated input routing, and concurrent rendering of multiple independent graphical interfaces, which are impossible to achieve otherwise. This technology bridges the gap between solitary EGM play and interactive, console-style multiplayer experiences within the regulated casino environment. This element is further enhanced by allowing players to customize their interface by resizing game segments and saving preferred layouts to a player's profile, which are managed by a first server system.

### Sequence Diagram Components:

Local Player: A Local Player is a user physically present at the VCLAPS! EGM. In a multiplayer context for this Novel Element, there would be multiple Local Players (e.g., Player 1, Player 2) each interacting with their assigned segment of the EGM's unitary touchscreen display or their dedicated set of physical controls. Their primary function is to provide real-time input for their respective game sessions.

Remote Player: A Remote Player interacts with the Wager-Based Gaming System via a web or mobile application. While the core of this Novel Element is focused on local multiplayer on a single screen, the underlying architecture may be extended to allow a Remote Player to occupy one of the screen segments, with their interface streamed to their device and their commands sent back to the EGM.

Physical EGM/ETGT Interface: This is the player-facing interface on the physical VCLAPS! EGM. For this Novel Element, it is a large, unitary touchscreen display capable of being dynamically segmented into multiple, independent zones. Each zone displays a full game UI with its own virtual controls. The interface also includes the EGM's physical hardware, such as multiple sets of player buttons and a single player tracking card reader.

Remote Player Interface: The Remote Player Interface is the graphical user interface on a remote player's web or mobile device. In a potential extension of this Novel Element, this interface would mirror the game segment assigned to the remote player on the physical EGM, displaying a real-time video feed of their game area and providing virtual controls for interaction.

Physical EGM/ETGT: The Physical EGM is the hardware unit that houses the processor, memory, and the unitary touchscreen display. It runs the Game Management System (GMS) software responsible for launching concurrent game instances, segmenting the screen, and processing and isolating player inputs. It also contains the shared peripherals, like the single player tracking reader, that service all concurrent sessions.

Wager-Based Gaming System Core Module: The Wager-Based Gaming System Core Module, in this context, refers to the centralized or server-side components that support the EGM's operation. This includes the First Server System, which manages the individual virtual meters for each player session on the EGM, handles player authentication via the player tracking system, and stores user-specific data such as custom UI layouts. It works in coordination with the EGM's GMS to manage the financial aspects of each independent session.

Video Streaming Server: While not central to the local multiplayer aspect of this Novel Element, a Video Streaming Server would be a required component in an alternative embodiment where a remote player occupies one of the EGM's screen segments. It would be responsible for capturing the video feed of that specific segment, encoding it, and streaming it with low latency to the Remote Player's device.

Casino Backend System: The Casino Backend System encompasses the broader casino network infrastructure, including the player account and player tracking databases managed by the First Server System, as well as the Casino Management System (CMS) or Second Server System that receives aggregated financial data from the EGM's unified regulatory meter. It ensures that all financial and gameplay data from the concurrent sessions is properly logged for compliance, auditing, and business analytics.

### Implementation Details:

The implementation of the intelligent shared multiplayer touchscreen control interface within the VCLAPS! EGM is a software-intensive solution built upon a capable hardware foundation. The EGM hardware is equipped with a large, high-resolution unitary touchscreen display, a powerful multi-core processor (e.g., processor 12, 204), and a graphics processing unit (GPU) capable of rendering multiple independent game UIs concurrently. The EGM also features multiple sets of physical player buttons and a single player tracking card reader designed to handle multiple player authentications for a single machine.

The software architecture is managed by a Game Management System (GMS) running on the EGM's processor. The GMS is responsible for dynamic screen segmentation. When a multiplayer mode is initiated, the GMS divides the touchscreen into a predefined number of distinct, non-overlapping zones or segments. The layout, including the size and position of these segments, may be fixed or, in an advanced embodiment, customizable by the players. To support this customization, the EGM's UI presents draggable borders between segments. The GMS receives coordinates from these drag gestures and recalculates the segment dimensions in real-time, subject to minimum size constraints, and then instructs the rendering engine to update the viewports.

Input processing is an important component. A UI Management layer within the GMS captures all raw touch events from the touchscreen controller. It identifies the precise coordinates of each touch and maps it to a specific segment. Within that segment, it further maps the coordinates to a virtual control (e.g., a “spin” button) of the game running in that segment. This input, now contextualized (e.g., “Player 2, Spin”), is routed exclusively to the corresponding game logic engine. This isolation is absolute; inputs in one segment have no effect on others. For physical buttons, the GMS maps each set of buttons to a player session upon authentication, ensuring button presses are also routed only to the correct game engine. This addresses the challenge of arbitrating access to shared hardware for independent sessions.

The system's integration with the First Server System enables personalized features. When a player customizes a layout, the GMS packages the configuration data (segment dimensions, game assignments) and sends it with the player's ID to the First Server System, which stores it in the player's profile in the casino's player account database. Upon the player's next login on any VCLAPS! EGM, the EGM queries the server for saved layouts and may automatically reconfigure the display, providing a persistent, personalized experience. This involves specific API calls between the EGM and the First Server System for storing and retrieving this UI configuration data.

In an alternative architecture, some of the GMS logic may be offloaded to a server to manage session initiation and configuration, especially in a network with many such EGMs. However, the real-time input processing and UI rendering must reside locally on the EGM to minimize latency and ensure a responsive player experience. All communication between the EGM and the server systems for session management, financial tracking, and layout storage uses secure protocols like TLS over TCP/IP to ensure data integrity and confidentiality.

### Example Walk-Through Scenario (Referencing Example VCLAPS! EGM Embodiment of FIG. 15):

Three players—Player A, Player B, and Player C—approach a VCLAPS! EGM 1500, which features a large, unitary game display 1530 and an Intelligent Shared Multiplayer Touchscreen Control Interface 1520 below it. The interface 1520 is visibly partitioned into three distinct player control stations, each with its own touchscreen area 1526, a small display 1522, and dedicated hardware peripherals including a TITO/Bill Validator 1532 and a Cash Bill Dispenser 1534.

Player A initiates a session at the leftmost station by inserting cash into their TITO/Bill Validator 1532. The system, communicating with the First Server System, establishes a virtual meter for Player A and credits it with 5000 credits. The large display 1530 updates to show Player A's game, “DOOR TO RICH,” and their credit balance. Player B and Player C do the same at their respective stations, funding their sessions to 4000 and 8000 credits to play “GOLD DRAGON” and “PIGGY RICHES,” respectively. All three game UIs are rendered concurrently on the shared display 1530.

Player C uses the virtual “BET” button on their touchscreen 1526 to set a wager of 200 credits, then presses the virtual “SPIN” button. The “PIGGY RICHES” game in their screen area on the main display 1530 animates, resulting in a 200 credit win. Simultaneously, Player B wagers 100 credits on “GOLD DRAGON” and wins 500 credits. The individual win meters on the main display 1530 update in real-time for each player.

Because Player B and Player C both had wins of at least 200 credits, they trigger a cooperative bonus feature described on the main display 1530. The physical “Bonus Spin” buttons 1528, located on the interface 1520, begin to flash for all three players. All players press their lit “Bonus Spin” button 1528, participating in a shared bonus event where the rewards are distributed among all active players, and their respective credit meters are updated by the system.

Following the bonus, Player A decides to use the EGM-as-ATM feature. Player A presses the “Withdraw Cash” button on their touchscreen 1522, enters an amount of $50, and authenticates the transaction. The First Server System authorizes the withdrawal from Player A's linked casino account, and a command is sent to Player A's specific Cash Bill Dispenser 1534, which physically dispenses $50. Player B and Player C continue their gameplay uninterrupted during this process.

Player Interaction: Players interact with the intelligent shared multiplayer interface through a combination of physical hardware and a dynamic touchscreen UI. For local players at the EGM, the interaction begins with authentication. Each player inserts their player tracking card into the single shared reader. The system then assigns them to a specific control set (physical buttons) and a corresponding segment on the unitary touchscreen display.

The primary interaction surface is the segmented touchscreen. Each player's segment displays a complete, independent game UI. They interact with virtual buttons, such as “Bet One,” “Bet Max,” “Select Lines,” and “Spin,” displayed within their segment. Touching a control in one segment only affects the game in that segment. The system provides immediate visual feedback within that zone-buttons depress, reels spin, balances update-creating a responsive and isolated experience.

If players wish to customize the interface, they may enter a layout editing mode. This overlays draggable handles on the borders between segments. Players may touch and drag these handles to resize their game windows. A “Save Layout” button allows them to persist their preferred configuration to their player account for future sessions. This provides a level of personalization and control not found in traditional EGMs.

In addition to the touchscreen, players may use their assigned set of physical buttons. These buttons are mapped by the Game Management System to the core functions of the game running in their associated screen segment (e.g., a physical “Spin” button would trigger a spin in that player's active game). The system ensures a seamless experience where players may use either the physical or virtual controls for their session. Feedback for physical button presses is still rendered within the player's corresponding screen segment.

### Distinguishing Novel Elements:

The core conceptual and technical novelty of the intelligent shared multiplayer touchscreen control interface lies in its specific, integrated solution for enabling true parallel gaming on a single physical EGM. While multi-game systems or touchscreens exist, this system is distinguished by the combination of several notable elements.

First is the dynamic, software-defined segmentation of a unitary touchscreen where each segment is mapped to a completely independent, concurrently running game session. This is not merely switching between full-screen game views; it is the simultaneous presentation and operation of multiple distinct game UIs on one display, as depicted in the figures.

Second is the sophisticated input isolation logic. The system's ability to process inputs from multiple sources (different physical button sets and distinct touchscreen zones) and route each command exclusively to its corresponding game logic engine is a fundamental innovation. This solves the technical challenge of preventing control cross-talk in a shared-screen, multi-user environment, making true parallel play possible.

Third is the integration with a higher-level player and financial management system (the First Server System). The interface is not just a display method; it's a front-end for a system that manages separate virtual meters for each player's session. This allows for independent financial accounting for two or more players sharing one machine.

Finally, the feature allowing players to customize the interface by resizing segments and saving these layouts to a server-side player profile is a novel enhancement. It transforms the EGM from a static appliance into a personalized gaming environment that adapts to user preference and follows the user across different machines, a feature not present in conventional EGMs. The computer is integral, as it performs the complex real-time processing required for segmentation, input routing, concurrent rendering, and server-side personalization that defines this unique human-computer interaction model for casino gaming.

### Distinguishing Inventive Steps:

The implementation of the intelligent shared multiplayer touchscreen control interface involves several specific and novel procedural steps that distinguish it from conventional EGM operations.

A first inventive step is the dynamic assignment and mapping of distinct player sessions to physically co-located control interfaces on a single EGM. This involves the system authenticating multiple players via a single reader, and then programmatically linking each authenticated player profile to both a unique segment of the unitary touchscreen and a specific set of physical or virtual controls. This step creates independent, personalized control spaces on shared hardware.

A second inventive step is the real-time processing and isolation of player inputs based on their source. The system's UI Management software continuously captures raw input data (e.g., touch coordinates, physical button signals) and executes a mapping algorithm. It transforms this raw data into a contextual command by identifying which player session the input belongs to (based on screen segment or button set origin) and routing the command exclusively to that session's game logic engine. This ensures that actions from one player have zero impact on another player's concurrent game state on the same screen.

A third inventive step is the server-side persistence and retrieval of user-specific interface customizations. This involves the EGM capturing a player-defined layout configuration (the size and position of game segments), transmitting this data to the First Server System to be stored with the player's profile, and subsequently allowing the player to automatically load and apply this custom layout upon logging into any compatible EGM on the network. This step creates a personalized, portable gaming environment that is managed by the distributed computer system.

### Technical Improvements to Existing Technical Problems:

This Novel Element provides specific technical solutions to several existing problems in casino gaming technology, improving the functioning of the EGM as a computer.

First, it addresses the problem of inefficient floor space utilization and low machine utility during non-peak hours. Conventional EGMs are single-user devices, meaning one machine serves one player at a time. This is inefficient for groups or when a player wishes to engage with multiple games. The shared multiplayer interface provides a technical solution by enabling a single EGM to function as multiple independent gaming terminals concurrently. This improves the EGM's computer functionality by allowing its processor and display resources to be partitioned and managed for parallel workloads, effectively increasing the revenue-generating potential and player capacity per square foot of casino floor without additional hardware.

Second, it solves the technical problem of providing a social, parallel gaming experience on slot-style machines, which are traditionally solitary. The interface, by allowing multiple players to engage in their own games side-by-side on a shared screen, creates a new form of social interaction. This technical improvement is achieved through the sophisticated software logic for input isolation and concurrent UI rendering, which is a direct enhancement of the EGM's computer-based user interface management. It makes the machine a hub for group entertainment, attracting a demographic that seeks social gaming experiences.

Third, the Novel Element tackles the problem of rigid and impersonal EGM interfaces. Traditional machines offer a one-size-fits-all display. The feature allowing players to resize game segments and save their preferred layouts to a server-side profile represents a technical improvement in human-computer interaction for gaming devices. It improves the functioning of the distributed computer system (EGM and First Server) by enabling it to store and retrieve user-specific UI preferences, dynamically reconfiguring the EGM's graphical output based on that remote data. This creates a more ergonomic, user-centric, and technically advanced gaming platform, which one of ordinary skill would recognize as a tangible improvement in providing a personalized user experience.

### Data Input:

To function correctly, the intelligent shared multiplayer touchscreen control interface may require several specific types of data inputs. From the players, the system receives player identification data via the single player tracking card reader, which is used to authenticate multiple users and link them to specific sessions. It also receives direct game control inputs, which may come from two sources: discrete signals from the multiple sets of physical player buttons, or coordinate-based touch data from interactions with the virtual controls displayed on the unitary touchscreen. For the UI customization feature, the system accepts touch-and-drag input on the segment borders to define new layout dimensions, and text input via a virtual keyboard if the player chooses to name their saved layout.

From the casino backend systems, specifically the First Server System, the EGM receives player profile data upon successful authentication. A novel input in this system is the retrieval of stored UI customization data. When a player logs in, the EGM queries the server and receives a data packet containing the player's saved layout configuration, which it then uses to set up the interface. This server-provided data input is unique as it directly dictates the EGM's graphical user interface arrangement for a multi-game session.

### Component Interactions and Procedural Steps:

The procedural flow for this Novel Element within the Wager-Based Gaming System begins with session initiation. One or more Local Players approach the Physical EGM/ETGT and insert their player tracking cards into the single player tracking reader. The Physical EGM reads the card data and sends an authentication request for each player to the Wager-Based Gaming System Core Module (specifically, the First Server System). The Core Module verifies the players against the Casino Backend System and confirms their identities back to the EGM.

Upon successful authentication of multiple players, the EGM's internal Game Management System (GMS) initiates a multiplayer mode. It dynamically partitions the Physical EGM/ETGT Interface—the unitary touchscreen—into distinct segments, one for each authenticated player. The GMS then queries the Core Module to check if any of the authenticated players have a saved custom UI layout stored in their profile. If so, the Core Module retrieves this configuration data from the Casino Backend System and transmits it to the EGM. The GMS uses this data to arrange the screen segments according to the player's preference; otherwise, a default layout is used.

Next, each Local Player selects a game for their assigned segment via the touchscreen. The GMS launches the corresponding independent game logic engines. As players interact using either physical buttons or the virtual controls on their touchscreen segment, the EGM's UI management software processes these inputs. It identifies the input's source (e.g., “Player 1 physical button” or “touch at coordinates [x,y] in Player 2's segment”) and routes a corresponding command exclusively to that player's game engine. The game engine processes the command, and any change in game state or financial outcome (wager/win) is communicated to the Core Module to update that player's specific virtual meter. The game engine also sends display updates to the EGM's rendering system, which refreshes only the relevant segment of the touchscreen, providing real-time, isolated feedback. This cycle of input, processing, and isolated output continues for all concurrent sessions.

### Data Processing:

The Wager-Based Gaming System performs several notable data processing tasks to enable the shared multiplayer interface. The EGM's processor, running the Game Management System, is central to this. Its primary task is input disambiguation and routing. It continuously processes a stream of raw input data from both the physical button controller and the touchscreen controller. It transforms this raw data into a contextual game commands. For a touch event, it processes the coordinate data, first mapping it to a specific screen segment, then to a specific virtual control within that segment's game UI, thus creating a command like [Player_2_Session, Spin_Action]. For a physical button press, it identifies the button's hardware ID and maps it to the currently assigned player session.

A second important processing task is UI and layout management. When a player resizes segments, the GMS processes the stream of drag-coordinate data to continuously recalculate the dimensions and positions of the multiple viewports. It then feeds these updated viewport parameters to the graphics rendering engine. This engine, in turn, processes the graphical output from each independent game logic engine and composites them into a single frame buffer, ensuring each game is clipped and rendered correctly within its assigned, and potentially changing, viewport boundaries.

Finally, the Wager-Based Gaming System Core Module processes UI customization data. When a player saves a layout, the EGM's GMS processes the current screen configuration into a structured data format (e.g., JSON or XML) describing the layout, and sends this to the Core Module. The Core Module processes this data by associating it with the player's ID and storing it persistently in the Casino Backend System's player profile database.

### Outputs and Responses:

The most prominent output of this Novel Element is the visual presentation on the Physical EGM/ETGT Interface. The unitary touchscreen outputs multiple, distinct, and concurrently active game UIs, each rendered within its own screen segment. This output is dynamic, as the system provides real-time updates to each segment independently, reflecting the game state changes (e.g., spinning reels, card animations) only for the game within that segment. When a player interacts with their controls, the corresponding segment provides immediate visual feedback, such as a button animation.

Another notable output is the distinct financial information for each session. The interface displays separate credit or virtual meter balances for each player, typically within their assigned segment, so each participant may track their funds independently. In response to a request to save a UI layout, the system outputs a confirmation message to the player. Upon a subsequent login, the system's primary response may be the automatic reconfiguration of the screen into the player's saved custom layout, a direct output based on data retrieved from the Casino Backend System. The system also outputs data to backend components; for every player action, a log entry detailing the player ID, session, action, and financial result is sent to the Wager-Based Gaming System Core Module for processing by the respective virtual meter and for auditing purposes.

### Data Storage and Reporting:

The implementation of this Novel Element may require specific data to be persistently stored, primarily within the Casino Backend System managed by the Wager-Based Gaming System Core Module. A notable piece of data requiring storage is the user-specific UI layout configuration. For each player who customizes their interface, a record is stored in a database table linked to their main player profile. This record would contain fields for layout name, number of segments, and the configuration details for each segment, including its size, position, and the ID of the game assigned to it.

Additionally, detailed session logs are generated for these multi-player interactions. The system needs to store logs that clearly associate every game event and financial transaction with the specific player session and screen segment it originated from on that EGM. This granular data storage is important for dispute resolution and for accurate business intelligence reporting. For example, the casino may generate reports to analyze the popularity of certain game combinations being played concurrently or to track revenue per screen segment on these specialized machines. This data storage structure, which links a single EGM's activity to multiple independent player sessions simultaneously, is a novel requirement compared to traditional EGM logging.

### Error Handling and Security Measures:

To ensure stable and fair operation, the Wager-Based Gaming System implements specific error handling for the shared interface. If one game logic engine crashes, the system is designed to isolate the fault. The corresponding screen segment may show an error message and offer a restart option, but it will not affect the operation of the other concurrent game sessions. The system also handles input conflicts; for instance, if two players touch the screen simultaneously near a border, the input processing logic may discard the ambiguous inputs to prevent unintended actions.

Security measures are important. To prevent one player from interfering with another's session, the input isolation managed by the Game Management System is paramount and is secured against software exploits that may allow cross-segment control. Player authentication is strictly enforced by the Core Module. When multiple players are active, the system maintains a secure session state for each, ensuring that financial transactions and game outcomes are always tied to the correctly authenticated player. Any attempt to perform an action for a session without a currently valid authentication token would be rejected. Furthermore, the ability to save and load UI layouts from the server is protected, requiring player authentication before any custom layout may be loaded, preventing one player from accessing or altering another's saved preferences.

### End of Interaction:

An interaction cycle involving the shared multiplayer interface concludes when one or all of the Local Players decide to end their session. If a single player, say Player 1, chooses to cash out, they initiate the command from their screen segment or physical button. The Wager-Based Gaming System Core Module processes the cash-out for Player 1's virtual meter, finalizing their financial transactions with the Casino Backend System. The GMS on the EGM then terminates Player 1's game instance. That screen segment becomes inactive or available for a new player to join, while Player 2's session continues uninterrupted in their own segment.

When the last active player ends their session, the Core Module finalizes all remaining transactions. The GMS on the EGM then resets the entire unitary touchscreen display to its default idle or attraction state. All temporary session data, such as the active player-to-segment mappings, are cleared. The final step involves the Core Module and EGM logging the end-of-session events for all involved players, providing a complete audit trail for the multiplayer engagement on that machine. The EGM is now ready for a new set of single or multiplayer interactions.

### Dynamic Touchscreen Segmentation and Input Logic

In at least one embodiment, the VCLAPS! Electronic Gaming Machine (EGM) system employs sophisticated software logic to manage its unitary touchscreen display, enabling dynamic segmentation, independent input processing from these segments, and concurrent rendering of multiple distinct game User Interfaces (UIs) without interference. This capability is central to offering multi-game and multi-player experiences on a single physical EGM.

### Dynamic Segmentation Logic:

The dynamic segmentation of the touchscreen is orchestrated by a Game Management System (GMS), which may reside within the EGM or be partially managed by a server system. When multiple games are to be displayed concurrently (either for a single player managing multiple games or for multiple players each playing their own game), the GMS determines the layout and dimensions of each segment. This determination may be based on several factors: the number of active games, player selections, predefined screen layout configurations (e.g., two-panel, three-panel as suggested by FIGS. 15 and 18), or the specific requirements of the games being displayed. The GMS allocates a specific rectangular area (a segment or zone) of the unitary touchscreen to each active game instance. Each segment is defined by its coordinates (e.g., top-left x,y and bottom-right x,y) and dimensions on the overall display. This partitioning information is maintained by the GMS and used by the input processing and UI rendering subsystems.

### Independent Input Processing:

The EGM's input processing software, often part of a UI Management layer within the GMS, is responsible for capturing raw touch events (e.g., touch down, touch up, touch move) from the touchscreen hardware. Upon detecting a touch event, the system immediately retrieves the precise coordinates of the touch. This coordinate data is then compared against the boundaries of the currently active and defined screen segments.

The core of independent input processing lies in this mapping:
1. Segment Identification: The system determines which segment, if any, the touch coordinates fall within.
2. Virtual Control Mapping: Within the identified segment, the system further maps the touch coordinates to specific virtual controls (e.g., virtual buttons for spin, bet adjustment, paytable access, as described in KF1 concept 1.5) displayed by the game UI active in that segment. This involves knowing the layout and active regions of the virtual controls for each game's UI.
3. Input Isolation and Routing: Once a touch is successfully mapped to a virtual control within a specific segment, the input event (e.g., “Spin Button Pressed”) is packaged with an identifier for that segment/game instance and routed exclusively to the Individual Game Logic Engine responsible for that particular game. Inputs detected in one segment do not affect, and are not visible to, the game logic engines of other segments, ensuring complete input isolation.

This process ensures that concurrent player interactions, whether from a single player managing multiple games or multiple players interacting with their respective screen segments, are processed independently and accurately. Robust error-checking algorithms are implemented to ensure accurate touch detection and prevent input spoofing or cross-game interference.

Concurrent UI Rendering without Interference:

The concurrent rendering of multiple game UIs is managed by a UI Rendering Management component, working closely with the GMS and the EGM's graphics processing unit (GPU). Each Individual Game Logic Engine generates the visual state and display updates for its game. The UI Rendering Management system then takes these individual game UI outputs and composites them onto the single physical touchscreen, ensuring each game's UI is rendered strictly within its allocated segment boundaries.

Notable aspects include:
1. Viewport Management: Each game effectively renders to a dedicated viewport corresponding to its assigned screen segment.
2. Resource Allocation: The EGM's processing system, including the GPU, allocates rendering resources (e.g., texture memory, shader processing) to each active game UI. The GMS may manage priorities to ensure smooth performance across all active segments.
3. Independent Refresh Cycles: Each game segment may, in principle, have its own refresh cycle dictated by its game logic, although typically they would be synchronized to the display's overall refresh rate. Updates to one game segment (e.g., reels spinning in game 1) do not cause flickering or overwriting in another segment (e.g., a static paytable display in game 2).
4. Graphics State Isolation: The rendering pipeline maintains separate graphics states for each segment, preventing visual elements or effects from one game from “bleeding” into another.
5. Synchronization: While independent, the display of all segments is synchronized for presentation to the user on the single screen, providing a cohesive multi-game interface.

This careful management of screen real estate, input event handling, and graphics rendering allows multiple, potentially graphically intensive and interactive game UIs to operate side-by-side on the same physical screen harmoniously and without functional or visual interference.

### Practical Application:

The practical application of this segmented touchscreen logic is the ability to offer a vastly more flexible and engaging gaming experience on a single EGM. For instance, a casino may offer a “game wall” experience on one machine, where a player may simultaneously play three different slot games, each with its own controls and display area, on one large, shared screen (as depicted in FIGS. 15 and 18). Alternatively, two or three players may share the same EGM, each interacting with their own game in their dedicated screen segment. This optimizes casino floor space, increases machine utility, and caters to player preferences for multi-tasking or social gaming. The computer (EGM) is not merely a tool but is integral to creating this novel, interactive, multi-game environment through its specialized input processing and display management capabilities.

### Technological Improvement/Improved Computer Functioning:

This segmented touchscreen logic provides a specific technological improvement to EGM functionality and the way computers manage complex user interactions and graphical displays in a specialized environment.
1. Improved Input Management: The ability to accurately capture, isolate, and route touch inputs from multiple, concurrently active virtual game interfaces on a single physical screen is an improvement over traditional single-game EGM input systems or simpler multi-game systems that may require switching UIs rather than simultaneous interaction. This improves the computer's input processing efficiency and accuracy for complex multi-interface scenarios.
2. Enhanced Graphical Display Management: The concurrent rendering of multiple independent game UIs, each with potentially different graphical demands and animations, within defined, non-interfering segments of a single screen improves the computer's (specifically the EGM's graphics subsystem's) display management capabilities. This may require more sophisticated resource allocation, viewport control, and rendering synchronization than typical single-application displays.
3. Increased EGM Utility and Efficiency: By enabling a single EGM to effectively function as multiple independent gaming stations through software-defined screen segmentation and control mapping, the technology improves the operational efficiency and utility of the EGM hardware itself. This is a direct improvement in how the computer resources of the EGM are leveraged.
4. Novel Human-Computer Interaction Model for Gaming: This system provides a new way for players to interact with gaming machines, allowing for simultaneous management of multiple games or shared-screen multiplayer experiences that are not commonly available, thus improving the computer's role in facilitating these novel interaction paradigms.

The software logic for dynamic segmentation, independent input processing, and concurrent UI rendering provides a specific solution that improves how the EGM functions as an interactive gaming platform.

### Example Walk-through Scenario:

A player, Jane, approaches a VCLAPS! EGM which has a large, unitary touchscreen. She opts for a single-player, multi-game mode and selects three distinct slot games: “Game A,” “Game B,” and “Game C.”
1. Segmentation: The Game Management System dynamically divides the EGM's touchscreen into three vertical segments of equal size. Segment 1 (left) is allocated to Game A, Segment 2 (middle) to Game B, and Segment 3 (right) to Game C.
2. UI Rendering: The UI Rendering Management system concurrently renders the full UI of Game A (including its reels, bet buttons, spin button) within Segment 1, Game B's UI in Segment 2, and Game C's UI in Segment 3. All three game UIs are simultaneously visible and active.
3. Input Processing (Game A): Jane decides to play Game A. She touches the virtual “Bet Max” button displayed within Segment 1. The EGM's input processing software captures the touch coordinates, determines they fall within Segment 1, and specifically on the “Bet Max” button for Game A. This input is routed exclusively to the Game Logic Engine for Game A. Game A processes the “Bet Max” command, updates its state, and its UI in Segment 1 reflects the new bet amount. Game B and Game C remain unaffected.
4. Input Processing (Game B): Next, Jane touches the “Spin” button within Segment 2 for Game B. The system similarly maps these coordinates to Segment 2 and the “Spin” command for Game B. Game B's engine processes the spin, and the reels in Segment 2 animate. Games A and C remain unaffected by this action.
5. Concurrent Activity: Jane may then quickly place a bet and spin on Game C using its virtual controls in Segment 3, while the reels of Game B are still spinning. The system handles these near-simultaneous inputs independently, routing each to the correct game logic engine. Each game segment updates its display independently based on its own game state and outcomes.

Throughout this scenario, the software logic ensures that Jane's interactions with one game segment are confined to that game, and all three games operate and display their UIs concurrently on the single touchscreen without any functional or visual interference, providing a seamless multi-game experience.

### Proportional Award Calculation Methods

In at least one embodiment, for cooperative games within the VCLAPS! Electronic Gaming Machine (EGM) system, the proportional calculation and distribution of awards, payouts, or prizes among participating players are managed by a server system, typically the First Server System (which may liaise with a dedicated game server or reward processor). This system employs specific methods and parameters to assess individual player contributions to the collective team outcome and allocates rewards accordingly, ensuring fairness and transparency.

### Parameters for Contribution Measurement:

The system is designed to track a variety of player actions and in-game metrics that signify contribution towards cooperative goals. These parameters are configurable per game type and cooperative mission design:
1. Wager-Based Contributions: The amount wagered by each player during the cooperative game session may be a primary factor. Players who risk more or contribute more to the collective wager pool may receive a proportionally larger share of monetary winnings.
2. Action-Based Contributions: Specific in-game actions important to achieving cooperative objectives are logged. This may include, but is not limited to:
   Successfully completing specific tasks or mini-games within the larger cooperative mission.
   Achieving certain performance metrics such as points scored, targets neutralized, items collected, puzzles solved, or objectives secured.
   Utilizing special abilities or resources that benefit the team.
   Time spent actively participating in important phases of the game.
3. Role-Based Contributions: Some cooperative games may assign specific roles to players. Contributions may be weighted based on the successful execution of role-specific duties.
4. Achievement/Milestone-Based Contributions: Unlocking specific team achievements or reaching collective milestones during the game may assign contribution points to the players involved.
5. Player Input/Decisions: In games with branching narratives or strategic decision points, the quality or impact of a player's input or decision that leads to a positive team outcome may be quantified as a contribution.

### Methods for Proportional Calculation:

The server system uses algorithms that process the tracked contribution parameters based on predefined rules or real-time gaming data to calculate each player's proportional share.
1. Points-Based System:
   Each significant action or contribution parameter is assigned a point value (e.g., completing objective X=50 points, wagering Y amount=10 points per unit).
   At the end of the cooperative game or a reward cycle, each player's total contribution points are summed.
   The total award pool is divided by the total team contribution points to get a “per-point value.”
   Each player's share is then their total points multiplied by the per-point value.
   Algorithm Example: Player_Share=(Player_Individual_Points/Team_Total_Points)*Total_Award_Pool.
2. Weighted Contribution System:
   Different contribution parameters are assigned different weights based on their importance to the game's success. For example, completing a primary objective may have a higher weight than collecting a secondary item.
   Each player's contribution in each category is multiplied by its weight, and these weighted scores are summed to get a total weighted contribution score for each player.
   Awards are distributed based on the ratio of each player's total weighted contribution score to the sum of all players' total weighted contribution scores.
3. Stake-Based Proportionality (Primarily for Monetary Rewards):
   If the award is monetary and directly tied to wagers, the proportion may be directly based on each player's share of the total amount wagered by the team for that specific game instance or bonus round that resulted in the award.
   Algorithm Example: Player_Share=(Player_Individual_Wager/Team_Total_Wager)*Total_Monetary_Award.
4. Tiered or Milestone-Based Distribution:
   Predefined rules may state that players reaching certain individual or team contribution milestones receive a fixed portion or percentage of the award. For example, “Players contributing over X points receive Y % of the bonus.”
   The remaining pool may then be distributed based on another proportional method.
5. Dynamic Real-Time Adjudication:
   In some sophisticated scenarios, the game server may use real-time gaming data to dynamically adjust contribution values. For instance, if a player's action at an important moment saved the team from failure, the system may assign a higher dynamic multiplier to that action's contribution value.

### Role of the Server System:

The First Server System (or a dedicated game/reward server it communicates with) performs the following:
1. Data Collection: Receives and logs detailed player action data, wager amounts, and performance metrics from the EGM for each player participating in the cooperative game.
2. Rule Storage & Application: Stores the game-specific rules for contribution parameters, point values, weights, and distribution algorithms. It applies these rules to the collected data.
3. Calculation Execution: Executes the chosen proportional calculation algorithm to determine each player's share of the total award, payout, or prize.
4. Award Instruction: Instructs the EGM (for credit meter updates on virtual meters) or the casino's financial systems (for direct account credits or larger prize claims) on how to distribute the calculated shares to each player. This involves updating individual player virtual meters and, subsequently, their linked player tracking accounts.

### Ensuring Fairness and Transparency:

The system may be designed to provide players with feedback on their contributions. For example, the EGM interface may display individual scores, contribution summaries, or how their actions are impacting the team's progress or their potential share of rewards. Post-game, a summary screen may show the breakdown of contributions and how rewards were distributed, enhancing transparency and trust in the fairness of the proportional award system. All calculations and distributions are logged for auditing purposes.

### Practical Application:

The practical application of these specific proportional award calculation methods is the ability to host engaging and fair cooperative multiplayer games on an EGM. It ensures that players are rewarded equitably based on their actual involvement and contribution, rather than a simplistic equal split that may discourage effort or enable free-riding. This makes cooperative games more appealing and commercially viable for casinos, as players feel their efforts are recognized. For example, in a cooperative mission to defeat a “boss” character, players who dealt more damage, performed important healing, or achieved notable objectives may receive a proportionally larger share of the jackpot, motivating active participation. The computer-based server system is desirable for tracking these potentially complex contributions in real-time and performing the calculations accurately and without bias.

### Technological Improvement/Improved Computer Functioning:

The server-based system for proportional award calculation in cooperative games represents a technological improvement in EGM and gaming server functionality.
1. Complex Data Tracking and Analysis: The server system is improved to track and analyze a multitude of granular in-game player actions and metrics specifically for the purpose of assessing contribution. This goes beyond simple win/loss tracking and involves sophisticated data logging and correlation.
2. Customizable Algorithm Execution: The server's computer functionality is enhanced by its ability to store, select, and execute various configurable algorithms (points-based, weighted, stake-based) for reward distribution. This adaptability to different game designs is an improvement.
3. Real-Time Contribution Assessment: For some methods, the server processes real-time gaming data to assess contributions dynamically, requiring more advanced processing capabilities than static payout tables.
4. Automated and Fair Reward Adjudication: Automating the complex task of fairly dividing a collective award based on varied individual inputs improves the efficiency and impartiality of the reward process compared to manual or simplistic divisions. This enhances the computer's role in game management and financial distribution.
5. Improved Player Engagement Mechanics: By enabling game designs where rewards are directly and proportionally tied to contribution, the underlying server technology facilitates a more engaging and strategically deep cooperative gaming experience, which is an improvement in how gaming systems deliver interactive entertainment.

This system enhances the computer's (server's) ability to manage complex social gaming mechanics and their associated financial outcomes in a fair, transparent, and automated manner.

### Example Walk-Through Scenario:

Three players—Player A, Player B, and Player C—are engaged in a cooperative “Monster Hunt” game on a VCLAPS! EGM. The objective is to defeat a powerful monster, and the team prize is 1000 bonus credits. The First Server System tracks contributions based on “Damage Dealt” (DD) and “Important Support Actions” (CSA) performed (e.g., healing an ally, stunning the monster). Each CSA is worth 50 DD equivalent points.
1. Gameplay and Contribution Tracking:
   Player A focuses on damage, dealing 600 DD. Player A performs 1 CSA (50 points). Total contribution for A=600+50=650 points.
   Player B balances damage and support, dealing 300 DD and performing 4 CSAs (4*50=200 points). Total contribution for B=300+200=500 points.
   Player C is newer and deals 100 DD, performing 0 CSAs. Total contribution for C=100 points. The EGM reports these actions to the First Server System in real-time, which logs them against each player's session and virtual meter context.
2. Award Calculation (Points-Based System):
   The team successfully defeats the monster.
   The First Server System calculates the Team_Total_Points=650 (A)+500 (B)+100 (C)=1250 points.
   The server calculates the per-point value for the bonus credits: 1000 credits/1250 points=0.8 credits per point.
3. Proportional Distribution:
   Player A's share=650 points*0.8 credits/point=520 credits.
   Player B's share=500 points*0.8 credits/point=400 credits.
   Player C's share=100 points*0.8 credits/point=80 credits.
4. Award Instruction and Meter Update:
   The First Server System sends instructions to the EGM. The EGM updates Player A's virtual meter by +520 credits, Player B's by +400 credits, and Player C's by +80 credits.
   The EGM interface may display a summary: “Team Victory! Prize: 1000 Credits. Player A: 520, Player B: 400, Player C: 80, based on contribution.”

This demonstrates how the server system uses defined parameters (DD, CSA) and a points-based calculation method to proportionally distribute the team award, reflecting each player's contribution to the cooperative success.

### EGM-as-ATM Authentication and Security

In at least one embodiment, the security for the Electronic Gaming Machine (EGM) functioning as a personal Automated Teller Machine (ATM) for player tracking accounts is multi-faceted, encompassing robust player authentication, secure communication, stringent transaction authorization, physical hardware security, and comprehensive audit trails.

Player Authentication: Before any ATM-like transaction (deposit to or withdrawal from a player's casino account) is permitted, the player may be securely authenticated at the EGM. This typically involves a multi-factor approach. The primary identification is often through the insertion of a casino-issued player tracking card into the EGM's player tracking card reader 138, 230, 326. Following card insertion, the player is commonly required to enter a Personal Identification Number (PIN) via the EGM's touchscreen 116 or a physical keypad. The EGM transmits this card data and encrypted PIN to the First Server System for verification against the Player Account Database. In some embodiments, enhanced security may involve biometric verification, leveraging EGM-equipped sensors such as a fingerprint scanner, or a camera (e.g., camera 127, 640, 950, 1062) for facial recognition, if such hardware is present. Only upon successful authentication by the First Server System is the player granted access to their account functions via the EGM.

Secure Communication: All data exchanged between the EGM and the First Server System concerning player authentication, account inquiries, and financial transaction details (e.g., player credentials, transaction types, amounts, account balances) is encrypted using industry-standard secure communication protocols, such as Transport Layer Security (TLS) or Secure Sockets Layer (SSL). This ensures the confidentiality and integrity of sensitive information during transit, preventing eavesdropping or man-in-the-middle attacks.

Transaction Authorization: Authorization for deposits and withdrawals is managed by the First Server System. For a deposit, after the EGM's credit input device (e.g., bill validator 128, 234, 601) validates the inserted cash or ticket, the EGM securely communicates the details to the First Server System. The First Server System then processes the transaction by crediting the authenticated player's casino account and confirming success. For a withdrawal, the player's request from the EGM interface is sent to the First Server System, which verifies the player's identity and checks the available balance in their casino account via the Player Account Database. If funds are sufficient and the transaction is authorized, the First Server System initiates a debit from the player's casino account and sends an explicit authorization command to the EGM to dispense the cash. The EGM will not dispense cash without this server-side authorization.

Physical Hardware Security: The EGM's cash handling peripherals, including the bill validator 128 and the cash dispensing device 137, are themselves hardened secure modules. These devices are physically secured within the EGM cabinet and may incorporate tamper-evident seals and sensors that may report any unauthorized access attempts to the casino security system or the EGM's management system.

Transaction Logging and Audit Trails: Comprehensive audit trails of all ATM-like transactions, authentication attempts (both successful and failed), and any system errors are logged securely. These logs are maintained by the First Server System and potentially mirrored or supplemented by logs on the EGM. Logs include details such as player ID, EGM ID, transaction type, amount, date/time, and authorization status, providing a traceable record for security reviews, dispute resolution, and compliance purposes.

Transaction Limits and AML Monitoring: Predefined limits may be imposed on withdrawal amounts, deposit amounts, or the frequency of ATM transactions per player or per EGM to mitigate fraud risks. Furthermore, these EGM-based ATM transactions are subject to Anti-Money Laundering (AML) monitoring (as detailed in Novel Element 4), where transaction patterns are analyzed for suspicious activity.

These layers of security work in concert to ensure that the EGM as ATM functionality is performed in a secure and controlled manner, safeguarding player accounts and casino assets.

### Practical Application:

The practical application of these security measures is the establishment of a trustworthy and reliable system for players to manage their casino funds directly at an EGM. Players may confidently deposit cash into their casino accounts or withdraw winnings as physical cash using the EGM, with the assurance that their identity is verified, their data is protected, and transactions are accurately processed under server authority. This transforms the EGM into a secure, multi-functional financial touchpoint, enhancing player convenience by reducing the need to visit separate ATMs or casino cages. For the casino, it provides a secure way to offer enhanced services, streamline cash handling processes, and maintain rigorous control over financial transactions occurring at the EGM. The computer systems (EGM and First Server System) are integral to implementing these complex security protocols, which are far beyond manual capability.

### Technological Improvement/Improved Computer Functioning:

The security measures for the EGM-as-ATM functionality represent a significant technological improvement in how EGMs operate and interact with casino financial systems. Conventional EGMs, while secure in their gaming and basic cash handling, do not typically offer direct, authenticated access to a player's distinct casino account for deposits and withdrawals with this level of integrated security.

The improvement in computer functioning includes:
1. Enhanced Authentication Processing: The EGM's computer system, in conjunction with the First Server System, performs robust multi-factor authentication (card+PIN, potentially biometrics) specifically for authorizing access to a player's casino account, which is a more complex authentication task than standard EGM credit loading.
2. Secure Transaction Protocol Management: The EGM's software and network interface are improved to handle secure, encrypted communication (e.g., TLS/SSL) with the First Server System for sensitive financial account transactions, ensuring data confidentiality and integrity beyond typical game data reporting.
3. Server-Side Authorization Logic: The First Server System's computer functionality is improved to act as an authorization hub for EGM-initiated ATM transactions, checking account balances and enforcing transaction rules before commanding EGM hardware (cash dispenser). This centralized server-side control over EGM peripheral actions for account transactions is a specific improvement.
4. Integrated Audit Trail Generation: The EGM and First Server System computers are programmed to generate detailed, synchronized audit trails specifically for these ATM-like account transactions, improving traceability and security monitoring.

These features collectively enable the EGM's computer system to perform new, secure financial roles, improving its overall functionality and integration within the casino's secure financial ecosystem.

### Example Walk-Through Scenario:

Player Sarah wishes to withdraw $200 from her casino player account using a VCLAPS! EGM.
1. Authentication: Sarah inserts her player tracking card into the EGM's reader 138. The EGM's touchscreen 116 prompts her to enter her 4-digit PIN. Sarah enters her PIN. The EGM encrypts the PIN and card data and sends it via a TLS-encrypted connection to the First Server System. The First Server System verifies the card and PIN against its Player Account Database. Authentication is successful.
2. Transaction Request: The EGM displays Sarah's account options. She selects “Withdraw Funds” and enters “$200”. The EGM transmits this request securely to the First Server System.
3. Authorization: The First Server System checks Sarah's account balance. It confirms she has $500 available. The server debits $200 from her account, logs this debit, and sends an encrypted authorization command to the EGM, instructing it to dispense $200.
4. Dispensing & Logging: The EGM receives the authorization. Its internal controller commands the cash dispensing device 137 to dispense $200. The EGM logs the dispensation and confirms completion back to the First Server System. Sarah collects her cash.
5. Security Logging: Both the EGM and the First Server System have logged the entire transaction: Player ID (Sarah), EGM ID, timestamp, transaction type (withdrawal), amount ($200), authentication success, and authorization grant. If Sarah had entered an incorrect PIN three times, the First Server System would have locked ATM access from that EGM for her card temporarily and logged these failed attempts. If the EGM's cash dispenser 137 had a mechanical issue, it would report an error to the First Server System, Sarah's account would not be debited (or would be immediately re-credited), and she would be notified of the issue.

### Technological Improvements and Practical Applications

In at least one embodiment, the VCLAPS! Electronic Gaming Machine (EGM) system, through the combination of its novel features—including the dual-architecture metering system, the EGM-as-ATM functionality, unified multi-game and multi-player management on a segmented unitary touchscreen with shared hardware, and integrated EGM-level AML monitoring—represents a specific and significant technological improvement to conventional EGM functionality and addresses concrete problems inherent in casino operations. The system is not merely an abstract idea or conventional data processing implemented on a generic computer; rather, it involves a specific configuration and interaction of software and hardware components (EGM processors 12, 204, memory 14, 208, specialized First and Second Server Systems, EGM peripherals like bill validators 128, 234, 601, cash dispensers 137, 602, player tracking readers 138, 230, 326, and dynamic touchscreen displays 116) to achieve new capabilities and improved performance.

The system achieves these improvements through specific technical steps and transformations. For instance, the dual-architecture metering system processes financial data by segregating it into granular virtual meters (managed by the First Server System) for individual player/session tracking and concurrently aggregating this data into a distinct unified regulatory meter (managed by the EGM or a Second Server System). This involves specific data routing logic within the EGM and server communications, data transformation for aggregation, and state management for numerous concurrent financial contexts. The EGM-as-ATM functionality involves secure authentication protocols (card, PIN, potential biometrics), encrypted communication with the First Server System, and server-authorized commands to EGM cash handling peripherals, transforming the EGM into a secure financial transaction point for player casino accounts. The unified multi-game/multi-player management relies on software logic for dynamic touchscreen segmentation, independent input processing from distinct screen zones (mapping touch coordinates to specific game virtual controls and routing to individual game logic engines), and concurrent rendering of multiple, independent game UIs without interference, all managed by the EGM's Game Management System and UI Rendering Management components. The EGM-level AML monitoring employs algorithms and a rule engine within the EGM or First Server System to analyze real-time virtual meter data, transaction peripheral data, and gameplay behavior against configurable rules and patterns (e.g., for structuring, minimal play) to detect and flag suspicious activity locally and promptly.

These are not mere data gathering or organizational tasks but involve specific technical operations, transformations of data into actionable commands or aggregated reports, and control over physical EGM components and player-facing interfaces to create a fundamentally improved and more versatile gaming apparatus.

### Practical Application:

The combined features of the VCLAPS! system provide numerous practical applications within a casino environment, directly solving tangible problems and enhancing operational capabilities.
1. Efficient Player Fund Management on Multi-Game/Multi-Player Machines: The dual-architecture metering and EGM-as-ATM features allow players to seamlessly manage funds in their casino accounts directly at the EGM, deposit cash to their account via the EGM, or withdraw physical cash from their account via the EGM, even when multiple independent game sessions (for one or more players) are active on that machine. This eliminates the need for players to move to separate cashier cages or ATMs for such common transactions, making fund management more efficient and integrated into their gaming experience.
2. Granular Individual Tracking Alongside Unified Regulatory Compliance: Casinos face the challenge of tracking individual player activity for loyalty, personalization, and responsible gaming, while also needing to report overall EGM performance in a consolidated manner for regulatory bodies. The system's First Server System manages distinct virtual meters for each player/session, providing the necessary granularity. Simultaneously, data from these virtual meters is aggregated into a unified regulatory meter, simplifying compliance for the EGM as a whole. This solves the problem of balancing detailed tracking with straightforward regulatory oversight on shared or multi-game devices.
3. Enhanced Machine Utility and Player Experience through New Interaction Models: The unified multi-game and multi-player management, leveraging a dynamically segmented unitary touchscreen with independent virtual controls for each segment, allows a single physical EGM to offer diverse gaming experiences. A single player may play multiple different games simultaneously, or multiple players may engage in their own separate games on the same EGM. This drastically improves the utility of the EGM hardware and optimizes casino floor space. It also introduces novel player interaction models, enhancing engagement and choice. The cooperative game modes with proportional award calculations further provide new, socially engaging practical gaming applications.
4. Improved Security and Compliance at Point-of-Origin: The integrated EGM-level AML monitoring provides immediate detection of suspicious financial activities directly at the terminal where they occur. This practical application addresses the need for timely intervention and supports robust AML compliance efforts by analyzing granular transaction and behavior data.

The computer components (EGM, servers, specialized software modules) are not merely tools for these applications but are fundamental to their existence and functionality, enabling interactions, calculations, and data management that would be otherwise impossible.

### Technological Improvement/Improved Computer Functioning:

The VCLAPS! system, through its combined novel elements, provides specific technological improvements to the functioning of EGMs and the supporting casino gaming network, addressing concrete technical problems:
1. Improved EGM Resource Management and Versatility: The system improves the EGM's computer functioning by enabling its processor and display hardware to manage and render multiple, independent, concurrent game applications and user interfaces via dynamic touchscreen segmentation and isolated input processing. This is a technical improvement over EGMs designed for single game execution or simple toggling between pre-loaded games without true concurrent, independent operation and UI presentation. It makes the EGM a more versatile and efficiently utilized computing device within the casino.
2. Advanced Financial Transaction Processing and Accounting Architecture: The dual-architecture metering system is a specific technological improvement to computerized financial accounting in a regulated gaming environment. It improves the EGM and associated server systems' ability to process and segregate financial data by creating two distinct but linked layers of metering: granular virtual meters for individual player/session account transactions (managed by the First Server System) and an aggregated unified regulatory meter. This specific architecture allows the system to handle complex financial scenarios (like direct player account deposits/withdrawals at the EGM, or multi-player individual balances) that are not well supported by traditional EGM metering, thus enhancing the computer's financial processing and reporting capabilities.
3. Enhanced Security and Compliance Functionality within the EGM System: The integration of secure authentication for ATM-like transactions (card, PIN, server validation for account access) and EGM-level AML monitoring algorithms that analyze real-time virtual meter and gameplay data represent direct technological improvements to the EGM system's security and compliance functions. These features improve the computer's ability to perform tasks of secure financial intermediation and localized threat detection, rather than acting as a passive game terminal.
4. Improved Human-Computer Interaction for Multi-Game/Multi-Player Scenarios: The software logic for dynamically segmenting a unitary touchscreen, mapping independent virtual controls within each segment, and routing inputs to distinct game engines provides a specific, improved technical means for human-computer interaction in a multi-application environment. This is a technological improvement in UI/UX management for complex gaming systems.

The specific configuration of EGM processors, memory, secure communication interfaces, specialized server software (for the First and Second Server Systems), and advanced software logic for game management, UI segmentation, input processing, multi-layered metering, and AML analysis interact to achieve these practical results.

For example, the EGM's processor executes the Game Management System software to handle concurrent game instances and UI segmentation logic. It communicates via secure network protocols with the First Server System (running on its own processors and memory) which manages virtual meters and player account databases. Data from these virtual meters is then aggregated, either by the EGM or the Second Server System, for the unified regulatory meter. This intricate interplay of distributed software and hardware components is desirable to delivering the system's improved functionality and addressing the identified technical problems in casino operations.

### Example Walk-Through Scenario:

Consider a casino floor equipped with VCLAPS! EGMs.
Scenario: Enhanced Machine Utility and Fund Management.

A player, Tom, approaches a VCLAPS! EGM displaying three different game UIs (Game X, Game Y, Game Z) on its large, segmented unitary touchscreen.
1. ATM Deposit: Tom inserts his player card. The EGM authenticates him with the First Server System (PT Server) using his PIN. He chooses an “Account Deposit” option. The EGM's bill validator 128 accepts his $100 cash. The EGM securely communicates this to the PT Server, which credits Tom's main casino account and confirms. This happens without Tom needing to go to a cashier.
2. Multi-Game Play & Individual Tracking: Tom decides to play Game X and Game Y simultaneously. He allocates $60 from his casino account to a virtual meter for Game X (VM-X) and $40 to a virtual meter for Game Y (VM-Y) via the EGM interface, authorized by the PT Server. The EGM's segmented touchscreen shows Game X in one segment and Game Y in another, each with independent virtual controls. He plays both, with VM-X and VM-Y independently tracking bets and wins.
3. AML Check: Tom makes several large bets on Game X quickly. The EGM's integrated AML module, analyzing data from VM-X and his betting velocity, flags this as unusual for his known profile (or against general thresholds if he were uncarded). An alert is quietly sent to the casino's AML compliance system, demonstrating localized, real-time monitoring.
4. Regulatory Meter Aggregation: Throughout Tom's play, the financial activity from VM-X and VM-Y (and any other active virtual meters on this EGM, perhaps from another player in a different segment if it were a multi-player setup) is aggregated by the EGM or Second Server System (CMS) into the EGM's single unified regulatory meter. So, if Tom wagered $30 on Game X and $20 on Game Y, the regulatory meter would reflect $50 in wagers for that period from this EGM.
5. ATM Withdrawal: Tom wins $50 on Game Y, credited to VM-Y. He decides to withdraw $30 cash. He requests this from VM-Y via the EGM interface. The PT Server verifies VM-Y's balance, authorizes the withdrawal from his linked casino account funds, and instructs the EGM's cash dispenser 137 to issue $30.

This scenario illustrates how the VCLAPS! system's combined features (EGM-as-ATM, multi-game with segmented screen, dual-architecture metering, AML) provide a technologically improved EGM that solves problems of fund management inefficiency, tracking granularity versus regulatory needs, limited machine utility, and AML latency, all through specific configurations and interactions of its software and hardware components.

### Alternative Server Architectures

In at least one embodiment, the VCLAPS! system architecture, while centered on a First Server System and a Second Server System, is flexible and may be implemented in various configurations to suit different operational and technical environments. The primary functions of managing granular player-specific virtual meters and aggregating data for a unified regulatory meter remain constant, but the physical and logical deployment of the server components may vary.

In one alternative embodiment, a distributed model may be employed where a portion of the First Server System's logic is executed directly on a powerful Electronic Gaming Machine (EGM) processor⁹. In this configuration, the EGM is equipped with enhanced processing capabilities (e.g., processor 12, 204) and sufficient memory (e.g., memory 14, 208) to handle real-time virtual meter updates for its own active sessions locally. The EGM would manage the state of its associated virtual meters, process wagers and wins against them, and communicate only finalized transaction data or summary updates to the central First Server System. The First Server System would still be responsible for the overarching player account management, including processing deposits to and withdrawals from the main player account database, and for authorizing transactions that affect the player's casino-wide balance. This distributed architecture reduces network traffic for high-frequency game activity data and increases the EGM's autonomy, improving responsiveness. Secure communication protocols remain desirable for the synchronization between the EGM's local virtual meter management and the central First Server System.

In another alternative embodiment, the First Server System and the Second Server System may be implemented on the same physical server hardware¹⁰. To maintain the distinct architectural separation required for both granular control and compliant regulatory reporting, the two systems would operate as logically separate, firewalled processes¹¹. This may be achieved using virtualization technologies or containerization. One virtual machine or container would run the First Server System application, managing the plurality of virtual meters and player account interactions. A second, logically isolated virtual machine or container would run the Second Server System (CMS) application, responsible for receiving aggregated data and maintaining the unified regulatory meter¹². Communication between these two logical servers would occur over a secure virtual network interface, enforcing the same data integrity and security rules as if they were on separate physical machines. This configuration reduces the hardware footprint and simplifies physical maintenance while preserving the functional and logical distinction of the dual-architecture metering system.

In every configuration, the fundamental data flow and separation of duties are preserved. The First Server System (or its distributed EGM component) handles the many-to-one relationship of multiple player sessions and their respective virtual meters. The Second Server System handles the aggregated, single-entity view required for regulatory compliance. Secure, authenticated communication protocols such as TLS/SSL are used for all data exchange, and robust data reconciliation mechanisms are in place to ensure consistency between the virtual meter data and the final aggregated regulatory meter data¹³

### Practical Application:

The practical application of these alternative server architectures is to provide casinos with flexibility in deploying the VCLAPS! system. A casino with a modern, powerful EGM inventory may opt for the distributed model to leverage its on-device processing power and reduce network load, leading to a highly responsive gaming experience¹⁴. A casino looking to consolidate its data center footprint and simplify hardware management may prefer the logically separated single-server model¹⁵. Both architectures achieve the same practical result: enabling a single EGM to support multiple, independent player sessions with distinct financial tracking via virtual meters, while ensuring simplified and accurate regulatory reporting through a unified meter. This solves the operational problem of needing to choose between granular player tracking and simple compliance, by providing a technical framework that supports both simultaneously in a physically and operationally efficient manner. The computer systems are integral, as they perform the processing, logical separation, and secure communication required to implement these flexible yet robust architectures.

### Technological Improvement/Improved Computer Functioning:

These alternative architectures represent specific technological improvements to the functioning of a casino gaming network. The distributed model improves the functioning of the EGM's computer by offloading real-time virtual meter calculations from a central server, enabling the EGM processor to perform more sophisticated local data management, which improves its efficiency and reduces latency in gameplay feedback¹⁶. This enhances the EGM's capabilities beyond a simple display terminal to a more powerful edge computing device within the network.

The single-server, logically separate model improves computer functionality by using virtualization or containerization to run multiple, secure server processes on a single hardware platform¹⁷. This is a more efficient use of server hardware resources compared to requiring separate physical servers for each function. The implementation of secure virtual networking to maintain a firewalled separation between the first and second server systems on the same machine is a specific technological approach to data security and system organization, improving the server's ability to perform multiple, distinct roles without compromising the integrity of either process. Both architectures provide a concrete technological improvement over a rigid, one-size-fits-all server configuration by offering adaptable solutions that optimize resource usage (network bandwidth, EGM processing power, or server hardware) depending on the specific operational context of the casino.

### Example Walk-Through Scenario:

Consider a casino implementing the logically separate single-server architecture. A single physical server in the data center runs two virtual machines (VMs). VM1 runs the First Server System (PT Server) application, and VM2 runs the Second Server System (CMS) application¹⁸. An EGM on the floor has two active players, Player X and Player Y.
1. Player Interaction: Player X inserts $20 into the EGM's bill validator¹⁹. The EGM sends an encrypted message over the network to the IP address of the physical server, directed to the port for VM1 (the PT Server).
2. First Server System Processing: VM1 receives the request, authenticates the EGM, and updates the virtual meter for Player X (VM-X) with a +$20 credit²⁰.
3. Data Aggregation: Periodically, the PT Server on VM1 provides aggregated data for the EGM. It sends a secure message over the server's internal virtual network to VM2 (the CMS)²¹. This message states that the EGM's total cash-in for the period has increased by $20.
4. Second Server System Processing: The CMS application on VM2 receives this data and updates the single unified regulatory meter for that EGM, reflecting a $20 increase in its cash-in total²².
5. Reconciliation: At the end of a reporting cycle, the CMS on VM2 may query the PT Server on VM1 for a detailed transaction log to reconcile its aggregated totals with the sum of the individual virtual meter transactions, ensuring data integrity despite both systems running on the same physical hardware²³.

This scenario illustrates how the core dual-architecture functionality is preserved in a consolidated hardware environment, providing a flexible and efficient deployment model.

### Expanded Cooperative Game Modes

In at least one embodiment, the VCLAPS! system architecture supports a variety of advanced cooperative game modes that extend beyond simple proportional award calculation, fostering deeper team-based interaction and strategy.¹ These modes are enabled by the First Server System's flexible management of virtual meters and the EGM's ability to handle inter-session communication between concurrently running games. Two such exemplary modes are the “Team Bank” mode and the “Player-Triggered Feature Unlock” mode.²

In a “Team Bank” cooperative mode, participating players pool their resources into a shared virtual meter for a specific cooperative mission or game.³This implementation is managed by the First Server System, which, upon initiation of the team game, creates a temporary, special-purpose “team bank” virtual meter. This team meter is logically distinct from the players' individual virtual meters but is linked to the cooperative game session and the participating players' accounts. Players then contribute funds to this team bank meter by authorizing transfers from their personal virtual meters. All wagers for the cooperative game are subsequently debited from this shared team bank meter, and any collective winnings are credited back to it. The First Server System tracks each player's individual contribution to the team bank. At the conclusion of the cooperative game, the remaining balance in the team bank virtual meter is distributed back to the individual players' personal virtual meters. The rules for this final distribution are configurable per game; for example, funds may be returned proportionally based on each player's initial contribution, or they may be split equally among all team members. The First Server System's processor executes the logic to create, manage contributions to, process game transactions against, and dissolve this shared virtual meter, handling all the necessary financial accounting.

In a “Player-Triggered Feature Unlock” cooperative mode, one player's successful game outcome or achievement directly triggers a bonus, feature, or advantage for another player or for the entire team.⁴ This functionality may require a real-time, event-driven communication pathway between the different game instances running concurrently on the EGM. This pathway is managed by the EGM's Game Management System (GMS), potentially in coordination with the First Server System. The system continuously monitors the game state of each linked cooperative session. When a predefined trigger event occurs in Player A's game—such as landing a specific symbol combination or completing a mission objective—Player A's Game Logic Engine sends an event message to the GMS. The GMS, recognizing this as a cross-session trigger, immediately routes a corresponding command to the Game Logic Engine of Player B (or all other team members). This command instructs the recipient's game to activate a specific bonus feature, such as awarding a set of free spins, adding a wild symbol to the game board, or applying a temporary score multiplier. The First Server System logs these cross-session trigger events and the resulting awards to ensure a complete audit trail and accurate reward accounting for all players involved.

### Practical Application:

The practical application of these expanded cooperative game modes is the creation of more diverse, strategic, and socially engaging gaming experiences on a single EGM. These modes address a growing player demand for interactive and less solitary forms of casino entertainment. The “Team Bank” mode introduces a practical element of collective resource management and shared financial risk and reward, encouraging teamwork and communication. The “Player-Triggered Feature Unlock” mode makes gameplay more exciting and interdependent, as players are incentivized to watch and root for their teammates, knowing that another player's success may directly benefit their own game. This transforms the EGM experience from parallel, isolated play into a truly collaborative event, enhancing player engagement and increasing the appeal of the EGM to groups. The computer systems are integral, as they are required to manage the complex real-time financial accounting of a shared resource like a team bank and to process the event-driven, inter-session communications needed for feature unlocks.

### Technological Improvement/Improved Computer Functioning:

These expanded cooperative modes represent a specific technological improvement to the functioning of the EGM and its supporting server systems. The “Team Bank” mode improves the computer functioning of the First Server System by enabling it to create and manage a new, more complex type of financial instrument: a shared, multi-access virtual meter. This may require more sophisticated logic to handle concurrent contributions from multiple sources and to execute a final, rule-based distribution of the remaining funds, which is an improvement over managing only single-owner virtual meters.

The “Player-Triggered Feature Unlock” mode improves the computer functioning of the EGM's Game Management System and processor. It elevates the system from merely running multiple applications in parallel isolation to managing real-time, event-driven, inter-session communication between them. This may require the EGM's computer to function as a local message bus or event handler for its running game instances, processing a trigger from one application and transforming it into a command for another. This capability to manage logical interactions between concurrent, independent game states is a technological improvement that enables a more dynamic and interactive system, improving the EGM's core function as an entertainment delivery platform.

### Example Walk-Through Scenario:

Scenario A: “Team Bank” Mode. Two players, Alice and Bob, decide to play a cooperative “Dungeon Quest” game on a VCLAPS! EGM. They opt for the “Team Bank” feature. The First Server System creates a “Dungeon Quest Team Meter.” Alice transfers 200 credits from her personal virtual meter, and Bob transfers 100 credits from his. The Team Meter now shows a balance of 300 credits. They play the game, and all wagers are debited from the Team Meter. They successfully complete the quest and win 600 credits, which are credited to the Team Meter, bringing its balance to 900 credits. They decide to end the game. Based on the game's rules for proportional distribution according to contribution, the First Server System calculates their shares: Alice (contributed ⅔) receives 600 credits back to her personal virtual meter, and Bob (contributed ⅓) receives 300 credits.

Scenario B: “Player-Triggered Feature Unlock” Mode. Alice and Bob are playing the same linked game on a segmented screen. Alice's game involves “collecting power gems,” and Bob's game involves “fighting monsters.” The game rules state that when Alice collects three power gems, Bob receives a “Mega Sword” for his next turn. Alice makes a spin and lands the third power gem. Her Game Logic Engine sends a “Gems_Collected” event to the EGM's Game Management System. The GMS immediately sends an “Activate_Mega_Sword” command to Bob's Game Logic Engine. Bob's game UI updates to show he now wields the Mega Sword, allowing him to defeat a monster he otherwise may not have, leading to a large win for him.

### Data Transformation Specifics

In at least one embodiment, the VCLAPS! system performs several specific and important data transformations that are fundamental to its operation and represent a technological improvement beyond the mere collection, organization, or outputting of data. These transformations occur at various points within the system, particularly between the Electronic Gaming Machine (EGM), the First Server System, and the Second Server System, enabling the system's unique functionalities.

One primary data transformation is the conversion of a raw transaction request from the EGM into a secure, authenticated database command by the First Server System. When a player initiates a financial transaction, such as a deposit, the EGM collects raw input data: the player's identifier from the player tracking card reader 138, the transaction type selected on the touchscreen 116, and the monetary value from the credit input device 128. This raw data is packaged and sent to the First Server System. The First Server System's processor then executes instructions that transform this raw request. The data is parsed, validated against business logic, and cross-referenced with the player's authentication status. The validated request is then transformed into a specific, structured, and authenticated database command, such as a parameterized SQL query or a call to a secure stored procedure. This command is the operative instruction that securely updates a record in the Player Account Database, for example by crediting the deposited amount to the player's account balance. This transformation turns a collection of raw player inputs into a secure, executable instruction that directly and precisely modifies a financial record in a controlled database environment.

A second important data transformation is the aggregation of granular virtual meter data into a consolidated data packet for the unified regulatory meter. The First Server System maintains a plurality of virtual meters, each logging a high-frequency stream of individual financial events (e.g., wager of $1.25 on Game A, win of $0.50 on Game B, wager of $2.00 on Game A). This granular, player-specific data stream is processed by an aggregation module, which may reside on the EGM or a Second Server System. This module transforms the series of individual transaction events into a single, structured data set. It categorizes and sums the events over a defined reporting period, producing aggregated totals for notable metrics like Total_Wagers, Total_Wins, Total_Cash_In, and Net_Win. The output of this transformation is a distinct data packet, formatted specifically for ingestion by the unified regulatory meter. This fundamentally changes the nature of the data from a real-time, granular, multi-context view to a consolidated, historical, single-context summary suitable for regulatory reporting.

A third data transformation involves converting a high-level server authorization into a low-level, specific EGM hardware command. For instance, when the First Server System authorizes a cash withdrawal, its logical decision (“Authorize dispense of $100 for Player X”) is transformed into a specific, encrypted command packet. This packet is formatted according to a hardware communication protocol that the EGM's internal microcontroller may interpret. This low-level command packet may contain precise instructions for activating the cash dispensing device's motors, controlling its optical sensors for a precise bill count, and confirming successful dispensation. This transformation bridges the gap between a logical, server-side financial decision and the direct, physical operation of the EGM's hardware components.

### Practical Application:

These data transformations are desirable for the practical application and functionality of the VCLAPS! system. The transformation of raw EGM requests into secure database commands is what allows the EGM to function as a secure personal ATM for player accounts, ensuring that all financial modifications are validated and accurately recorded. The transformation of granular virtual meter data into aggregated regulatory packets is practically applied to solve the problem of maintaining detailed, individual player tracking for loyalty and personalization while simultaneously providing simplified, compliant financial reporting for the EGM as a single entity. The transformation of server authorizations into specific hardware command packets enables secure, remote control over the EGM's physical functions, such as dispensing cash, which is important for the system's ATM-like capabilities. Without these specific transformations, the system may not function in its intended secure, compliant, and versatile manner.

### Technological Improvement/Improved Computer Functioning:

The data transformations performed by the VCLAPS! system represent a clear technological improvement and an enhancement to the functioning of the involved computer systems (EGM and servers). The system does not merely use a computer to process data; it uses the specific processing capabilities of the distributed system to fundamentally change the data's structure, purpose, and utility.

The transformation of raw inputs into secure database commands improves the server's computer functioning by enabling it to act as a secure transaction processor, applying rules and validation logic to create executable commands that have a direct effect on a secure data store. The aggregation of virtual meter data into a regulatory data packet is a technological improvement in data management for a regulated environment, allowing the system's computers to maintain and present two distinct, concurrent views of financial data (granular and aggregated) from a single set of events.

The transformation of a logical server decision into an encrypted, low-level hardware command improves the functioning of both the server and the EGM. It enhances the server's function by giving it precise, secure control over a remote physical device. It improves the EGM's computer functioning by enabling its microcontroller to be an integral part of a secure, distributed workflow, executing specific physical actions based on validated data packets from a server. These specific data transformations are central to how the VCLAPS! system solves concrete technical problems in casino operations, and they constitute an improvement in how the underlying computer technology is applied in this field.

### Example Walk-Through Scenario:

A player initiates a $50 cash withdrawal from their player account at a VCLAPS! EGM.
1. Initial Data: The EGM captures the raw data: Player ID from their card, the “Withdraw $50” command from the touchscreen, and the PIN they entered.
2. Transformation 1 (Request to Command): The EGM sends this raw data packet to the First Server System. The server validates the PIN and transforms the request into a secure database transaction: BEGIN_TRANSACTION; UPDATE accounts SET balance=balance—50.00 WHERE player_id=‘PID123’ AND balance>=50.00; COMMIT;. This is executed against the Player Account Database.
3. Transformation 3 (Authorization to Hardware Command): Upon successful execution of the database command, the First Server System generates a logical authorization (“OK_TO_DISPENSE_50”). It transforms this into an encrypted hardware command packet, like {cmd: ‘dispense’, val: 50, currency: ‘USD’, nonce: ‘xyz . . . ’}, and sends it to the EGM.
4. Hardware Action: The EGM's microcontroller receives and decrypts the packet. It interprets the command and activates the cash dispenser's motors and sensors to count out and provide $50 cash.
5. Transformation 2 (Event to Regulatory Data): The First Server System logs a “−$50” event for the player's virtual meter. Later, the aggregation module reads this event and adds $50 to the Total_Cash_Out field in the data structure it is building for the unified regulatory meter. This transforms the specific player transaction into a component of an anonymous, aggregated report.

### Hardware Control Specifics

In at least one embodiment, the VCLAPS! system architecture enables server systems, particularly the First Server System, to exert specific, secure, and direct control over the physical hardware components of the Electronic Gaming Machine (EGM). This control is not merely a high-level authorization but involves the generation and interpretation of low-level command packets that activate and manage EGM peripherals. This capability is fundamental to features like the EGM-as-ATM, where server-side financial logic must translate into precise physical actions at the EGM.

The process of exerting this control may be illustrated using the example of a server-authorized cash withdrawal from a player's account via the EGM's cash dispensing device 137. After the First Server System authenticates the player and validates that sufficient funds exist in their casino account, it generates a specific and encrypted hardware command packet. This is not a generic approval message, but a structured, machine-interpretable data packet formatted for the EGM's internal control systems.

In one embodiment, this command packet contains several fields: a command identifier that specifies the action to be taken (e.g., a hexadecimal code for “Dispense Cash”); target device identifiers specifying the peripheral to be controlled; a parameter field containing the precise details of the action (e.g., an amount of 100 and a currency code for ‘USD’); a unique transaction ID to link the physical action back to the specific financial transaction record on the server; and security elements such as a one-time-use nonce to prevent replay attacks and a digital signature generated with the First Server System's private notable.

This command packet is transmitted to the EGM over a secure, encrypted communication channel. The EGM's main processor (e.g., processor 12, 204) receives the packet, authenticates its origin by verifying the server's digital signature, and then decrypts it. The validated command is then routed to the dedicated microcontroller that governs the specified hardware peripheral—in this case, the cash dispensing device 137. The EGM's microcontroller is programmed with firmware specifically designed to interpret these command packets. Upon receiving the ‘dispense’ command, the microcontroller executes a precise, low-level firmware routine. This routine directly interfaces with the hardware, activating the electric motors that drive the bill transport mechanism and engaging optical or mechanical sensors to count each individual bill as it is dispensed. The routine continues until the exact number of bills corresponding to the authorized amount has been counted, at which point the microcontroller deactivates the motors. Throughout this process, the microcontroller also monitors sensors for any hardware errors, such as a bill jam. Upon completion or error, the microcontroller sends a detailed status report back to the EGM's main processor, which is then securely relayed to the First Server System to confirm the outcome and finalize the transaction record.

### Practical Application:

The practical application of this specific hardware control mechanism is the creation of a highly secure and auditable system where physical EGM actions, especially those involving cash handling, are under the direct authority of a central server. This solves the important problem of securely bridging a server-side financial transaction with a real-world physical event at a remote terminal. It allows the EGM to function as a reliable personal ATM, because the dispensing of cash is not left to the EGM's sole discretion but is instead a direct execution of a validated server command. This ensures that every dollar dispensed is irrevocably tied to an authorized and logged transaction on a player's account, which is desirable for preventing financial discrepancies, minimizing fraud, and providing a trustworthy experience for the player.

### Technological Improvement/Improved Computer Functioning:

This method of server control over EGM hardware is a specific technological improvement to the functioning of the distributed computer system that comprises the casino network. It improves the computer functionality of the First Server System by elevating its role from a data manager to a direct, remote controller of physical apparatus. The server's computer is enhanced to perform the specific task of generating low-level, encrypted, and signed command packets designed for machine interpretation, a function beyond typical data processing.

Furthermore, this improves the computer functioning of the EGM. The EGM's microcontroller is transformed from an autonomous component into a secure, trusted agent within a server-managed workflow. Its firmware is specifically improved to parse these secure command packets and translate them into precise electromechanical actions. This tight, secure coupling between a server's logical command and a machine's physical execution is a technological improvement over systems that rely on simpler, high-level “go/no-go” signals, as it provides greater precision, security, and auditability. This improved hardware control protocol enhances the overall integrity, security, and capability of the gaming system.

### Example Walk-Through Scenario:

A player has been authenticated at a VCLAPS! EGM and has requested to withdraw $80 from their player account. The First Server System has verified the player and their account balance, and now must command the EGM to dispense the cash.
1. Command Generation: The First Server System's processor transforms the logical authorization (“Dispense $80”) into a specific command packet: {command_id: 0x01, target: ‘dispenser’, params: {amount: 80, currency: ‘USD’}, tx_id: ‘AB-123’, signature: ‘ . . . ’}. This packet is encrypted and sent to the EGM.
2. Command Interpretation: The EGM's main processor receives and validates the packet. It identifies the target as the ‘dispenser’ and routes the command parameters to the cash dispenser's dedicated microcontroller.
3. Hardware Execution: The microcontroller's firmware interprets the command. Knowing the dispenser is loaded with $20 bills, it calculates it must dispense four bills. It activates the dispenser's motors. An optical sensor counts the bills as they pass: “1 . . . 2 . . . 3 . . . 4”. After the fourth bill is counted, the microcontroller immediately stops the motors.
4. Feedback: The microcontroller sends a “Success, 4 bills dispensed” status message to the EGM's main processor. The EGM relays this confirmation to the First Server System.
5. Finalization: The First Server System receives the confirmation and finalizes transaction ‘AB-123’ in its database as successfully completed. The player collects their $80, and the entire physical action has been securely controlled and logged by the server.

### User Interface Customization

In at least one embodiment, the VCLAPS! Electronic Gaming Machine (EGM) system provides players with the capability to customize the layout of the segmented unitary touchscreen display. This functionality enhances the user experience by allowing players to tailor the multi-game interface to their personal preferences. The customization features may include resizing individual game segments and saving preferred multi-game layouts to a player's profile, which is managed by the First Server System.

The ability to resize game segments is implemented through the EGM's Game Management System (GMS) and its UI Management software. In this embodiment, when a player activates a layout editing mode, the UI presents draggable handles or borders between the active game segments on the touchscreen. The EGM's input processing software is configured to detect touch-and-drag gestures on these specific UI elements. When a player drags a border, the UI Management software continuously captures the coordinate data and sends a stream of resize events to the GMS. The GMS processes these events in real-time, recalculating the dimensions and coordinates for the affected screen segments. To maintain usability, the GMS enforces predefined constraints, such as a minimum allowable width or height for any game segment. Once the player confirms the new layout, the GMS instructs the EGM's UI Rendering Management component to re-render each game's user interface within its newly defined viewport. The game applications themselves may be designed to be responsive, allowing their graphical elements to scale gracefully to fit various aspect ratios and sizes.

The feature for saving and loading preferred multi-game layouts is managed through the interaction between the EGM and the First Server System, and is linked to the player's tracking account. In one embodiment of a saving process, after a player has arranged the game segments to their satisfaction, they may select a “Save Layout” or similar option presented on the EGM's interface. Upon this selection, the EGM's GMS packages the current layout configuration data. This data packet includes information such as the number of active segments, the specific game title assigned to each segment, and the precise dimensions and positioning coordinates of each segment. The EGM then transmits this configuration data, along with the authenticated player's ID, to the First Server System. The First Server System receives this data and stores it within the Player Account Database, creating a persistent record of the player's custom layout.

For the loading process, when a player initiates a session on any compatible VCLAPS! EGM and authenticates with their player tracking card, the EGM may send a request to the First Server System to check for any saved UI layouts. The First Server System queries the Player Account Database for the player's profile and retrieves any stored layout configurations. This data is then transmitted back to the EGM. The EGM's GMS parses the received configuration data and automatically executes the commands to set up the segmented display according to the player's saved preference. This involves launching the specified games and assigning them to their corresponding segments at the saved sizes and positions, allowing the player to instantly begin their session with their personalized multi-game setup.

### Practical Application:

The practical application of user interface customization is the delivery of a deeply personalized and convenient gaming experience. It solves the problem of rigid, static multi-game interfaces that do not account for individual player preferences. A player who finds one game particularly engaging may make its segment larger for better visibility and immersion, while shrinking less-played games. The ability to save these layouts to a player profile provides significant convenience, allowing a player to move to any VCLAPS! EGM in the casino and instantly recreate their preferred multi-game environment with a single selection. This reduces setup time on subsequent visits, enhances player comfort and control, and fosters a stronger sense of personal ownership over the gaming experience, which may increase player loyalty and session duration. The computer is integral to this application, as it is required to manage the complex real-time UI rendering, input handling, and server-side storage and retrieval of user-specific configuration data.

### Technological Improvement/Improved Computer Functioning:

The implementation of user interface customization represents a specific technological improvement to the functioning of the EGM and the casino gaming network. The dynamic resizing functionality improves the EGM's computer functioning by implementing a more advanced, user-driven graphical rendering system. The EGM's processor and GPU are enhanced to handle real-time recalculation of multiple, concurrent application viewports and to re-render complex graphical interfaces in immediate response to direct user manipulation of the layout. This is a technological improvement over systems that may only render predefined, static layouts.

The feature for saving and loading layouts improves the functioning of the overall distributed gaming system. It enhances the First Server System's computer functionality by enabling it to store, manage, and serve user-specific UI configuration data, transforming the server from a simple financial and loyalty tracker into a comprehensive user experience personalization engine. Correspondingly, the EGM's computer functionality is improved by its ability to dynamically receive this configuration data from a remote server and completely reconfigure its multi-game display presentation based on the data. This makes the EGM a more intelligent and adaptable client terminal. This server-client interaction for UI personalization is a technological improvement that allows for a persistent, customized user environment that follows the player across different physical machines on the network.

### Example Walk-Through Scenario:

A player, Maria, is authenticated at a VCLAPS! EGM and is playing three games concurrently in three equal vertical segments. She decides she wants to focus more on the center game, “Gold Rush.” She activates an “Edit Layout” mode on the screen. Draggable handles appear on the borders of the segments. She touches the right border of the left segment and drags it further to the left, shrinking that segment. She then drags the left border of the right segment further to the right. The EGM's GMS recalculates the segment dimensions in real-time, making the center segment for “Gold Rush” significantly wider.

Pleased with this layout, Maria selects “Save Layout” and names it “Focus Mode” via a virtual keyboard. The EGM sends the layout data (e.g., Game1: “Pharaoh's Gold”, Position: Left, Size: 20%; Game2: “Gold Rush”, Position: Center, Size: 60%; Game3: “Space Gems”, Position: Right, Size: 20%) to the First Server System, which saves it to her player profile. The next day, Maria sits at a different VCLAPS! EGM and inserts her player card. After authentication, the EGM interface presents an option: “Load Saved Layout: Focus Mode.” She selects it. The EGM queries the First Server System, receives the “Focus Mode” data, and automatically configures its screen and launches the three games in her custom 60/20/20 resized segments.

### Biometric Authentication Details

In at least one embodiment, the security of the Electronic Gaming Machine (EGM) as a personal ATM functionality is enhanced through the integration of biometric authentication. This provides a robust verification method for authorizing direct deposits to and withdrawals from a player's tracking account via the EGM's cash handling peripherals. The implementation leverages EGM-equipped hardware and secure server-side processing. The EGM may be equipped with biometric sensors, such as an integrated fingerprint scanner or a high-resolution camera (e.g., camera 127, 640, 950, 1062) capable of performing facial recognition scans¹. This biometric factor is used in conjunction with or as an alternative to traditional PIN-based verification to create a more secure authentication process.

The implementation involves two distinct process flows: enrollment and verification. The enrollment process is designed to securely capture and store a player's biometric data. In one embodiment, a player initiates enrollment at a secure, designated terminal, such as a casino loyalty club kiosk or with the assistance of authorized casino staff. The player first authenticates using their existing credentials (e.g., player tracking card and PIN) to ensure they are the legitimate account holder. The system then prompts the player to provide their biometric sample; for instance, to look into the camera for a facial scan or to place their finger on the fingerprint scanner multiple times for a complete capture. The captured raw biometric data is processed by specialized software to extract unique features and create a secure biometric template, which is a mathematical representation of the data. This template, not the raw image or scan, is then encrypted and transmitted to the First Server System to be stored in the Player Account Database, securely associated with that player's account.

The verification process flow occurs at any VCLAPS! EGM equipped with the necessary sensors. When a player initiates a transaction that may require high security, such as an ATM-like withdrawal, they first identify themselves with their player tracking card³. The EGM then prompts for biometric verification. The player looks at the EGM's camera or places their finger on the scanner. The EGM's processor and biometric sensor hardware capture the live biometric data and generate a new, temporary template from this live scan. This live template is encrypted and transmitted to the First Server System. The First Server System's processor then performs a high-speed comparison of the received live template against the securely stored, enrolled template for that player account. A successful match, where the comparison score exceeds a predefined confidence threshold, results in the First Server System sending an authorization message back to the EGM, permitting the transaction to proceed. A failed match results in a denial, and multiple consecutive failed attempts may trigger a temporary lock on account access for security purposes.

### Practical Application:

The practical application of integrating biometric authentication into the EGM is to significantly increase the security of player account transactions, thereby preventing unauthorized access and fraudulent withdrawals. It solves the concrete problem of PINs being forgotten, stolen, or observed by others (shoulder surfing). By tying ATM-like functionality to a player's unique biological characteristics, it ensures that only the legitimate owner of the player tracking account may access and manage their funds through the EGM. This builds player trust and confidence in using the EGM for financial transactions beyond gameplay. For the casino, it reduces the risk of financial loss due to fraudulent account access and minimizes disputes related to unauthorized transactions. The computer systems—EGM and servers—are integral to this application, as they perform the complex tasks of secure biometric capture, template creation, and high-speed matching that are impossible to perform manually and are desirable for a secure and practical implementation.

### Technological Improvement/Improved Computer Functioning:

The implementation of biometric authentication represents a specific technological improvement to the functioning of the EGM and the associated casino server network. It enhances the EGM's computer functionality by enabling it to act as a secure biometric data capture terminal, a role beyond its traditional gaming and simple cash validation functions. The EGM's processor is utilized to interface with specialized sensors (camera, fingerprint scanner), process raw biometric data to create a template, and manage secure communication of this sensitive data.

This system improves the First Server System's computer functionality by incorporating a specialized biometric matching engine. This engine performs computationally intensive one-to-one template comparisons, a specific processing task that enhances the server's capabilities as a security and authentication hub. The overall technological improvement lies in the creation of a more secure financial transaction system within the casino network. By adding biometrics as an authentication factor⁴, the system moves beyond conventional card-and-PIN methods, which are solely based on knowledge and possession, to include an inherence factor (something the user is). This provides a more robust and reliable method of user verification, directly improving the computer's function in safeguarding access to financial accounts and authorizing the operation of physical hardware like cash dispensers.

### Example Walk-Through Scenario:

A player, David, decides to enroll in his casino's biometric authentication program at a loyalty desk kiosk. He inserts his player card and enters his PIN. The kiosk, running software controlled by the First Server System, prompts him to look into its camera for a facial scan. The system captures his facial data, converts it into an encrypted template, and stores it with his player account.

Later, David is playing at a VCLAPS! EGM and wants to withdraw $300 from his player account. He inserts his player card into the EGM's reader. The EGM's display, instead of asking for a PIN, shows a message “Please Look at the Camera to Authenticate.” The EGM's camera performs a scan of David's face, and the EGM's processor generates a live template. This template is securely sent to the First Server System. The server compares the live template from the EGM with the enrolled template stored in David's account. The templates match with a high confidence score. The First Server System sends an authorization command to the EGM. The EGM's screen confirms “Authentication Successful” and proceeds with the withdrawal, dispensing $300 from its cash dispenser.

The transaction is securely logged against David's authenticated session.

### Additional Features and Concepts

1.1 Multiple Games Running while Sharing the Same Set of Meters (Coin in/Coin Out/Etc) as Well as the Same Cash Box, which from Operator Perspective, Consider as a Single EGM

Example Implementation Details: Implementing this feature involves the integration of software and hardware components within the Electronic Gaming Machine (EGM) framework. The EGM is designed to run multiple independent games simultaneously, leveraging a unified metering system that tracks the coin-in and coin-out across all games. This unified approach simplifies the operator's task of monitoring and auditing, treating multiple game instances as a singular EGM entity. Technically, the EGM's main control unit orchestrates the operation of multiple games, ensuring they share the same metering and cash box resources without interference. This is achieved through the development of a sophisticated game management software layer that abstracts the complexities of individual game states and metering logistics into a cohesive, easily manageable system.

Example Walk-Through Interaction: A player approaches the EGM, attracted by the variety of games available on a single machine. After inserting cash into the bill acceptor, the player selects one of the multiple games presented on the touchscreen interface. As the player engages with the selected game, they notice the seamless integration; the credits added reflect across all games, and winnings from any game adjust the unified credit balance in real time. The player enjoys the flexibility of switching between games without the need to cash out or transfer credits, enhancing their gaming experience by the diversity of options and the convenience of a single transaction point.

Example Benefits to Players: Players benefit from a diversified gaming experience without the inconvenience of managing multiple transactions or moving between different machines. The integration of multiple games with shared metering and a single cash box reduces downtime and maximizes playtime, offering a seamless transition between games. Additionally, the consolidation enhances the opportunity for players to engage with a wider variety of games, potentially increasing their chances of finding games that suit their preferences and playing style.

Example Advantages to Casino: For the casino, this feature streamlines operational and auditing processes by consolidating multiple games into a single EGM for accounting purposes. It reduces the physical space required to host a variety of games, optimizing floor space usage. Furthermore, the increased variety and convenience may lead to higher player engagement and retention, potentially boosting the casino's revenue.

Example Procedural Flow: The procedural flow begins with the player inserting cash, which the EGM's bill acceptor processes, updating the unified credit meter. The player selects a game from the available options, with the game management system ensuring that all interactions reflect on the shared metering system. As the player engages with different games, the system continuously updates the unified meter for credits, bets, and winnings. When the player decides to cash out, the system consolidates the final credit balance across all games, issuing a single transaction for the payout. Throughout this process, backend systems log all transactions and gameplay data, ensuring compliance with regulatory standards and facilitating easy auditing. In scenarios requiring maintenance or updates, the system may isolate individual games or components without disrupting the entire EGM operation, thanks to the modular design and intelligent software management layer.

This approach leverages modern software development practices, including modular architecture and microservices, to ensure scalability, maintainability, and compliance with gaming regulations. The integration of secure, real-time data processing and transaction handling mechanisms ensures the integrity of gaming operations and player transactions, aligning with the casino's operational excellence goals and regulatory requirements.

Identification of Concept: This inventive concept involves a VCLAPS! EGM that allows multiple games to run concurrently while sharing the same set of meters (coin in, coin out, etc.) and a single cash box. This system treats multiple game instances as one EGM from an operational perspective, enhancing ease of management and auditing for operators.

### Sequence Diagram Components:

VCLAPS! EGM: The central unit that manages game operations and metering.

Player A, Player B: Players interacting with the EGM, each possibly engaged in different games.
Bill Validator: Accepts and validates currency inserted by players.
Unified Meter System: Tracks and updates financial transactions across all games.
Cash Box: Collects and stores currency from all games.
Backend System: Logs and manages game data for compliance and auditing.

Implementation Details: The main control unit within the VCLAPS! EGM orchestrates the operations of multiple games, ensuring they share metering resources and the cash box without interference. This is enabled by sophisticated game management software that abstracts the complexities of individual game states into a cohesive system.

### Distinguishing Novel Features:

Unified Metering: Allows simultaneous tracking and updating of financial transactions across multiple games.
Single Cash Box Integration: Reduces hardware needs and simplifies cash management.

### Distinguishing Novel Steps:

1. Centralized Game Management: The EGM centrally manages multiple games, using unified metering logic.
2. Real-Time Financial Updates: All games contribute to a unified financial state, updating in real time.
3. Single Transaction Payout: Upon cashing out, players receive a consolidated transaction from all engaged games.

Initial Interaction: Players insert cash into the bill validator, select their games via a touchscreen, and play. The integrated system updates the unified meter and cash box in real time, reflecting transactions across all games.

Data Input: Input from players includes cash insertion, game selection, and in-game actions, all processed by the EGM's integrated systems.

Component Interactions and Procedural Steps:
1. Player inserts cash, which is processed by the bill validator.
2. Player selects a game; the game management system ensures all interactions reflect on the shared meter.
3. As players engage with different games, the unified system updates meters for credits, bets, and winnings.
4. Upon cashing out, the system consolidates the final balance across all games, issuing a single transaction for payout.

Data Processing: The software processes all player inputs, game outcomes, and financial transactions, maintaining a consistent and accurate financial state across multiple games.

Outputs and Responses: Players receive real-time updates on credits and winnings. Upon cashing out, a unified payout is processed, providing a seamless experience across multiple games.

Data Storage and Reporting: All transactions and gameplay data are logged in backend systems, aiding in compliance with regulatory standards and facilitating easy auditing.

Error Handling and Security Measures: The system includes mechanisms for error detection and resolution, ensuring reliable operation. Security measures protect against fraud and ensure data integrity.

End of Interaction: After cashing out or ending their session, the system resets, ready for the next players, maintaining the integrity and separation of player interactions and financial transactions.

### 1.2 Games May be Jackpot Linked, Competing Amongst Players, or Players Collab on Certain Mission

Example Implementation Details: The HighFive platform is designed to support a versatile range of game types, whether they are individually played, linked to a progressive jackpot, facilitate player competition, or involve cooperative missions. This flexibility is made possible through an advanced software architecture that not only manages the gameplay mechanics unique to each game type but also ensures that all games may interact with the shared financial and operational infrastructure of the EGM. For instance, a jackpot-linked game may contribute to and benefit from a pooled jackpot fund, while a game designed for player competition may accurately track and compare scores or achievements in real-time.

Example Walk-Through Interaction: A player at a HighFive EGM may start with a traditional slot game, contributing to a progressive jackpot with each spin. Later, they may switch to a competitive game, challenging another player at the same EGM or connected through a network, competing for the best score or fastest completion time. Finally, they may engage in a cooperative mission, working together with other players to achieve a common goal. Throughout these transitions, the shared financial system seamlessly manages the player's funds, bets, and winnings across the different game types.

Example Benefits to Players: Players benefit from an enriched gaming experience that caters to a wide range of preferences and play styles, all within a single EGM. The ability to contribute to a progressive jackpot offers the excitement of potentially large payouts, while competitive and cooperative games provide social interaction and teamwork elements, enhancing the overall entertainment value. This diverse offering may keep players engaged for longer periods, offering them more ways to enjoy their gaming experience.

Example Advantages to Casino: For casinos, the HighFive concept provides an effective way to cater to diverse player demographics and preferences without needing to increase the number of physical machines on the casino floor. This not only optimizes the use of space but also potentially attracts a broader audience of players.

Additionally, the integrated nature of the platform encourages players to try different types of games, potentially increasing their time and money spent at the machine.

Example Procedural Flow: Upon engaging with the HighFive EGM, the player selects from the variety of available games. As they play, the system dynamically adjusts to the specific rules, payouts, and interactions of each game type, whether accumulating jackpot contributions, managing competitive leaderboards, or coordinating cooperative gameplay objectives. Financial transactions are universally managed by the shared meter system, providing a consistent and seamless management of funds across all game types. This holistic approach ensures that regardless of how the player chooses to engage with the machine, the experience remains fluid and integrated, with all operational and financial aspects handled efficiently by the platform's backend infrastructure.

### Identification of Concept:

This inventive concept focuses on the VCLAPS! EGM's ability to support a diverse range of game types including progressive jackpots, competitive games, and cooperative missions. This flexibility is enabled by an advanced software architecture that integrates various gameplay mechanics while managing shared financial and operational infrastructure.

### Sequence Diagram Components:

VCLAPS! EGM: Central unit managing gameplay and financial transactions.
Player A, Player B: Players interacting with the EGM, potentially in different gameplay modes.
Game Management System: Manages game rules, payouts, and interactions specific to each game type.
Financial System: Handles all financial transactions across different game types.
Backend System: Ensures data integrity and compliance with gaming regulations.

Implementation Details: The VCLAPS! EGM utilizes a robust game management system to accommodate different game types, whether linked to a jackpot, competitive scoring, or cooperative gameplay. This system ensures seamless financial and operational integration across various game types.

### Distinguishing Novel Features:

Adaptive Game Management: Adjusts game mechanics and interactions based on selected game type.
Integrated Financial Transactions: Manages bets and payouts across different game types through a unified system.

### Distinguishing Novel Steps:

1. Dynamic Game Adjustment: The system adjusts game rules and interactions dynamically based on the chosen game type.
2. Seamless Financial Integration: Financial transactions are uniformly managed, regardless of the game type, ensuring a consistent user experience.
3. Real-Time Competitive and Cooperative Elements: Supports real-time updates for competitive and cooperative game elements, enhancing player engagement.

Initial Interaction: Players select their preferred game type from the VCLAPS! EGM. The system adjusts the gameplay interface and rules according to the selected game type.

Data Input: Players input their game selections, and during gameplay, all actions related to bets, choices, and strategies are processed.

### Component Interactions and Procedural Steps:

1. Game Selection: Players choose a game type; the Game Management System configures the game accordingly.
2. Gameplay: Players engage with the game, with the system managing rules and interactions specific to the chosen type.
3. Financial Management: The Financial System handles all transactions, updating player credits and payouts based on game outcomes.

Data Processing: All player interactions and game outcomes are processed to ensure accurate financial tracking and game integrity.

Outputs and Responses: Players receive real-time feedback on their game interactions and financial status. Winnings are calculated and displayed according to the specific game rules.

Data Storage and Reporting: Gameplay data and financial transactions are logged and maintained by the Backend System, supporting regulatory compliance and operational analysis.

Error Handling and Security Measures: The system includes robust error handling and security protocols to maintain data integrity and ensure fair play.

End of Interaction: After gameplay, the system updates all balances and prepares for the next session, ensuring all settings and financials are reset for new players.

This procedural flow ensures that the VCLAPS! EGM may offer a flexible, engaging, and compliant gaming experience across a variety of game types.

### 1.3 Options of Multiple Player Buttons (for Multiple Players), or a Single Player May Play all 3 Games at the Same Time

Example Implementation Details: The HighFive EGM is equipped with a unique interface design that incorporates multiple player buttons, allowing for individualized control in multiplayer scenarios or enabling a single player to engage with multiple games simultaneously. This design leverages advanced input recognition and processing algorithms to differentiate between player inputs in a multiplayer setup or to manage concurrent game sessions for a single player. The interface dynamically adjusts based on the active game mode, displaying relevant controls and information to streamline the gameplay experience.

Example Walk-Through Interaction: In a multiplayer setting, each player has a dedicated set of buttons, ensuring they may make selections, place bets, and interact with their chosen game independently. If a single player opts to play multiple games at once, the interface seamlessly transitions to present the controls and information for all active games, allowing the player to manage each game effectively. This flexibility enhances the EGM's appeal, catering to both social players looking for a shared gaming experience and solo players seeking the challenge of multitasking between games.

Example Benefits to Players: This feature offers players unparalleled control over their gaming experience. In multiplayer modes, each participant enjoys an individualized interaction with the EGM, fostering a sense of ownership and personal engagement with the game. For solo players, the ability to play multiple games concurrently presents a unique challenge that may heighten the excitement and potential rewards of their session, as they juggle the demands of each game.

Example Advantages to Casino: Casinos benefit from the HighFive EGM's flexible interface by accommodating a wider variety of player preferences and play styles without additional equipment. This adaptability may lead to increased machine usage, as players are drawn to the unique multiplayer capabilities or the challenge of managing multiple games. Furthermore, the increased engagement facilitated by this feature may translate to longer play sessions and potentially increased revenue per machine.

Example Procedural Flow: Upon approaching the HighFive EGM, players choose their preferred play mode-multiplayer or solo with multiple games. The machine's interface then adapts to display the relevant player buttons and game information for the selected mode. In multiplayer, each player uses their set of buttons to interact with the game, with the system processing inputs separately to ensure a smooth and independent gaming experience. In solo mode, the player navigates the controls for multiple games, with the interface providing clear indications of each game's status and available actions. Throughout the session, the system continuously monitors and processes inputs, ensuring that every action is accurately reflected in the gameplay and financial transactions, regardless of the mode or number of games being played.

### Identification of Concept:

This inventive concept enhances the VCLAPS! EGM by incorporating multiple player buttons, allowing individualized control in multiplayer scenarios or enabling a single player to engage with multiple games simultaneously.

### Sequence Diagram Components:

VCLAPS! EGM: Manages individual and simultaneous game sessions.
Player A, Player B: Players who may engage in multiplayer or solo modes.
Player Interface: Displays relevant controls and information for active games.
Game Management System: Handles the logic for multiple simultaneous games.
Backend System: Logs and analyzes gameplay data for compliance and performance assessment.

Implementation Details: The VCLAPS! EGM's interface includes multiple sets of player buttons, programmed to respond to inputs from multiple players in a multiplayer setting or a single player managing multiple games.

### Distinguishing Novel Features:

Flexible Player Interface: May switch between multiplayer and solo game modes dynamically.
Individualized Game Control: Each player has dedicated buttons and game controls.

### Distinguishing Novel Steps:

1. Dynamic Interface Adjustment: The interface adjusts to display controls for one or multiple games based on the number of players and game mode selected.
2. Separate Input Processing: In multiplayer mode, inputs from different players are processed separately to ensure independent game control.
3. Simultaneous Game Management: In solo mode, a single player may manage multiple games, with the system keeping each game's state and controls distinct.

Initial Interaction: Players approach the VCLAPS! EGM and select their preferred play mode-either multiplayer with individual games or solo with multiple games.

Data Input: Input includes player mode selection, individual game choices, and in-game actions such as bets and selections.

### Component Interactions and Procedural Steps:

1. Mode Selection: Players choose multiplayer or solo modes.
2. Game Selection and Interface Configuration: The EGM configures the player interface to match the selected mode and displays appropriate game controls.

Gameplay Interaction: Players interact with the games using their dedicated buttons; the system processes these inputs to maintain separate or simultaneous game states as required.

Data Processing: The EGM processes all player interactions, updating game states and financial transactions while ensuring that inputs in multiplayer mode do not interfere with each other.

Outputs and Responses: Players receive real-time feedback on their actions, game status, and account balances directly through the interface.

Data Storage and Reporting: Gameplay data and financial transactions are securely logged in the backend system for compliance and operational analysis.

Error Handling and Security Measures: Robust error handling mechanisms are in place to address any input conflicts or system errors, ensuring continuous and reliable gameplay.

End of Interaction: At the end of the gaming session, the system resets the interfaces and prepares for the next players, ensuring that all settings are cleared and ready.

### 1.4 Independent Mapping of the Same Touchscreen to Different Games

Example Implementation Details: The HighFive EGM incorporates advanced touchscreen technology that supports independent mapping to different games simultaneously. This means that different sections of the touchscreen may be allocated to separate games, allowing a single or multiple players to interact with multiple games on the same screen. Through sophisticated software algorithms, the EGM dynamically partitions the touchscreen real estate, assigning distinct interactive zones for each game based on the current play mode and the number of games being played.

Example Walk-Through Interaction: A player or players engaging with the HighFive EGM in a mode where multiple games are active will see the touchscreen display divided into sections, each corresponding to a different game. Touch inputs within each section are processed independently, ensuring that actions taken in one game do not affect another. This allows for simultaneous interaction with multiple games, whether by a single player managing all games or by multiple players each focusing on a different section of the screen.

Example Benefits to Players: This technology significantly enhances player engagement by offering a customizable gaming experience. Players have the freedom to interact with multiple games without the need to switch screens or machines, facilitating a seamless and immersive gaming session. For multiplayer scenarios, this feature ensures that each participant may have their own dedicated game interaction space on a single screen, promoting social gaming experiences without compromising individual control and immersion.

Example Advantages to Casino: For casinos, the independent mapping feature of the HighFive EGM maximizes the utility and appeal of each machine. By enabling multiple games to be played simultaneously on a single machine, casinos may offer a broader gaming experience in a compact setup, potentially increasing machine utilization and player satisfaction. This may lead to higher foot traffic and prolonged engagement, contributing to the overall profitability of the gaming floor.

Example Procedural Flow: When the HighFive EGM activates multiple game modes, the system automatically configures the touchscreen display into segmented interaction zones, each dedicated to a specific game. As players initiate actions within these zones, the machine's software processes each input independently, correlating each touch to the correct game and ensuring accurate game play and financial tracking. The dynamic partitioning of the screen allows for real-time adjustments to the layout, accommodating changes in the number of active games or players. This procedural flow ensures a fluid and intuitive gaming experience, leveraging the full capabilities of modern touchscreen technology to enhance player interaction and satisfaction.

### Identification of Concept:

This concept revolves around the VCLAPS! EGM's capability to independently map different sections of a touchscreen to different games, allowing multiple players or a single player to interact with multiple games on the same screen simultaneously.

### Sequence Diagram Components:

VCLAPS! EGM: Manages the distribution and control of game interfaces on the touchscreen.
Player A, Player B: Players interacting with their respective game sections on the touchscreen.
Touchscreen Interface: Divides into different interactive zones for each game.
Game Management System: Ensures that touch inputs in one game section do not affect others.
Backend System: Logs gameplay data and maintains system integrity.

Implementation Details: Advanced touchscreen technology and software algorithms enable the VCLAPS! EGM to dynamically partition the touchscreen, assigning distinct interactive zones for each game based on the current play mode and number of games being played.

### Distinguishing Novel Features:

Dynamic Touchscreen Partitioning: Automatically configures different game sections on the touchscreen.
Independent Game Interaction: Ensures that actions in one section are processed separately from others.

### Distinguishing Novel Steps:

1. Touchscreen Configuration: Automatically segments the touchscreen into different game areas when multiple game modes are activated.
2. Independent Input Processing: Inputs within each game area are processed independently, ensuring accurate game control and feedback.
3. Real-Time Interface Adjustments: Adjusts the layout and controls based on changes in the number of games or players.

Initial Interaction: Players activate multiple game modes, prompting the EGM to configure the touchscreen into segmented interaction zones.

Data Input: Players interact with the touchscreen within their designated game zones; each touch is processed in relation to the specific game area.

### Component Interactions and Procedural Steps:

1. Screen Segmentation: On game initiation, the touchscreen is divided into sections corresponding to different games.
2. Game Interaction: Players touch their respective sections to control the games; the system ensures these interactions are confined to the designated zones.
3. Continuous Input Monitoring: The system monitors and processes touches, correlating each to the correct game and updating states and financials accordingly.

Data Processing: Touch inputs are analyzed and processed to maintain game integrity and provide responsive feedback.

Outputs and Responses: Each player sees game-specific responses and updates in their section of the touchscreen, providing a personalized and immersive experience.

Data Storage and Reporting: Interaction data and game outcomes are recorded for compliance, analysis, and performance improvement.

Error Handling and Security Measures: The system includes safeguards to prevent and correct input errors or misregistrations on the touchscreen.

End of Interaction: After gameplay, the system resets the touchscreen configuration, clearing all game-specific settings and preparing for the next session.

1.5 Same Touchscreen, 3 Sets of Virtual Buttons, Each Mapped to a Different Game, that are Independently Controllable

Example Implementation Details: Within the HighFive EGM's innovative framework, a single touchscreen interface hosts three sets of virtual buttons, each uniquely mapped to control one of three different games simultaneously. This is facilitated through the machine's software, which divides the screen into three interactive zones. Each zone possesses a distinct set of virtual buttons designed for the input requirements of its corresponding game. This division allows for the parallel operation of multiple games without interference, enhancing the EGM's versatility and player engagement.

Example Walk-Through Interaction: Upon selecting the multi-game mode, players are greeted by a touchscreen interface cleverly segmented into three parts. Each segment displays its own game-specific virtual buttons, such as spin, bet adjustment, and paytable access, relevant to the game it controls. Players may interact with these virtual buttons to play the games, with the touchscreen accurately registering inputs for each game separately. In a multiplayer scenario, this setup allows players to each take control of a game, while in single-player mode, one player may challenge themselves by managing all three games.

Example Benefits to Players: This unique interface design empowers players with the ability to engage in multiple gaming experiences simultaneously without leaving their seat or switching machines. The clear separation of game controls ensures easy navigation and interaction, minimizing the learning curve and maximizing the entertainment value. For multi-players, it fosters a shared, yet individual gaming experience, promoting both competition and camaraderie.

Example Advantages to Casino: Casinos deploying HighFive EGMs may leverage this feature to distinguish their gaming floor with a novel offering that boosts machine playtime and attracts a diverse player demographic. By accommodating multiple games in a single unit, casinos may efficiently utilize floor space while offering expansive gaming options, potentially increasing overall machine turnover and player retention rates.

Example Procedural Flow: The procedural initiation of this feature begins as soon as players opt for the multi-game or multiplayer mode. The EGM's system dynamically generates and assigns virtual button sets to designated zones on the touchscreen, aligning with the selected games. Input detection is zone-specific, ensuring that actions on virtual buttons influence only the corresponding game. The system's backend seamlessly manages the outcome of these interactions, updating game states and financial meters in real-time, ensuring a cohesive and engaging multi-game experience on a single machine.

### Identification of Concept:

This concept extends the flexibility of the VCLAPS! EGM by incorporating three sets of virtual buttons on the same touchscreen, each set independently controllable and mapped to a different game.

### Sequence Diagram Components:

VCLAPS! EGM: Hosts the virtual button sets on the touchscreen and manages game interactions.
Player A, Player B, Player C: Each player controls a set of virtual buttons mapped to different games.
Touchscreen Interface: Displays virtual buttons for multiple games simultaneously.
Game Management System: Manages the distinct game interactions through separate button sets.
Backend System: Logs interactions and ensures compliance with gaming regulations.

Implementation Details: The VCLAPS! EGM's software divides the touchscreen into three interactive zones, each with a unique set of virtual buttons designed for the specific requirements of its corresponding game. This setup allows for the parallel operation of multiple games without interference.

### Distinguishing Novel Features:

Multi-Game Virtual Button Sets: Allows multiple games to be played simultaneously on the same machine with clear, separate controls.
Zone-Specific Input Detection: Ensures that interactions with virtual buttons affect only the corresponding game.

### Distinguishing Novel Steps:

1. Dynamic Button Set Generation: Automatically creates and assigns virtual button sets to designated zones on the touchscreen based on the selected games.
2. Zone-Specific Interaction Processing: Inputs on virtual buttons are processed specifically for the game associated with that zone.
3. Real-Time Game State Management: Updates game states and financial meters in real-time based on interactions with the virtual buttons.

Initial Interaction: Players select the multi-game or multiplayer mode, prompting the EGM to generate and display virtual buttons for the selected games.

Data Input: Players interact with the touchscreen's virtual buttons, with each set corresponding to a different game.

### Component Interactions and Procedural Steps:

1. Virtual Button Display: Upon game selection, the EGM displays corresponding virtual buttons in designated touchscreen zones.
2. Gameplay Interaction: Players use the virtual buttons to interact with their games; the system ensures these interactions are game-specific.
3. Continuous Monitoring and Updating: The system tracks all button presses, updating game states and financial transactions accordingly.

Data Processing: The EGM processes each touch on the virtual buttons, correlating actions to the appropriate games and ensuring accurate responses.

Outputs and Responses: Players receive immediate feedback from their game interactions through the virtual buttons, enhancing the gaming experience.

Data Storage and Reporting: All gameplay data and financial transactions are securely stored and reported, aiding in compliance and operational analysis.

Error Handling and Security Measures: Includes mechanisms to handle misregistrations or errors in button interactions, maintaining game integrity and reliability.

End of Interaction: The system resets the virtual button configurations and clears all temporary settings, preparing for new players or game sessions.

1.6 Virtual Meters Sets, Each Virtual Meter Set Mapped to a Different Game and May be Linked to a Separate Player Tracking Account. Virtual Meters Aggregated or Combined for Regulatory Purposes into a Single Unified Credit Meter Set for Reporting Purposes. Virtual Meter Sets May be Routed to Different Player Accounts.

Example Implementation Details: The HighFive EGM introduces virtual meter sets that are individually associated with each game being played on the machine. These virtual meters track the financial transactions (bets, wins, and balances) for their respective games. For personalization and tracking purposes, each set of virtual meters may be linked to a different player's tracking account, enabling personalized game progress and financial tracking. For compliance with regulatory requirements, these virtual meter sets are aggregated into a single unified credit meter set that represents the cumulative financial activity across all games for reporting purposes.

Example Walk-Through Interaction: When engaging with multiple games on the HighFive EGM, players may either link their play to their existing player tracking accounts or play anonymously. As they interact with each game, the virtual meters for that game update in real time, reflecting the current financial status. If linked to player accounts, these updates may also sync with the casino's player tracking system, allowing for personalized rewards and tracking. When it's time for regulatory reporting or machine auditing, the EGM aggregates all virtual meter sets into a unified set that accurately reflects the total activity on the machine.

Example Benefits to Players: Players enjoy a highly personalized gaming experience with the ability to track their progress and financial transactions on a game-by-game basis. Linking virtual meter sets to player tracking accounts also allows players to earn rewards based on their activity across multiple games, enhancing the value of their play. This feature also assures players that their individual contributions to shared games are recognized and rewarded.

Example Advantages to Casino: For casinos, this feature simplifies the complexity of offering multi-game experiences on a single machine, ensuring that all regulatory reporting requirements are seamlessly met. It also enhances the casino's ability to offer personalized experiences and rewards, improving player loyalty and satisfaction. Additionally, the aggregation of virtual meters into a single reporting set streamlines financial tracking and auditing processes, maintaining compliance while reducing operational overhead.

Example Procedural Flow: The operational flow begins with the player's selection of games and the optional linking of their player tracking account. As the player interacts with each game, the corresponding virtual meters update in real-time. These virtual meter sets are then programmatically aggregated into a unified credit meter set for regulatory reporting, while still allowing for individual game tracking to be reflected in the player's account. This ensures a balance between personalized gaming experiences and regulatory compliance, managed through the EGM's sophisticated software platform.

### Identification of Concept:

This concept introduces virtual meter sets in the VCLAPS! EGM, where each set is linked to a specific game and potentially to individual player tracking accounts, allowing personalized tracking of game progress and financial transactions.

### Sequence Diagram Components:

VCLAPS! EGM: Central unit managing game operations and virtual meter sets.
Player A, Player B: Players engaging with different games, each with separate virtual meters.
Virtual Meter System: Tracks financial transactions for each game independently.
Player Tracking System: Links virtual meters to player accounts for personalized tracking.
Backend System: Manages data aggregation and reporting for compliance.

Implementation Details: Virtual meter sets are assigned to each game being played on the machine, tracking all financial transactions (bets, wins, balances) individually. These meters may be linked to player accounts, providing personalized progress and financial tracking.

### Distinguishing Novel Features:

Individual Game Financial Tracking: Allows each game to have its own set of financial meters.
Linkage to Player Accounts: Enables meters to be associated with player tracking accounts for personalized monitoring.

### Distinguishing Novel Steps:

1. Initialization of Virtual Meters: When a player starts a game, a virtual meter set is initialized specifically for that game session.
2. Linking Meters to Player Accounts: If players opt to link their play to their tracking accounts, their game interactions update their personal virtual meter sets.
3. Aggregation for Reporting: For compliance, all individual meter sets are aggregated into a unified set that accurately reflects the total activity for reporting purposes.

Initial Interaction: Players select games and decide whether to link their play to their tracking accounts.

Data Input: Inputs include game selection, bets placed, winnings, and other game interactions, all tracked by the corresponding virtual meter set.

### Component Interactions and Procedural Steps:

1. Game and Account Selection: Players choose a game and opt to link it with their player tracking accounts.
2. Gameplay and Meter Updates: As players engage with the game, the corresponding virtual meters update in real-time.
3. Data Aggregation and Compliance: The virtual meter sets are programmatically aggregated into a unified credit meter set for regulatory reporting, while still reflecting individual game tracking in the player's account.

Data Processing: The system processes all gameplay data and financial transactions, ensuring accurate tracking and compliance with gaming regulations.

Outputs and Responses: Players see their game progress and financial status updated in real-time, linked to their personal tracking accounts if chosen.

Data Storage and Reporting: All game data and transactions are securely stored and reported, both at the individual and aggregated levels, to maintain compliance and facilitate audits.

Error Handling and Security Measures: Robust mechanisms are in place to handle errors in data tracking and to secure personal player information against unauthorized access.

End of Interaction: At the end of a gaming session, the system ensures all data is accurately finalized and reported, preparing the machine for the next players.

### 1.7 AML (Anti-Money Laundering) Mechanisms Built in

Example Implementation Details: The HighFive EGM incorporates built-in Anti-Money Laundering (AML) mechanisms designed to monitor and report suspicious financial activities directly from the machine. This is achieved through the integration of advanced software algorithms capable of identifying patterns of play and financial transactions that may indicate potential money laundering activities. These mechanisms work in real-time, analyzing the aggregated virtual meter sets and individual transactions against predefined criteria of suspicious behaviors.

Example Walk-Through Interaction: As players engage with the HighFive EGM, their gameplay and financial transactions are continuously monitored by the AML mechanisms. These systems are designed to be non-intrusive, operating seamlessly in the background to ensure a smooth gaming experience. Should the system detect activity that meets the criteria for suspicion, it automatically flags the transaction and, depending on the severity and the casino's protocols, may notify casino security or compliance officers for further investigation.

Example Benefits to Players: For players, the inclusion of AML mechanisms in the HighFive EGM provides an added layer of security and peace of mind, knowing that the gaming environment adheres to high standards of financial integrity and compliance. This feature reassures players that the casino is actively protecting against fraudulent activities, contributing to a safer gaming experience.

Example Advantages to Casino: Casinos benefit from the HighFive EGM's built-in AML mechanisms by ensuring compliance with regulatory requirements regarding money laundering. This proactive approach to detecting and reporting suspicious activities not only helps protect the casino's financial interests but also maintains its reputation as a secure and responsible gaming establishment. Additionally, automating these processes reduces the need for manual oversight, streamlining operations and allowing for more efficient allocation of security and compliance resources.

Example Procedural Flow: The procedural flow for the AML mechanisms begins with the continuous monitoring of gameplay and financial transactions on the HighFive EGM. Using advanced analytics, the system evaluates these activities against established patterns of suspicious behavior. If a potential issue is detected, the system flags the activity and follows the casino's predetermined protocol, which may include recording the incident for further analysis, alerting casino staff, or taking immediate preventative actions. This integrated approach ensures that all necessary steps are taken to investigate and address potential AML concerns promptly and effectively.

### Identification of Concept:

This concept integrates advanced Anti-Money Laundering (AML) mechanisms directly into the VCLAPS!EGM to monitor and report suspicious financial activities, enhancing the security and integrity of gaming operations.

### Sequence Diagram Components:

VCLAPS! EGM: Implements and manages AML monitoring.
Player A, Player B: Subjects of AML monitoring during gameplay.
AML Monitoring System: Analyzes transactions and player behavior for potential money laundering activities.
Compliance System: Handles alerts and reports based on AML findings.
Security and Compliance Officers: Respond to AML alerts and take necessary actions.

Implementation Details: AML mechanisms are built into the software, using algorithms capable of detecting patterns of play and transactions that may indicate potential money laundering.

### Distinguishing Novel Features:

Real-Time Monitoring and Analysis: Continuously analyzes player transactions and behavior for signs of money laundering.
Automated Alert System: Generates alerts when suspicious activities are detected, potentially notifying security or compliance officers.

### Distinguishing Novel Steps:

1. Continuous Transaction Monitoring: All player transactions are continuously monitored by the AML system.
2. Pattern Detection and Alert Generation: The system uses predefined criteria to identify suspicious behavior and automatically generates alerts.
3. Compliance and Investigation Protocols: In response to alerts, compliance officers review the activities and take appropriate actions, including further investigation or immediate intervention.

Initial Interaction: Players begin their gaming session, and the AML system starts monitoring their transactions and behavior in real-time.

Data Input: All monetary transactions and certain behavioral data during gameplay are inputs into the AML monitoring system.

### Component Interactions and Procedural Steps:

1. Real-Time Data Monitoring: As players engage with the games, their transactions and actions are monitored.
2. Suspicious Activity Detection: The system analyzes the data to detect any patterns that meet the criteria for suspicion.
3. Alert and Response Management: If suspicious activity is detected, the system alerts the compliance team, who may initiate further actions based on the severity of the findings.

Data Processing: The AML system processes and analyzes large volumes of transaction data to identify potentially illicit activities.

Outputs and Responses: The system may generate internal alerts and, if necessary, notifications to external bodies or authorities, depending on regulatory requirements and internal protocols.

Data Storage and Reporting: All monitoring data and analysis outcomes are securely stored for compliance, auditing, and future investigations.

Error Handling and Security Measures: The AML system includes error detection capabilities to ensure accurate monitoring and robust security measures to protect data integrity and privacy.

End of Interaction: At the end of a gaming session, the AML monitoring concludes for that session, with all relevant data secured and maintained for compliance and reporting.

### 1.8 Single Meter Set

Example Implementation Details: The HighFive EGM simplifies financial tracking and regulatory compliance by consolidating all virtual meter sets from multiple games into a single meter set for reporting purposes. This approach streamlines the process of financial monitoring and auditing, providing a unified view of the machine's total activity. The single meter set reflects the aggregate financial transactions across all games, ensuring accuracy and simplifying the reconciliation process.

Example Walk-Through Interaction: Players engaging with various games on the HighFive EGM do not interact directly with the single meter set; instead, they see their individual virtual meters for each game. However, all their transactions contribute to the single meter set, which acts as the EGM's financial backbone. This consolidated meter set captures the total bet, win, and cash transactions, serving as the primary source for financial reporting and auditing.

Example Benefits to Players: While the direct impact on players may be minimal, the efficiency and accuracy of the single meter set system ensure that players' financial transactions are managed securely and reliably. This contributes to a trustworthy gaming environment where players may focus on enjoying their gameplay experience, confident in the knowledge that their financial interactions are accurately recorded and managed.

Example Advantages to Casino: For casinos, the single meter set feature of the HighFive EGM offers significant operational benefits. By consolidating financial data into a single, easily auditable format, casinos may streamline their financial reporting processes, reduce errors in financial reconciliation, and ensure compliance with regulatory standards. This simplification of financial tracking makes it easier for casinos to manage their gaming floor operations, optimize their financial performance, and maintain high standards of regulatory compliance.

Example Procedural Flow: The single meter set is automatically updated in real-time with financial data from each game played on the HighFive EGM. The system aggregates this data, updating the single meter set to reflect the current financial status of the machine. This process includes the reconciliation of bets, wins, and cash transactions across all active games. For reporting purposes, the single meter set provides a comprehensive overview of the machine's financial activity, which may be accessed by casino management for auditing, analysis, and regulatory reporting, ensuring a streamlined and efficient approach to financial management and compliance.

### Identification of Concept:

This concept simplifies the financial tracking and regulatory compliance for the VCLAPS! EGM by consolidating all virtual meter sets from multiple games into a single meter set for reporting purposes.

### Sequence Diagram Components:

VCLAPS! EGM: Manages the aggregation of financial data from multiple games.
Player A, Player B: Engage with games whose financial transactions are tracked.
Single Meter System: Aggregates and reports financial data.
Backend System: Handles data reconciliation and compliance reporting.
Casino Management: Uses aggregated data for financial management and regulatory reporting.

Implementation Details: The single meter set is a centralized financial tracking system that aggregates data from all active games on the VCLAPS! EGM, providing a comprehensive view of financial transactions for ease of management and auditing.

### Distinguishing Novel Features:

Unified Financial Reporting: Consolidates financial data from multiple games into a single reportable entity.
Simplified Auditing and Compliance: Facilitates easier auditing and compliance with regulatory standards by providing a unified financial overview.

### Distinguishing Novel Steps:

1. Real-Time Financial Aggregation: Financial data from each game is continuously aggregated into the single meter set.
2. Comprehensive Data Reconciliation: Ensures that all financial transactions are accurately captured and reconciled in the single meter set.
3. Regulatory Reporting Preparedness: Prepares comprehensive financial reports based on the aggregated data, ready for regulatory scrutiny and internal management review.

Initial Interaction: Players engage with various games on the VCLAPS! EGM, and the system begins aggregating financial data for each game into the single meter set.

Data Input: Financial transactions from each game, including bets, wins, and cash-outs, are inputs into the single meter system.

### Component Interactions and Procedural Steps:

1. Game Financial Data Collection: As players engage with the games, financial transactions are recorded.
2. Aggregation to Single Meter Set: The system aggregates these transactions into the single meter set, updating in real-time.
3. Data Reconciliation and Reporting: The backend system reconciles all transactions within the single meter set and prepares reports for compliance and management.

Data Processing: The system processes and aggregates financial data from multiple sources, ensuring accurate and up-to-date financial reporting.

Outputs and Responses: The single meter set provides a consolidated view of all financial transactions on the machine, simplifying financial management and regulatory reporting.

Data Storage and Reporting: Financial data is stored in a centralized system, facilitating easy access for auditing and compliance checks.

Error Handling and Security Measures: Includes error detection and correction mechanisms to ensure the accuracy of financial data and robust security protocols to protect data integrity.

End of Interaction: After a gaming session, the system finalizes all financial data within the single meter set, ensuring it is ready for reporting and the next session.

### 1.9 Single Bill Acceptor

Example Implementation Details: The single bill acceptor in a HighFive gaming system may serve as the primary currency input mechanism for the entire gaming apparatus. Integrated seamlessly within the slot machine's architecture, this feature simplifies the physical design and enhances user interaction. By consolidating currency acceptance into a singular, efficient unit, the system not only minimizes hardware redundancy but also streamlines the maintenance process. For example, in a scenario where multiple games are hosted within the same cabinet, the single bill acceptor eliminates the need for separate currency validators for each game, thereby reducing operational and upkeep costs. This implementation leverages advanced validation technologies to ensure high security and acceptance rates for various currencies, thereby supporting a global deployment strategy.

Example Walk-Through Interaction: A player approaches the HighFive slot machine and inserts a bill into the single bill acceptor. The machine, equipped with sophisticated software, quickly validates the currency, credits the player's account, and allows the player to choose from the available game options. This seamless process enhances the player's experience by allowing immediate access to games without the hassle of managing multiple currency inputs. The intuitive design of the single bill acceptor, prominently positioned for easy access, guides the player through a straightforward transaction process, thereby encouraging continued play and interaction with the machine.

Example Benefits to Players: The integration of a single bill acceptor in the HighFive gaming concept offers significant benefits to players. Primarily, it provides a hassle-free way to load credits onto the machine, allowing players to focus more on the gaming experience rather than the mechanics of currency acceptance. The efficiency and speed of a single bill acceptor reduce wait times and potential frustrations associated with bill rejection, fostering a more enjoyable and engaging gaming session. Additionally, the simplified currency input mechanism makes it easier for players, including those who may be less familiar with slot machines, to start playing their preferred games quickly.

Example Advantages to Casino: From a casino's perspective, the single bill acceptor presents multiple advantages. First, it reduces the cost and complexity of the gaming machine's hardware setup by eliminating the need for multiple currency acceptance units. This not only lowers initial investment costs but also simplifies maintenance and service routines. Furthermore, the use of a single bill acceptor may enhance the casino floor's aesthetic and functional consistency, creating a more streamlined and attractive gaming environment. Lastly, the efficiency and reliability of this system may lead to increased player satisfaction and, consequently, higher revenue generation from the gaming floor.

Example Procedural Flow: The procedural flow for implementing the single bill acceptor feature within a HighFive gaming system begins with the player's insertion of a bill into the acceptor. The machine's firmware then activates the validation process, using optical and magnetic sensors to authenticate the currency. Upon successful validation, the system updates the player's credit balance, reflected immediately on the display. The player is then prompted to select a game, and the credits are allocated accordingly. Throughout this process, the gaming machine communicates with the central casino management system, updating player activity and currency transactions in real-time to ensure compliance with regulatory requirements and to enable accurate financial tracking.

### Identification of Concept:

This concept integrates a single bill acceptor within the VCLAPS! EGM to serve as the primary currency input mechanism for all games housed within the machine, simplifying the hardware setup and enhancing player interaction.

### Sequence Diagram Components:

VCLAPS! EGM: Central unit that manages currency acceptance and game credit allocation.
Player A: Player inserting currency into the bill acceptor.
Single Bill Acceptor: Validates and processes all currency inputs.
Financial System: Updates player credits based on validated currency.
Game Management System: Allows players to select and play games based on updated credits.
Backend System: Logs transactions and ensures system integrity.

Implementation Details: The single bill acceptor efficiently processes all currency inputs, crediting the player's account, which may then be used across multiple games on the machine. This setup uses advanced validation technologies to ensure high security and acceptance rates.

### Distinguishing Novel Features:

Consolidated Currency Acceptance: A single point of currency input for multiple games reduces hardware complexity and potential points of failure.
Enhanced User Interaction: Simplifies the player's experience by eliminating the need to insert currency for each game separately.

### Distinguishing Novel Steps:

1. Currency Validation and Credit Update: The bill acceptor validates the inserted currency and updates the player's credit accordingly.
2. Seamless Credit Allocation to Games: Players may seamlessly allocate credits to any game on the machine without additional transactions.
3. Real-Time Financial Logging: All transactions are immediately logged in the backend system for compliance and auditing.

Initial Interaction: Player A approaches the VCLAPS! EGM and inserts a bill into the single bill acceptor.

Data Input: The player inserts currency, which is validated by the bill acceptor.

### Component Interactions and Procedural Steps:

1. Currency Insertion: Player A inserts a bill into the bill acceptor.
2. Validation and Credit Update: The bill acceptor validates the currency and communicates with the financial system to update the player's credits.
3. Game Selection and Engagement: Player A uses the updated credits to select and play games. The game management system facilitates game selection based on available credits.

Data Processing: The bill acceptor processes the physical currency to validate its authenticity and determine its denomination, updating the financial system accordingly.

Outputs and Responses: Player A receives feedback on credit updates directly on the EGM interface, enabling immediate game selection and play.

Data Storage and Reporting: Transaction data from the bill acceptor is logged by the backend system, supporting financial tracking and regulatory compliance.

Error Handling and Security Measures: Robust mechanisms are in place to handle potential bill validation errors or fraud attempts, ensuring secure and reliable operations.

End of Interaction: Once the transaction is completed, the system ensures the player's credits are up to date and ready for immediate use, resetting the bill acceptor for the next player.

### 1.10 Single Coin Box

Example Implementation Details: The single coin box implementation within the HighFive gaming system centralizes the collection of coins from multiple games within a single unit. This design simplifies the internal architecture of the gaming cabinet, facilitating ease of access for collection and maintenance. For instance, in a setup where a single machine offers a variety of games, the single coin box negates the need for multiple coin collectors, streamlining the cash handling process. Advanced mechanical and electronic design ensures the secure and efficient transport of coins from the coin acceptor to the coin box, minimizing the risk of jams or security breaches.

Example Walk-Through Interaction: Upon deciding to cash out, a player hits the ‘collect’ button on the HighFive slot machine. The machine calculates the total credits and converts them into coins, dispensing them into the collection tray for the player to collect. This process is managed smoothly, with coins being directed from individual game modules to the centralized single coin box, then routed to the player. This efficient and secure method provides a satisfying physical culmination to the gaming experience, enhancing player satisfaction.

Example Benefits to Players: The single coin box offers players a unified and reliable method for coin collection, eliminating confusion and ensuring a consistent cash-out experience across different games within the HighFive system. It reassures players of the security and reliability of their winnings, as the streamlined process reduces mechanical failures and ensures that the correct amount is always dispensed. Additionally, the convenience of having a single exit point for coins simplifies the collection process, making the gaming experience more enjoyable and hassle-free.

Example Advantages to Casino: For casinos, a single coin box system reduces the complexity and cost associated with machine design and maintenance. By consolidating coin collection into one unit, casinos benefit from simplified cash handling procedures and reduced maintenance requirements, leading to lower operational costs and increased machine uptime. Additionally, the single coin box system may offer enhanced security features, minimizing the risk of theft and ensuring accurate accounting of coins collected, which is desirable for regulatory compliance and financial reporting.

Example Procedural Flow: The procedural flow for the single coin box feature begins with the player's request to cash out. The machine's software calculates the total winnings and signals the coin dispensing mechanism. Coins are then routed from the single coin box through a secure chute to the collection tray. During this process, sensors monitor the flow of coins to prevent jams and ensure accuracy. Once the transaction is complete, the system updates the machine's and the central management system's accounting records, providing real-time data on payouts and maintaining the integrity of financial management. Regular maintenance checks are scheduled to ensure the coin box and dispensing mechanisms are functioning correctly, further enhancing the reliability of the system.

### Identification of Concept:

This concept features a single coin box in the VCLAPS! EGM, centralizing the collection of coins from multiple games into one unit, streamlining the cash handling process and reducing the internal machine complexity.

### Sequence Diagram Components:

VCLAPS! EGM: Manages the coin output and collection processes.
Player A: Engages with the EGM and decides to cash out.
Single Coin Box: Collects and secures coins from all games.
Coin Dispensing Mechanism: Directs coins from the games to the coin box and then to the player.
Backend System: Monitors and logs the coin transactions for auditing and compliance.

Implementation Details: The single coin box design facilitates the efficient transport and collection of coins within the EGM, minimizing the risk of jams or security breaches through advanced mechanical and electronic design.

### Distinguishing Novel Features:

Centralized Coin Collection: Consolidates coin outputs from multiple games, simplifying the internal architecture of the EGM.
Enhanced Security and Efficiency: Reduces the risk of theft and operational issues related to multiple coin collectors.

### Distinguishing Novel Steps:

1. Coin Collection and Routing: All coins from various games are directed to a centralized coin box.
2. Efficient Coin Dispensing: The coin dispensing mechanism manages the flow of coins to ensure accurate and secure payouts to players.
3. Compliance and Auditing Readiness: The backend system logs all coin transactions, ensuring all activities are compliant with regulatory standards.

Initial Interaction: Player A plays various games on the VCLAPS! EGM and presses ‘collect’ to cash out.

Data Input: Player A's request to cash out triggers the coin dispensing mechanism.

Component Interactions and Procedural Steps:
1. Cash-Out Request: Player A initiates a cash-out, which activates the coin dispensing mechanism.
2. Coin Routing and Collection: Coins are directed from individual games to the single coin box and then dispensed to the player.
3. Transaction Logging: The backend system logs the details of the coin transactions for compliance and operational analysis.

Data Processing: The EGM processes the player's cash-out request, calculates the total amount, and controls the coin dispensing mechanism to ensure accurate payouts.

Outputs and Responses: Player A receives the dispensed coins in a collection tray, providing a tangible culmination to the gaming experience.

Data Storage and Reporting: All coin transaction data is securely stored in the backend system, facilitating easy access for maintenance, auditing, and compliance checks.

Error Handling and Security Measures: The system includes sensors and checks to prevent and quickly resolve jams or inaccuracies in the coin dispensing process, maintaining reliability and security.

End of Interaction: After the coins are dispensed and collected, the system resets the coin box and prepares for the next transaction, ensuring operational readiness and security.

### 1.11 Single Player Tracking Reader

Example Implementation Details: Integrating a single player tracking reader into the HighFive gaming system offers a streamlined approach to player identification and tracking across multiple games. This unified system allows for the consistent collection of player data, regardless of the specific game being played. Utilizing RFID or magnetic stripe technology, the reader efficiently captures player information with a simple card swipe or tap, linking gameplay to individual player accounts. This setup facilitates personalized gaming experiences, enabling the system to offer game suggestions, loyalty rewards, and promotional offers tailored to player preferences and history.

Example Walk-Through Interaction: A player approaches the HighFive machine and swipes their loyalty card through the single player tracking reader. The system immediately recognizes the player, greeting them by name on the display and presenting them with their favorite games and any personalized offers available. As the player engages with various games within the HighFive system, their activity is seamlessly recorded, updating their player profile in real time. This continuous interaction enhances the player's experience by making it more engaging and rewarding.

Example Benefits to Players: The single player tracking reader offers numerous benefits to players by creating a personalized gaming experience. Players receive tailored recommendations and rewards based on their gaming history, enhancing their engagement and loyalty. The convenience of a single swipe or tap for identification across multiple games within the HighFive system simplifies the player's interaction, making their gaming experience smoother and more enjoyable. Additionally, the consolidation of player data into one account allows for easier tracking of rewards and promotions, increasing player satisfaction.

Example Advantages to Casino: From a casino's perspective, the single player tracking reader provides significant advantages in terms of data collection and customer relationship management. By gathering comprehensive player data, casinos may analyze gaming trends, player preferences, and spending patterns, enabling the development of targeted marketing strategies and promotions. This data-driven approach leads to increased player retention and higher revenue. Furthermore, the streamlined player tracking system reduces hardware redundancy and maintenance costs, while offering enhanced security features to protect player information.

Example Procedural Flow: Upon player identification through the single player tracking reader, the system retrieves the player's profile from the casino's central database. The player's activity across different games is tracked in real time, with data being continuously updated to reflect new gameplay transactions and rewards. This information is used not only for personalized player engagement but also for compiling detailed analytics for casino management. Regular data synchronization ensures that player profiles are up-to-date across all platforms, including online and mobile, providing a cohesive gaming experience. The procedural flow encompasses data collection, analysis, and application, fostering a dynamic and responsive gaming environment.

### Identification of Concept:

This concept integrates a single player tracking reader in the VCLAPS! EGM, streamlining player identification and tracking across multiple games, enabling personalized gaming experiences and efficient data collection.

### Sequence Diagram Components:

VCLAPS! EGM: Hosts the player tracking reader and manages game interactions based on player data.
Player A: Uses a loyalty card or digital identifier for player tracking.
Single Player Tracking Reader: Captures and processes player information.
Player Profile System: Stores and manages player data, game preferences, and rewards.
Backend System: Ensures data synchronization and compliance with privacy regulations.

Implementation Details: The player tracking reader uses RFID or magnetic stripe technology to capture player information efficiently, linking gameplay to individual player accounts. This facilitates personalized game suggestions, loyalty rewards, and promotional offers.

### Distinguishing Novel Features:

Unified Player Data Collection: A single point for player data entry enhances the ease and speed of player identification across multiple games.
Personalized Player Engagement: Tailors the gaming experience based on individual player histories and preferences, collected through the tracking reader.

### Distinguishing Novel Steps:

1. Efficient Player Identification: The tracking reader quickly identifies players as they interact with the EGM, updating their profiles in real-time.
2. Personalized Game and Reward Suggestions: Based on the captured player data, the system offers personalized game recommendations and rewards.
3. Data Synchronization and Privacy Compliance: Ensures that all player data is synchronized across the casino's platforms and complies with data protection regulations.

Initial Interaction: Player A swipes their loyalty card through the single player tracking reader upon approaching the VCLAPS! EGM.

Data Input: The loyalty card swipe inputs player identification data into the system, triggering profile retrieval and update processes.

### Component Interactions and Procedural Steps:

1. Card Swipe and Identification: Player A's loyalty card is read by the tracking reader, which identifies the player and retrieves their profile.
2. Profile Update and Game Customization: The player profile system updates real-time data and customizes the gaming experience based on player preferences and history.
3. Engagement and Reward Management: As Player A engages with the games, their actions are tracked, and rewards are updated accordingly.

Data Processing: The tracking reader processes the identification data to retrieve and update the player's profile, synchronizing it with ongoing game interactions and rewards.

Outputs and Responses: Player A receives personalized greetings, game suggestions, and rewards directly on the EGM interface, enhancing their gaming experience.

Data Storage and Reporting: Player interaction and reward data are securely stored in the backend system, supporting detailed analytics for casino management and ensuring compliance with privacy standards.

Error Handling and Security Measures: Robust security features protect player data from unauthorized access, with error handling mechanisms in place to address any issues in data capture or processing.

End of Interaction: At the end of the gaming session, the system ensures that all player data is up-to-date and securely logged, ready for future interactions and compliance reporting.

### 1.12 Single GM Running Multiple Game Sessions by Different Players

Example Implementation Details: In the HighFive gaming system, a single Game Manager (GM) module orchestrates multiple game sessions simultaneously for different players. This module utilizes sophisticated software to manage various gaming activities across several interfaces while maintaining distinct player sessions. This approach enables a centralized control mechanism that ensures consistency and fairness in game operations and outcomes, irrespective of the number of players or games being managed.

Example Walk-Through Interaction: Players at a HighFive enabled EGM may engage in their chosen games independently, even though these games are managed by the same GM. Each player's actions, such as spins, bets, and payouts, are individually tracked and processed. The GM module provides real-time updates and game state management, ensuring that each session is isolated from others, thus maintaining the integrity and uniqueness of every player's gaming experience.

Example Benefits to Players: This setup allows players to enjoy a personalized gaming experience while interacting with a system that efficiently handles multiple game sessions in parallel. Players benefit from a seamless and uninterrupted gaming session, with the assurance that their game outcomes are being managed fairly and independently of other activities on the same machine.

Example Advantages to Casino: For casinos, having a single GM running multiple game sessions simplifies the operational complexity of managing numerous games and players simultaneously. This efficiency may lead to reduced hardware requirements and lower maintenance costs. Additionally, the ability to host multiple sessions on a single machine optimizes floor space and may increase machine profitability.

Example Procedural Flow: When a player starts a game on a HighFive EGM, the GM registers the session and begins tracking all related activities. As the player engages with the game, all inputs and outcomes are processed through the centralized GM, which updates the game's state in real-time. If multiple players are using the same machine, each session is handled distinctly, with the GM ensuring no crossover or interference between sessions.

This is achieved through the use of advanced partitioning algorithms and session management protocols that maintain the integrity of each player's experience. At the end of each session, results are compiled and reported individually, ensuring accurate record-keeping and fair play.

Identification of Concept: This concept involves a single Game Manager (GM) module in the VCLAPS! EGM that orchestrates multiple game sessions simultaneously for different players, maintaining the integrity and uniqueness of each session.

Sequence Diagram Components:
VCLAPS! EGM: Hosts the GM module and interfaces for multiple games.
Player A, Player B: Independently engaged in their own game sessions.
Game Manager (GM): Coordinates and manages individual game sessions.
Session Management System: Ensures separation and integrity of each game session.
Backend System: Logs session data and maintains system compliance.

Implementation Details: The GM utilizes sophisticated software to manage various gaming activities, ensuring that separate player sessions do not interfere with each other and maintaining a fair and consistent gaming environment.

### Distinguishing Novel Features:

Centralized Game Session Management: A single manager handles multiple independent game sessions.
Isolated Player Interactions: Ensures that actions in one session do not impact any other.

### Distinguishing Novel Steps:

1. Session Initialization: The GM initiates and sets up each player's game session upon their selection.
2. Real-Time Session Updates: Continuously updates and manages the state of each game, ensuring independence and fairness.
3. Comprehensive Session Logging: All session activities are logged for compliance and auditing purposes.

Initial Interaction: Players at the VCLAPS! EGM select their games, triggering the GM to start individual sessions.

Data Input: Input includes each player's game selection and in-game actions, processed separately by the GM.

### Component Interactions and Procedural Steps:

1. Game Selection and Session Start: Players choose their games, and the GM initializes separate sessions.
2. Independent Gameplay Management: The GM manages each game session independently, processing inputs and updating game states without crossover.
3. Session Data Handling: The backend system logs all session data, ensuring accurate recording and compliance with gaming regulations.

Data Processing: The GM processes inputs from each session independently, maintaining the integrity and uniqueness of each player's experience.

Outputs and Responses: Players receive real-time updates specific to their game session, ensuring a personalized and uninterrupted gaming experience.

Data Storage and Reporting: All game session data is securely stored, providing a reliable basis for performance analysis and regulatory compliance.

Error Handling and Security Measures: Robust mechanisms ensure that session data is accurately processed and secured, with protocols in place to handle any potential errors or security issues.

End of Interaction: Each game session is concluded independently, with the GM ensuring that all data is properly finalized and the system is ready for new sessions.

1.13 Multiple Different Concurrent Games with Different Paytables and Volatilities

Example Implementation Details: This feature enables a single Electronic Gaming Machine (EGM) to host multiple games simultaneously, each with distinct paytables and volatility settings. Implementation involves software architecture capable of managing separate game instances within a unified interface. Each game operates independently in terms of gameplay mechanics but is integrated into the casino's network for financial transactions and data logging. This setup may require advanced game management systems that allocate resources dynamically and ensure the integrity of each game's outcomes without interference.

### Example Walk-Through Interaction:

A player interacts with the EGM by selecting from available games, each displayed with unique themes and paytables. As the player engages with one game, they may switch to another game on the same machine, experiencing different levels of risk and reward. The EGM seamlessly tracks bets and payouts for each game, maintaining separate records that contribute to the player's total session data.

### Example Benefits to Players:

Players enjoy a diverse gaming experience without leaving their seat, moving seamlessly between games with different levels of volatility and winning potential. This feature caters to various player preferences and strategies, enhancing the overall casino experience by providing multiple gambling options in a single interaction.

### Example Advantages to Casino:

Casinos benefit from increased player engagement as the variety keeps players entertained longer on a single machine. It also optimizes casino floor space, allowing more games to be offered without additional physical hardware, which may lead to increased revenue and customer satisfaction.

### Example Sequence Diagram Description & Procedural Flow:

The sequence begins with the player choosing a game from the touchscreen menu. The EGM's central processor then allocates resources to run the selected game while maintaining connectivity with the other games. As the player switches games, the system updates the credit meter and records transactions separately for each game. Backend systems ensure all data syncs with the casino's central database for real-time financial tracking and player activity analysis.

### Identification of Concept:

This inventive concept enables a single VCLAPS! EGM to host multiple games simultaneously, each with its own paytable and volatility settings, managed by a unified interface that ensures no cross-interference.

### Sequence Diagram Components:

VCLAPS! EGM: Manages multiple game instances with distinct settings.
Player A: Engages with multiple games, selecting different volatility levels.
Game Management System: Handles the operational aspects of each game, ensuring separate paytables and volatilities.
Financial System: Manages bets and payouts for each game individually.
Backend System: Ensures data integrity and synchronization with casino servers.

Implementation Details: The EGM's software architecture supports separate game instances within a unified interface, allowing players to experience different levels of risk and reward without leaving their seat.

### Distinguishing Novel Features:

Multiple Games with Independent Settings: Supports distinct paytables and volatility settings for each game on the same machine.
Seamless Game Switching: Players may easily switch between games with different characteristics without any operational delay.

### Distinguishing Novel Steps:

1. Game Instance Initialization: Each game is started with its specific settings based on player selections.
2. Independent Financial Transactions: Bets and payouts are managed separately for each game, respecting their individual paytables.
3. Continuous Data Synchronization: The backend system continuously syncs all game data with the casino's central database, ensuring accuracy and compliance.

Initial Interaction: Player A selects from available games displayed on the EGM, each with unique themes and paytables.

Data Input: Player A's selections and bets for each game, along with in-game decisions, are processed independently.

### Component Interactions and Procedural Steps:

1. Selection and Configuration: Player A chooses games; the EGM configures each game with its respective settings.
2. Gameplay and Transaction Management: Player A engages with the games; the financial system handles transactions based on the specific paytables of each game.
3. Data Management and Reporting: Continuous updates and data synchronization with the backend system maintain the integrity of financial and gameplay reporting.

Data Processing: The EGM processes each game's transactions separately, ensuring that financial outcomes reflect the selected game's settings.

Outputs and Responses: Player A experiences the distinct characteristics of each game in real-time, with separate feedback and outcomes based on the chosen paytables and volatilities.

Data Storage and Reporting: Game and financial data are meticulously recorded and synchronized, supporting effective management and compliance with gaming regulations.

Error Handling and Security Measures: The system incorporates safeguards to prevent data errors and ensure the security of transactional and gameplay information.

End of Interaction: Player A concludes gaming sessions, with the EGM resetting each game independently, ready for new players or sessions.

### 1.14 Head-to-Head (Competitive) Game Play & Betting Modes

Example Implementation Details: This feature introduces competitive gameplay modes within an EGM, where players may challenge each other in real-time. The EGM is designed with dual interfaces, each capable of running a game independently while connected to a central competition server that coordinates the gameplay. The system uses matchmaking algorithms to pair players of similar skill levels and betting preferences, enhancing the competitive nature of the game.

### Example Walk-Through Interaction:

Two players seated at the same EGM select the competitive mode and choose their game. The system initiates a session where both players are given the same game challenges, and their scores are compared in real-time on split screens. Players may place bets against each other, with payouts determined by the outcome of the game.

### Example Benefits to Players:

This mode enhances the excitement of traditional slot play by adding a social and competitive element. Players may test their skills against others, potentially winning more based on their gaming abilities, which adds a layer of strategy to the slot experience.

### Example Advantages to Casino:

The competitive mode may attract a demographic that enjoys skill-based gaming in addition to chance, potentially increasing player retention and attracting new customers looking for interactive experiences.

### Example Sequence Diagram Description & Procedural Flow:

The sequence diagram would detail the player selection process, game initialization, real-time scoring, and bet handling. The EGM receives player inputs, processes them through the game logic, and updates scores simultaneously. All transactional data and player interactions are logged and monitored by the casino's gaming network to ensure fair play and compliance with gaming regulations.

### Identification of Concept:

This inventive concept introduces head-to-head competitive gameplay modes within a VCLAPS! EGM, where players may challenge each other in real-time, enhancing the traditional slot play experience with a social and competitive element.

### Sequence Diagram Components:

VCLAPS! EGM: Hosts dual interfaces for competitive gameplay.
Player A, Player B: Compete against each other in real-time within the same EGM.
Competition Server: Coordinates and manages the competitive gameplay, ensuring fairness.
Scoring System: Tracks and compares player scores in real-time.
Backend System: Logs gameplay data and manages compliance with gaming regulations.

Implementation Details: The EGM is equipped with dual interfaces and connected to a central competition server that handles matchmaking and score comparisons, allowing players to engage in games where their skills directly affect the game outcome.

### Distinguishing Novel Features:

Real-Time Competitive Interaction: Players may see their scores compared against their opponents in real-time, adding a layer of direct competition.
Skill-Based Game Elements: Adds an element of strategy and skill to the gaming experience, differentiating it from traditional luck-based slot games.

### Distinguishing Novel Steps:

1. Matchmaking and Game Initialization: Players are paired based on skill levels and game preferences, and the competition begins.
2. Real-Time Scoring and Adjustments: Scores are updated in real-time, with the EGM adjusting game dynamics based on ongoing performance.
3. Outcome Determination and Reward Allocation: At the end of the game, scores are compared, and rewards are allocated based on the competitive outcome.

Initial Interaction: Two players select the competitive mode on the VCLAPS! EGM and choose their game.

Data Input: Input includes player selections, in-game actions, and bets, all contributing to the real-time competitive scoring.

### Component Interactions and Procedural Steps:

1. Player Matching and Session Start: Players are matched by the competition server, which then initiates the game.
2. Competitive Gameplay: Players engage in the game, with their actions and scores logged and compared by the scoring system.
3. Real-Time Feedback and Adjustments: The competition server provides real-time feedback and adjusts game parameters to maintain competitive balance.

Data Processing: The competition server processes all inputs and scores, ensuring fair play and accurate scoring.

Outputs and Responses: Players receive continuous updates on their performance relative to their opponent, enhancing the competitive aspect of the game.

Data Storage and Reporting: All competition data is securely stored in the backend system, facilitating audits and ensuring compliance with gaming standards.

Error Handling and Security Measures: Robust error handling protocols are in place to address any discrepancies in scoring or gameplay, with security measures ensuring the integrity of competitive interactions.

End of Interaction: At the end of the competitive session, the system evaluates the results, awards the winner, and resets the interfaces for the next players.

### 1.15 Team Play (Cooperative) Game Play & Betting Modes

Example Implementation Details: In the team play mode, the EGM allows multiple players to collaborate on a single game or a series of interconnected games. This mode integrates a multiplayer interface where actions by one player may benefit all team members. The software design includes communication protocols that allow for shared game progress and cooperative strategies. Team play is facilitated through a network that synchronizes game states across multiple player stations.

### Example Walk-Through Interaction:

Players form a team and choose their game from the EGM's multiplayer menu. As they play, individual achievements contribute to a common goal, such as advancing a story or completing a puzzle. The EGM displays collective progress and updates each player's contributions in real time, enhancing the collaborative experience.

### Example Benefits to Players:

This mode promotes social interaction and teamwork, as players must coordinate their actions to achieve shared objectives. It enhances the gaming experience by adding layers of strategy and communication that are not present in solitary play, making the game more engaging and rewarding.

### Example Advantages to Casino:

Team play may increase the duration of player sessions as teams work together towards common goals, potentially increasing overall spend per visit. This mode also differentiates the casino's offerings, attracting groups looking for a social gaming experience.

### Example Sequence Diagram Description & Procedural Flow:

The sequence involves initializing the team session, managing inputs from all team members, updating the shared game state, and handling payouts based on team achievements. The EGM processes inputs from each player, updates the game accordingly, and communicates changes to all team members' screens. All transactions and progress data are tracked by the casino network to manage rewards and ensure compliance.

### Identification of Concept:

This inventive concept introduces a team play mode in the VCLAPS! EGM, allowing multiple players to collaborate on a single game or a series of interconnected games. This mode is designed to enhance social interaction and teamwork, with shared game progress and cooperative strategies.

### Sequence Diagram Components:

VCLAPS! EGM: Facilitates and manages the multiplayer team play environment.
Players (Team Members): Engage in collaborative gameplay, contributing to shared objectives.
Multiplayer Interface: Supports interaction between team members, displaying collective progress and updates.
Game Management System: Coordinates the gameplay mechanics and ensures synchronization across player actions.
Backend System: Logs team activities and manages rewards based on collective achievements.

Implementation Details: The EGM's software includes communication protocols that support shared game progress and cooperative strategies, enabling players to work together towards common goals.

### Distinguishing Novel Features:

Shared Game Progress: Enhances the gaming experience by adding layers of strategy and communication that are absent in solitary play.
Cooperative Betting and Rewards: Allows for bets and rewards to be managed based on team achievements, promoting a collective gaming effort.

### Distinguishing Novel Steps:

1. Team Session Initialization: When players form a team, the EGM initializes a shared game session, linking all team members' inputs and progress.
2. Collective Progress Updates: The game reflects the collective actions of the team, with each player's contributions impacting the overall game progress.
3. Reward Distribution Based on Team Achievements: At the end of the game, rewards are distributed to the team based on their collective performance.

Initial Interaction: Players form a team at the EGM and select a game that supports cooperative play.

Data Input: Inputs from all team members regarding game choices and in-game decisions are aggregated and processed collectively.

### Component Interactions and Procedural Steps:

1. Team Formation and Game Selection: Players register as a team and choose a cooperative game.
2. Shared Gameplay Management: The multiplayer interface and game management system coordinate the game dynamics to reflect team strategies and achievements.
3. Synchronization of Team Actions: Continuous synchronization ensures that each player's actions are updated and reflected in real-time across the team interface.

Data Processing: The EGM processes the collective inputs from the team, updating the game state to accurately reflect the joint efforts and strategies.

Outputs and Responses: The EGM provides real-time feedback on the collective progress and achievements, enhancing the collaborative experience.

Data Storage and Reporting: All data related to team interactions, strategies, and outcomes are logged for performance analysis and reward management.

Error Handling and Security Measures: Protocols are in place to handle any discrepancies or errors in team input processing, ensuring a fair and enjoyable gaming experience for all participants.

End of Interaction: Upon completion of the game, the team's final scores and rewards are calculated and distributed, with the system resetting for the next set of players

1.16 Virtual Machines and Virtual Meter Sets that Combine into One ‘Physical’ Meter Set to Report to Game Server

Example Implementation Details: This feature allows virtualization of multiple gaming machines within a single EGM framework. Each virtual machine operates independently but uses a software layer to aggregate financial data into a single meter set for reporting purposes. This design uses virtualization technology to partition hardware resources efficiently, while maintaining separate game environments that feed into a unified accounting system.

### Example Walk-Through Interaction:

A player chooses from several virtual machines displayed on the EGM's single interface. As they play different games, the EGM tracks individual game metrics such as bets and payouts, which are then aggregated into a single meter set. This unified data is reported to the game server for monitoring and analysis.

### Example Benefits to Players:

Players may switch between games without physically moving to different machines, enjoying a variety of gaming experiences on a single EGM. This setup simplifies the player's interaction and financial tracking across multiple games.

### Example Advantages to Casino:

For casinos, this system streamlines financial reporting and operational management, as it consolidates data from multiple games into one reportable set. It reduces hardware needs and optimizes floor space, while providing detailed insights into player behavior across different games.

### Example Sequence Diagram Description & Procedural Flow:

The procedural flow includes initializing the virtual machines, tracking gameplay metrics for each, aggregating these metrics into a unified meter set, and reporting to the game server. The system dynamically allocates resources to each virtual machine based on demand and tracks all financial transactions to ensure accurate and compliant reporting.

### Identification of Concept:

This concept revolves around virtualizing multiple gaming machines within a single VCLAPS! EGM framework, using a software layer to aggregate financial data from each virtual machine into a single meter set for reporting purposes. This design enhances the flexibility and efficiency of managing multiple games on a single physical machine.

### Sequence Diagram Components:

VCLAPS! EGM: Hosts multiple virtual machines, each representing a separate game.
Virtual Machine Instances: Run independently but share common financial tracking.
Virtual Meter System: Aggregates financial data from all virtual machines.
Game Server: Receives consolidated reports from the EGM for monitoring and analysis.
Backend System: Ensures accurate financial tracking and compliance with gaming regulations.

Implementation Details: Virtual machines operate independently, each with its own game environment, but their financial transactions are aggregated by a centralized meter system that reports to the game server.

### Distinguishing Novel Features:

Resource-Efficient Game Management: Virtual machines use shared hardware resources efficiently, reducing the physical footprint of gaming machines.
Consolidated Financial Reporting: Simplifies financial management by aggregating data from multiple virtual games into one reportable set.

### Distinguishing Novel Steps:

1. Initialization of Virtual Machines: Each virtual machine is initialized with its specific game settings and starts independent operation.
2. Aggregation of Financial Metrics: Financial transactions from each virtual machine are aggregated by the virtual meter system, maintaining detailed tracking while simplifying reporting.
3. Reporting to Game Server: The consolidated financial data is sent to the game server for analysis and compliance purposes.

Initial Interaction: A player selects from various virtual machines displayed on the EGM's interface, initiating multiple games.

Data Input: Player interactions and financial transactions within each virtual machine are inputs for the virtual meter system.

### Component Interactions and Procedural Steps:

1. Virtual Machine Selection and Activation: The player chooses and activates virtual machines, each configured to run its game independently.
2. Financial Transaction Management: As the player engages with the games, the virtual meter system tracks and aggregates financial data.
3. Data Consolidation and Reporting: The aggregated data is reported to the game server, ensuring comprehensive monitoring and compliance.

Data Processing: The system dynamically allocates resources to each virtual machine and tracks all financial transactions to ensure accurate and compliant reporting.

Outputs and Responses: The player may seamlessly switch between virtual games, with financial transactions being managed centrally but reflected individually for each game.

Data Storage and Reporting: Financial and gameplay data from all virtual machines are stored and reported in an aggregated format, simplifying management and regulatory compliance.

Error Handling and Security Measures: Advanced error detection and security protocols are implemented to manage the virtual machines and protect data integrity.

End of Interaction: At the end of the gaming session, the virtual machines are reset, and the financial data is finalized for reporting.

### 1.17 Dividing Awards, Payouts, Prizes Between Players (Proportionality)

Example Implementation Details: This feature involves a system for proportionally dividing awards, payouts, and prizes among players based on their contributions or stakes in a game. Implemented through software algorithms, this system calculates each player's share of the total rewards based on predefined rules or real-time gaming data.

### Example Walk-Through Interaction:

During a cooperative or competitive game, each player's contribution to the outcome is measured and recorded. At the end of the game, the total winnings are distributed proportionally, displayed on the EGM's screen, and credited to each player's account.

### Example Benefits to Players:

This feature ensures fairness in reward distribution, making games more appealing to players who value equitable play. It also enhances the gaming experience by directly linking rewards to individual performance or investment.

### Example Advantages to Casino:

Fair and transparent distribution of winnings may improve player satisfaction and trust in the gaming system, potentially increasing player loyalty and repeat visits. It also allows casinos to host games with variable player contributions and reward structures, adding diversity to their gaming offerings.

### Example Sequence Diagram Description & Procedural Flow:

The sequence diagram would detail player input recording, contribution assessment, reward calculation, and distribution. Each player's actions are logged, their impact on the game outcome is assessed, and their share of the total rewards is calculated and disbursed. This process is supported by backend systems that ensure the accuracy of calculations and the security of financial transactions.

### Identification of Concept:

This inventive concept facilitates the proportional division of awards, payouts, and prizes among players based on their contributions or stakes in a game, implemented through software algorithms that calculate each player's share of total rewards based on predefined rules or real-time gaming data.

### Sequence Diagram Components:

VCLAPS! EGM: Manages the distribution of rewards based on player contributions.
Players: Engage in games where their contributions affect the outcome and their share of rewards.
Reward Calculation System: Calculates the proportional share of each player based on their game contributions.
Payout System: Distributes rewards according to the calculated shares.
Backend System: Logs transactions and ensures fairness in reward distribution.

Implementation Details: Software algorithms within the EGM calculate the proportion of total winnings to be distributed to each player, ensuring fairness and transparency in multiplayer games.

### Distinguishing Novel Features:

Fair Reward Distribution: Ensures that rewards are split proportionally among players, directly linking their earnings to their performance or investment.
Transparency in Payouts: Players may see how their actions influence their rewards, enhancing trust and satisfaction.

### Distinguishing Novel Steps:

1. Contribution Tracking and Assessment: The system tracks each player's contributions throughout the game.
2. Proportional Reward Calculation: At the end of the game, the system calculates each player's share of the rewards based on their contributions.
3. Transparent and Fair Payouts: Rewards are distributed to players according to the calculated proportions, ensuring fairness.

Initial Interaction: Players start a multiplayer game where their contributions will determine their share of the total rewards.

Data Input: Inputs include player actions and contributions throughout the game, which affect the outcome and their proportion of the rewards.

### Component Interactions and Procedural Steps:

1. Gameplay and Contribution Tracking: As players engage with the game, their contributions are continuously tracked.
2. Calculation of Reward Proportions: After the game, the reward calculation system assesses contributions and calculates each player's share.
3. Distribution of Payouts: The payout system distributes rewards based on these calculations, ensuring each player receives their fair share.

Data Processing: The system processes gameplay data to assess contributions and calculate reward proportions accurately.

Outputs and Responses: Players receive payouts proportional to their contributions, which are clearly communicated, enhancing the gaming experience through fairness.

Data Storage and Reporting: Detailed records of player contributions and payouts are maintained for transparency and to support potential audits.

Error Handling and Security Measures: Robust error detection and correction mechanisms ensure the accuracy of contribution assessments and reward calculations.

End of Interaction: The game concludes with the proportional distribution of rewards, and the system prepares for the next game, resetting all tracking and calculation parameters.

### 1.18 Players Bet Against Each Other: Double Down During Competition

Example Implementation Details: This feature enables direct betting between players within a competitive gaming scenario on an EGM. Players may “double down,” or increase their bets, in response to game developments or opponent actions. This may require an advanced gaming system capable of managing player-to-player transactions and dynamically adjusting odds based on in-game events.

### Example Walk-Through Interaction:

During a competitive match, a player opts to double down, signaling this choice on the EGM interface. The system then recalculates the potential payouts and updates the game odds, reflecting the new stakes. Opponents may respond by matching the new bet or conceding, influencing the game's strategic depth and potential rewards.

### Example Benefits to Players:

This feature adds a layer of strategic complexity and high-stakes decision-making, enhancing the excitement and engagement of competitive play. It allows players to leverage their confidence in their gaming skills to increase potential winnings.

### Example Advantages to Casino:

Enhanced betting options may lead to increased wager sizes and more dynamic gaming sessions, potentially boosting casino revenue. Additionally, the interactive and competitive nature of this feature may attract a demographic interested in skill-based gaming.

### Example Sequence Diagram Description & Procedural Flow:

The procedural flow starts with the player's decision to double down, followed by the system's bet acceptance and odds adjustment. Other players' responses are then processed, and the game outcome is calculated based on the new bets. The system ensures all financial transactions are secure and compliant with gaming regulations, while providing a fair and transparent gaming environment.

### Identification of Concept:

This concept enables direct betting between players within a competitive gaming scenario on the VCLAPS!EGM. Players may “double down” or increase their bets in response to game developments or opponent actions, adding strategic depth to the gameplay.

### Sequence Diagram Components:

VCLAPS! EGM: Facilitates and manages the betting interactions and game dynamics.
Player A, Player B: Competitors who may adjust their bets based on the game's progression.
Betting System: Manages the bets, increases, and payouts based on the competitive outcomes.
Game Logic Processor: Adjusts game settings and outcomes based on player interactions and bets.
Backend System: Logs betting data and ensures compliance with gaming regulations.

Implementation Details: Advanced gaming systems within the EGM manage player-to-player transactions and dynamically adjust odds and potential payouts based on in-game events and player decisions.

### Distinguishing Novel Features:

Dynamic Betting Adjustments: Allows players to modify their bets during the game, influencing the potential outcomes and rewards.
Strategic Gameplay Enhancement: Introduces a layer of strategic decision-making that extends beyond traditional gameplay mechanics.

### Distinguishing Novel Steps:

1. Initiation of Betting Round: At a notable point in the game, players are given the option to double down on their bets.
2. Betting Adjustment Processing: The betting system processes any increases and recalculates potential payouts.
3. Game Outcome Based on Adjusted Bets: The game logic processor determines the game outcome considering the updated bets, ensuring fairness and excitement.

Initial Interaction: Players start a competitive match, and as the game progresses, they are prompted to adjust their bets based on their confidence and game developments.

Data Input: Inputs include initial bets, decisions to increase bets, and responses to the game's progression from each player.

### Component Interactions and Procedural Steps:

1. Betting Decision Prompt: Players are notified of the opportunity to double down their bets during the game.
2. Bet Adjustment by Players: Player A and Player B decide and input their increased bets.
3. Outcome Calculation and Payout: Following the bet adjustments, the game concludes, and payouts are calculated based on the new bet amounts and game outcomes.

Data Processing: The betting system updates the bet amounts and communicates with the game logic processor to adjust game dynamics accordingly.

Outputs and Responses: Players receive immediate feedback on their bet adjustments and are informed of the updated potential outcomes and eventual payouts.

Data Storage and Reporting: All transactional data related to bets and outcomes is securely logged by the backend system for compliance and auditing.

Error Handling and Security Measures: Robust mechanisms are in place to prevent errors during bet processing and to secure transaction data against tampering or fraud.

End of Interaction: The game ends with final payouts based on the adjusted bets, and the system resets for the next players.

### 1.19 Multiple Player Tracking Cards Linked to the Egm for Tax and Regulatory Purposes

Example Implementation Details: This feature integrates multiple player tracking cards with a single EGM, allowing each card to be associated with specific games or bets made on the machine. The system tracks individual player data and game outcomes, which may be reported for tax purposes under each player's account.

### Example Walk-Through Interaction:

Players insert their tracking cards into the EGM, which recognizes and logs each player's activity separately. As players engage with the games, their individual wins and losses are recorded under their respective accounts, enabling accurate reporting of taxable winnings.

### Example Benefits to Players:

Players may manage their gaming sessions individually, even when using the same EGM. This feature ensures personal gaming history and financial transactions are accurately logged and reported, providing transparency and ease of tax reporting.

### Example Advantages to Casino:

Casinos benefit from automated and accurate record-keeping that simplifies compliance with gaming and tax regulations. This system also enhances customer service by providing players with detailed reports of their gaming activity.

### Example Sequence Diagram Description & Procedural Flow:

The procedural flow includes player card recognition, game activity tracking, and data aggregation for each player. The system updates player profiles in real-time with game outcomes, ensuring that all information is ready for regulatory reporting. Backend systems maintain data integrity and security, supporting both casino management and regulatory compliance.

### Identification of Concept:

This concept involves integrating multiple player tracking cards with a single EGM, allowing each card to be associated with specific games or bets made on the machine. This setup facilitates accurate record-keeping for tax purposes and enhances personalized gaming experiences.

### Sequence Diagram Components:

VCLAPS! EGM: Manages game selection and bet tracking for multiple players.
Players: Each uses a tracking card to log their game activity and financial transactions.
Player Tracking System: Identifies players and links their activities to their respective tracking accounts.
Financial System: Manages and logs bets, wins, and losses associated with each player's card.
Compliance and Tax Reporting System: Ensures accurate financial reporting for regulatory purposes.

Implementation Details: Player tracking cards are used to individually record players' activities on the EGM, linking each game session and associated financial transactions to specific players, which is notable for compliance and personalized service.

### Distinguishing Novel Features:

Individualized Player Tracking: Each player's card logs activities separately, enhancing the accuracy of financial and gameplay reporting.
Enhanced Regulatory Compliance: Facilitates detailed and precise reporting for tax and regulatory purposes.

### Distinguishing Novel Steps:

1. Card Recognition and Session Linking: Each player inserts their tracking card, which is recognized by the system to link all game activities to their account.
2. Gameplay and Transaction Logging: As players engage with games, all associated transactions are logged under their individual accounts.

Regulatory Reporting: The system compiles and reports data for each player separately, adhering to tax and regulatory requirements.

Initial Interaction: Players insert their tracking cards into the EGM, which recognizes each card and links upcoming game sessions and transactions to the respective player accounts.

Data Input: Inputs include player identification via tracking cards and all in-game financial transactions linked to these cards.

### Component Interactions and Procedural Steps:

1. Tracking Card Insertion and Identification: Players insert their cards, which are read by the player tracking system.
2. Financial Transaction Tracking: All bets, wins, and losses are tracked by the financial system and linked to the respective player's tracking card.
3. Compliance Reporting: The compliance and tax reporting system aggregates and formats these data for submission to regulatory bodies.

Data Processing: The system processes identification and transaction data to ensure accurate linkage and reporting of each player's gaming activities.

Outputs and Responses: Players may view their gaming history and financial transactions through their linked tracking accounts, receiving personalized updates and promotions based on their activities.

Data Storage and Reporting: Detailed logs of all player activities and transactions are maintained, providing a reliable basis for audits and compliance checks.

Error Handling and Security Measures: Robust security protocols protect player data, with error detection systems in place to ensure the accuracy of transaction logging and reporting.

End of Interaction: Players complete their gaming sessions, with all data securely logged and reported, and the tracking system resets for new interactions.

### 1.20 For Tax Purposes, Individual Game Winnings Reported Under Players' Tax Ids

Example Implementation Details: This functionality allows winnings from each game played on an EGM to be reported individually under the player's Social Security number or tax ID. The system uses secure identification methods and detailed financial tracking to accurately attribute and report winnings for each game session.

### Example Walk-Through Interaction:

When initiating a game session, players enter their tax ID, linking it to the session's financial transactions. The system then tracks these transactions and compiles a detailed report of winnings, which may be used for tax purposes, distinguishing between different players' earnings on the same machine.

### Example Benefits to Players:

This feature provides meticulous financial tracking and reporting, desirable for accurate tax submissions. Players may confidently manage their gambling earnings and report them in compliance with tax regulations.

### Example Advantages to Casino:

For casinos, this system offers a streamlined approach to financial reporting and tax compliance, enhancing operational efficiency. It also builds trust with players by ensuring their financial data is handled accurately and confidentially.

### Example Sequence Diagram Description & Procedural Flow:

The sequence involves player identification, game wager tracking, winnings calculation, and financial report generation. Each step is securely processed to protect sensitive information, with all data linked to the player's tax ID for straightforward tax reporting. The system's robust security measures prevent data breaches and ensure compliance with financial regulations.

### Identification of Concept:

This concept allows winnings from each game played on an EGM to be reported individually under the player's tax ID. It enhances financial tracking and compliance by ensuring precise attribution of winnings to players for tax reporting purposes.

### Sequence Diagram Components:

VCLAPS! EGM: Manages individual game sessions and tracks winnings.
Player: Engages in games and earns winnings to be reported.
Tax Reporting System: Links winnings to the player's tax ID and prepares reports.
Financial System: Tracks and calculates winnings for each game.
Backend System: Ensures data integrity and compliance with financial regulations.

Implementation Details: The EGM uses secure identification methods to link each game session and associated winnings to a player's tax ID, facilitating accurate financial reporting and compliance with tax regulations.

### Distinguishing Novel Features:

Tax ID Linked Winnings: Directly links each player's winnings to their tax ID, simplifying tax submissions and compliance.
Accurate Financial Tracking: Ensures that all winnings are correctly reported and attributed, reducing errors in tax reporting.

### Distinguishing Novel Steps:

1. Player Identification and Game Association: At the start of each session, the player's tax ID is linked to the game, ensuring all winnings are tracked under this ID.
2. Winnings Calculation and Attribution: Winnings are calculated and recorded under the player's tax ID immediately upon game completion.
3. Tax Reporting Preparation: The tax reporting system prepares detailed reports of winnings for each player, ready for tax filing.

Initial Interaction: Before starting a game, players enter their tax ID, which the EGM links to their upcoming game sessions and potential winnings.

Data Input: Inputs include the player's tax ID at the beginning of the session and detailed financial transactions related to game winnings.

### Component Interactions and Procedural Steps:

1. Tax ID Entry and Verification: Players input their tax ID, which is verified and linked to their game sessions by the EGM.
2. Financial Tracking of Winnings: As players win games, the financial system calculates and records the winnings under the linked tax ID.
3. Tax Report Generation: The tax reporting system generates accurate reports of these winnings, formatted for easy tax reporting.

Data Processing: The EGM processes tax IDs and financial transactions, ensuring accurate linkage and reporting of winnings to individual players.

Outputs and Responses: Players receive confirmation of their winnings being recorded under their tax IDs, providing transparency and confidence in the financial management of their gaming activities.

Data Storage and Reporting: All transactional data is securely stored in the backend system, supporting detailed financial audits and compliance with tax regulations.

Error Handling and Security Measures: Advanced error detection and correction mechanisms ensure the accuracy of financial tracking and the security of sensitive tax ID information.

End of Interaction: At the end of the gaming session, all financial data is finalized and prepared for reporting, with the system resetting for the next player.

### 1.21: Rewards Based on Player Longevity and Loyalty

This concept introduces a reward system within the VCLAPS! EGM that provides incentives based on player longevity and loyalty. Players accumulate points or rewards the longer they play and the more frequently they return, enhancing player engagement and retention.

### 1.22: Real-Time Multi-Player Soft Meter Tracking and Player Tracking Account Logging.

Feature Summary: Maintain multiple separate soft meters to individually track player activities, bets, wins, payouts, jackpots etc. from multiple different players concurrently engaged in gaming sessions at the VCLAPS!EGM. Record and/or update each players' soft meter data on that player's player tracking account. The VCLAPS!EGM is configured or designed to concurrently update multiple player tracking accounts (e.g., in real-time) during gaming session(s) and/or at end of gaming session (e.g., upon cashout event for a given player).

### Identification of Feature

The VCLAPS! EGM is designed to maintain multiple separate soft meters for tracking player activities, bets, wins, payouts, jackpots, and other gaming metrics concurrently. Each player's data is recorded on their respective player tracking account, ensuring accurate and real-time updates. The EGM supports simultaneous sessions for multiple players, enabling concurrent updates to various player tracking accounts during and at the end of gaming sessions, including upon cashout events.

This inventive concept involves maintaining multiple separate soft meters to track various player activities such as bets, wins, payouts, jackpots, and more for multiple players concurrently engaged in gaming sessions at the VCLAPS! EGM. Each player's data is recorded in real-time on their respective player tracking account, allowing for simultaneous updates during and at the end of gaming sessions. The VCLAPS! EGM is configured to handle multiple player interactions concurrently, ensuring accurate tracking and reporting of each player's gaming metrics.

In at least one embodiment, the Real-Time Multi-Player Soft Meter Tracking and Player Tracking Account Logging inventive concept involves maintaining multiple separate soft meters for tracking various player activities (bets, wins, payouts, etc.) for multiple players concurrently engaged in gaming sessions at the VCLAPS! EGM. Each player's data is recorded in real-time on their respective player tracking account, allowing for simultaneous updates during and at the end of gaming sessions. The VCLAPS! EGM handles multiple player interactions concurrently, ensuring accurate tracking and reporting of each player's gaming metrics.

### Novel Implementation Details and Features

The VCLAPS! EGM introduces several novel implementation details and features that differentiate it from conventional EGMs, such as, for example:
Individual Soft Meters for Each Player: The VCLAPS! EGM maintains separate soft meters for each player's activities, such as bets, wins, and payouts, which are updated in real-time and recorded to individual player tracking accounts. This may be differentiated from consolidating game performance meters from multiple players into a single set of regulatory meters, mimicking a single-player game for regulatory purposes.
Real-Time Data Segregation and Concurrent Updates: The VCLAPS! EGM implements real-time data segregation, ensuring that each player's activities are tracked independently without interference. Concurrent updates to multiple soft meters are possible during gaming sessions. This may be differentiated from combining player performance meters into a single regulatory meter, with no real-time independent tracking for each player.
Player-Specific Data Transmission: The VCLAPS! EGM facilitates player-specific data transmission to individual tracking accounts upon session completion or cashout, ensuring accurate and individualized record-keeping. This may be differentiated from reporting consolidated regulatory meters to the central casino management system, treating multiple players as a single entity for accounting purposes.
Enhanced User Interface and Player Interaction: The VCLAPS! EGM provides a user interface that displays separate progress bars or indicators for each player, highlighting their individual gaming metrics. This may be differentiated from displaying combined game performance meters, with the regulatory meters appearing as a single set of data for the entire gaming session.
Scalability and Robust Data Processing: The VCLAPS! EGM is designed with scalable architecture to handle multiple concurrent gaming sessions efficiently, supporting robust data processing and real-time updates. This may be differentiated from using peer-to-peer networking to combine game performance meters but does not support independent real-time updates for each player.

### Utilization of Novel Implementation Details and Features

The novel implementation details and features of the VCLAPS! EGM enable the Real-Time Multi-Player Soft Meter Tracking and Player Tracking Account Logging inventive concept to be deployed in multiplayer gaming sessions effectively:
Independent Soft Meters: By maintaining separate soft meters for each player, the VCLAPS! EGM ensures accurate tracking of individual player activities, enhancing transparency and trust.

Real-Time Data Updates: The system's ability to update soft meters in real-time allows for precise and timely record-keeping, which is notable for regulatory compliance and player satisfaction.
Player-Specific Reporting: The VCLAPS! EGM's capability to transmit data to individual player tracking accounts ensures that each player's performance is logged accurately, facilitating better player behavior analysis and personalized marketing strategies.
Enhanced User Experience: The user interface displays separate metrics for each player, providing a clear and engaging gaming experience, with players able to monitor their progress independently.
Scalability: The scalable architecture supports multiple concurrent gaming sessions, ensuring seamless operation even during peak times.

### Novel and Unique Implementation Details for Supporting Multiplayer Gaming Sessions

The VCLAPS! EGM introduces several novel and unique implementation details that support multiplayer gaming sessions more effectively than conventional EGMs:
Real-Time Independent Tracking: Unlike the prior art, which may consolidate data for regulatory purposes, the VCLAPS! EGM tracks and updates each player's data independently in real-time, providing more accurate and transparent record-keeping.
Concurrent Data Processing: The system supports concurrent updates for multiple players, ensuring that each player's activities are recorded accurately and without delay.
Individual Player Interfaces: Each player has access to a dedicated interface that displays their metrics separately, enhancing the gaming experience and allowing for better individual performance monitoring.
Player-Specific Data Transmission: The ability to transmit data to individual player tracking accounts upon session completion or cashout ensures that each player's performance is logged accurately and independently, facilitating personalized marketing and better player behavior analysis.

These novel implementation details and features differentiate the VCLAPS! EGM from conventional single-player EGMs, providing a more engaging and reliable multiplayer gaming experience. The VCLAPS! EGM's approach to real-time independent tracking, concurrent data processing, and player-specific reporting sets it apart as a more advanced and player-friendly solution for multiplayer gaming sessions.

### Example Walk-Through Interaction

A player, Alice, approaches the VCLAPS! EGM and inserts her player tracking card, linking her account to the machine. She starts playing a slot game, and her bets, wins, and other activities are tracked by a dedicated soft meter associated with her account. As Alice plays, Bob joins the machine and inserts his player tracking card. Bob's activities are tracked separately, with a different soft meter recording his bets, wins, and payouts.

Alice hits a jackpot, and her soft meter updates to reflect this win. Simultaneously, Bob wins a smaller payout, and his meter updates accordingly. Throughout their session, the VCLAPS! EGM continuously updates both Alice's and Bob's soft meters in real-time, ensuring each player's data is accurately recorded. When Alice decides to cash out, her soft meter data is finalized and transmitted to her player tracking account, while Bob continues to play.

The machine's interface shows separate progress bars or indicators for each player, highlighting their individual gaming metrics. Alice's cashout process involves the EGM consolidating her accumulated credits and dispensing them, while her soft meter data is logged for record-keeping and reporting purposes.

### Example Benefits to Players

Players benefit from precise and individualized tracking of their gaming activities, ensuring accurate records of their bets, wins, and payouts. This transparency enhances trust in the gaming experience and allows players to monitor their progress and performance closely. Additionally, players may enjoy multiplayer gaming sessions without interference, knowing their data is kept separate and secure.

### Example Advantages to Casino

The VCLAPS! EGM's ability to track multiple players' activities concurrently enhances operational efficiency and data accuracy. Casinos may offer a more engaging and interactive gaming experience, attracting more players. The real-time data updates facilitate better player behavior analysis and marketing strategies. Moreover, the system ensures compliance with regulatory requirements for accurate reporting and auditing.

### Implementation Details:

The VCLAPS! EGM incorporates advanced software algorithms and hardware components to manage separate soft meters for each player. The machine's central processing unit (CPU) handles data input from player interactions and updates the soft meters in real-time. Each player tracking account is linked to a unique identifier within the system, ensuring data integrity and separation.

The EGM's interface is designed to display individual player metrics, with separate visual elements for each player's activities. The backend system communicates with the casino's central server, transmitting updated soft meter data for record-keeping and analysis. The machine's architecture supports scalable and robust data processing, ensuring seamless operation during peak gaming sessions.

The VCLAPS! EGM is equipped with advanced hardware and software components to support real-time tracking and logging of multiple players' activities. The machine features multiple player interfaces, each linked to a separate soft meter that records individual player data. The EGM's central processing unit (CPU) manages these interfaces and updates the soft meters in real-time based on player interactions.

Each player tracking account is associated with a unique identifier, ensuring that data from different players is kept separate. The EGM communicates with the casino's central servers to update player tracking data continuously. The interface displays individual player metrics, allowing players to monitor their progress.

During a gaming session, the EGM processes inputs from various players, updating their respective soft meters without interference. The backend system aggregates this data for record-keeping and compliance purposes. The architecture supports scalable data processing, ensuring smooth operation even during peak times.

This approach is differentiated from conventional EGMs by its ability to handle multiple player sessions simultaneously, ensuring accurate and real-time tracking for each player. The integration of separate soft meters for each player and the capability to update player tracking accounts in real-time are notable differentiators.

### Distinguishing Novel Features

The novel implementation of maintaining multiple separate soft meters differentiates the VCLAPS! EGM from conventional single-player EGMs. This feature supports concurrent multiplayer sessions, enhancing the gaming experience and operational efficiency. The system's ability to update player tracking accounts in real-time and during cashout events ensures accurate and timely data recording, notable for regulatory compliance and player satisfaction.

The novel implementation of multiple separate soft meters and real-time tracking at the VCLAPS! EGM allows for a unique multiplayer gaming experience. Unlike traditional single-player EGMs, this system supports concurrent gaming sessions for multiple players, enhancing both the gaming experience and operational efficiency.

The ability to update player tracking accounts in real-time and during cashout events ensures accurate data recording and regulatory compliance. Each player's data is tracked independently, preventing interference and ensuring precise record-keeping. The VCLAPS! EGM's architecture supports robust and scalable data processing, desirable for handling the complexities of multiplayer sessions.

The use of advanced software algorithms and dedicated hardware components enables seamless management of multiple gaming sessions. The system's real-time data segregation and concurrent updates further distinguish it from conventional EGMs, providing a more engaging and reliable gaming environment.

### Distinguishing Novel Steps

Real-Time Data Segregation: Implementing real-time data segregation for multiple players, ensuring that each player's activities are tracked independently.
Concurrent Soft Meter Updates: Enabling the EGM to update multiple soft meters concurrently during gaming sessions, including real-time adjustments based on in-game events.
Player-Specific Data Transmission: Facilitating player-specific data transmission to their respective tracking accounts upon session completion or cashout, ensuring accurate and individualized record-keeping.

### Player Interaction:

Players interact with the VCLAPS! EGM through dedicated interfaces, each linked to their respective soft meters. Player A, for example, inserts their player tracking card and begins a session, with their bets, wins, and activities tracked in real-time. Player B joins the machine, and their activities are tracked separately.

Throughout the session, players may monitor their progress via the EGM's interface, which displays individual metrics. When Player A decides to cash out, the system finalizes and transmits their data to their tracking account. Player B continues playing, with their data updated concurrently.

This process ensures that each player's interactions are tracked accurately and independently, providing a transparent and engaging gaming experience. The VCLAPS! EGM's ability to support multiple players simultaneously enhances the overall gaming environment.

### Data Input:

Data inputs required from players include:
Player Tracking Card: Identifies the player and links their activities to their tracking account.
Bets and Wagers: Amounts wagered by the player during each game session.
Game Interactions: Actions taken within the game, such as spins, button presses, and selections.
Cash or Ticket Insertions: Currency or tickets inserted into the machine.

These inputs are processed in real-time, with the EGM updating each player's soft meter independently. The system ensures accurate and timely tracking of all player activities, enhancing the gaming experience and ensuring regulatory compliance.
1. Component Interactions and Procedural Steps:
2. Player Identification: Player inserts tracking card, linking their account to the EGM.
3. Game Session Initialization: EGM initializes separate soft meters for each player.
4. Real-Time Tracking: Player actions are tracked in real-time, with data sent to the respective soft meters.
5. In-Game Events: RNG generates outcomes, updating soft meters based on wins and payouts.
6. Concurrent Updates: EGM updates multiple soft meters simultaneously, ensuring accurate tracking for all players.
7. Cashout Process: Player initiates cashout, and EGM finalizes and transmits data to their tracking account.
8. Data Logging: EGM logs all transactions for auditing and reporting.
9. Session Termination: EGM resets soft meters for the next session.

These interactions ensure that each player's data is tracked accurately and independently, providing a transparent and engaging gaming experience.

### Data Processing:

The VCLAPS! EGM processes player inputs in real-time, updating each player's soft meter based on their actions. The system uses advanced algorithms to segregate data for multiple players, ensuring accurate tracking. Outcomes generated by the RNG are used to update soft meters, reflecting wins and payouts. Data is transmitted to player tracking accounts during and after sessions, ensuring accurate record-keeping.

### Outputs and Responses:

The system provides real-time feedback to players through the EGM's interface, displaying individual metrics such as bets, wins, and credits. Upon cashout, players receive a consolidated report of their activities, and their data is transmitted to their tracking account. The EGM also logs all transactions for auditing and compliance purposes, ensuring accurate and transparent record-keeping.

### Data Storage and Reporting:

The EGM stores detailed records of all player activities, including bets, wins, and payouts. This data is transmitted to central servers for auditing and compliance purposes. The system ensures secure and accurate storage of all data, facilitating regulatory reporting and analysis.

### Error Handling and Security Measures:

The VCLAPS! EGM includes robust error-checking mechanisms to detect and correct any discrepancies in data tracking. Security measures protect against fraud and tampering, ensuring the integrity of player data. The system is designed to handle errors gracefully, maintaining accurate and reliable tracking of all player activities.

### End of Interaction:

At the end of a session, the EGM finalizes and transmits some or all recorded soft meter player data (e.g., for a given player) to that player's tracking account. The system then resets the soft meters, ensuring a clean slate for the next session. This process ensures accurate and transparent record-keeping, providing a seamless transition between gaming sessions.

Example Soft Meters (e.g., instantiated for each different player at the VCLAPS! EGM):
1. Bet Meter: Records the total amount wagered by a player during their gaming session, including bets placed on each game and each round.
2. Win Meter: Tracks the total winnings accumulated by a player, detailing the amounts won in each game and round.
3. Payout Meter: Logs the payouts received by the player, including cashouts and prizes collected during the session.
4. Jackpot Contribution Meter: Records the player's contributions to the progressive jackpot pool, including the percentage or fixed amount taken from each bet.
5. Jackpot Win Meter: Tracks the amounts won from progressive jackpots, detailing individual jackpot wins.
6. Bonus Meter: Logs the bonuses awarded to the player, such as free spins, multipliers, or other promotional rewards.
7. Time Played Meter: Records the total time spent by the player on the EGM, including time spent on each game.
8. Game Participation Meter: Tracks the specific games played by the player, detailing participation in different game types and modes.
9. Spin Count Meter: Logs the number of spins made by the player, including normal and bonus spins.
10. Session Meter: Records data related to individual gaming sessions, including start and end times, session duration, and total activity during the session.
11. Coin In Meter: Tracks the total value of coins or credits inserted by the player into the machine.
12. Coin Out Meter: Logs the total value of coins or credits dispensed to the player from the machine.
13. Cash In Meter: Records the amount of cash inserted by the player into the EGM.
14. Ticket In Meter: Tracks the value of tickets inserted by the player for credits.
15. Ticket Out Meter: Logs the value of tickets printed or dispensed to the player.
16. Credit Meter: Records the current credit balance of the player, detailing credits earned, used, and remaining.
17. Loss Meter: Tracks the total losses incurred by the player, calculated as the difference between the total bets and total wins.
18. Promotional Credit Meter: Logs credits awarded through promotions, such as bonus codes or player loyalty programs.
19. Loyalty Points Meter: Tracks loyalty points earned by the player, based on their activity and engagement with the EGM.
20. Error Meter: Records any errors or malfunctions encountered during the player's gaming session, detailing the nature and impact of each error.
21. Reel Stop Meter: Logs the number of times and positions at which each reel stops during the player's spins.
22. Bet Adjustment Meter: Tracks changes in bet amounts made by the player during the gaming session.
23. Free Play Meter: Records the usage and remaining balance of any free play credits awarded to the player.
24. Skill-Based Game Performance Meter: Logs performance metrics specific to skill-based games, such as accuracy, speed, and levels achieved.
25. Side Bet Meter: Tracks the total amount wagered on side bets, separate from main game bets.
26. Multiplayer Contribution Meter: Records contributions made by the player in multiplayer or cooperative games, detailing how their actions impact the group outcome.
27. Interactive Feature Usage Meter: Logs interactions with special game features, such as bonus rounds, mini-games, or interactive story elements.
28. Achievement Meter: Tracks achievements unlocked by the player, such as completing certain game challenges or reaching milestones.
29. Virtual Currency Meter: Records the acquisition and usage of virtual currency within the game, separate from real money transactions.
30. Daily Activity Meter: Logs daily activity metrics, including the number of sessions, total time played, and total bets and wins for each day.
31. Weekly Activity Meter: Aggregates weekly activity data, providing insights into the player's engagement over a week.
32. Monthly Activity Meter: Aggregates monthly activity data, detailing the player's engagement and performance over a month.
33. Player Decision Meter: Tracks notable decisions made by the player during gameplay, such as choosing different paths in interactive storylines or selecting bonus options.
34. Event Participation Meter: Logs participation in special events or tournaments, including entry fees, progress, and outcomes.
35. Win Frequency Meter: Records the frequency and distribution of wins, providing insights into how often and in what amounts the player wins.
36. Loss Frequency Meter: Tracks the frequency and distribution of losses, detailing how often and in what amounts the player loses.
37. Bet Type Meter: Logs different types of bets placed by the player, such as single line bets, multi-line bets, or max bets.
38. Engagement Meter: Tracks player engagement metrics, such as the number of interactions per session and average session duration.
39. Return to Player (RTP) Meter: Calculates and logs the player's Return to Player percentage based on their total bets and wins.
40. Session Interval Meter: Records the intervals between gaming sessions, providing insights into the player's gaming habits and frequency of play.

### Sequence Diagram Components:

VCLAPS! EGM: The electronic gaming machine managing multiple gaming sessions.
Player A: One of the players interacting with the VCLAPS! EGM.
Player B: Another player interacting with the VCLAPS! EGM concurrently.
Individual Player Interfaces: Interfaces through which players interact with the EGM.
Bill Validators: Components that validate and accept currency or tickets inserted by players.
Network Communication Components: Facilitate data exchange between the EGM and casino network servers.
VCLAPS! EGM Cash Box: Collects and stores cash from players.
Data Communication Components: Manage data transfer within the EGM and to external servers.
Random Number Generators (RNG): Generate random outcomes for games.
Individual Player Game Meters: Track game-specific data for each player.
Individual Player Tracking Account Interfaces: Link player activities to their accounts.
VCLAPS! EGM Hardware Components: Physical components such as touchscreens and buttons.
VCLAPS! EGM Software Components: Software managing game logic and player activity tracking.
Backend System Components: Central servers managing data storage and processing.
Casino Network Components: Infrastructure supporting communication and data exchange.
Casino Network Servers: Host player tracking and game management systems.
Game Servers: Handle game logic and RNG operations.
Player Tracking Servers: Store and manage player tracking data.

### VCLAPS! Flow Procedures

### Example Procedures and Flow Diagrams

Various example embodiments of different procedures and/or procedural flows disclosed herein may be used for facilitating activities relating to one or more of the VCLAPS! aspects.

According to different embodiments, at least a portion of the various types of functions, operations, actions, and/or other features provided by the VCLAPS! procedures may be implemented at one or more client systems(s), at one or more System Servers (s), and/or combinations thereof.

In at least one embodiment, one or more of the VCLAPS! procedures may be operable to utilize and/or generate various different types of data and/or other types of information when performing specific tasks and/or operations. This may include, for example, input data/information and/or output data/information. For example, in at least one embodiment, the VCLAPS! procedures may be operable to access, process, and/or otherwise utilize information from one or more different types of sources, such as, for example, one or more local and/or remote memories, devices and/or systems. Additionally, in at least one embodiment, the VCLAPS! procedures may be operable to generate one or more different types of output data/information, which, for example, may be stored in memory of one or more local and/or remote devices and/or systems. Examples of different types of input data/information and/or output data/information which may be accessed and/or utilized by the VCLAPS! procedures may include, but are not limited to, one or more of those described and/or referenced herein.

In at least one embodiment, a given instance of the VCLAPS! procedures may access and/or utilize information from one or more associated databases. In at least one embodiment, at least a portion of the database information may be accessed via communication with one or more local and/or remote memory devices. Examples of different types of data which may be accessed by the VCLAPS! procedures may include, but are not limited to, one or more of those described and/or referenced herein.

According to specific embodiments, multiple instances or threads of the VCLAPS! procedures may be concurrently implemented and/or initiated via the use of one or more processors and/or other combinations of hardware and/or hardware and software. For example, in at least some embodiments, various aspects, features, and/or functionalities of the VCLAPS! procedures may be performed, implemented and/or initiated by one or more of the various systems, components, systems, devices, procedures, processes, etc., described and/or referenced herein.

According to different embodiments, one or more different threads or instances of the VCLAPS! procedures may be initiated in response to detection of one or more conditions or events satisfying one or more different types of minimum threshold criteria for triggering initiation of at least one instance of the VCLAPS! procedures. Various examples of conditions or events which may trigger initiation and/or implementation of one or more different threads or instances of the VCLAPS! procedures may include, but are not limited to, one or more of those described and/or referenced herein.

According to different embodiments, one or more different threads or instances of the VCLAPS! procedures may be initiated and/or implemented manually, automatically, statically, dynamically, concurrently, and/or combinations thereof. Additionally, different instances and/or embodiments of the VCLAPS! procedures may be initiated at one or more different time intervals (e.g., during a specific time interval, at regular periodic intervals, at irregular periodic intervals, upon demand, etc.).

In at least one embodiment, initial configuration of a given instance of the VCLAPS! procedures may be performed using one or more different types of initialization parameters. In at least one embodiment, at least a portion of the initialization parameters may be accessed via communication with one or more local and/or remote memory devices. In at least one embodiment, at least a portion of the initialization parameters provided to an instance of the VCLAPS! procedures may correspond to and/or may be derived from the input data/information.

### Example Sequence Diagram Description & Procedural Flow

1. Player Identification: Each player inserts their tracking card, linking their account to the EGM.
2. Game Session Initialization: The EGM initializes separate soft meters for each player based on their unique identifiers.
3. Real-Time Tracking: As players interact with the machine, their activities (bets, wins, payouts) are tracked and recorded in real-time by their respective soft meters.
4. In-Game Events: The EGM processes in-game events (e.g., hitting a jackpot) and updates the corresponding player's soft meter.
5. Concurrent Updates: The system ensures concurrent updates to multiple soft meters without data interference.
6. Cashout Process: When a player decides to cash out, their soft meter data is finalized and transmitted to their player tracking account.
7. Data Logging: The EGM logs all transactions and updates for auditing and reporting purposes. 8. Session Termination: The system resets the soft meter for the next player, ensuring clean data segregation for subsequent sessions.

### Example SequenceDiagram (Mermaid Notation):

participant PlayerA as Player A
participant PlayerB as Player B
participant EGM as VCLAPS! EGM
participant EGMActivity as EGM Activity Tracking Component(s)
participant EGMSoftMeterA as EGM Soft Meters Player A
participant EGMSoftMeterB as EGM Soft Meters Player B
participant CasinoServers as Casino Network Servers
participant TrackingServers as Player Tracking Servers
participant PlayerAccountA as Player A Player Tracking Account
participant PlayerAccountB as Player B Player Tracking Account
PlayerA-EGM: Insert tracking card
PlayerB->>EGM: Insert tracking card
EGM->>EGMSoftMeterA: Initialize soft meter
EGM->>EGMSoftMeterB: Initialize soft meter
PlayerA-EGM: Place bet
EGM-EGMActivity: Track bet
EGMActivity->>EGMSoftMeterA: Update soft meter
PlayerB-EGM: Place bet
EGM-EGMActivity: Track bet
EGMActivity->>EGMSoftMeterB: Update soft meter
PlayerA-EGM: Spin
EGM-EGMActivity: Process spin
EGMActivity->>EGMSoftMeterA: Update with outcome
PlayerB->>EGM: Spin
EGM-EGMActivity: Process spin
EGMActivity->>EGMSoftMeterB: Update with outcome
EGM->>CasinoServers: Transmit real-time data
EGM->>TrackingServers: Update player tracking accounts
TrackingServers->>PlayerAccountA: Update data
TrackingServers->>PlayerAccountB: Update data
PlayerA-EGM: Cashout
EGM->>EGMSoftMeterA: Finalize data
EGM->>TrackingServers: Transmit final data
TrackingServers->>PlayerAccountA: Finalize tracking data
PlayerB->>EGM: Continue playing
PlayerA--EGM: Leave
PlayerB->>EGM: Cashout
EGM->>EGMSoftMeterB: Finalize data
EGM->>TrackingServers: Transmit final data
TrackingServers->>PlayerAccountB: Finalize tracking data
EGM-EGM: Reset soft meters for next session

It will be appreciated that the procedural flows and activities disclosed herein are merely specific examples of procedural flows and/or other activities which may be implemented to achieve one or more aspects of the VCLAPS! techniques described herein. Other embodiments of procedural flows (not shown) may include additional, fewer and/or different steps, actions, and/or operations than those illustrated in the example procedural diagrams of the Figures.

### Detailed Procedural Flow Descriptions for Implementing VCLAPS! EGM Concepts

### Concept 1.1: Unified Metering and Cash Box for Multiple Games

Overview: The VCLAPS! EGM supports multiple games running simultaneously while sharing a single set of meters and a cash box. From the operator's perspective, it functions as a single EGM, simplifying operational management and compliance.

### Example Procedural Flow:

Initial Interaction: Players approach the EGM and insert cash or tickets.
The unified credit system updates the player's balance.

### 2. Game Selection:

Players select from multiple games available on the same machine.
The EGM displays the selected game while sharing the same set of meters and cash box.

### 3. Gameplay:

Players engage in their chosen games, placing bets and playing as they wish.
The system tracks selected financial transactions (coins in, coins out) using a unified metering system.
Data Input: Player Inputs: Cash insertion, game selection, in-game actions.
System Inputs: Game state updates, bet amounts, win amounts, and credit adjustments.

### 4. Component Interactions:

Bill Validator: Accepts and validates currency, updating the unified credit meter.
Touchscreen Interface: Allows players to interact with the games.
Central Game Management System: Manages the operation of multiple games, ensuring resource sharing.
Data Processing: Each transaction is processed in real-time, updating the unified meters.
Selected data is consolidated to reflect the total credits available.
Outputs and Responses: Unified Credit Meter Updates: Display updated credit balances.
Cash Out Transactions: Consolidate credits from selected games into a single transaction.
Data Storage and Reporting: Selected transactions are logged in a centralized database.
This facilitates easy auditing and ensures compliance with gaming regulations.
Error Handling and Security Measures: Robust error-checking mechanisms prevent transaction errors.
Security protocols protect against fraud and tampering.
End of Interaction: Players cash out through a single transaction.
The system resets, ready for the next player, maintaining the integrity of metering and cash management.

### Concept 1.2: Flexible Game Support on a Single EGM

Overview: The VCLAPS! EGM supports various game types, including individual play, jackpot-linked games, competitive games, and cooperative missions, selected within a single machine.

### Example Procedural Flow:

Initial Interaction: Players approach the EGM and select from a variety of game types.
The selection interface allows for intuitive switching between different game modes.

### 2. Game Selection:

Players choose games based on their preferences: individual play, progressive jackpot, competitive, or cooperative missions.

### 3. Gameplay:

The game management system dynamically adjusts to handle different game mechanics.
Players' progress in individual or multiplayer modes contributes to the overall game dynamics.
Data Input: Player Inputs: Game selection, in-game actions specific to the chosen game type.
System Inputs: Adjustments based on game type (e.g., jackpot contributions, score updates).

### 4. Component Interactions:

Player Interface: Displays game selection and real-time updates.
Central Game Processor: Manages game dynamics and applies game rules.
Financial System: Manages bets, payouts, and jackpot distributions.
Data Processing: The game processor handles logic and rules for each game type.
Adjustments are made dynamically based on player interactions and system status.
Outputs and Responses: Game Outcomes: Display specific outcomes for each game type in real-time.
Financial Transactions: Managed seamlessly across different games.
Data Storage and Reporting: Selected transactional and gameplay data are logged centrally.
This ensures compliance and facilitates detailed performance analysis.
Error Handling and Security Measures: Robust error detection and handling mechanisms ensure gameplay integrity.
Security measures protect against fraud and ensure fair play.
End of Interaction: Players conclude their sessions by cashing out or exiting the game.
The system finalizes and logs selected game and financial data.

### Concept 1.3: Multiple Player Interfaces for Concurrent or Solo Play

Overview: The VCLAPS! EGM supports multiple player buttons, allowing individual players to control their gameplay independently or enabling a single player to engage with multiple games simultaneously.

### Example Procedural Flow:

Initial Interaction: Players approach the EGM and choose their preferred play mode.
The EGM adjusts its display and controls accordingly.

### 2. Game Selection:

Players select from multiple games available on the same machine.
The machine's interface dynamically adjusts to support multiplayer or solo play.

### 3. Gameplay:

In multiplayer mode, each player interacts independently with their chosen game.
In solo mode, a single player may control multiple games simultaneously.
Data Input: Player Inputs: Game selection, bets, choices within the game.
System Inputs: Synchronization of inputs based on player mode.

### 4. Component Interactions:

Multiple Player Buttons: Each button set is dedicated to a player or game.
Touchscreen/Display: Updates based on the selected mode.
Game Management System: Coordinates input processing and game responses.
Data Processing: Inputs from multiple players are processed independently.
Inputs from a single player managing multiple games are synchronized.
Outputs and Responses: Game State Updates: Reflect each player's interactions.
Financial Transactions: Handled separately for each player or game.
Data Storage and Reporting: Details from each game session are logged separately.
This maintains clear records for compliance and auditing.
Error Handling and Security Measures: Error detection mechanisms ensure accurate input processing.
Security protocols prevent tampering and ensure data integrity.
End of Interaction: Players end their game sessions by cashing out or exiting.
The system resets interfaces for the next players.
Concept 1.4: Independent Mapping of Touchscreen to Different Games

Overview: This concept uses advanced touchscreen technology to allow different sections of the touchscreen to be independently mapped to different games, enabling simultaneous interactions with multiple games on the same screen.

### Example Procedural Flow:

Initial Interaction: Players approach the EGM, which displays multiple games on the touchscreen divided into distinct sections.
Players select their games by interacting with the appropriate section of the screen.

### 2. Game Selection:

Players choose games displayed in different sections of the touchscreen.

### 3. Gameplay:

Each section of the touchscreen is independently mapped to a specific game.
Players interact with their chosen game via its designated touchscreen section.
Data Input: Player Inputs: Touch interactions within designated game zones.
System Inputs: Processing of touch inputs specific to each game zone.

### 4. Component Interactions:

Touchscreen: Segmented into different zones for each game.
Game Controllers: Manage game logic for inputs from their respective zones.
Central Processing Unit: Coordinates touchscreen and game interactions.
Data Processing: Each touch input is processed within its respective zone.
Actions in one game do not affect another.
Outputs and Responses: Visual Feedback: Each zone updates independently according to the game it represents.
Game Results: Displayed in real-time within each zone.
Data Storage and Reporting: Interaction data from each zone is stored separately.
This allows detailed tracking of player behavior and game performance.
Error Handling and Security Measures: Error-checking algorithms ensure accurate touch detection.
Security measures protect against input spoofing and ensure data integrity.
End of Interaction: Players end their sessions, and the system resets each section of the touchscreen.

### Concept 1.5: Virtual Button Mapping to Multiple Games

Overview: This concept introduces an interface where a single touchscreen supports three sets of virtual buttons, each mapped to a different game, allowing players to interact with multiple games simultaneously.

### Example Procedural Flow:

Initial Interaction: Players select the multi-game mode on the EGM.
The touchscreen interface presents segmented zones with virtual buttons for each game.

### 2. Game Selection:

Players choose games displayed in different touchscreen segments.
Each segment features a unique set of virtual buttons for its corresponding game.

### 3. Gameplay:

Players interact with the virtual buttons within their designated game zones.
Each set of virtual buttons controls its respective game independently.
Data Input: Player Inputs: Interactions with virtual buttons specific to each game.
System Inputs: Recognition and processing of inputs by game zone.

### 4. Component Interactions:

Virtual Buttons: Serve as input methods for each game.
Touchscreen: Detects and differentiates inputs across zones.
Game Management System: Ensures that inputs affect only the intended game.
Data Processing: Inputs are processed in real-time, with each virtual button set influencing its game.
Ensures independent game control without interference.
Outputs and Responses: Game State Updates: Reflect players' interactions with virtual buttons.
Financial Transactions: Managed independently for each game.
Data Storage and Reporting: Gameplay and transaction data are logged separately for each zone.
Facilitates compliance and performance analysis.
Error Handling and Security Measures: Systems ensure accurate input detection and processing.
Prevents cross-game interference and secures data handling.
End of Interaction: The game resets virtual buttons and clears the touchscreen for the next players.

### Concept 1.6: Virtual Meters for Multiple Games

Overview: This concept integrates virtual meter sets to track financial transactions for each game independently on the VCLAPS! EGM. These virtual meters may link to different player tracking accounts and are aggregated for regulatory reporting.

### Example Procedural Flow:

Initial Interaction: Players link gameplay to their tracking accounts or play anonymously.
Virtual meters update in real-time as players engage with games.

### 2. Game Selection:

Players choose from various games available on the EGM.
Each game is associated with its own set of virtual meters.

### 3. Gameplay:

Virtual meters track financial transactions (bets, wins, balances) for each game.
Meters may link to individual player accounts for personalized tracking.
Data Input: Player Inputs: Bets and game selections linked to respective virtual meters.
System Inputs: Updates to virtual meters based on game activity.

### 4. Component Interactions:

Virtual Meters: Track and update financial transactions for each game.
Player Tracking System: Optionally links meters to player accounts.
Data Processing: Virtual meters update in real-time, reflecting current financial statuses.
Data is aggregated for compliance reporting.
Outputs and Responses: Meter Updates: Displayed to players showing real-time financial status.
Aggregated Data: Used for regulatory reporting and auditing.
Data Storage and Reporting: Data from virtual meters is stored at both game and account levels.
Aggregation handled programmatically for compliance.
Error Handling and Security Measures: Ensures accuracy of financial tracking.
Protects against data manipulation or loss.
End of Interaction: System aggregates virtual meters into a unified report.
Individual game data remains accessible through player accounts.

These procedural flows illustrate the comprehensive steps involved in implementing the inventive concepts for the VCLAPS! EGM, ensuring detailed coverage from player interaction to system processing and regulatory compliance.

### Concept 1.7: Anti-Money Laundering (AML) Mechanisms

Overview: This concept incorporates AML mechanisms within the VCLAPS! EGM to monitor and report suspicious financial activities. Advanced software algorithms analyze player behavior and financial transactions in real-time to detect potential money laundering activities.

### Example Procedural Flow:

Initial Interaction: Players engage with the EGM as usual, with gameplay and financial transactions continuously monitored by AML systems.

### 2. Gameplay and Financial Monitoring:

The AML monitoring system runs in the background, analyzing player behavior and transaction patterns.
Transactions are continuously checked against predefined criteria for suspicious activity.
Data Input: Player Inputs: Regular gameplay actions and financial transactions.
System Inputs: Continuous analysis of transaction patterns compared to AML criteria.

### 3. Component Interactions:

AML Monitoring System: Analyzes data flows from gameplay and financial transactions. Central Database: Stores detailed logs of selected activities for further analysis if required.
Data Processing: The AML system evaluates every transaction against established patterns of suspicious activity.
Anomalies are flagged for further review.
Outputs and Responses: Alerts: Generated in real-time if suspicious activities are detected.
Reports: Compiled detailing selected flagged activities for further investigation or regulatory review.
Data Storage and Reporting: Selected gameplay and transaction data are logged with flagged activities highlighted.
Detailed records are maintained for easy retrieval and analysis.
Error Handling and Security Measures: Robust error detection and data validation protocols ensure accurate monitoring.
Security measures protect data integrity and player privacy.
End of Interaction: The system continues monitoring until the player disengages completely.
Selected transactions within the session are vetted for compliance.

### Concept 1.8: Single Meter Set for Financial Tracking

Overview: This concept simplifies financial tracking and regulatory compliance by consolidating selected virtual meter sets from multiple games into a single meter set, streamlining financial monitoring and auditing.

### Example Procedural Flow:

Initial Interaction: Players engage with various games, with selected their financial transactions (bets, wins) feeding into a single meter set.
The unified meter set operates invisibly in the background.

### 2. Gameplay:

Selected financial transactions are aggregated into a single meter set.
Players experience seamless financial tracking across multiple games.
Data Input: Player Inputs: Bets and wins from various games.
System Inputs: Real-time aggregation of financial transactions into the single meter set.

### 3. Component Interactions:

Financial Processing Unit: Manages data aggregation into the single meter set.
Database: Logs detailed financial transactions and aggregates them for reporting.
Data Processing: Financial transactions from selected games are aggregated in real-time.
The single meter set reflects the current financial status across selected games.
Outputs and Responses: Financial Reports: Generated from the single meter set for auditing and regulatory reporting.
Data Storage and Reporting: Aggregated financial data is stored centrally.
Provides a comprehensive overview of the EGM's financial activity for audits or reviews.
Error Handling and Security Measures: Systems ensure accurate aggregation and reporting of financial data.
Safeguards prevent data corruption or loss.
End of Interaction: The single meter set provides a consolidated report of financial activity.
Ready for regulatory compliance and operational review.
Concept 1.9: Single Bill Acceptor for Currency Management

Overview: This concept features a single bill acceptor serving as the primary currency input mechanism for the entire gaming apparatus, simplifying hardware and enhancing player interactions.

### Example Procedural Flow:

Initial Interaction: Players insert currency into the single bill acceptor.
The bill validator checks and accepts the currency, updating the unified credit meter.

### 2. Gameplay:

Players use credits from the centralized meter to play multiple games.
The EGM consolidates selected financial transactions through the single bill acceptor.
Data Input: Player Inputs: Currency insertion and game selections.
System Inputs: Currency validation and credit meter updates.

### 3. Component Interactions:

Single Bill Acceptor: Accepts various currencies and updates the credit meter.
Central Processing Unit: Manages financial transactions and credit allocation.
Data Processing: Currency is validated and credits are updated in real-time.
Financial transactions are managed centrally through the single bill acceptor.
Outputs and Responses: Credit Meter Updates: Reflect currency input and gameplay outcomes.
Cash Out Transactions: Managed centrally, providing seamless player experience.
Data Storage and Reporting: Detailed logs of selected currency transactions are stored centrally.
Facilitates easy auditing and compliance.
Error Handling and Security Measures: Advanced validation technologies ensure high security and acceptance rates.
Error detection protocols prevent transaction errors.
End of Interaction: Players cash out through a single transaction.
The system resets for the next player.

### Concept 1.10: Single Coin Box for Coin Management

Overview: This concept employs a single coin box for managing selected coin-related transactions within the EGM, simplifying hardware design and maintenance.

### Example Procedural Flow:

Initial Interaction: Players insert coins into the coin slot.
The coin validator checks and accepts the coins, updating the unified credit meter.

### 2. Gameplay:

Players use credits from the centralized meter to play multiple games.
The EGM consolidates selected coin-related transactions through the single coin box.
Data Input: Player Inputs: Coin insertion and game selections.
System Inputs: Coin validation and credit meter updates.

### 3. Component Interactions:

Single Coin Box: Accepts coins and updates the credit meter.
Central Processing Unit: Manages coin transactions and credit allocation.
Data Processing: Coins are validated and credits are updated in real-time.
Financial transactions are managed centrally through the single coin box.
Outputs and Responses: Credit Meter Updates: Reflect coin input and gameplay outcomes.
Cash Out Transactions: Managed centrally, providing seamless player experience.
Data Storage and Reporting: Detailed logs of selected coin transactions are stored centrally.
Facilitates easy auditing and compliance.
Error Handling and Security Measures: Advanced validation technologies ensure high security and acceptance rates.
Error detection protocols prevent transaction errors.
End of Interaction: Players cash out through a single transaction.
The system resets for the next player.

### Concept 1.11: Single Player Tracking Reader

Overview: This concept features a single player tracking reader to manage selected player interactions and tracking across multiple games within the EGM, simplifying hardware and enhancing player tracking efficiency.

### Example Procedural Flow:

Initial Interaction: Players insert their player tracking card into the reader.
The system verifies the card and links it to the player's profile.

### 2. Gameplay:

Player actions and gameplay data are tracked and associated with the player's profile.
Selected games within the EGM share the single tracking reader for player interactions.
Data Input: Player Inputs: Card insertion, gameplay actions.
System Inputs: Player profile verification, tracking updates.

### 3. Component Interactions:

Single Player Tracking Reader: Reads and verifies player tracking cards.
Central Processing Unit: Manages player data and tracking information.
Data Processing: Player actions are tracked in real-time and associated with their profile.
Data from selected games is consolidated through the single tracking reader.
Outputs and Responses: Player Profile Updates: Reflect gameplay actions and points earned.
Promotions and Bonuses: Managed based on tracked player activity.
Data Storage and Reporting: Detailed logs of player interactions are stored centrally.
Facilitates personalized player experiences and compliance.
Error Handling and Security Measures: Advanced verification technologies ensure accurate player tracking.
Error detection protocols prevent tracking errors.
End of Interaction: Players remove their cards and the system updates their profiles.
The system resets for the next player.

### Concept 1.12: Single EGM Running Multiple Game Sessions by Different Players

Overview: This concept allows a single EGM to run multiple game sessions concurrently for different players, enhancing the machine's utilization and player engagement.

### Example Procedural Flow:

Initial Interaction: Players approach the EGM and insert cash or tickets.
Each player selects a game from the available options.

### 2. Gameplay:

Multiple players engage in separate game sessions simultaneously.
The system manages each game session independently.
Data Input: Player Inputs: Cash insertion, game selection, in-game actions.
System Inputs: Game state updates, bet amounts, win amounts, credit adjustments.

### 3. Component Interactions:

Bill Validator: Accepts currency and updates the credit meter for each player.
Touchscreen Interface: Allows players to interact with their selected games.
Central Game Management System: Manages multiple game sessions concurrently.
Data Processing: Each game session is processed independently.
The system ensures selected data reflects accurately across concurrent game sessions.
Outputs and Responses: Credit Meter Updates: Reflect updated balances for each player.
Game Outcomes: Display specific results for each game session.
Data Storage and Reporting: Selected transactions are logged in a centralized database.
Facilitates easy auditing and ensures compliance with gaming regulations.
Error Handling and Security Measures: Robust error-checking mechanisms prevent transaction errors.
Security protocols protect against fraud and tampering.
End of Interaction: Players cash out through individual transactions.
The system resets each game session for new players.
   Concept 1.13: Multiple Different Concurrent Games with Different Paytables and Volatilities

Overview: This concept allows a single EGM to offer multiple different games concurrently, each with its own paytable and volatility, providing a diverse gaming experience.

### Example Procedural Flow:

Initial Interaction: Players approach the EGM and insert cash or tickets.
Players select from a variety of games with different paytables and volatilities.

### 2. Gameplay:

Players engage with their selected games, experiencing different paytables and volatilities.
The system manages each game independently while providing a unified experience.
Data Input: Player Inputs: Cash insertion, game selection, in-game actions.
System Inputs: Game state updates, bet amounts, win amounts, credit adjustments.

### 3. Component Interactions:

Bill Validator: Accepts currency and updates the credit meter for each player.
Touchscreen Interface: Allows players to interact with their chosen games.
Central Game Management System: Manages the operation of multiple games.
Data Processing: Each game's unique paytable and volatility are applied in real-time.
The system ensures accurate application of game rules and payouts.
Outputs and Responses: Credit Meter Updates: Reflect updated balances based on individual game outcomes.
Game Outcomes: Display specific results for each game.
Data Storage and Reporting: Selected transactions are logged in a centralized database.
Facilitates easy auditing and ensures compliance with gaming regulations.
Error Handling and Security Measures: Robust error-checking mechanisms ensure accurate application of paytables.
Security protocols protect against fraud and ensure data integrity.
End of Interaction: Players cash out through individual transactions.
The system resets each game session for new players.

These detailed procedural flows for each inventive concept of the VCLAPS! EGM cover every aspect of player interaction, system processing, and compliance, ensuring a comprehensive and robust gaming experience.

### Concept 1.14: Head-to-Head (Competitive) Game Play & Betting Modes

Overview: This concept introduces head-to-head competitive game play and betting modes within the VCLAPS!EGM, allowing players to compete directly against each other.

### Example Procedural Flow:

Initial Interaction: Players approach the EGM and insert cash or tickets.
Players select the head-to-head competitive mode from the game options.

### 2. Game Setup:

The EGM pairs players for competition.
Players place their bets and the game rules for head-to-head competition are displayed.

### 3. Gameplay:

Players engage in competitive gameplay, with each player's actions influencing the outcome.
The system tracks each player's performance and updates scores in real-time.
Data Input: Player Inputs: Bet amounts, in-game actions.
System Inputs: Game state updates, score tracking, bet adjustments.

### 4. Component Interactions:

Touchscreen Interface: Allows players to interact with the competitive game.
Central Game Processor: Manages the head-to-head competition rules and real-time updates.
Data Processing: The system processes each player's actions independently and updates scores.
Competitive outcomes are determined based on predefined game rules.
Outputs and Responses: Score Updates: Displayed in real-time to both players.
Game Outcomes: Determined based on competitive performance, with the winner receiving the payout.
Data Storage and Reporting: Selected competitive game transactions and scores are logged in a centralized database.
Facilitates easy auditing and ensures compliance with gaming regulations.
Error Handling and Security Measures: Robust error-checking mechanisms ensure fair play and accurate score tracking.
Security protocols protect against fraud and ensure data integrity.
End of Interaction: The winner receives their payout, and the system updates the credit meters accordingly.
The system resets for the next competitive session.

### Concept 1.15: Team Play (Cooperative) Game Play & Betting Modes

Overview: This concept introduces team play cooperative game play and betting modes, allowing players to collaborate towards a common goal within the VCLAPS! EGM.

### Example Procedural Flow:

Initial Interaction: Players approach the EGM and insert cash or tickets.
Players select the team play cooperative mode from the game options.

### 2. Game Setup:

The EGM groups players into teams.
Players place their bets and the game rules for team play are displayed.

### 3. Gameplay:

Players collaborate in their gameplay, with their combined efforts influencing the outcome.
The system tracks each team's performance and updates scores in real-time.
Data Input: Player Inputs: Bet amounts, in-game actions.
System Inputs: Game state updates, score tracking, bet adjustments.

### 4. Component Interactions:

Touchscreen Interface: Allows players to interact with the cooperative game.
Central Game Processor: Manages the team play rules and real-time updates.
Data Processing: The system processes each player's actions and updates team scores.
Cooperative outcomes are determined based on predefined game rules.
Outputs and Responses: Score Updates: Displayed in real-time to selected team members.
Game Outcomes: Determined based on team performance, with rewards distributed among team members.
Data Storage and Reporting: Selected cooperative game transactions and scores are logged in a centralized database.
Facilitates easy auditing and ensures compliance with gaming regulations.
Error Handling and Security Measures: Robust error-checking mechanisms ensure fair play and accurate score tracking.
Security protocols protect against fraud and ensure data integrity.
End of Interaction: Rewards are distributed among team members, and the system updates the credit meters accordingly.
The system resets for the next cooperative session.
   Concept 1.16: Virtual Machines and Virtual Meter Sets That Combine into One ‘Physical’ Meter Set to Report to Game Server

Overview: This concept integrates virtual machines and virtual meter sets that combine into one ‘physical’ meter set for reporting purposes, streamlining financial tracking and compliance.

### Example Procedural Flow:

Initial Interaction: Players approach the EGM and select their games.
Each game operates as a virtual machine with its own virtual meter set.

### 2. Gameplay:

Players engage with their chosen games, with financial transactions tracked by virtual meters.
The system aggregates virtual meter data into a single ‘physical’ meter set for reporting.
Data Input: Player Inputs: Bets, game selections, in-game actions.
System Inputs: Virtual meter updates, financial transactions.

### 3. Component Interactions:

Virtual Machines: Operate independently, each with its own virtual meter.
Financial Processing Unit: Aggregates virtual meter data into a single ‘physical’ meter set.
Data Processing: Virtual meter data is processed in real-time and aggregated.
The aggregated data is reported as a single ‘physical’ meter set.
Outputs and Responses: Meter Updates: Display aggregated financial status.
Financial Reports: Generated from the single ‘physical’ meter set for regulatory compliance.
Data Storage and Reporting: Aggregated financial data is stored centrally.
Facilitates compliance and detailed performance analysis.
Error Handling and Security Measures: Systems ensure accurate aggregation and reporting of financial data.
Safeguards prevent data corruption or loss.
End of Interaction: The system provides a consolidated report of financial activity.
Ready for regulatory compliance and operational review.

### Concept 1.17: Dividing Awards, Payouts, Prizes Between Players (Proportionality)

Overview: This concept focuses on dividing awards, payouts, and prizes between players based on their contributions, ensuring fair distribution within the VCLAPS! EGM.

### Example Procedural Flow:

Initial Interaction: Players approach the EGM and select their games.
The system tracks each player's contribution to the game outcomes.

### 2. Gameplay:

Players engage with their chosen games, with the system tracking their performance.
Contributions are recorded for proportional distribution of rewards.
Data Input: Player Inputs: Bets, game selections, in-game actions.
System Inputs: Performance tracking, contribution calculations.

### 3. Component Interactions:

Game Management System: Tracks each player's contributions.
Reward Distribution Processor: Calculates proportional awards based on contributions.
Data Processing: Each player's contributions are processed in real-time.
Proportional awards are calculated based on predefined rules.
Outputs and Responses: Reward Notifications: Displayed to players showing their proportional awards.
Financial Transactions: Managed based on calculated awards.
Data Storage and Reporting: Detailed logs of contributions and awards are stored centrally.
Facilitates compliance and detailed performance analysis.
Error Handling and Security Measures: Systems ensure accurate tracking and calculation of contributions.
Security protocols protect against fraud and ensure data integrity.
End of Interaction: Players receive their proportional rewards, and the system updates the credit meters.
The system resets for the next gaming session.

### Concept 1.18: Players Bet Against Each Other: Double Down During Competition

Overview: This concept allows players to bet against each other and double down during competitive gameplay within the VCLAPS! EGM.

### Example Procedural Flow:

Initial Interaction: Players approach the EGM and insert cash or tickets.
Players select the competitive mode and the option to bet against each other.

### 2. Game Setup:

The EGM pairs players for competition
Players place initial bets and have the option to double down during gameplay.

### 3. Gameplay:

Players engage in competitive gameplay, placing additional bets and doubling down as desired.
The system tracks each player's bets and updates their balances in real-time.
Data Input: Player Inputs: Initial bets, in-game actions, double down bets.
System Inputs: Game state updates, bet tracking, score updates.

### 4. Component Interactions:

Touchscreen Interface: Allows players to interact with the competitive game.
Central Game Processor: Manages competitive rules and bet tracking.
Data Processing: The system processes each bet and action, updating player balances.
Competitive outcomes are determined based on predefined game rules.
Outputs and Responses: Score and Bet Updates: Displayed in real-time to both players.
Game Outcomes: Determined based on competitive performance and bet results.
Data Storage and Reporting: Selected competitive game transactions and scores are logged in a centralized database.
Facilitates easy auditing and ensures compliance with gaming regulations.
Error Handling and Security Measures: Robust error-checking mechanisms ensure fair play and accurate bet tracking.
Security protocols protect against fraud and ensure data integrity.
End of Interaction: The winner receives their payout, including any doubled down amounts.
The system updates credit meters and resets for the next competitive session.

### Concept 1.19: Multiple Player Tracking Cards Linked to the EGM for Tax and Regulatory Purposes

Overview: This concept allows multiple player tracking cards to be linked to the VCLAPS! EGM for tax and regulatory reporting purposes, ensuring each player's activity is accurately recorded.

### Example Procedural Flow:

Initial Interaction: Players insert their tracking cards into the EGM.
The system verifies and links each card to the respective player profile.

### 2. Gameplay:

Players engage with their chosen games, and their activity is tracked and linked to their cards.
The system updates player profiles with gameplay and financial data.
Data Input: Player Inputs: Card insertion, game selections, in-game actions.
System Inputs: Player verification, profile updates, transaction tracking.

### 3. Component Interactions:

Player Tracking Readers: Verify and link tracking cards.
Central Processing Unit: Manages player data and updates profiles.
Data Processing: Each player's activity is tracked in real-time and associated with their card.
Data is processed for tax and regulatory reporting.
Outputs and Responses: Player Profile Updates: Reflect gameplay actions and financial transactions.
Regulatory Reports: Generated for compliance based on tracked data.
Data Storage and Reporting: Detailed logs of player activity are stored centrally.
Facilitates personalized player experiences and compliance with tax regulations.
Error Handling and Security Measures: Advanced verification technologies ensure accurate player tracking.
Error detection protocols prevent tracking errors and data loss.
End of Interaction: Players remove their cards, and the system finalizes updates to their profiles.
The system resets for the next players.

### Concept 1.20: For Tax Purposes, Individual Game Winnings Reported Under Players' Tax IDs

Overview: This concept ensures that individual game winnings are reported under the respective players' tax IDs, facilitating accurate tax reporting and compliance.

### Example Procedural Flow:

Initial Interaction: Players insert their tracking cards into the EGM.
The system verifies and links each card to the respective player profile.

### 2. Gameplay:

Players engage with their chosen games, and their winnings are tracked and associated with their tax IDs.
The system updates player profiles with gameplay and financial data.
Data Input: Player Inputs: Card insertion, game selections, in-game actions.
System Inputs: Player verification, profile updates, transaction tracking.

### 3. Component Interactions:

Player Tracking Readers: Verify and link tracking cards.
Central Processing Unit: Manages player data and updates profiles.
Data Processing: Each player's winnings are tracked in real-time and associated with their tax ID.
Data is processed for tax reporting.
Outputs and Responses: Player Profile Updates: Reflect gameplay actions and winnings.
Tax Reports: Generated for compliance based on tracked data.
Data Storage and Reporting: Detailed logs of player winnings are stored centrally.
Facilitates accurate tax reporting and compliance.
Error Handling and Security Measures: Advanced verification technologies ensure accurate player tracking.
Error detection protocols prevent tracking errors and data loss.
End of Interaction: Players remove their cards, and the system finalizes updates to their profiles.

The system generates required tax reports and resets for the next players.

These detailed procedural flows provide a comprehensive guide for implementing the inventive concepts of the VCLAPS! EGM, ensuring robust and compliant gaming experiences for players and operators alike.

### Concept 1.21: Rewards Based on Player Longevity and Loyalty

Overview: This concept introduces a reward system within the VCLAPS! EGM that provides incentives based on player longevity and loyalty. Players accumulate points or rewards the longer they play and the more frequently they return, enhancing player engagement and retention.

### Example Procedural Flow:

Initial Interaction: Players insert their player tracking card into the EGM.
The system verifies the player's identity and retrieves their profile.

### 2. Profile Check and Reward Status:

The system checks the player's history, including total playtime, frequency of visits, and accumulated loyalty points.
Current rewards status is displayed to the player, showing progress towards the next reward tier. 3. Gameplay and Points Accumulation:
Players engage with their chosen games, and the system tracks playtime and actions in real-time.
Players earn loyalty points based on the duration of play, amount wagered, and frequency of visits.
Data Input: Player Inputs: Card insertion, game selections, in-game actions.
System Inputs: Playtime tracking, wager amounts, visit frequency.

### 4. Component Interactions:

Player Tracking System: Monitors player activity and updates loyalty points.
Game Management System: Ensures accurate tracking of gameplay and points accumulation.
Reward Processor: Manages the calculation and allocation of rewards based on predefined criteria.
Data Processing: The system processes player activity data in real-time, updating loyalty points and rewards status.
Rewards are calculated based on accumulated points, playtime, and visit frequency.
Outputs and Responses: Loyalty Points Updates: Displayed to players in real-time, showing progress and points earned.
Reward Notifications: Inform players when they reach new reward tiers or earn bonuses.
Player Feedback: Regular updates and messages about their current status and upcoming rewards.

### 5. Reward Distribution:

Players may redeem accumulated loyalty points for rewards such as free spins, bonus credits, or physical gifts.
The system manages the distribution of rewards, updating the player's profile accordingly.
Data Storage and Reporting: Detailed logs of player activity, loyalty points, and rewards are stored centrally.
Facilitates easy auditing and ensures compliance with loyalty program rules.
Error Handling and Security Measures: Advanced verification technologies ensure accurate tracking of player activity and points.
Error detection protocols prevent tracking errors and ensure data integrity.
End of Interaction: Players remove their cards, and the system finalizes updates to their profiles.
Loyalty points and rewards status are updated and stored for future sessions.
The system resets for the next player, ready to track new loyalty activities.

### Detailed Steps:

### 1. Player Identification:

Player inserts tracking card.
System verifies identity and retrieves profile.

### 2. Profile and Reward Status Display:

Display current points and reward tier status.
Show progress towards the next reward level.

### 3. Gameplay Tracking:

Track playtime, wager amounts, and visit frequency.
Update loyalty points in real-time based on predefined criteria.

### 4. Points Accumulation:

Award points for each minute of playtime.
Additional points for wagers exceeding certain thresholds.
Bonus points for consecutive days of play or frequent visits.

### 5. Reward Notifications:

Notify player when reaching new tiers or earning bonuses.
Display messages about available rewards and redemption options.

### 6. Reward Redemption:

Allow players to redeem points for rewards.
Update player profile with redeemed rewards and new points balance.

### 7. Data Logging and Reporting:

Log selected player activity, points earned, and rewards redeemed.
Generate reports for auditing and compliance.

### 8. End Session:

Player removes card, finalizing profile updates.
System resets for the next player.

This procedural flow ensures a comprehensive and rewarding experience for players based on their loyalty and longevity, encouraging continued engagement with the VCLAPS! EGM.

### Concept 1.22: Real-Time Multi-Player Soft Meter Tracking and Player Tracking Account Logging

Overview: This concept implements real-time multi-player soft meter tracking and player tracking account logging within the VCLAPS! EGM. The system tracks each player's in-game activities and financial transactions, logging them to individual player accounts in real-time, enhancing transparency and personalized player experiences.

### Example Procedural Flow:

Initial Interaction: Players insert their player tracking cards into the EGM.
The system verifies each player's identity and retrieves their profiles.

### 2. Game Selection and Setup:

Players select their games from the available options on the EGM.
The system allocates soft meters to each player to track individual in-game activities and financial transactions.

### 3. Gameplay and Real-Time Tracking:

Players engage in their chosen games.
The system continuously updates each player's soft meter in real-time, tracking bets, wins, losses, and other in-game activities.
Data Input: Player Inputs: Card insertion, game selections, bets, in-game actions.
System Inputs: Game state updates, financial transactions, soft meter updates.

### 4. Component Interactions:

Player Tracking Readers: Verify and link tracking cards to player profiles.
Soft Meters: Track in-game activities and financial transactions for each player.
Game Management System: Manages game operations and updates soft meters.
Central Processing Unit: Coordinates real-time data processing and account logging.
Data Processing: The system processes player actions and financial transactions in real-time.
Soft meters for each player are updated continuously, reflecting current game activities and financial statuses.
Outputs and Responses: Soft Meter Updates: Displayed to players in real-time, showing current bets, wins, and losses.
Player Account Logging: Each player's activities and transactions are logged to their tracking account.
Data Storage and Reporting: Detailed logs of player activities and soft meter data are stored centrally.
Facilitates easy auditing and ensures compliance with regulatory standards.
Error Handling and Security Measures: Advanced verification technologies ensure accurate tracking of player activities and soft meters.
Error detection protocols prevent tracking errors and ensure data integrity.
Security measures protect against data tampering and fraud.
End of Interaction: Players remove their cards, and the system finalizes updates to their profiles and soft meters.
The system logs selected activities and transactions to the players' accounts.
The EGM resets for the next players.

### Detailed Steps:

### 1. Player Identification:

Players insert tracking cards into the EGM.
System verifies identities and retrieves profiles.

### 2. Game Selection:

Players choose games from the available options.
System allocates soft meters to each player for tracking purposes.

### 3. Gameplay Tracking:

Track in-game activities, including bets, wins, and losses in real-time.
Update soft meters continuously based on player actions.

### 4. Soft Meter Management:

Each player's activities are tracked by their allocated soft meter.
Soft meters reflect real-time updates of bets, wins, and other financial transactions.

### 5. Account Logging:

Log selected player activities and transactions to individual player tracking accounts.
Provide real-time updates to players on their activities and financial status.
Data Storage and Reporting: Store detailed logs of selected activities and soft meter data centrally.
Generate reports for auditing and compliance purposes.
Error Handling and Security Measures: Ensure accurate tracking and logging of player activities.
Implement error detection protocols to maintain data integrity.
Secure data against tampering and fraud.

### 6. End Session:

Players remove their cards, finalizing profile and soft meter updates.
Log selected activities to player accounts for future reference.
System resets for the next players.

This procedural flow ensures comprehensive real-time tracking and logging of multi-player activities, enhancing transparency and personalized experiences while maintaining compliance and data integrity within the VCLAPS!EGM.

Although several example embodiments of one or more aspects and/or features have been described in detail herein with reference to the accompanying drawings, it is to be understood that aspects and/or features are not limited to these precise embodiments, and that various changes and modifications may be effected therein by one skilled in the art without departing from the scope of spirit of the invention(s) as defined, for example, in the appended claims.

1. A first server system for improving the functionality of a physical electronic gaming machine (EGM) by enabling individualized player account transactions on a shared, regulated gaming terminal, the system comprising:
at least one network interface for receiving, from a single EGM communicatively coupled to the first server system, financial transaction data and game activity data, the EGM comprising a display interface, at least one credit input device, and at least one cash dispensing device;
at least one processor; and
a non-transient memory storing instructions that, when executed by the at least one processor, cause the first server system to be operable for:
the first server system establishing and maintaining, within the memory, a plurality of distinct virtual meters, wherein each virtual meter of the plurality of virtual meters is exclusively associated with a distinct game session from a plurality of concurrent game sessions presented on the display interface of the single EGM, thereby creating a specific data structure that enables individualized financial accounting for each of the plurality of concurrent game sessions;
the first server system receiving, from the EGM via the at least one network interface, a request for a first financial transaction associated with a first player account and a first virtual meter of the plurality of virtual meters, the first player account being maintained in a player account database distinct from operational funds of the EGM;
the first server system processing the first financial transaction by transforming raw transaction data in the request into authenticated database commands that cause an update to the first virtual meter and initiate a corresponding financial update to the first player account, thereby overcoming the technical problem of managing granular, independent financial transactions on a shared hardware platform;
the first server system receiving game activity data from the EGM corresponding to player interactions within the plurality of concurrent game sessions, and in response, updating one or more virtual meters of the plurality of virtual meters based on the received game activity data; and
the first server system transforming data derived from the plurality of virtual meters into a formatted data packet for aggregation into a single unified regulatory meter associated with the EGM, the single unified regulatory meter being distinct from the plurality of virtual meters and configured for providing a consolidated EGM financial overview for regulatory compliance, wherein the dual-architecture of maintaining the plurality of distinct virtual meters separate from the single unified regulatory meter improves the functionality of the first server system by enabling concurrent, individualized financial control on the shared physical EGM while maintaining streamlined regulatory reporting.

2. The first server system of claim 1, wherein the first financial transaction is a fund withdrawal transaction initiated at the EGM to withdraw funds from the first player account, and wherein processing the first financial transaction comprises:
the first server system initiating a debit from the first player account; and
the first server system generating and transmitting an encrypted command packet to the EGM, the encrypted command packet being uniquely interpreted by a microcontroller of the EGM to activate motors and optical sensors of the at least one cash dispensing device for dispensing a precise amount of physical currency corresponding to the fund withdrawal transaction, thereby providing a secure hardware-level implementation of the withdrawal.

3. The first server system of claim 1, wherein the first financial transaction is a fund deposit transaction initiated at the EGM to deposit physical currency into the first player account, and wherein processing the first financial transaction comprises:
the first server system receiving, from the EGM, a confirmation of receipt of the physical currency via the at least one credit input device; and
the first server system initiating a corresponding credit to the first player account in the player account database.

4. The first server system of claim 1, wherein the instructions, when executed by the at least one processor, further cause the first server system to be operable for:
the first server system receiving authentication data for a first player associated with the first player account from the EGM, the authentication data comprising at least data from a player tracking card and a personal identification number (PIN); and
the first server system authorizing the first financial transaction only upon successful verification of the authentication data, thereby improving security of the EGM as a financial terminal.

5. The first server system of claim 1, wherein the display interface of the EGM is a unitary touchscreen display, and wherein the instructions, when executed by the at least one processor, further cause the first server system to be operable for:
the first server system causing the unitary touchscreen display to be dynamically segmented into a plurality of distinct interface segments, wherein each distinct interface segment corresponds to one of the plurality of concurrent game sessions and comprises a set of virtual controls; and
the first server system processing touch inputs by identifying coordinates of a touch within one of the plurality of distinct interface segments and isolating the touch input to control only the corresponding concurrent game session, thereby providing an improved human-computer interface for managing multiple games on a single device.

6. The first server system of claim 1, wherein the instructions, when executed by the at least one processor, further cause the first server system to be operable for:
the first server system performing, at the EGM in near real-time, a localized anti-money laundering analysis by analyzing financial transaction data and gameplay behavior data associated with the first virtual meter to detect suspicious patterns at a point of origin;
the first server system calculating, as part of the localized anti-money laundering analysis, a ratio of a total wagered amount to a total deposited amount for the distinct game session associated with the first virtual meter; and
the first server system generating an anti-money laundering alert if the calculated ratio falls below a predefined minimal play threshold, thereby providing a specific technological improvement to how gaming technology addresses financial crime risks.

7. The first server system of claim 1, wherein at least one game session of the plurality of concurrent game sessions is a cooperative game session involving a plurality of players, and wherein the instructions, when executed by the at least one processor, further cause the first server system to be operable for:
the first server system tracking specific in-game actions performed by each of the plurality of players during the cooperative game session;
the first server system calculating a weighted contribution score for each of the plurality of players based on the tracked in-game actions; and
the first server system calculating, based on the weighted contribution score for each of the plurality of players, a proportional share of a collective award for each of the plurality of players, thereby enabling a fair and automated distribution of rewards in a complex multi-player environment.

8. The first server system of claim 5, wherein the first server system is further operable for associating a first virtual meter with a first distinct interface segment and a second virtual meter with a second distinct interface segment, thereby enabling simultaneous, financially-independent gaming sessions for a first player and a second player on the single EGM.

9. The first server system of claim 1, wherein the instructions, when executed by the at least one processor, further cause the first server system to be operable for:
the first server system receiving, from the single EGM, identification data from multiple distinct player tracking cards inserted into a single player tracking card reader of the EGM; and
the first server system associating a different virtual meter of the plurality of virtual meters with each of the multiple distinct player tracking cards for individualized tax and regulatory reporting for each player.

10. A method for improving the functionality of a physical electronic gaming machine (EGM) by enabling concurrent, individualized player account transactions on a shared, regulated gaming terminal, the method being implemented in a system including the single EGM and a first server system, the EGM comprising a display interface, at least one credit input device, and at least one cash dispensing device, and the first server system comprising at least one processor and a non-transient memory storing a plurality of instructions;
the method comprising causing the at least one processor of the first server system to execute the plurality of instructions for:
maintaining, by the first server system within the memory, a plurality of distinct virtual meters, wherein each virtual meter of the plurality of virtual meters is exclusively associated with a distinct game session from a plurality of concurrent game sessions presented on the display interface of the single EGM, thereby creating a specific data structure that enables individualized financial accounting for each of the plurality of concurrent game sessions;
receiving, by the first server system from the EGM, a request for a first financial transaction associated with a first player account and a first virtual meter of the plurality of virtual meters, the first player account being maintained in a player account database distinct from operational funds of the EGM;
processing, by the first server system, the first financial transaction by transforming raw transaction data in the request into authenticated database commands that cause an update to the first virtual meter and initiate a corresponding financial update to the first player account, thereby overcoming the technical problem of managing granular, independent financial transactions on a shared hardware platform; and
transforming, by the first server system, data derived from the plurality of virtual meters into a formatted data packet for aggregation into a single unified regulatory meter associated with the EGM, the single unified regulatory meter being distinct from the plurality of virtual meters and configured for providing a consolidated EGM financial overview for regulatory compliance, wherein the dual-architecture of maintaining the plurality of distinct virtual meters separate from the single unified regulatory meter provides a technical solution that enables concurrent, individualized financial control on the shared physical EGM while maintaining streamlined regulatory reporting.

11. The method of claim 10, wherein the first financial transaction is a fund withdrawal transaction from the first player account that is performed independent of any immediate wager-based gaming activity on the EGM, thereby transforming the EGM into a versatile financial terminal for a player's casino account.

12. The method of claim 10, further comprising causing the at least one processor of the first server system to execute the plurality of instructions for:
receiving, by the first server system via an encrypted communication channel from the EGM, a request to authenticate a player for the first financial transaction; and
transmitting, by the first server system, an authorization command to the EGM for the first financial transaction only upon successful authentication of the player, thereby improving security of the EGM as a financial terminal.

13. The method of claim 10, further comprising causing the at least one processor of the first server system to execute the plurality of instructions for:
monitoring, by the first server system, for a structuring pattern in financial transactions associated with the first virtual meter, wherein the structuring pattern comprises a plurality of cash-in transactions that are individually below a first monetary threshold but collectively exceed a second monetary threshold within a defined time window; and
generating, by the first server system, an anti-money laundering alert upon detection of the structuring pattern.

14. The method of claim 10, wherein the display interface of the EGM is a unitary touchscreen display, the method further comprising causing the at least one processor of the first server system to execute the plurality of instructions for:
causing, by the first server system, the EGM to present a segmented user interface on the unitary touchscreen display, wherein each segment of the segmented user interface is independently mapped to one of the plurality of concurrent game sessions; and
isolating player input received within one segment to control only the game session mapped to that segment, thereby providing an improved human-computer interface for managing multiple games on a single device.

15. The method of claim 10, further comprising:
receiving, by the first server system, game activity data corresponding to player interactions within one or more of the plurality of concurrent game sessions; and
updating, by the first server system, one or more virtual meters of the plurality of virtual meters in real-time based on the received game activity data.

16. The method of claim 12, wherein receiving the request to authenticate the player comprises receiving data from a player tracking card and a personal identification number (PIN).

17. The method of claim 10, wherein the first financial transaction is a fund deposit transaction initiated at the EGM to deposit physical currency into the first player account, and wherein processing the transaction comprises initiating a corresponding credit to the first player account.

18. The method of claim 14, further comprising mapping a first virtual meter to a first segment of the segmented user interface and a second virtual meter to a second segment, thereby enabling simultaneous, financially-independent gaming sessions for two distinct players on the single EGM.

19. The method of claim 10, wherein at least one game session is a cooperative game session, the method further comprising:
tracking, by the first server system, in-game actions for a plurality of players;
calculating, by the first server system, a weighted contribution score for each player based on the tracked actions; and
calculating, by the first server system, a proportional share of a collective award for each player based on the weighted contribution score.

20. A gaming system for improving human-computer interaction and providing individualized financial services on a shared gaming terminal, the system comprising:
a single electronic gaming machine (EGM) comprising a unitary touchscreen display, a credit input device, a cash dispensing device, and a single player tracking card reader, the EGM being configured for executing a plurality of game applications concurrently; and
a first server system communicatively coupled to the EGM, the first server system comprising a processor and a memory, the memory storing instructions that, when executed by the processor, cause the first server system to be operable for:
the first server system causing the unitary touchscreen display of the single EGM to be dynamically segmented into a plurality of distinct interface segments, each distinct interface segment being mapped to one of a plurality of concurrently selectable games and displaying a unique game interface for independent player interaction;
the first server system establishing, in response to a first player selecting a first game via a first distinct interface segment, a first virtual meter associated with a first player account, wherein the first player account is identified via the single player tracking card reader and maintained in a player account database distinct from operational funds of the EGM;
the first server system, in response to receiving a financial transaction request from the EGM initiated by the first player, processing the financial transaction by causing a corresponding update to the first virtual meter and initiating an update to the first player account, wherein the financial transaction utilizes the credit input device or the cash dispensing device of the EGM to execute a deposit to or a withdrawal from the first player account; and
the first server system providing data from the first virtual meter for aggregation into a single unified regulatory meter for the EGM, wherein the specific combination of the dynamically segmented unitary touchscreen display, the shared physical EGM hardware, and the server-managed, distinct first virtual meter provides a technical solution that improves the EGM's functionality by enabling concurrent, independent game sessions with individualized player account transactions on the single EGM.

21. The gaming system of claim 20, wherein the first server system is further operable for:
the first server system establishing, in response to a second player selecting a second game via a second distinct interface segment of the unitary touchscreen display, a second virtual meter associated with a second player account identified via the single player tracking card reader; and
the first server system managing the first virtual meter and the second virtual meter concurrently and independently to enable simultaneous, distinct gaming sessions for the first player and the second player on the single EGM.

22. The gaming system of claim 20, wherein the financial transaction is a withdrawal from the first player account, and wherein the first server system is further operable for:
the first server system authenticating the first player by verifying a personal identification number (PIN) received from the EGM;
the first server system verifying a balance of the first player account; and
the first server system generating and transmitting an authorization command to the EGM that causes the cash dispensing device to physically dispense currency only after successful authentication and verification, thereby tying the server's logical authorization to a physical transformation.

23. The gaming system of claim 20, wherein the single player tracking card reader, the credit input device, and the cash dispensing device are shared physical hardware resources managed by the first server system to service a plurality of independent game sessions running concurrently on the unitary touchscreen display.

24. The gaming system of claim 20, wherein the first server system is further operable for processing touch inputs received from the EGM by identifying coordinates of a touch within the first distinct interface segment and routing a corresponding game control command exclusively to a game application associated with the first game.

25. The gaming system of claim 20, wherein the first server system performs a localized anti-money laundering analysis by calculating a ratio of a total wagered amount to a total deposited amount for the first virtual meter and generating an alert if the ratio falls below a predefined threshold.

26. The gaming system of claim 21, wherein at least one of the concurrently selectable games is a head-to-head competitive game, and wherein the first server system is further operable for resolving a bet between the first player account and the second player account based on an outcome of the head-to-head competitive game.

27. The gaming system of claim 22, wherein authenticating the first player further comprises verifying biometric data received from a biometric sensor on the EGM.

28. The gaming system of claim 20, wherein the plurality of concurrently selectable games includes a first game with a first volatility level and a second game with a second, different volatility level, and wherein the first server system manages virtual meters for both games concurrently.
